(19) United States
(12) Patent Application Publication
(10) Pub. No.: US 2026/0124760 A1
(43) Pub. Date: May 7, 2026

(54) ROBOTIC PACKAGE HANDLING SYSTEMS AND METHODS

(71) Applicant: AMBI Robotics, Inc., Berkeley, CA (US)

(72) Inventor: Jeffrey B. Mahler, Berkeley, CA (US)

(73) Assignee: AMBI Robotics, Inc., Berkeley, CA (US)

(21) Appl. No.: 19/295,531

(22) Filed: Aug. 8, 2025

Related U.S. Application Data
(63) Continuation-in-part of application No. 18/974,775, filed on Dec. 9, 2024.
(60) Provisional application No. 63/681,086, filed on Aug. 8, 2024.

(51) Int. Cl. B25J 9/16; B07C 5/10; B07C 5/36; B25J 9/00; B25J 15/06

(52) U.S. Cl. CPC B25J 9/1697; B07C 5/10; B07C 5/362; B25J 9/0093; B25J 9/1687; B25J 15/0616; B07C 2501/0063

(57) ABSTRACT

One embodiment is directed to a robotic package handling system, comprising: an input assembly configured to receive a plurality of items as they are sequenced upon the input assembly; a gantry sortation assembly operatively coupled to the input assembly, the gantry sortation assembly comprising a frame assembly movably coupled to a first horizontal member, the first horizontal member movably coupled to a vertical grasping assembly comprising a distal grasping end effector, wherein the distal grasping end effector is configured to reach the plurality of items on the input assembly and a plurality of output structures transiently positioned about a perimeter within the frame assembly and configured to be movable away from the frame without further use of the gantry sortation assembly; a first imaging assembly positioned and oriented to capture image information pertaining to the plurality of items, input assembly, and gantry sortation assembly; and a first computing system.

### RELATED APPLICATION DATA

This application claims priority to U.S. Provisional Ser. No. 63/681,086 titled “ROBOTIC PACKAGE HANDLING SYSTEMS AND METHODS,” filed on Aug. 8, 2024 and is a Continuation-in-Part of U.S. Ser. No. 18/974,775 titled “ROBOTIC PACKAGE HANDLING SYSTEMS AND METHODS,” filed Dec. 9, 2024. The entire disclosures of the above applications are expressly incorporated by reference herein.

### FIELD OF THE INVENTION

This invention relates generally to the field of robotics, and more specifically to a new and useful system and method for planning and adapting to object manipulation by a robotic system. More specifically the present invention relates to robotic systems and methods for managing and processing packages.

### BACKGROUND

Many industries are adopting forms of automation. Robotic systems, and robotic arms specifically, are increasingly being used to help with the automation of manual tasks. The cost and complexity involved in integrating robotic automation, however, are limiting this adoption.

Because of the diversity of possible uses, many robotic systems are either highly customized and uniquely designed for a specific implementation or are very general robotic systems. The highly specialized solutions can only be used in limited applications. The general systems will often require a large amount of integration work to program and setup for a specific implementation. This can be costly and time consuming.

Further complicating the matter, many potential uses of robotic systems have changing conditions. Traditionally, robots have been designed and configured for various uses in industrial and manufacturing settings. These robotic systems generally perform very repetitive and well-defined tasks. The increase in e-commerce, however, is resulting in more demand for forms of automation that must deal with a high degree of changing or unknown conditions. Many robotic systems are unable to handle a wide variety of objects and/or a constantly changing variety of objects, which can make such robotic systems poor solutions for the product handling tasks resulting from e-commerce. Thus, there is a need in the robotics field to create a new and useful system and method for planning and adapting to object manipulation by a robotic system. This invention provides such new and useful systems and methods.

### SUMMARY

One embodiment is directed to a robotic package handling system, comprising: an input assembly configured to receive a plurality of items as they are sequenced upon the input assembly; a gantry sortation assembly operatively coupled to the input assembly, the gantry sortation assembly comprising a frame assembly movably coupled to a first horizontal member, the first horizontal member movably coupled to a vertical grasping assembly comprising a distal grasping end effector, wherein the distal grasping end effector is configured to reach the plurality of items on the input assembly as well as a plurality of output structures transiently positioned about a perimeter within the frame assembly and configured to be movable away from the frame without further use of the gantry sortation assembly; a first imaging assembly positioned and oriented to capture image information pertaining to the plurality of items, input assembly, and gantry sortation assembly; and a first computing system operatively coupled to the gantry sortation assembly and first imaging assembly, and configured to receive the image information from the first imaging assembly and command movements of the gantry sortation assembly based at least in part upon the image information; wherein the first computing system is configured to operate the gantry sortation assembly to move a targeted item from the input assembly based at least in part upon the image information, and release the targeted item into a targeted output structure with a position and orientation relative to the targeted output structure that is based at least in part upon the image information. The input assembly may be selected from the group consisting of: a table, a conveyance, a robot, a bin, a container, a chute, and a tray. The input assembly may comprise a conveyance that is electromechanical. The input assembly may comprise a multi-axis electromechanical conveyance. The input assembly may comprise a robot having a mobile base. The input assembly may be configured to present the plurality of items to the distal grasping end effector in a substantially singulated manner. The input assembly may comprise a plurality of surfaces configured for transient storage of items in an operational cache configuration. The operational cache configuration may be electromechanically movable to provide additional transient storage surfaces. The input assembly may comprise a herringbone conveyance operatively coupled to the first computing system and configured to automatically position the one or more items in a central position within reach of the distal grasping end effector. The first computing system may be configured to operate the herringbone conveyance based at least in part upon the image information from the first imaging assembly. The input assembly may comprise an input conveyance and a plurality of movable members configured to extend above the input conveyance, the plurality of movable members and input conveyance being operatively coupled to the first computing system and configured to automatically reposition the one or more items when on the input conveyance. The first computing system may be configured to operate the plurality of movable members and input conveyance based at least in part upon the image information from the first imaging assembly. The frame assembly may define a substantially rectangular prismic working volume. The frame assembly may comprise a plurality of support column members coupled with a plurality of span members, wherein the first horizontal member is movably coupled between two span members and is configured to be electromechanically movable relative to coupled span members. The vertical grasping assembly may comprise one or more electromechanically controllable degrees of freedom of motion to controllably move the distal grasping end effector relative to the first horizontal member. The distal grasping end effector of the vertical grasping assembly may be vertically controllably movable relative to the first horizontal member in a direction substantially perpendicular to a plane of a support surface upon which the frame assembly is positioned. The distal grasping end effector may be further controllably rotatable relative to the first horizontal member. The vertical grasping assembly may be operatively coupled to the first horizontal member with a breakaway configuration such that upon loading to a threshold loading configuration at a breakaway coupling, the vertical grasping assembly will move relative to the first horizontal member from an operating position and orientation to a relief position and orientation to relieve the threshold loading configuration, after which it will return to the operating position and orientation. The breakaway coupling may be spring-biased to retain and return to the operating position and orientation. The breakaway coupling may comprise an adjustable spring-biased loading configuration. The breakaway coupling may be configured to cause delivery of an electronic flag to the first computing system when caused to reach a relief position and orientation that is beyond a flag relief position and orientation. The first computing system may be configured to stop motion of the gantry sortation assembly when the electronic flag is delivered to the first computing system. One or more portions of the working volume may be isolated using one or more removable mechanical fence assemblies. One or more portions of the working volume may be isolated using one or more controllable electronic fence assemblies. The one or more controllable electronic fence assemblies may comprise one or more prescribed radiation paths, radiation emittors, and path completion detectors. The one or more controllable electronic fence assemblies may be configured to create an operational flag when an object has breached one of the one or more prescribed radiation paths, to provide one or more safety zones for monitoring. The distal grasping end effector may comprise a first suction cup assembly coupled to a controllably activated vacuum load operatively coupled to the first computing system, the first suction cup assembly configured such that operating the distal grasping end effector to grasp a targeted item comprises engaging the targeted item and controllably activating the vacuum load. The first imaging assembly may comprise a camera. The first imaging assembly may comprise a stereoscopic camera assembly. The first imaging assembly may comprise a depth camera. The first imaging assembly may comprise a plurality of image capture devices, each having a field of view. The first imaging assembly may comprise a first image capture device having a first field of view positioned and oriented to capture image information pertinent to the input assembly and a second image capture device having a second field of view positioned and oriented to capture image information pertinent to the gantry sortation assembly. The fields of view of the image capture devices may be positioned and oriented to capture image information pertinent to a flow of an item from the first imaging assembly, to the gantry sortation assembly, and to a targeted output structure. At least one image capture device of the plurality of image capture devices may be positioned and oriented to capture image information pertinent to an interior of a targeted output structure. The at least one image capture device may be configured to provide image information pertaining to interior portion factors selected from the group consisting of: shape of interior of output structure, geometry of items within output structure, and fill level within output structure. The first computing system may be configured to operate the gantry sortation assembly to place the targeted item into the targeted output structure with a position and orientation automatically selected to optimize geometric fit of the targeted item within the targeted output structure. The first computing system may be configured to operate the gantry sortation assembly to sequence items into one of the plurality of output structures based upon a pattern regarding a planned subsequent unloading of the plurality of output structures. The pattern may be determined automatically by the first computing system based at least in part upon the image information from the first imaging assembly. The pattern may be determined at least in part based upon a predetermined patterning preference. The first computing system may be configured to operate the gantry sortation assembly to sequence items into one the plurality of output structures based upon a pattern regarding a known planned subsequent relative positioning of one or more of the plurality of output structures within a delivery vehicle. The first computing system may be configured to operate the gantry sortation assembly to sequence packages into one of the plurality of output structures based upon a known delivery route pertaining to a planned unloading of at least one of the plurality of output structures. The input assembly may be configured to be operated by the first computing system to control the supply of items based at least in part upon a number of the one or more items transiently coupled to input assembly. The input assembly may be configured to be operated by the first computing system to control the supply of items based at least in part upon the image information pertaining to the one or more items at the input assembly. The input assembly may comprise one or more mechanical singulation elements configured to mechanically process and direct the substantially singulated supply of items toward the gantry sortation assembly. The one or more mechanical singulation elements may be selected from the group consisting of: a ramp sequence; a vibratory actuator; a belt; a coordinated plurality of belts; a ball sorter conveyor; a step sequence; a chute with one or more 90-degree turns; a mechanical diverter; a vertical mechanical filter; and a horizontal mechanical filter. The input assembly may be configured to be operated by the first computing system to prune away certain items which do not become substantially singulated as a result of the mechanical process using a diversion element configured to selectably divert one or more targeted items. The first computing system may be configured to automatically controllably release the targeted item to a targeted output structure selected from the plurality of output structures based at least in part upon image information from the first image capture device which may be utilized by the first computing system to estimate a factor selected from the group consisting of: item geometry; item compliance; estimated item bounding box geometry; item relative mass; relative rigidity of item material; item mechanical stability; and item moment of inertia. At least one of the targeted output structures may be selected from the group consisting of: a bin, a sack, a tote, a gaylord container, a chute, a conveyance, a pallet, a bin, a tote, a mobile robot, a truck, a shipping container, and a truck-loading system. The first computing system may be configured to operate the gantry sortation assembly to move the targeted item by planning and executing one or more motions from the first horizontal member relative to the frame assembly, from the vertical grasping assembly relative to the first horizontal member, and/or from the distal grasping end effector relative to the vertical grasping assembly while also causing the distal grasping end effector to removably couple to the targeted item. The distal grasping end effector may comprise a first suction cup assembly coupled to a controllably activated vacuum load operatively coupled to the first computing system, the first suction cup assembly configured such that operating the distal grasping end effector to grasp and become removably coupled to a targeted item comprises engaging the targeted item and controllably activating the vacuum load. The first computing system may be configured to analyze candidate movements and select execution movements to move the targeted item based at least in part upon runtime use of a neural network operated by the computing system, the neural network trained using views developed from synthetic data comprising information related to three-dimensional models of one or more synthetic items in various positions and orientations relative to other structures. The computing system may be configured to operate the neural network in a convolutional sim-to-real configuration.

Another embodiment is directed to a robotic package handling system, comprising: an end effector assembly configured to transfer one or more packages from an input assembly to an output assembly, wherein the input assembly is configured to have a plurality of surfaces configured for transient storage of packages in an operational cache configuration; a first imaging device positioned and oriented to capture image information pertaining to the one or more packages; a first computing system operatively coupled to the end effector assembly and the first imaging device, and configured to receive the image information from the first imaging device and command movements of the end effector assembly based at least in part upon the image information; wherein the input assembly is operatively coupled to the first computing system and configured to be operated by the first computing system based at least in part upon the image information to mechanically process a plurality of incoming packages to provide a supply of packages to be transferred to the input assembly; and wherein the first computing system is configured to operate the end effector assembly to move a targeted package of the one or more packages from the input assembly based at least in part upon the image information, and release the targeted package to be at least transiently coupled with the output assembly with a position and orientation based at least in part upon the image information. The operational cache configuration may be electromechanically movable to provide additional transient storage surfaces. The end effector assembly may comprise a first suction cup assembly coupled to a controllably activated vacuum load operatively coupled to the first computing system, the first suction cup assembly configured such that operating the end effector assembly to move a targeted package comprises engaging the targeted package and controllably activating the vacuum load. The end effector assembly may be coupled to a robotic arm. The robotic arm may be configured to controllably removably couple to the targeted package from one of the plurality of surfaces of the input assembly, and to controllably place and removably couple from the targeted package to be at least transiently coupled with the output assembly. The first imaging device may comprise a camera. The first imaging device may comprise a stereoscopic camera assembly. The first imaging device may comprise a depth camera. The input assembly may be configured to be operated by the first computing system to control the supply of packages based at least in part upon a number of the one or more packages transiently coupled to output assembly. The input assembly may be configured to be operated by the first computing system to control the supply of packages based at least in part upon the image information pertaining to the one or more packages at the input assembly. The system further may comprise a second image capture device operatively coupled to the first computing system and configured to capture information pertaining to the one or more packages on the input assembly. The system further may comprise a second image capture device operatively coupled to the first computing system and configured to capture information pertaining to the one or more packages on the output assembly. The first image capture device may be positioned and oriented to capture information pertaining to packages being moved from the input assembly to the output assembly. The input assembly may comprise an electromechanical conveyance. At least a portion of the conveyance may comprise a multi-axis electromechanical conveyance. The output assembly may be configured to controllably release the targeted package to an output container. The output container may be selected from the group consisting of: a bin, a sack, a tote, a gaylord container, a chute, a conveyance. The first computing system may be operatively coupled to the output assembly. The output assembly may be configured to controllably release the targeted package to a distribution module, the distribution module being operatively coupled to the first computing system and configured to controllably release the targeted package to an output container. The output container may be selected from the group consisting of: a bin, a sack, a tote, a gaylord container, a chute, a conveyance. The distribution module may comprise a tray or bin movably coupled to a transport assembly coupled between the distribution module and the output assembly. The distribution module may be movably coupled to the transport assembly using a pan-tilt actuation assembly operatively coupled to the first computing system. The transport assembly may comprise an elevated gantry assembly configured to have physical access to an array of available output containers. The transport assembly comprises a rail assembly configured to have physical access to an array of available output containers. A plurality of output containers comprising the array of available output containers may be coupled together as an assembly to be transferred away from the output assembly together. A plurality of output containers comprising the array of available output containers may be removably coupled together as an assembly to be transferred away from the output assembly together. The distribution module may be configured to be able to controllably release the targeted package to a targeted output container selected from an array of available output containers. The first computing system may be configured to operate the distribution module to sequence packages into one a plurality of targeted output containers selected from the array of available output containers based upon a multi-pass sorting algorithm. The multi-pass sorting algorithm may comprise a hash-sort configuration selected to facilitate efficient sequenced unloading of the plurality of targeted output containers. The first computing system may be configured to automatically controllably release the targeted package to a targeted output container selected from an array of available output containers based at least in part upon image information from the first image capture device. The first computing system may be configured to automatically controllably release the targeted package to a targeted output container selected from an array of available output containers based at least in part upon image information from the first image capture device which may be utilized by the first computing system to estimate a factor selected from the group consisting of: package geometry; package compliance; estimated package bounding box geometry; package relative mass; relative rigidity of package material; package mechanical stability; and package moment of inertia. The system further may comprise a second image capture device fixedly coupled to the distribution module and configured to provide image information pertaining to movement of packages between the distribution module and the array of available output containers. The second image capture device may be further configured to provide image information pertaining to interior portions defined within output containers comprising the array of available output containers. The second image capture device may be configured to provide image information pertaining to interior portion factors selected from the group consisting of: shape of interiors of output containers, geometry of items within output containers, and fill level within output containers. The first computing system may be configured to operate the distribution module to place the targeted package into the targeted output container with a position and orientation automatically selected to optimize geometric fit of the targeted package within the targeted output container. The first computing system may be configured to operate the distribution module to sequence packages into one a plurality of targeted output containers selected from the array of available output containers based upon a known pattern regarding a planned unloading of the plurality of targeted output containers. The first computing system may be configured to operate the distribution module to sequence packages into one a plurality of targeted output containers selected from the array of available output containers based upon a known pattern regarding a planned relative positioning of the plurality of targeted output containers within a delivery vehicle. The first computing system may be configured to operate the distribution module to sequence packages into one a plurality of targeted output containers selected from the array of available output containers based upon a known delivery route pertaining to a planned unloading of the plurality of targeted output containers. The input assembly may comprise a herringbone conveyance operatively coupled to the first computing system and configured to automatically position the one or more packages in a central position within reach of the end effector assembly. The first computing system may be configured to operate the herringbone conveyance based at least in part upon the image information from the first image capture device. The input assembly may comprise an input conveyance and a plurality of movable members configured to extend above the input conveyance, the plurality of movable members and input conveyance being operatively coupled to the first computing system and configured to automatically reposition the one or more packages when on the input conveyance. The first computing system may be configured to operate the plurality of movable members and input conveyance based at least in part upon the image information from the first image capture device. The first image capture device may be configured to capture image information pertaining to the one or more packages as they are positioned upon the input assembly. The first computing system may be configured to establish an identity for each of the one or more packages based at least in part upon the image information captured from the input assembly. The first computing system may be configured to utilize the established identity in releasing the targeted package to the output assembly. The first computing system may be configured to utilize the established identity in releasing the targeted package to the output assembly based at least in part upon characteristics of the targeted package which may be associated with the established identity. The first computing system may be configured to associated other predetermined information pertaining to the one or more packages from another operatively coupled computing system based at least in part upon the image information captured from the input assembly. The input assembly may comprise a primary item processing/input system.

Another embodiment is directed to a robotic package handling method, comprising: an input assembly configured to receive a plurality of items as they are sequenced upon the input assembly; a gantry sortation assembly operatively coupled to the input assembly, the gantry sortation assembly comprising a frame assembly movably coupled to a first horizontal member, the first horizontal member movably coupled to a vertical grasping assembly comprising a distal grasping end effector, wherein the distal grasping end effector is configured to reach the plurality of items on the input assembly as well as a plurality of output structures transiently positioned about a perimeter within the frame assembly and configured to be movable away from the frame without further use of the gantry sortation assembly; a first imaging assembly positioned and oriented to capture image information pertaining to the plurality of items, input assembly, and gantry sortation assembly; and a first computing system operatively coupled to the gantry sortation assembly and first imaging assembly, and configured to receive the image information from the first imaging assembly and command movements of the gantry sortation assembly based at least in part upon the image information; wherein the first computing system is configured to operate the gantry sortation assembly to move a targeted item from the input assembly based at least in part upon the image information, and release the targeted item into a targeted output structure with a position and orientation relative to the targeted output structure that is based at least in part upon the image information. The input assembly may be selected from the group consisting of: a table, a conveyance, a robot, a bin, a container, a chute, and a tray. The input assembly may comprise a conveyance that is electromechanical. The input assembly may comprise a multi-axis electromechanical conveyance. The input assembly may comprise a robot having a mobile base. The input assembly may be configured to present the plurality of items to the distal grasping end effector in a substantially singulated manner. The input assembly may comprise a plurality of surfaces configured for transient storage of items in an operational cache configuration. The operational cache configuration may be electromechanically movable to provide additional transient storage surfaces. The input assembly may comprise a herringbone conveyance operatively coupled to the first computing system and configured to automatically position the one or more items in a central position within reach of the distal grasping end effector. The first computing system may be configured to operate the herringbone conveyance based at least in part upon the image information from the first imaging assembly. The input assembly may comprise an input conveyance and a plurality of movable members configured to extend above the input conveyance, the plurality of movable members and input conveyance being operatively coupled to the first computing system and configured to automatically reposition the one or more items when on the input conveyance. The first computing system may be configured to operate the plurality of movable members and input conveyance based at least in part upon the image information from the first imaging assembly. The frame assembly may define a substantially rectangular prismic working volume. The frame assembly may comprise a plurality of support column members coupled with a plurality of span members, wherein the first horizontal member is movably coupled between two span members and is configured to be electromechanically movable relative to coupled span members. The vertical grasping assembly may comprise one or more electromechanically controllable degrees of freedom of motion to controllably move the distal grasping end effector relative to the first horizontal member. The distal grasping end effector of the vertical grasping assembly may be vertically controllably movable relative to the first horizontal member in a direction substantially perpendicular to a plane of a support surface upon which the frame assembly is positioned. The distal grasping end effector may be further controllably rotatable relative to the first horizontal member. The vertical grasping assembly may be operatively coupled to the first horizontal member with a breakaway configuration such that upon loading to a threshold loading configuration at a breakaway coupling, the vertical grasping assembly will move relative to the first horizontal member from an operating position and orientation to a relief position and orientation to relieve the threshold loading configuration, after which it will return to the operating position and orientation. The breakaway coupling may be spring-biased to retain and return to the operating position and orientation. The breakaway coupling may comprise an adjustable spring-biased loading configuration. The breakaway coupling may be configured to cause delivery of an electronic flag to the first computing system when caused to reach a relief position and orientation that is beyond a flag relief position and orientation. The first computing system may be configured to stop motion of the gantry sortation assembly when the electronic flag is delivered to the first computing system. One or more portions of the working volume may be isolated using one or more removable mechanical fence assemblies. One or more portions of the working volume may be isolated using one or more controllable electronic fence assemblies. The one or more controllable electronic fence assemblies may comprise one or more prescribed radiation paths, radiation emittors, and path completion detectors. The one or more controllable electronic fence assemblies may be configured to create an operational flag when an object has breached one of the one or more prescribed radiation paths, to provide one or more safety zones for monitoring. The distal grasping end effector may comprise a first suction cup assembly coupled to a controllably activated vacuum load operatively coupled to the first computing system, the first suction cup assembly configured such that operating the distal grasping end effector to grasp a targeted item comprises engaging the targeted item and controllably activating the vacuum load. The first imaging assembly may comprise a camera. The first imaging assembly may comprise a stereoscopic camera assembly. The first imaging assembly may comprise a depth camera. The first imaging assembly may comprise a plurality of image capture devices, each having a field of view. The first imaging assembly may comprise a first image capture device having a first field of view positioned and oriented to capture image information pertinent to the input assembly and a second image capture device having a second field of view positioned and oriented to capture image information pertinent to the gantry sortation assembly. The fields of view of the image capture devices may be positioned and oriented to capture image information pertinent to a flow of an item from the first imaging assembly, to the gantry sortation assembly, and to a targeted output structure. At least one image capture device of the plurality of image capture devices may be positioned and oriented to capture image information pertinent to an interior of a targeted output structure. The at least one image capture device may be configured to provide image information pertaining to interior portion factors selected from the group consisting of: shape of interior of output structure, geometry of items within output structure, and fill level within output structure. The first computing system may be configured to operate the gantry sortation assembly to place the targeted item into the targeted output structure with a position and orientation automatically selected to optimize geometric fit of the targeted item within the targeted output structure. The first computing system may be configured to operate the gantry sortation assembly to sequence items into one of the plurality of output structures based upon a pattern regarding a planned subsequent unloading of the plurality of output structures. The pattern may be determined automatically by the first computing system based at least in part upon the image information from the first imaging assembly. The pattern may be determined at least in part based upon a predetermined patterning preference. The first computing system may be configured to operate the gantry sortation assembly to sequence items into one the plurality of output structures based upon a pattern regarding a known planned subsequent relative positioning of one or more of the plurality of output structures within a delivery vehicle. The first computing system may be configured to operate the gantry sortation assembly to sequence packages into one of the plurality of output structures based upon a known delivery route pertaining to a planned unloading of at least one of the plurality of output structures. The input assembly may be configured to be operated by the first computing system to control the supply of items based at least in part upon a number of the one or more items transiently coupled to input assembly. The input assembly may be configured to be operated by the first computing system to control the supply of items based at least in part upon the image information pertaining to the one or more items at the input assembly. The input assembly may comprise one or more mechanical singulation elements configured to mechanically process and direct the substantially singulated supply of items toward the gantry sortation assembly. The one or more mechanical singulation elements may be selected from the group consisting of: a ramp sequence; a vibratory actuator; a belt; a coordinated plurality of belts; a ball sorter conveyor; a step sequence; a chute with one or more 90-degree turns; a mechanical diverter; a vertical mechanical filter; and a horizontal mechanical filter. The input assembly may be configured to be operated by the first computing system to prune away certain items which do not become substantially singulated as a result of the mechanical process using a diversion element configured to selectably divert one or more targeted items. The first computing system may be configured to automatically controllably release the targeted item to a targeted output structure selected from the plurality of output structures based at least in part upon image information from the first image capture device which may be utilized by the first computing system to estimate a factor selected from the group consisting of: item geometry; item compliance; estimated item bounding box geometry; item relative mass; relative rigidity of item material; item mechanical stability; and item moment of inertia. At least one of the targeted output structures may be selected from the group consisting of: a bin, a sack, a tote, a gaylord container, a chute, a conveyance, a pallet, a bin, a tote, a mobile robot, a truck, a shipping container, and a truck-loading system. The first computing system may be configured to operate the gantry sortation assembly to move the targeted item by planning and executing one or more motions from the first horizontal member relative to the frame assembly, from the vertical grasping assembly relative to the first horizontal member, and/or from the distal grasping end effector relative to the vertical grasping assembly while also causing the distal grasping end effector to removably couple to the targeted item. The distal grasping end effector may comprise a first suction cup assembly coupled to a controllably activated vacuum load operatively coupled to the first computing system, the first suction cup assembly configured such that operating the distal grasping end effector to grasp and become removably coupled to a targeted item comprises engaging the targeted item and controllably activating the vacuum load. The first computing system may be configured to analyze candidate movements and select execution movements to move the targeted item based at least in part upon runtime use of a neural network operated by the computing system, the neural network trained using views developed from synthetic data comprising information related to three-dimensional models of one or more synthetic items in various positions and orientations relative to other structures. The computing system may be configured to operate the neural network in a convolutional sim-to-real configuration.

Another embodiment is directed to a robotic package handling method, comprising: an end effector assembly configured to transfer one or more packages from an input assembly to an output assembly, wherein the input assembly is configured to have a plurality of surfaces configured for transient storage of packages in an operational cache configuration; a first imaging device positioned and oriented to capture image information pertaining to the one or more packages; a first computing system operatively coupled to the end effector assembly and the first imaging device, and configured to receive the image information from the first imaging device and command movements of the end effector assembly based at least in part upon the image information; wherein the input assembly is operatively coupled to the first computing system and configured to be operated by the first computing system based at least in part upon the image information to mechanically process a plurality of incoming packages to provide a supply of packages to be transferred to the input assembly; and wherein the first computing system is configured to operate the end effector assembly to move a targeted package of the one or more packages from the input assembly based at least in part upon the image information, and release the targeted package to be at least transiently coupled with the output assembly with a position and orientation based at least in part upon the image information. The operational cache configuration may be electromechanically movable to provide additional transient storage surfaces. The end effector assembly may comprise a first suction cup assembly coupled to a controllably activated vacuum load operatively coupled to the first computing system, the first suction cup assembly configured such that operating the end effector assembly to move a targeted package comprises engaging the targeted package and controllably activating the vacuum load. The end effector assembly may be coupled to a robotic arm. The robotic arm may be configured to controllably removably couple to the targeted package from one of the plurality of surfaces of the input assembly, and to controllably place and removably couple from the targeted package to be at least transiently coupled with the output assembly. The first imaging device may comprise a camera. The first imaging device may comprise a stereoscopic camera assembly. The first imaging device may comprise a depth camera. The input assembly may be configured to be operated by the first computing system to control the supply of packages based at least in part upon a number of the one or more packages transiently coupled to output assembly. The input assembly may be configured to be operated by the first computing system to control the supply of packages based at least in part upon the image information pertaining to the one or more packages at the input assembly. The method further may comprise providing a second image capture device operatively coupled to the first computing system and configured to capture information pertaining to the one or more packages on the input assembly. The method further may comprise providing a second image capture device operatively coupled to the first computing system and configured to capture information pertaining to the one or more packages on the output assembly. The first image capture device may be positioned and oriented to capture information pertaining to packages being moved from the input assembly to the output assembly. The input assembly may comprise an electromechanical conveyance. At least a portion of the conveyance may comprise a multi-axis electromechanical conveyance. The output assembly may be configured to controllably release the targeted package to an output container. The output container may be selected from the group consisting of: a bin, a sack, a tote, a gaylord container, a chute, a conveyance. The first computing system may be operatively coupled to the output assembly. The output assembly may be configured to controllably release the targeted package to a distribution module, the distribution module being operatively coupled to the first computing system and configured to controllably release the targeted package to an output container. The output container may be selected from the group consisting of: a bin, a sack, a tote, a gaylord container, a chute, a conveyance. The distribution module may comprise a tray or bin movably coupled to a transport assembly coupled between the distribution module and the output assembly. The distribution module may be movably coupled to the transport assembly using a pan-tilt actuation assembly operatively coupled to the first computing system. The transport assembly may comprise an elevated gantry assembly configured to have physical access to an array of available output containers. The transport assembly comprises a rail assembly configured to have physical access to an array of available output containers. A plurality of output containers comprising the array of available output containers may be coupled together as an assembly to be transferred away from the output assembly together. A plurality of output containers comprising the array of available output containers may be removably coupled together as an assembly to be transferred away from the output assembly together. The distribution module may be configured to be able to controllably release the targeted package to a targeted output container selected from an array of available output containers. The first computing system may be configured to operate the distribution module to sequence packages into one a plurality of targeted output containers selected from the array of available output containers based upon a multi-pass sorting algorithm. The multi-pass sorting algorithm may comprise a hash-sort configuration selected to facilitate efficient sequenced unloading of the plurality of targeted output containers. The first computing system may be configured to automatically controllably release the targeted package to a targeted output container selected from an array of available output containers based at least in part upon image information from the first image capture device. The first computing system may be configured to automatically controllably release the targeted package to a targeted output container selected from an array of available output containers based at least in part upon image information from the first image capture device which may be utilized by the first computing system to estimate a factor selected from the group consisting of: package geometry; package compliance; estimated package bounding box geometry; package relative mass; relative rigidity of package material; package mechanical stability; and package moment of inertia. The method further may comprise providing a second image capture device fixedly coupled to the distribution module and configured to provide image information pertaining to movement of packages between the distribution module and the array of available output containers. The second image capture device may be further configured to provide image information pertaining to interior portions defined within output containers comprising the array of available output containers. The second image capture device may be configured to provide image information pertaining to interior portion factors selected from the group consisting of: shape of interiors of output containers, geometry of items within output containers, and fill level within output containers. The first computing system may be configured to operate the distribution module to place the targeted package into the targeted output container with a position and orientation automatically selected to optimize geometric fit of the targeted package within the targeted output container. The first computing system may be configured to operate the distribution module to sequence packages into one a plurality of targeted output containers selected from the array of available output containers based upon a known pattern regarding a planned unloading of the plurality of targeted output containers. The first computing system may be configured to operate the distribution module to sequence packages into one a plurality of targeted output containers selected from the array of available output containers based upon a known pattern regarding a planned relative positioning of the plurality of targeted output containers within a delivery vehicle. The first computing system may be configured to operate the distribution module to sequence packages into one a plurality of targeted output containers selected from the array of available output containers based upon a known delivery route pertaining to a planned unloading of the plurality of targeted output containers. The input assembly may comprise a herringbone conveyance operatively coupled to the first computing system and configured to automatically position the one or more packages in a central position within reach of the end effector assembly. The first computing system may be configured to operate the herringbone conveyance based at least in part upon the image information from the first image capture device. The input assembly may comprise an input conveyance and a plurality of movable members configured to extend above the input conveyance, the plurality of movable members and input conveyance being operatively coupled to the first computing system and configured to automatically reposition the one or more packages when on the input conveyance. The first computing system may be configured to operate the plurality of movable members and input conveyance based at least in part upon the image information from the first image capture device. The first image capture device may be configured to capture image information pertaining to the one or more packages as they are positioned upon the input assembly. The first computing system may be configured to establish an identity for each of the one or more packages based at least in part upon the image information captured from the input assembly. The first computing system may be configured to utilize the established identity in releasing the targeted package to the output assembly. The first computing system may be configured to utilize the established identity in releasing the targeted package to the output assembly based at least in part upon characteristics of the targeted package which may be associated with the established identity. The first computing system may be configured to associated other predetermined information pertaining to the one or more packages from another operatively coupled computing system based at least in part upon the image information captured from the input assembly. The input assembly may comprise a primary item processing/input system.

### BRIEF DESCRIPTION OF THE DRAWINGS:

FIGS. 1A and 1B illustrate a high level flow diagrams of sortation processing configuration.

FIG. 2A illustrates various subsystems which may be utilized for package processing and primary induction.

FIG. 2B illustrates a singulation configuration for processing packages or other items, which may incorporate one or more conveyance features.

FIG. 2C illustrates a side view of a physical singulation configuration.

FIGS. 2D-2F illustrate aspects of conveyance-based processing modules.

FIGS. 2G-2L illustrate aspects of robotic sortation embodiments which may incorporate one or more suction cup assemblies to assist in forming a package-grasping end effector module.

FIG. 2M illustrates a chute assembly configuration.

FIG. 3 illustrates a semi-rigid output container.

FIG. 4A illustrates a process flow embodiment pertaining to a sortation configuration to output containers.

FIGS. 4B, 5A, and 5B illustrate various aspects of package sortation and distribution configurations featuring a movable distribution module.

FIGS. 6, 7A-7C, 8A-8B, 9A-9B, and 10A-10M illustrate aspects of configurations which may be utilized for using output containers such as totes or bags with handles.

FIGS. 11A-11G and 12A-12H illustrate various aspects of a configuration which may be removably grasp an output container such as a bag or tote using vacuum and a lower pick up tray.

FIG. 13 illustrates how various output container volumes or packages may be assembled together and or utilized together with geometric efficiency.

FIG. 14 illustrates various aspects of a configuration wherein a package or item comprises various components and features which may be tracked or examined using various sensors or image capture devices.

FIGS. 15A-15B, 16A-16H, and 17A-17F illustrate various aspects of conveyance integrations which may be utilized on computer-coupled sortation systems.

FIGS. 18A-18E illustrate various aspects of specific package configurations and a flow for processing such packages to transfer or shipping outputs.

FIGS. 19A-19D and 20A-20C illustrate aspects of assemblie which may be utilized to scale sortation of packages or other items.

FIGS. 21A-21G illustrate aspects of sorting unique package or item geometries or constructs, such as envelopes.

FIGS. 22, 23A-23B, 24A-24B, and 25A-25B illustrate various aspects of computer-controlled sortation configurations from primary item processing to transfer out or other endpoint.

FIGS. 26A-26D illustrate various views of image capture devices, such as cameras, and other devices directed integrated with a mobile distribution module which may be configured to deliver packages to output containers with specific levels of control, such as vectoring, positioning, and orientation into an output container.

FIGS. 27A-27F and 28A-28D illustrate various views of sortation configurations wherein an input assembly, such as one comprising a conveyance, may be configured to deliver packages to a mobile distribution module which may be configured to deliver packages to output containers with specific levels of control, such as vectoring, positioning, and orientation into an output container.

FIG. 29 illustrates a process flow configuration from primary item or package processing, to precision sortation, to pack-out processing.

FIGS. 30 and 31 illustrate aspects of sortation systems comprising a mobile distribution module which may be configured to deliver packages to output containers with specific levels of control, such as vectoring, positioning, and orientation into an output container.

FIGS. 32A-32H illustrate aspects of sortation systems featuring integrated image capture devices, output assemblies, as well as mechanical and electronic isolation or safety gate configurations.

FIGS. 33A-33H and 34A-34C illustrate various aspects of sortation systems featuring rail-based output distribution and input assemblies featuring conveyances.

FIGS. 35A-35C illustrate aspects of integrated sortation systems at relative scale in warehouse environments.

FIGS. 36A-36B and 37A-37C illustrate aspects of integrated sortation systems with various different input assembly and sortation configurations featuring robotic arms.

FIGS. 38A and 38B illustrate loaded pallets with items or packages of various levels of geometric homogeneity.

FIGS. 39A-39F, 40A-40B, and 41A-41Z illustrate various aspects of gantry-based sortation units and components thereof.

FIGS. 42A-42C illustrate various aspects of vacuum flow valve configurations which may be utilized with distal coupling assemblies such as that shown in FIG. 41Y.

FIGS. 43A-43C illustrate various aspects of computer-controlled gantry-based sortation units and components thereof.

FIGS. 44, 45, 46, 47, and 48 illustrate aspects of system-level flow configurations pertaining to computer-controlled sortation systems.

FIGS. 49A-49B, 50A-50B, and 51A-51B illustrate aspects of stability modeling and dependency which may be utilized in sortation and packing of output containers.

FIGS. 52A-52E illustrate various aspects of assemblies of pluralities of sortation components which may be utilized together.

FIGS. 53A-53D illustrate aspects of configurations which may be utilized to controllably move one or more output structures, such as one or more pallets, away from a gantry-based sortation assembly.

FIGS. 54A-54H illustrate various aspects of assemblies and components which may be utilized with gantry-based sortation systems.

FIGS. 55A-55E illustrate various aspects of certain output structures or output containers.

FIGS. 56A-56I illustrate various aspects of truck loading which may be automated and/or facilitated using sortation systems such as those described herein.

FIG. 57 illustrates aspects of a system-level flow configuration pertaining to computer-controlled sortation.

FIGS. 58A-58G illustrate aspects of operational cache configurations wherein additional surfaces may be brought into the operational functionality of an input assembly suitable for use with the subject sortation configurations to enhance capabilities thereof.

FIGS. 59A-59B illustrate aspects of system-level flow configurations pertaining to computer-controlled sortation with expanded operational cache or expanded buffer cache functionality.

FIGS. 60A-60E illustrate various configurations wherein one or more aspects of a sortation assembly or system may be transiently isolated.

FIGS. 61A-61B illustrate aspects of system-level flow configurations pertaining to computer-controlled sortation with neural network computing.

FIGS. 62 and 63 illustrate sortation configurations with various relatively large-sized output containers or output structures.

FIGS. 64A-64B illustrate electromechanical apparatuses which may be operatively coupled with a sortation system to enhance output container stability and/or functionality; FIG. 64C illustrates an associated flow configuration featuring use of a custom-manufactured output structure or container.

FIGS. 65A-65B illustrate aspects of assembly wall configurations which may be utilized with computerized sortation configurations; FIG. 65C illustrates an associated flow configuration with grouping or aggregation of packages or items.

FIGS. 66 and 67A-67B illustrate various aspects of sortation systems to direct items or packages to one or more assemblies of output containers or structures.

FIGS. 68A-68D illustrate various aspects of electromechanical systems which may be integrated with sortation systems and utilized to move various items, packages, and/or input or output containers or structures.

FIGS. 69A-69C illustrate various aspects of rail-based electromechanical systems which may be integrated with sortation systems and utilized to move various items, packages, and/or input or output containers or structures.

FIG. 70 illustrates various aspects of a system flow utilizing elements such as those illustrated in FIGS. 68A-68D and 69A-69C in a sortation system integration.

FIGS. 71A-71B and 72 illustrate various aspects of sortation systems with integration visualization elements, such as image capture devices.

FIGS. 73A-73C and 74 illustrate various aspects of sortation systems with integration visualization elements, such as mobile computing and/or virtual reality visualization systems.

FIGS. 75A-75B and 76 illustrate various aspects of tracking or measurement system elements which may be integrated into sortation systems for enhanced functionality.

FIGS. 77A-77D illustrate various aspects of sortation issues and configurations which may be utilized in air logistics.

FIGS. 78 and 79 illustrate various aspects of computing configurations which may be utilized as integrated with various types of sensors and subsystems.

### DETAILED DESCRIPTION

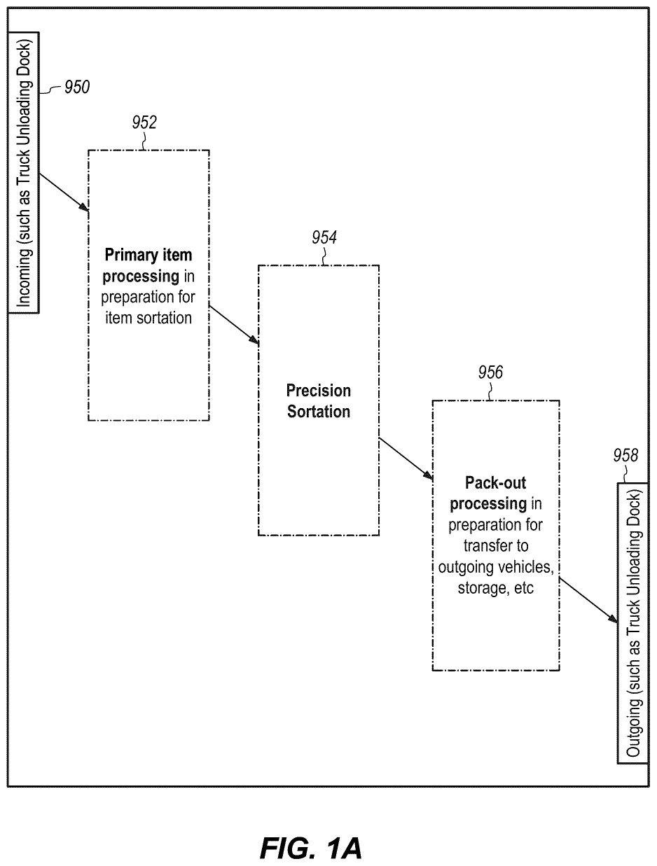

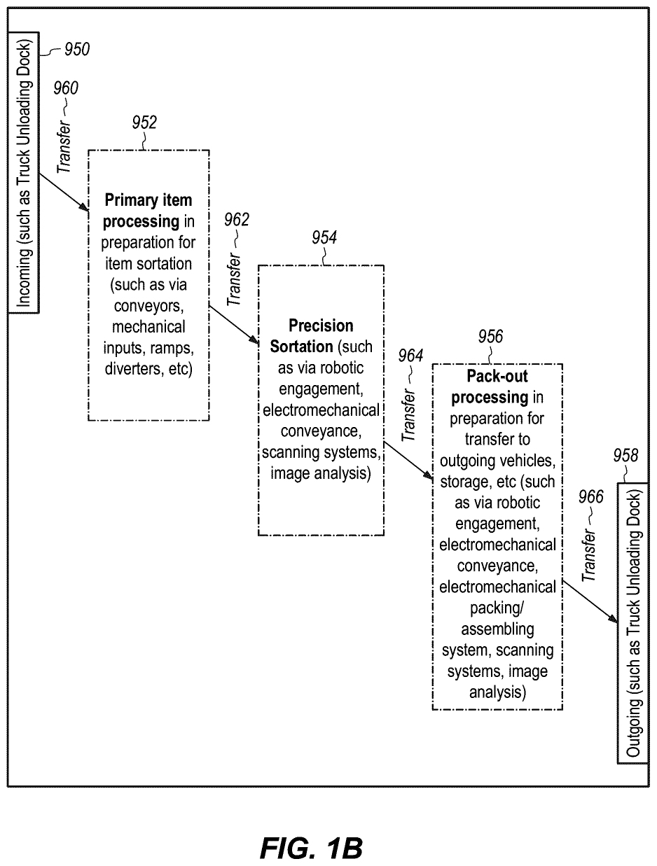

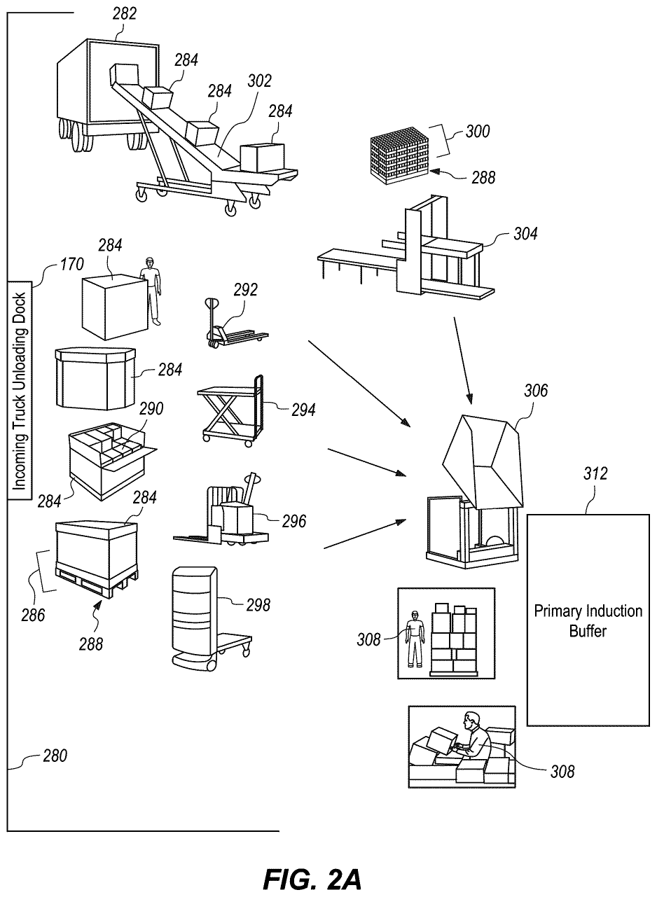

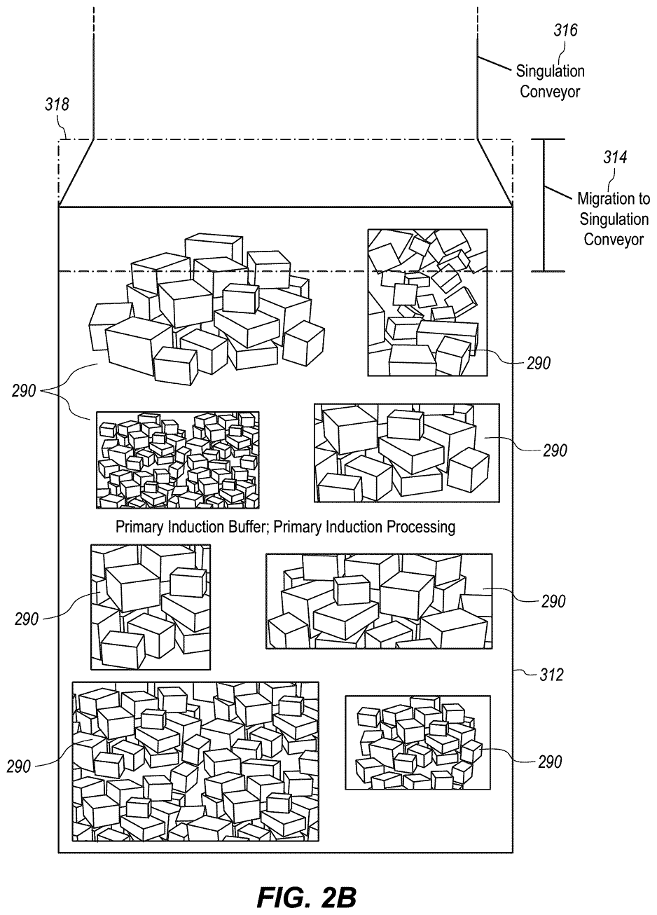

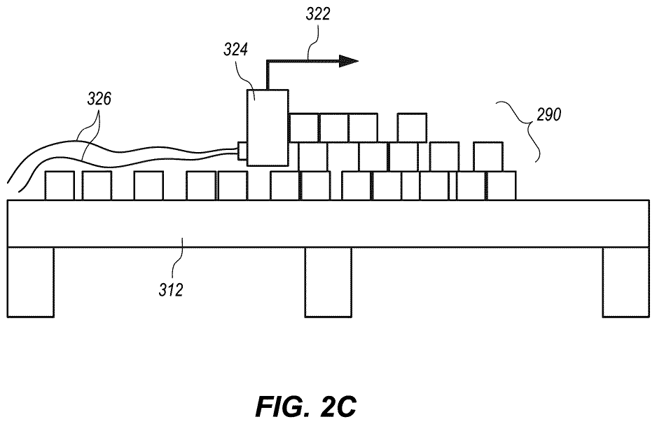

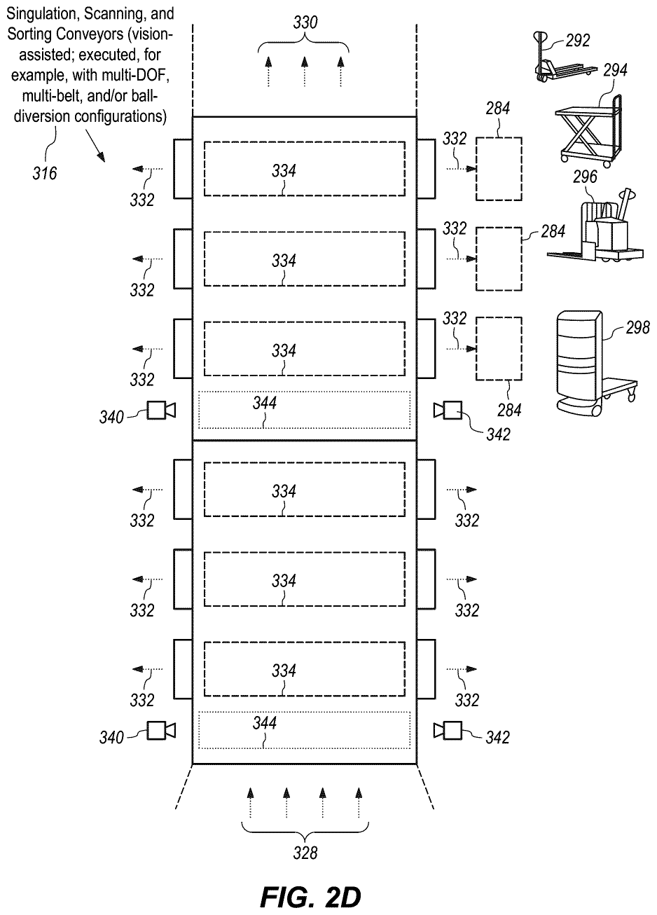

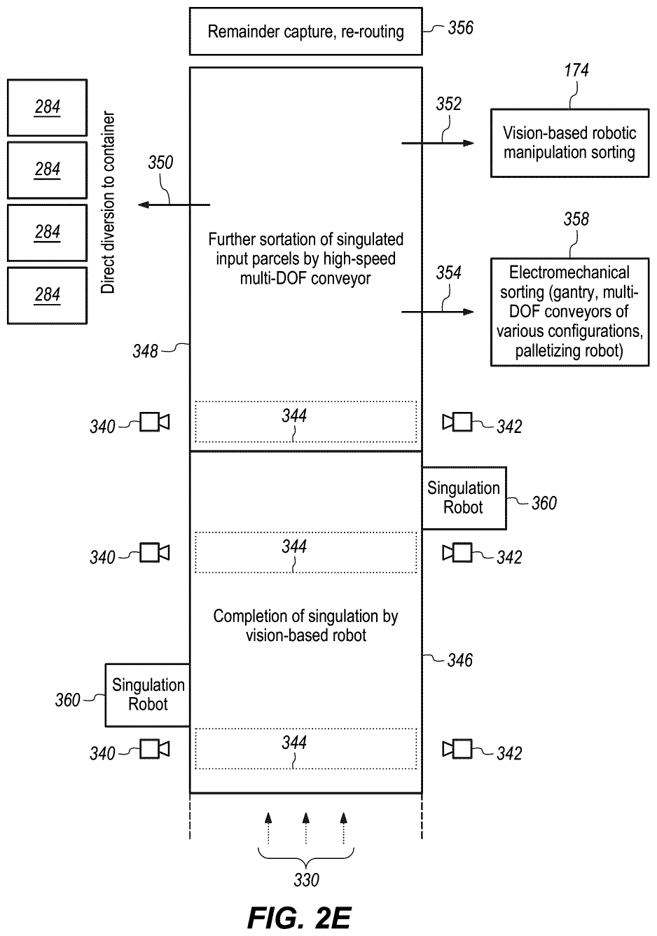

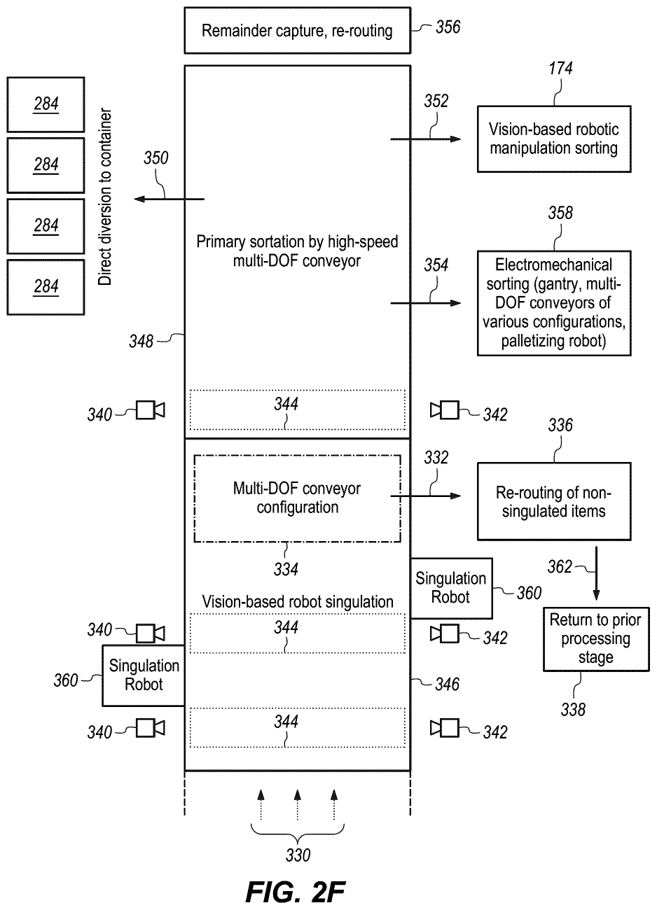

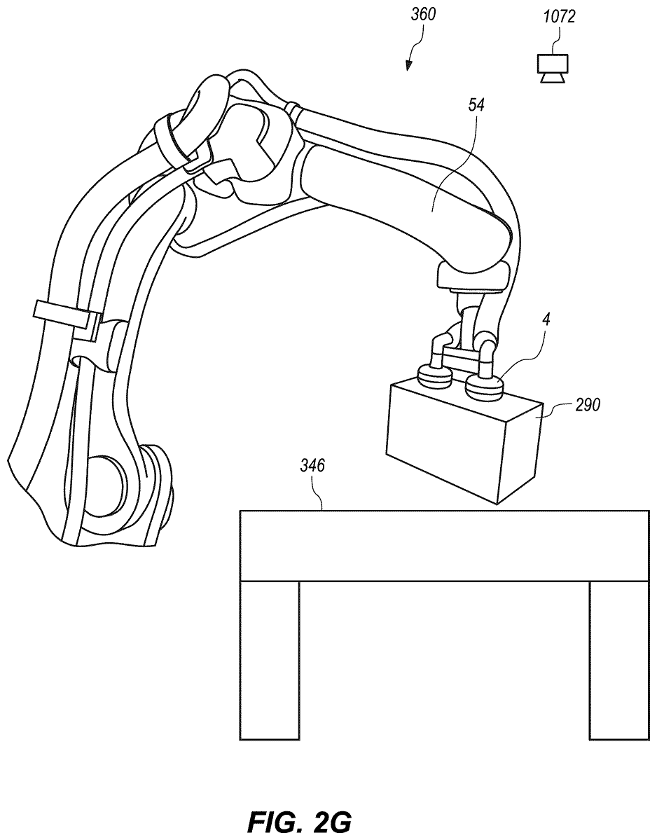

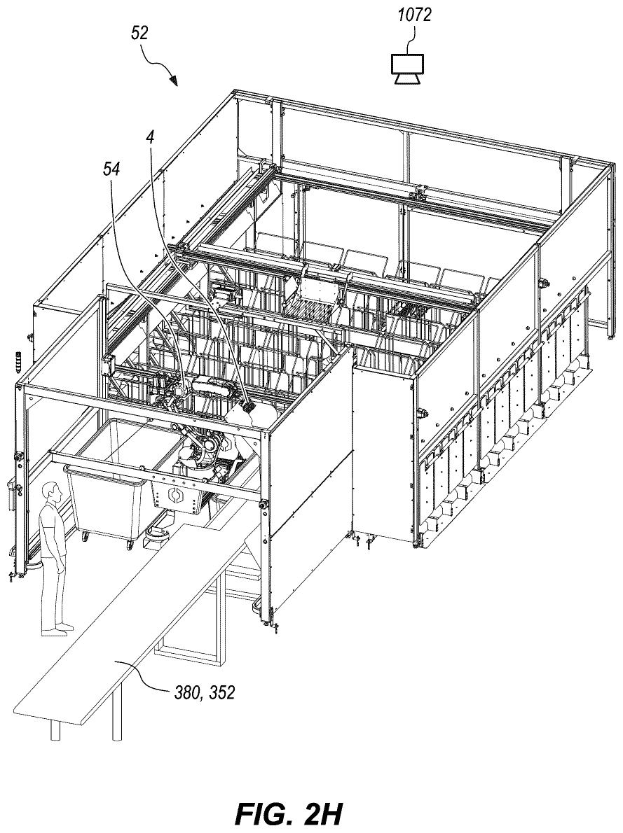

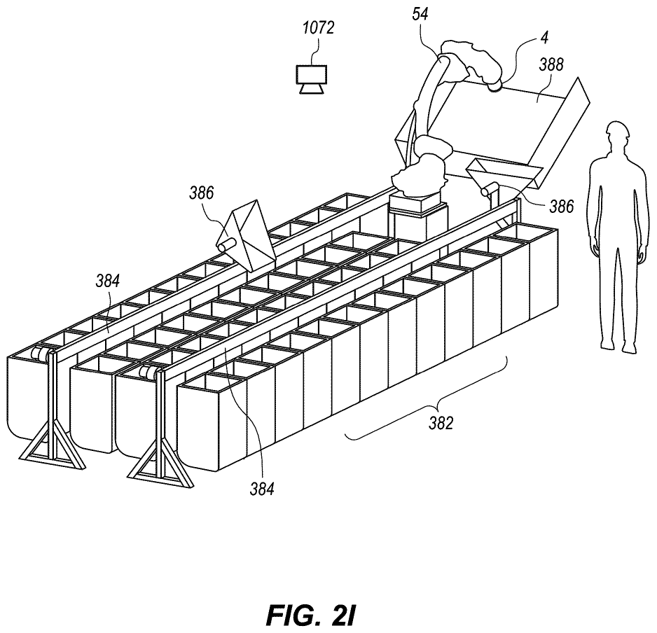

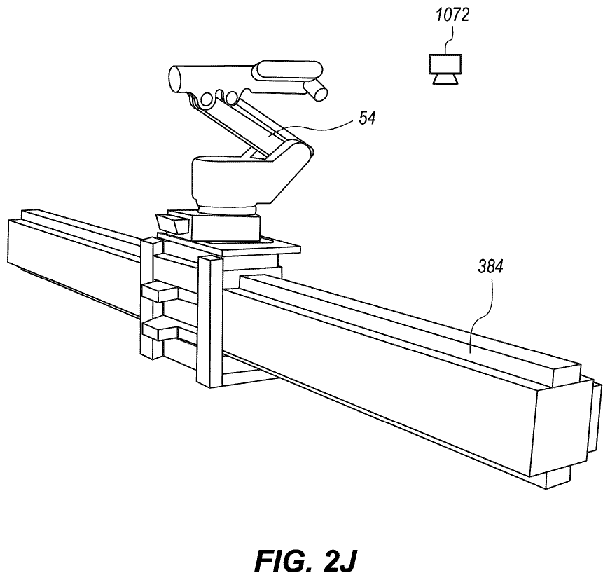

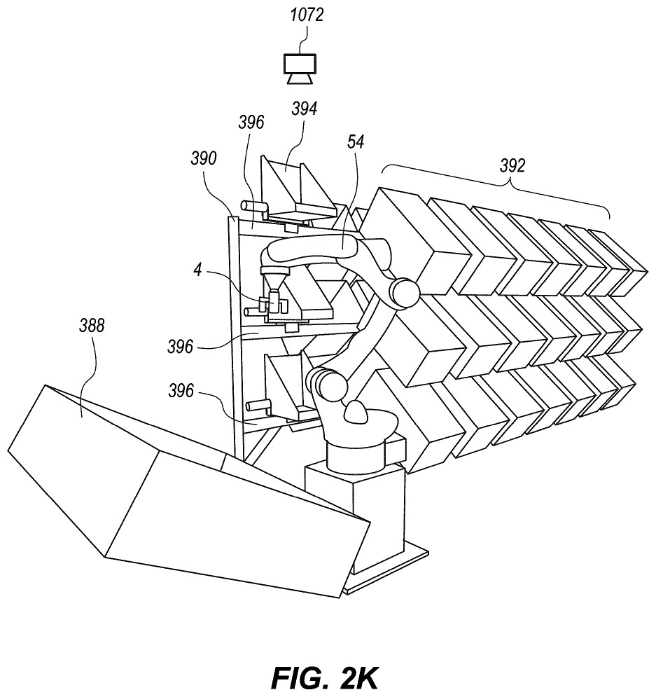

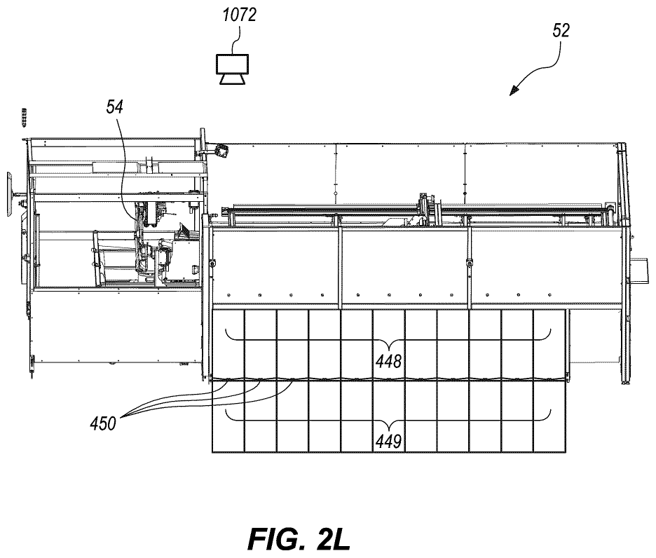

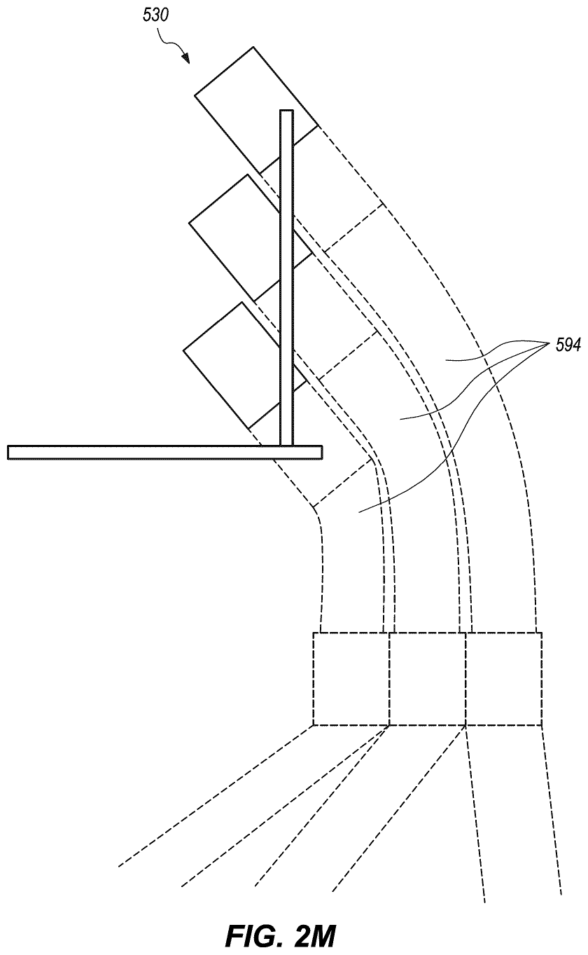

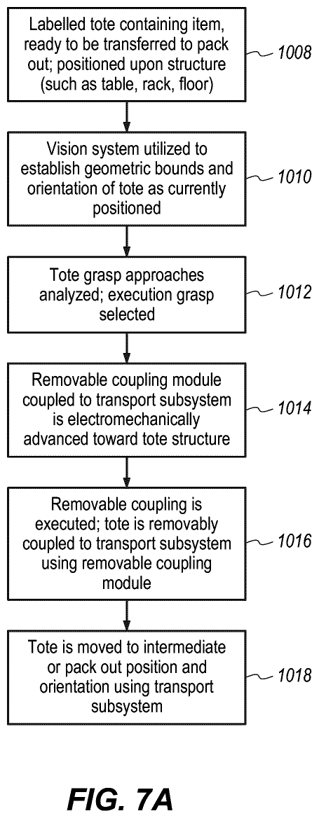

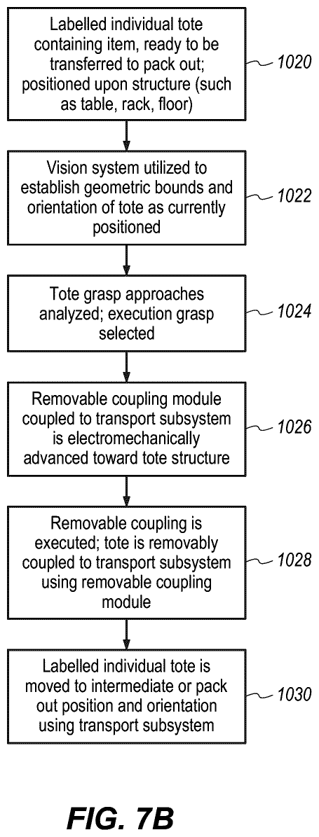

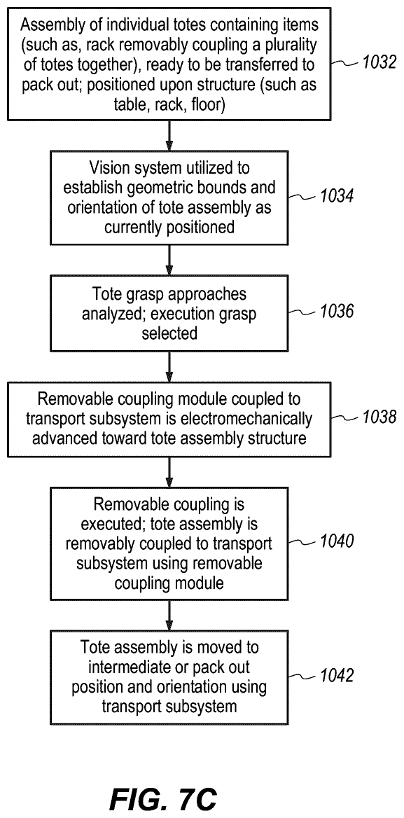

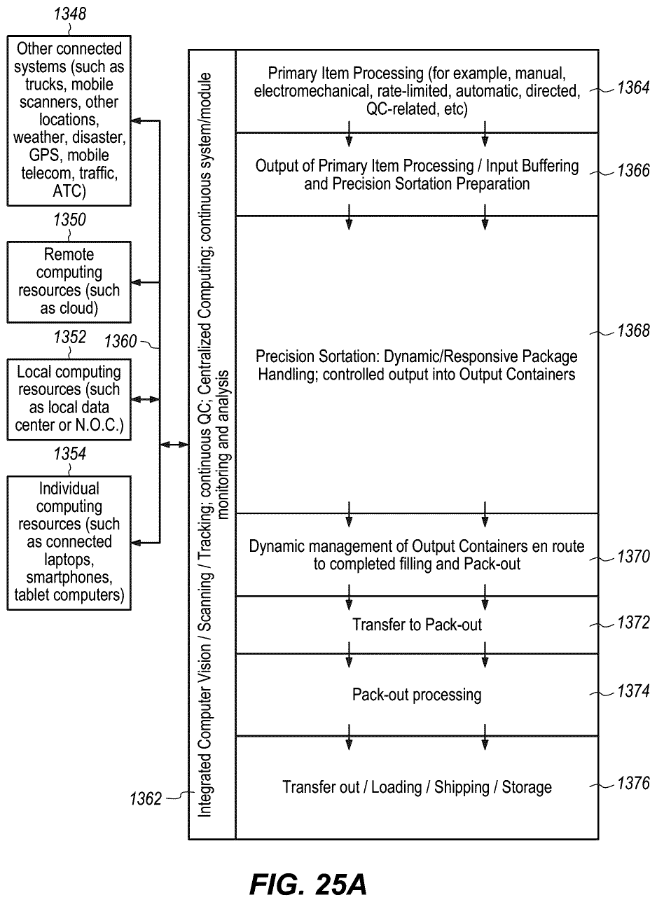

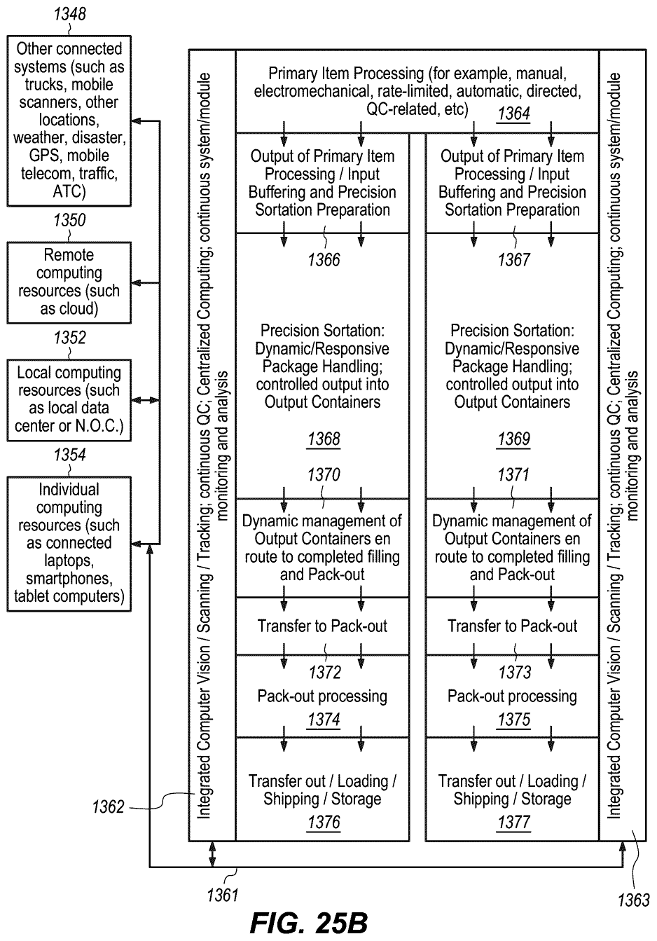

Referring to FIG. 1A, from a high-level flow perspective, various package handling logistical challenges pertain to the processing of packages from various inputs such as incoming truck unloading (950), into a primary item processing configuration wherein the various items may be transported or transferred to an input assembly subsystem such as a conveyor, chute, or other structure to generally aggregate various incoming packages and potentially accomplish some processing (952) in preparation for precision sortation (954) to one or more destinations and/or output containers or routing configurations, followed by pack-out processing (956) to process the sorted output for subsequent transfer or shipping (958). Generally such processes are organized to assist with business needs wherein there are various input sources of various types of incoming packages, and there are various outputs for different destinations, output package types, kitting processes, and the like. The system configurations described herein and in the incorporated reference provide significant flexibility and modularity, while also emphasizing speed of throughput as well as due care in the handling of valuable packages and items therein. The terms “packages” and “items” are used interchangeable herein, and may be used in reference, for example, to boxes, bags, envelopes, OEM packaging, and other containment configurations for items to be shipped. Referring to FIG. 1B, between each subprocess, there generally is a transfer (960, 962, 964, 966), and these transfers may be accomplished using automated means such as mobile robots, electromechanical conveyance systems, chutes, and the like, they may also be conducted with the assistance of personnel (308), either directly or from a controls perspective. For example, referring to FIG. 2A, at the input side, such as at an incoming truck (282) unloading dock, various large containers, such as those known as “gaylord” containers (284) or pallets (288) comprising various layers or couplings of items (300, 290) may be unloaded using an electromechanical conveyance system (302), and may be locally handled and mobilized using pallet jacks (292), scissor lifts (294), forklifts (296), mobile robots (298), palletizing or pallet-unloading systems (304), and/or electromechanical or hydraulic container dumpers (306) so that they may be directed toward a primary induction buffer (312) such as a large conveyance, as shown in FIG. 2B. Various features (318) such as ramps, chutes, reductions, and steps may be utilized to assist in directing the packages (290) toward a singulation conveyor (316) while also assisting with singulation (unstacking piles, generally moving toward single packages as isolated as possible for sorting and picking processes); the depicted singulation conveyor may also be termed an “input assembly” configuration. For example, referring to FIG. 2C, a controllable (326) overhead structure (324) may be configured to un-stack packages (290) that approach it upon a conveyance table or structure (312). Referring to FIG. 2D, incoming packages (328) from such early processing may then be further processed, such as by image-based analysis and scanning (such as via a barcode scanner or scanning device configured to use captured image information to determine barcode information); various image capture devices (340, 342) are illustrated to assist with identifying, characterizing, and processing the various packages. In scenarios wherein two or more image capture devices are present, they preferably are configured to produce image information that has at least some uncorrelated error (i.e., different devices, from different perspectives, etc.) so that so-called “sensor fusion” techniques may be utilized to assist with analysis and determination regarding the various packages by using the aggregation of the information to produce results better than each individual device alone. Incoming parcels (328) pass through the fields of view of one or more scanning and/or image capture devices (340, 342; additional may be positioned underneath a transparent viewing window 344; such devices may comprise computer vision cameras and/or barcode scanners, for example, as described above in reference to the package identification and analysis configurations pertaining to robotic sortation systems; generally they are configured to identify packages as they are moving quickly by, and provide an intercoupled computing system, such as a personal computer, mainframe, mobile computer, or the like (refer ahead to FIGS. 25A and 25B and associated discussion, for example; generally all embodiments herein are discussed in reference to computing resource or computing system connectivity, such as via wired or wireless connection, such as via IEEE 802.11, Bluetooth, nearfield, or other wireless connectivity) with the ability to not only log the presence and instantaneous position of the package, but to also activate a multi-axis conveyor system, such as one featuring a conveyance zone (334) featuring second-axis of conveyance movement which may be utilized to eject or transfer (332) and thereby provide a limited sortation or routing capability during singulation). Various multi-axis conveyor systems, as facilitated by the scanning and identification capability, may be configured to facilitate some early sorting/routing (332), at least some of which may be directly into containers (284) which may be transported (292, 294, 296, 298, etc.) directly to pack-out processing. The intercoupled computing system may be configured to operate the various degrees of freedom of the conveyor to divert or exit various packages based upon known positioning of such identified packages on the conveyor, such as via the timing of the scanning (340, 342, 344) and/or the timing or positioning of the conveyor belt or belts, such as from joint monitoring encoders intercoupled into the conveyor drive configuration. Packages or parcels that are not diverted or sorted (330) may be moved ahead along the conveyor system (316) to further processing. Referring to FIG. 2E, in a next sequence of illustrative system configurations wherein processing throughput and velocity is maintained as a maximum as long as possible into the processing, incoming packages (330) may be passed through a scanning configuration (340, 342, 344) as shown, to provide a singulation robot subsystem (360) opportunity to operate a robotic arm (54) and end effector (4) with benefit of the scanning/image capture provided by the scanning configuration (340, 342, 344), to capture, lift, and reposition various parcels or packages (290) for improved singulation on the associated conveyor (346) or other structure, all of which may be operatively coupled to one or more computing systems or resources. In other words, where a package position needs to be adjusted, the robot (54, 4) can move it into better singulation position, subject to computerized automation and/or control, and alternatively given time, provide for a sortation on the spot with delivery straight to a nearby container for transfer to pack-out. A plurality of such singulation robots (360; such as illustrated in FIG. 2G, shown therein with an operatively coupled image capture device 1072 positioned to capture robot operation, such as with a selected package or item 290) is shown in series (but may be in parallel from either side of a conveyor 348, or both series and parallel depending upon throughput objectives). A third scanning configuration is shown after the singulation robots (360) to provide the system with a final viewing of singulation status and a sorting opportunity, such as through multi-degree-of-freedom conveyor: directly (350) to containers (284) for transfer to pack-out, directly (352) to a vision-based robotic sortation system (174) such as is described in reference to FIG. 7A, and/or directly (354) to electromechanical sorting by gantry, further multi-degree-of-freedom conveyor, palletizing robot, or other integrated subsystem (358).

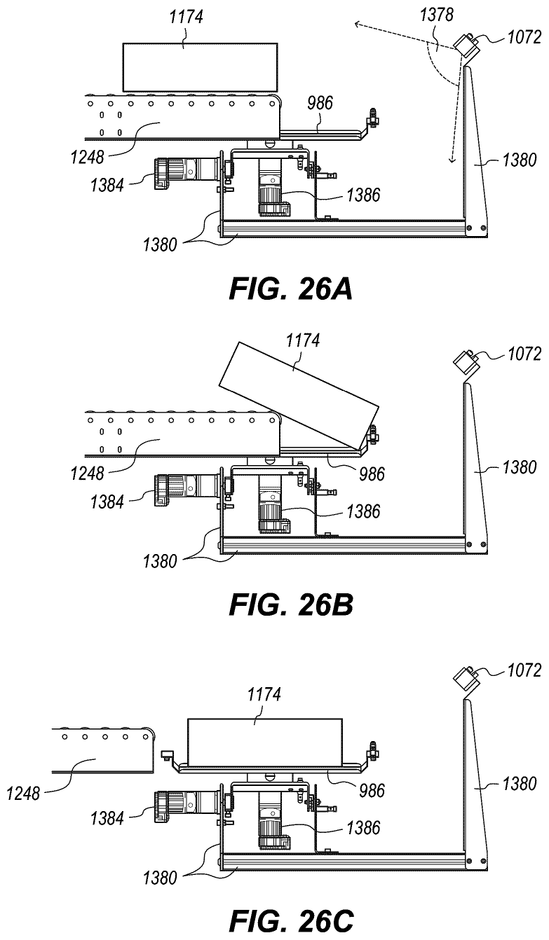

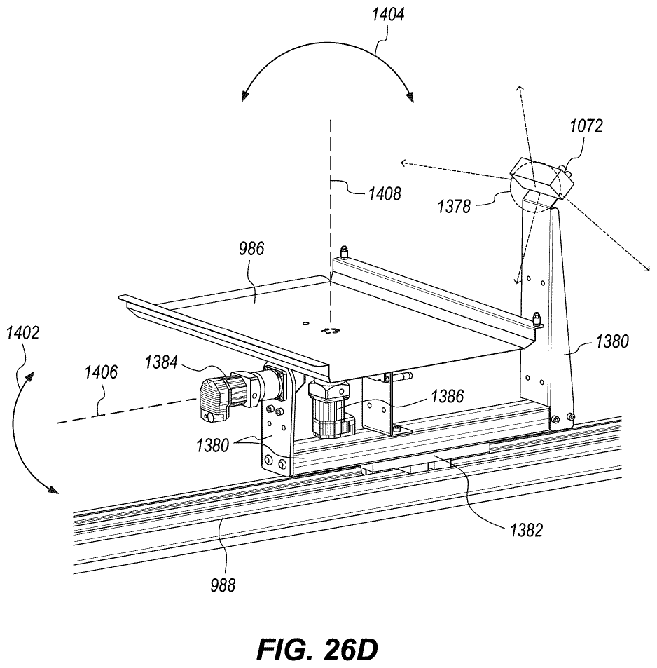

Referring to FIG. 2F, a configuration similar to that of FIG. 26A is illustrated, with an additional multi-degree-of-freedom conveyor (334) for additional diversion (332) alternative, such as for re-routing of non-singulated items (336) or transferring (362) for return (338) to prior processing stage for further singulation. Packages which are not directed to sorting or re-routing (332) may be passed into a remainder capture (356) container, chute, conveyor, or other capture device for re-routing to prior processing stages.

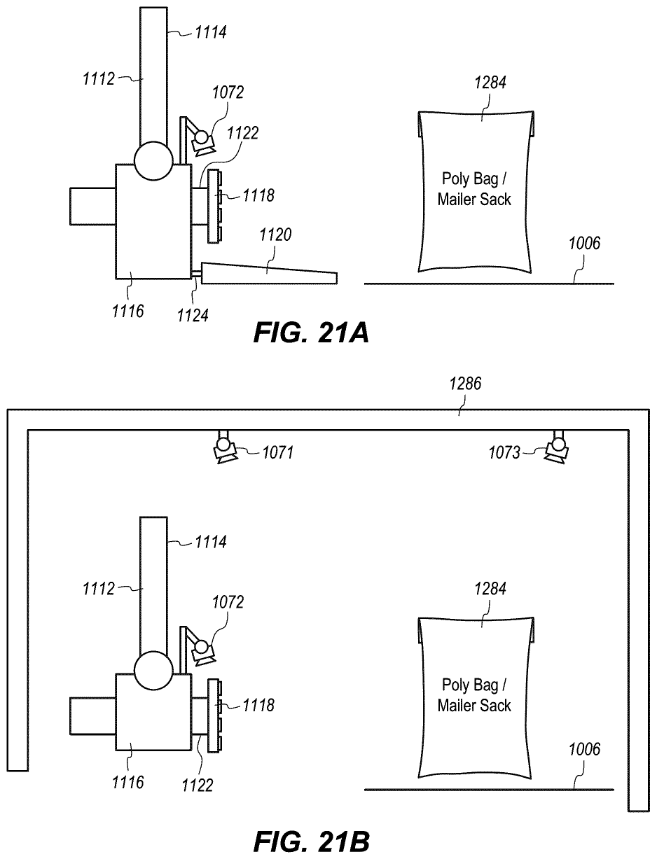

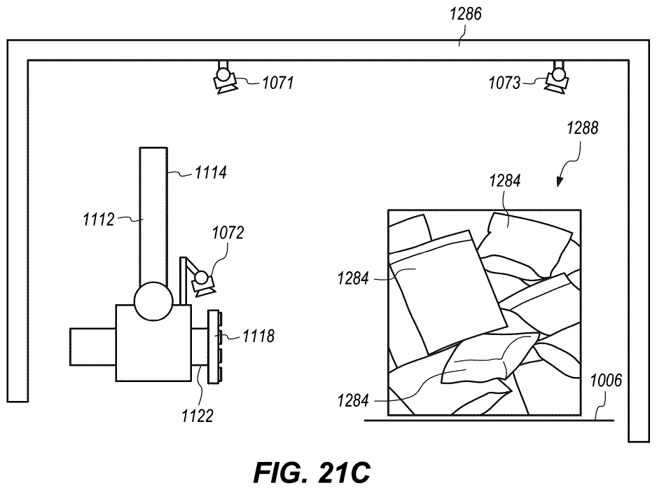

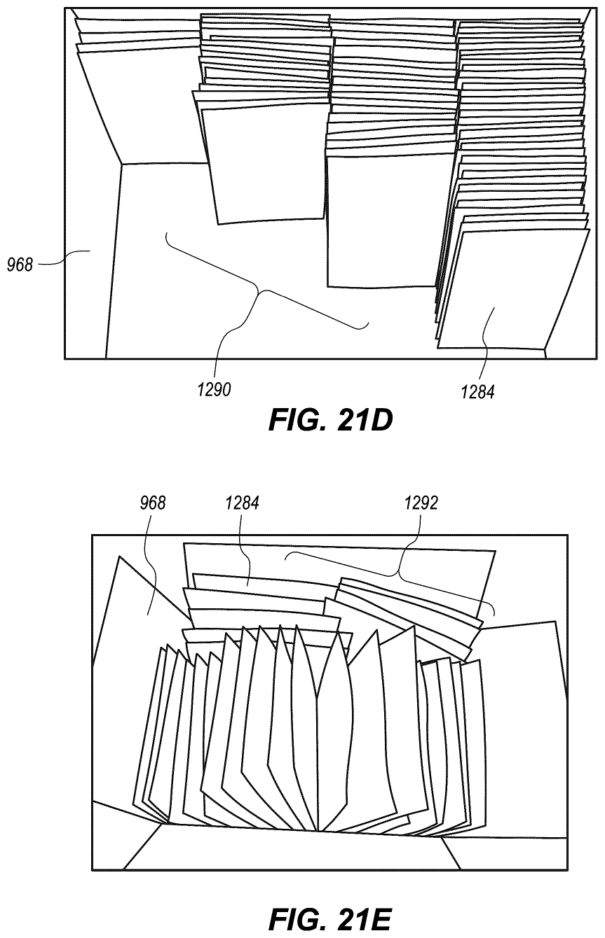

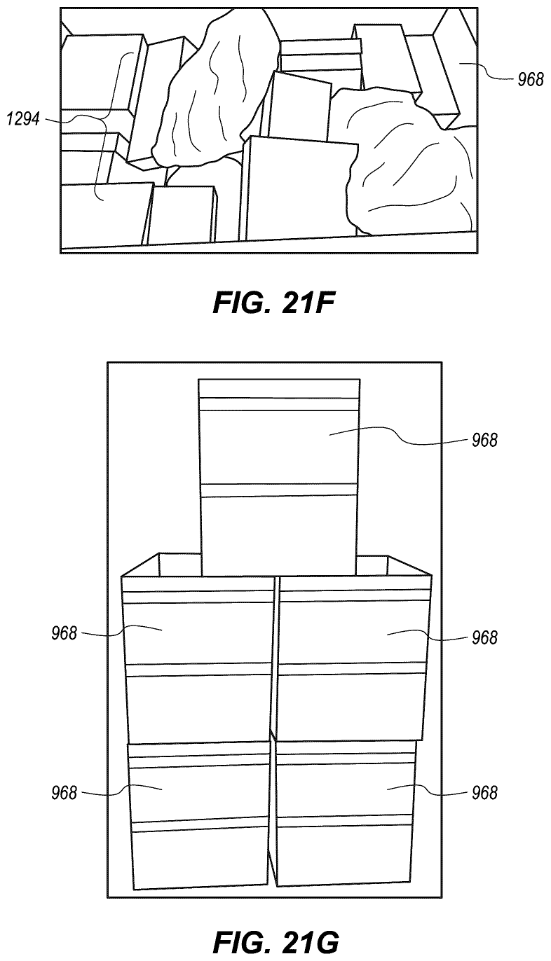

Referring to FIG. 2H, a robotic sortation system (52) such as that described in reference to FIG. 7A is shown with a conveyor (380) input routing feed (352), all of which may be observed by an operatively coupled image capture device (1072) positioned to capture operations such as by the robot (54) and conveyor (380), all of which may be operatively coupled to a computing resource. Referring to FIG. 21, a group of sortation containers or bins (382) may be served by a sorting robot (54, 4) as described above, which may be fed by a sloped/gravity-feed input container or input assembly configuration (388) for input packages to be sorted by the robot (54, 4) and placed into one of two electromechanically controllably tiltable distribution containers (386) which may be controllably and electromechanically movable along two linear rail (384) subsystems for delivery into the bins (382). An image capture device (1072) may be operatively coupled and configured to capture operations such as by the robot (54) and rail system (384). Referring to FIG. 2J, a linear rail (384) may also be operatively and controllably coupled to a robot arm (54) for further sorting and distribution alternative configuration, speed, and constraint. As noted above, an image capture device (1072) may be operatively coupled and configured to capture operations such as by the robot (54) and rail system (384). Referring to FIG. 2K, a computerized robotic sorting configuration (54, 4) may be utilized to pick from an sloped input feed container (388) and distribute to one of a stack of three electromechanically controllably tiltable distribution containers (394) which may be controllably and electromechanically movable along three associated linear rail (396) subsystems for delivery into a group of bins (392). An image capture device (1072) may be operatively coupled and configured to capture operations such as by the robot (54), rail system (396), and associated bins (392). Referring to FIG. 2L, in various embodiments, the robotic sortation system may be configured to sort to a top layer of bins or containment features (448), after which a controllably openable door (450) may be switched to an open condition such that parcels or items previously located in the top layer of bins or containment features (448) fall down and are transferred to a lower layer (449) of bins or containment features (448). The doors (450) may be closed again, such that sorting may continue into the upper layer (448), and also such that transfer of the sorted goods out of the lower layer (449) may progress, such as via conveyor or via swapping out the entire lower layer (449) for transfer away from the sorting robot and swapping in of a new/empty lower layer. One or more image capture devices (1072) may be operatively coupled the intercoupled computing resource and configured to capture operations such as by the robot (54) and sortation assembly (52). Referring to FIG. 2M, various exit conduits and configurations may be utilized to guide away sorted packages, such as tilted bin orientations (592), exit conduits or ramps (594), or one or more vertically-oriented layers of controllably releasable doors.

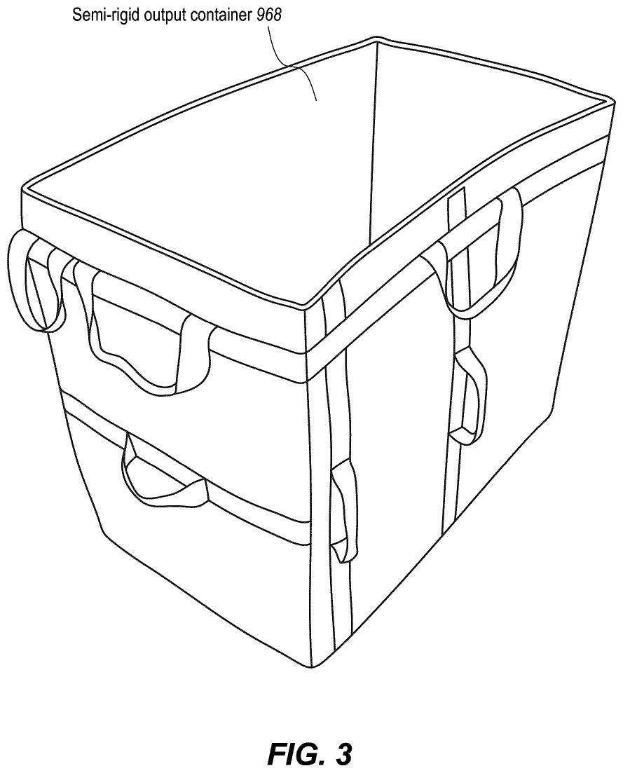

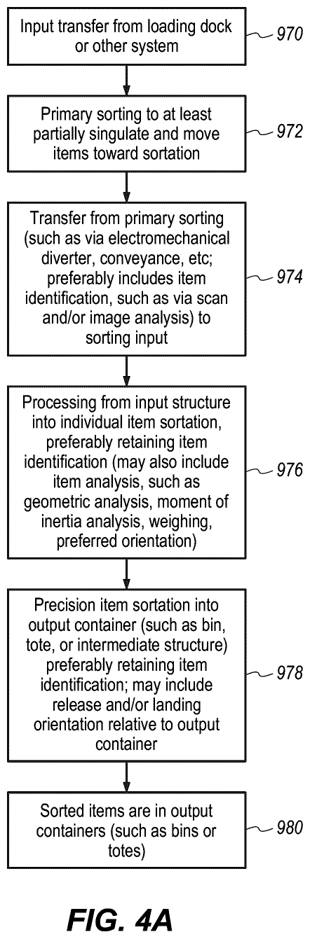

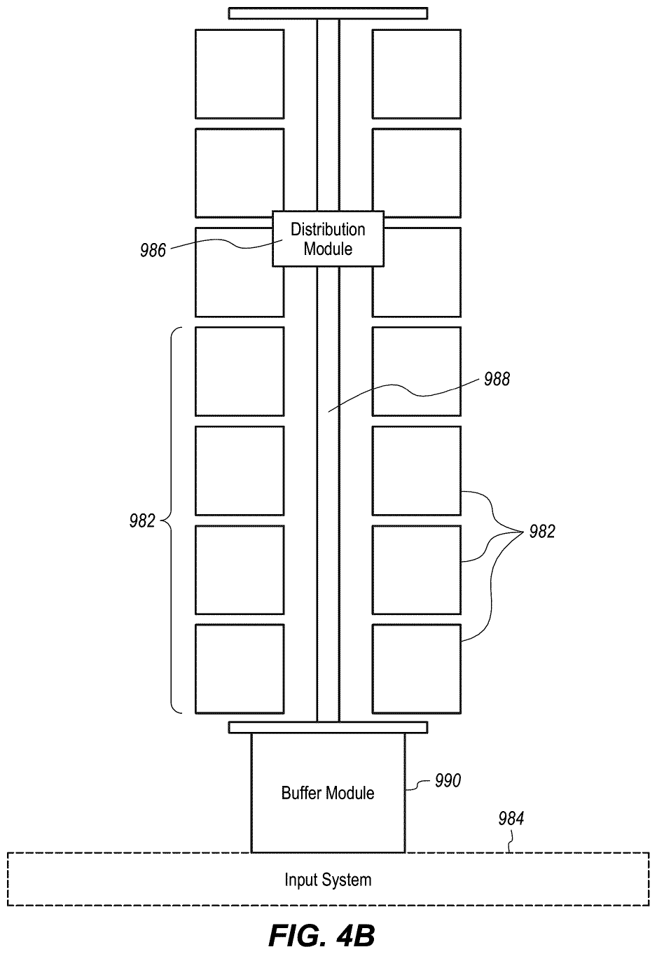

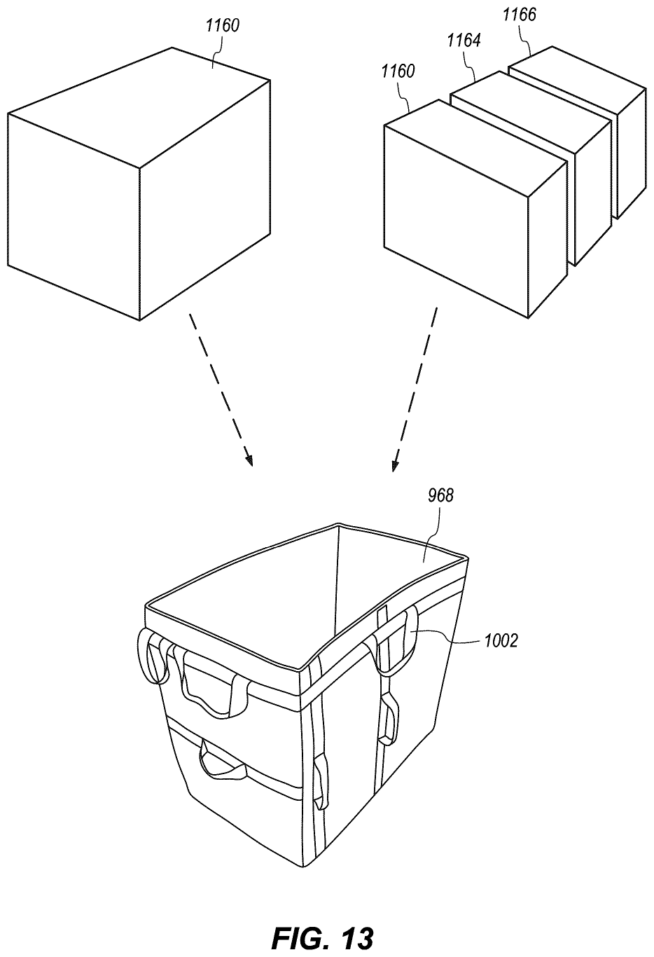

Referring to FIG. 3, in various embodiments it may be of interest to fill, handle, empty, or otherwise process containers such as the semi-rigid rectangular output container (968) shown in FIG. 13, various of which have been widely used in package and parcel processing and delivery logistics. Referring to FIG. 4A, from a high-level perspective, an input transfer from loading dock or other system may be processed (970); primary sorting may be conducted to at least partially singulate and move items toward sortation (972); a transfer may be conducted from primary sorting (such as via electromechanical diverter, conveyance, etc.; preferably includes item identification, such as via scan and/or image analysis) to sorting input (974); processing may be conducted from the input structure into individual item sortation, preferably retaining item identification (may also include item analysis, such as geometric analysis, moment of inertia analysis, weighing, preferred orientation) (976). Precision item sortation may be conducted into output container (such as bin, tote, or intermediate structure, such as that illustrated in FIG. 3) preferably retaining item identification; may include release and/or landing orientation relative to output container (978). This may result in the sorted items being in output containers (such as bins, totes, or such as a container such as that illustrated in FIG. 3) (980).

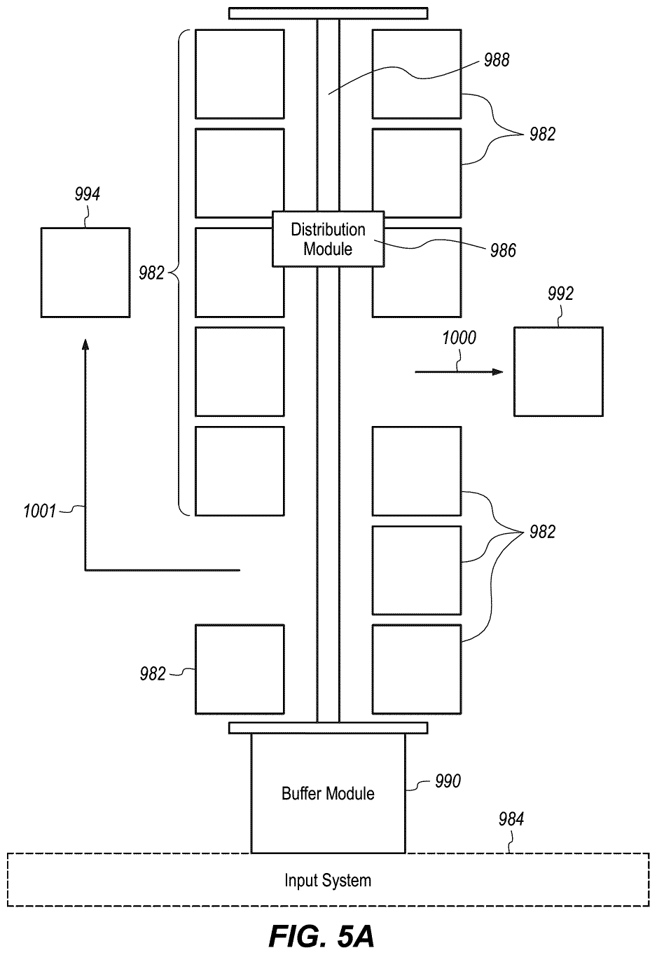

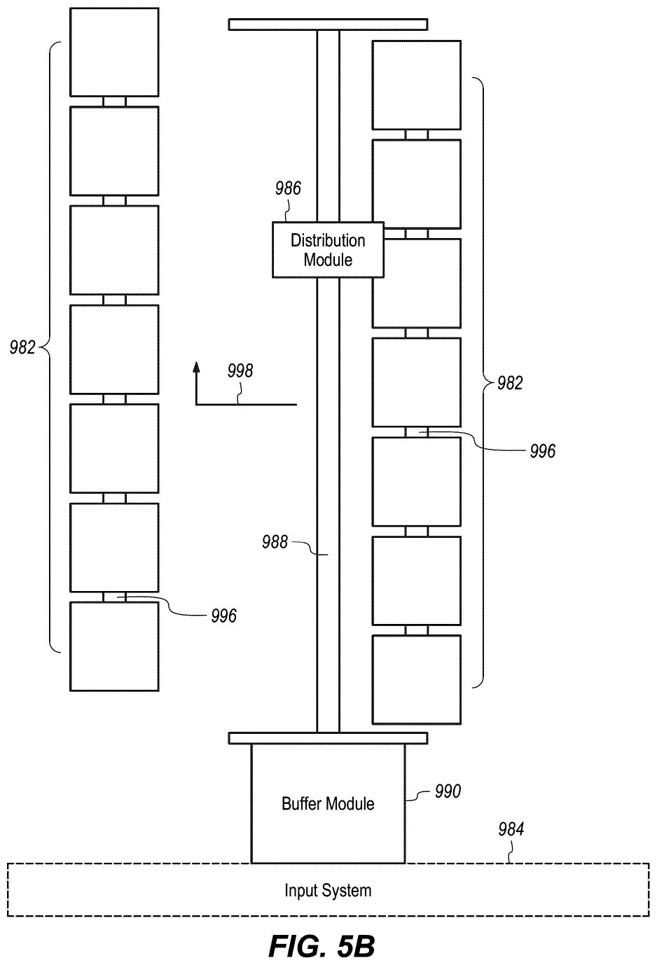

Referring to FIGS. 4B, 5A, and 5B, after incoming packages arrive through primary processing with the input system or input assembly (984) to a sortation system, they may be automatically advanced onto a buffer module (990, such as a small conveyor, pan/tilt tray, package escalator, ramp and/or chute, or the like; all operatively coupled for computerized/automatic control), which may assist in refining or producing singulation, and which may also be configured to assist in exposing package labeling and preferably orienting packages for further processing as described in further detail below. Referring to FIG. 4B and as described in various configurations in the incorporated reference, the buffer module (990) may be configured to automatically pass packages to a distribution module (986, such as an automatically-controlled pan-tilt bin coupled to a linear rail (988), and/or gantry configuration) so that it may distribute to each of a plurality of local output containers (982).

Referring to FIG. 5A, in various configurations, it may be desirable to be able to transfer out (1001, 1000) individual output containers (994, 992) individually, or to transfer out groupings of output containers (as shown in FIG. 5B, wherein a structural rack (996) may be coupled to a plurality of output containers (982) so that an entire rack with coupled containers may be transferred out (998) together as shown in FIG. 5B, followed by an empty or partially loaded different rack (not shown) being similarly transferred in to continue output sortation as uninterrupted as possible.

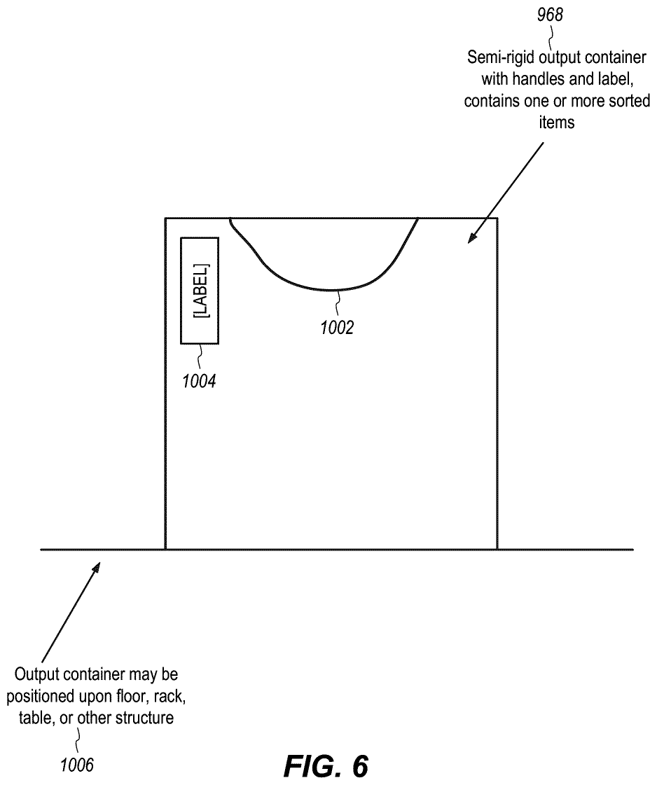

Referring to FIGS. 6-11G, various embodiments are illustrated which may be utilized to electromechanically grasp one or more individual output containers such as that (968) illustrated in FIG. 3. Referring to FIG. 6, an output container (968) may be semi-rigid and comprise a generally rectangular-prismic geometry with one or more external labels (1004) and two or more external handles (1002, 1003).

Referring to FIG. 7A, a labelled tote containing item, ready to be transferred to pack out; positioned upon structure (such as table, rack, floor) (1008); a vision system may be utilized to establish geometric bounds and orientation of tote as currently positioned (1010). Various tote grasp approaches may be analyzed and an execution grasp selected (1012). A removable coupling module maybe coupled to transport subsystem is electromechanically advanced toward tote structure (1014) and a removable coupling may be executed; a tote or output container may be removably coupled to a transport subsystem using a removable coupling module such as a robotic manipulator (1016). The tote may be moved to an intermediate or pack-out position and oriented using a transport subsystem (1018).

Referring to FIG. 7B, a labelled individual tote containing item may be ready to be transferred to pack out; positioned upon structure (such as table, rack, floor) (1020). A vision system may be utilized to establish geometric bounds and orientation of tote as currently positioned (1022). Tote or output container grasp approaches may be analyzed and an execution grasp selected (1024). A removable coupling module coupled to transport subsystem may be electromechanically advanced toward tote structure (1026). A removable coupling may be executed; tote may be removably coupled to transport subsystem using removable coupling module (1028). The labelled individual tote may be moved to intermediate or pack out position and orientation using transport subsystem (1030).

Referring to FIG. 7C, an assembly of individual totes containing items (such as a rack removably coupling a plurality of totes together), may be ready to be transferred to pack out; positioned upon structure (such as table, rack, floor) (1032). A vision system may be utilized to establish geometric bounds and orientation of tote assembly as currently positioned (1034). Tote or output container grasp approaches may be analyzed and an execution grasp selected (1036). A removable coupling module coupled to the transport subsystem may be electromechanically advanced toward the tote assembly structure (1038). A removable coupling may be executed with the tote assembly removably coupled to the transport subsystem using the removable coupling module (1040). The tote assembly may be moved to an intermediate or pack out position and orientation using the transport system (1042).

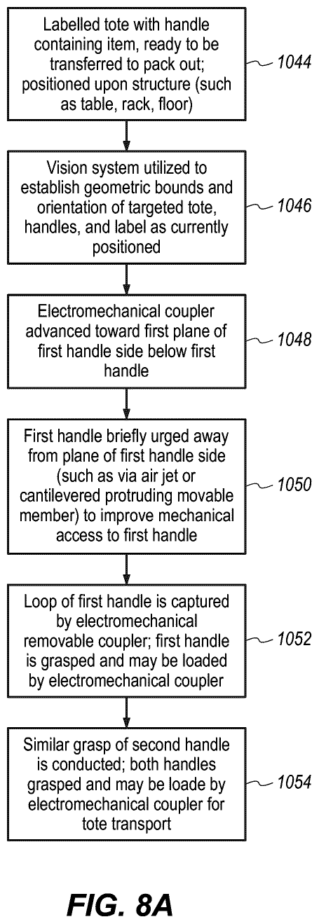

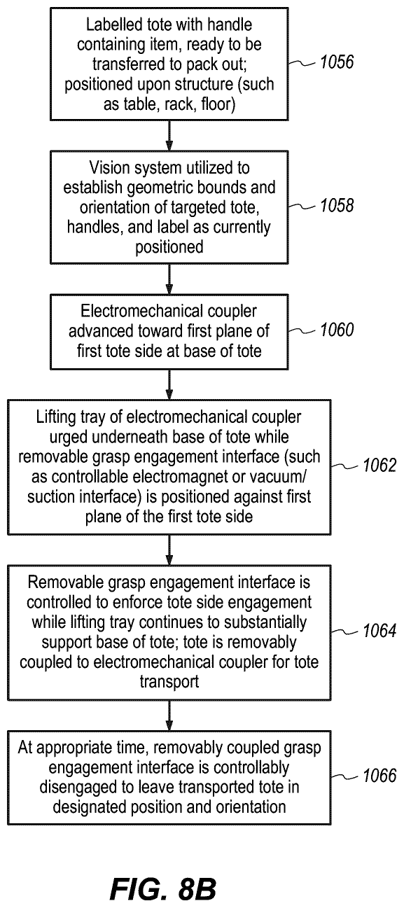

Referring to FIG. 8A, a labelled tote with handle containing item, may be ready to be transferred to pack out; positioned upon structure (such as table, rack, floor) (1044). A vision system may be utilized to establish geometric bounds and orientation of targeted tote, handles, and label as currently positioned (1046). An electromechanical coupler may be advanced toward a first plane of first handle side below first handle (1048). A first handle may be briefly urged away from plane of first handle side (such as via air jet or cantilevered protruding movable member) to improve mechanical access to first handle (1050). A loop of the first handle may be captured by electromechanical removable coupler; first handle is grasped and may be loaded by electromechanical coupler (1052). A similar grasp of a second handle may be conducted; both handles grasped and may be loaded by electromechanical coupler for tote transport (1054).

Referring to FIG. 8B, a labelled tote with a handle containing an item, may be ready to be transferred to pack out; positioned upon structure (such as table, rack, floor) (1056). A vision system may be utilized to establish geometric bounds and orientation of targeted tote, handles, and label as currently positioned (1058). An electromechanical coupler may be advanced toward a first plane of a first tote or output container side at the base of the container (1060). A lifting tray of the electromechanical coupler may be urged underneath base of tote while removable grasp engagement interface (such as controllable electromagnet or vacuum/suction interface) is positioned against first plane of the first tote side (1062). A removable grasp engagement interface may be controlled to enforce tote side engagement while lifting tray continues to substantially support base of tote; tote is removably coupled to electromechanical coupler for tote transport (1064). At an appropriate time, the removably coupled grasp engagement interface may be controllably disengaged to leave transported tote in designated position and orientation (1066).

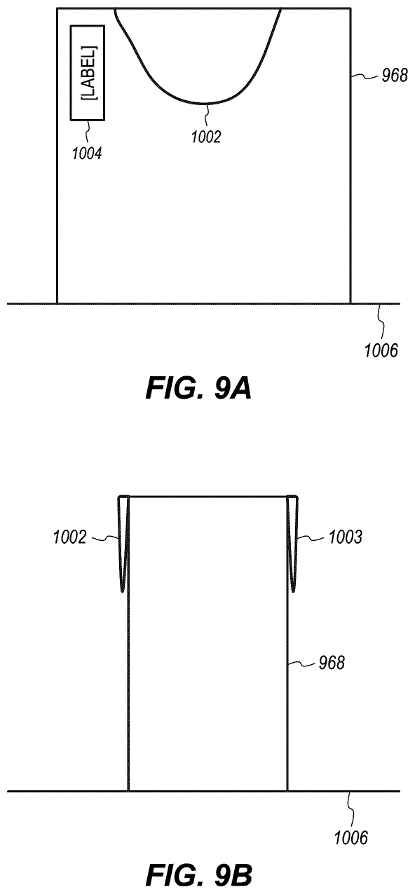

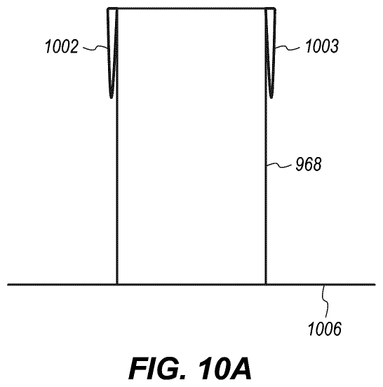

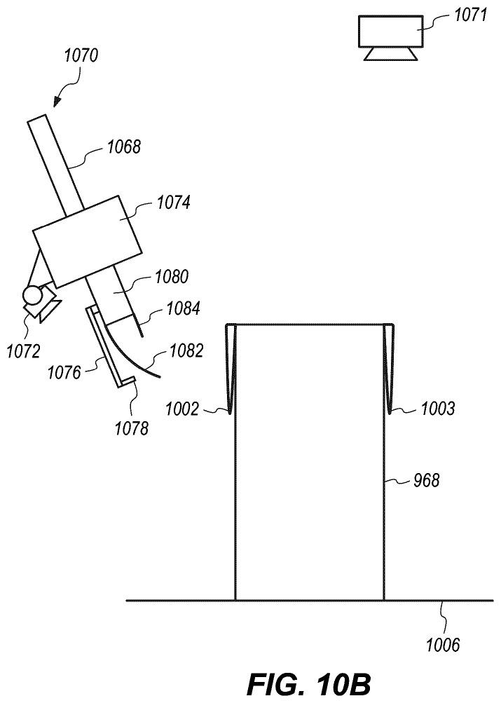

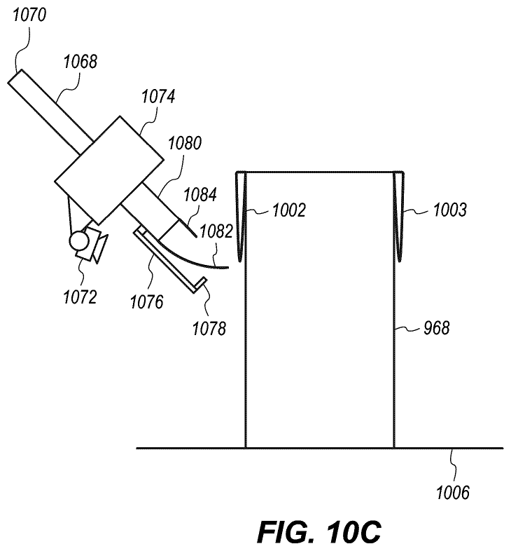

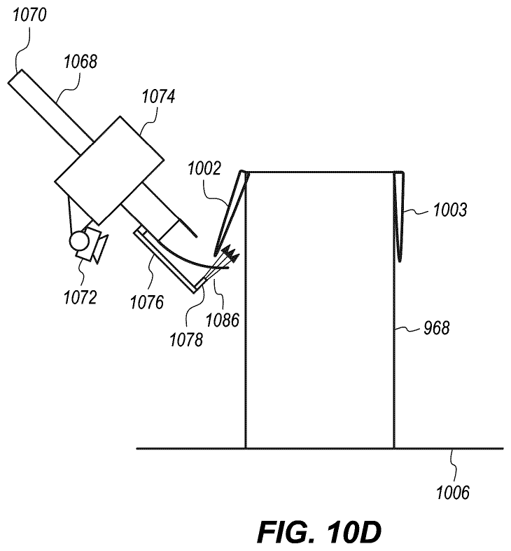

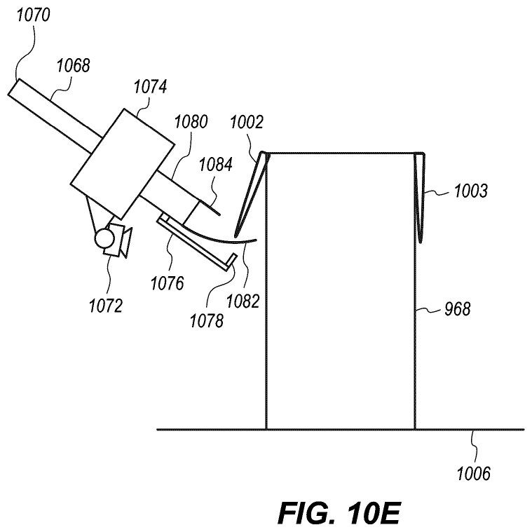

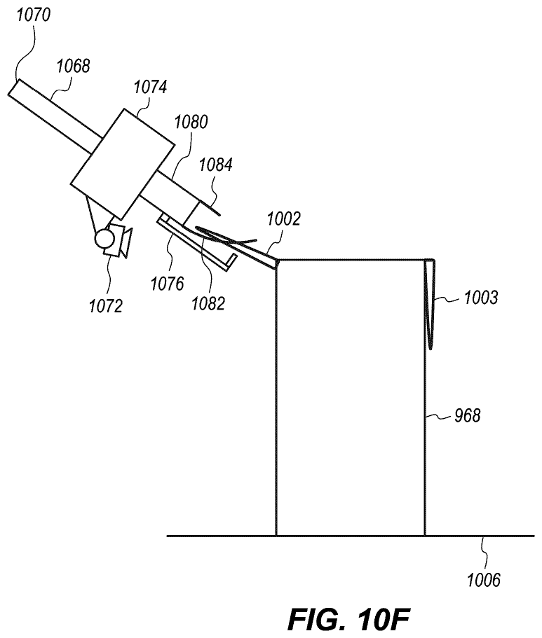

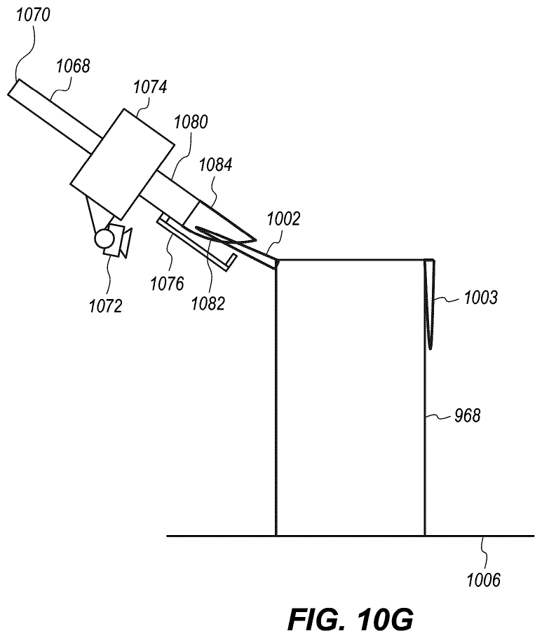

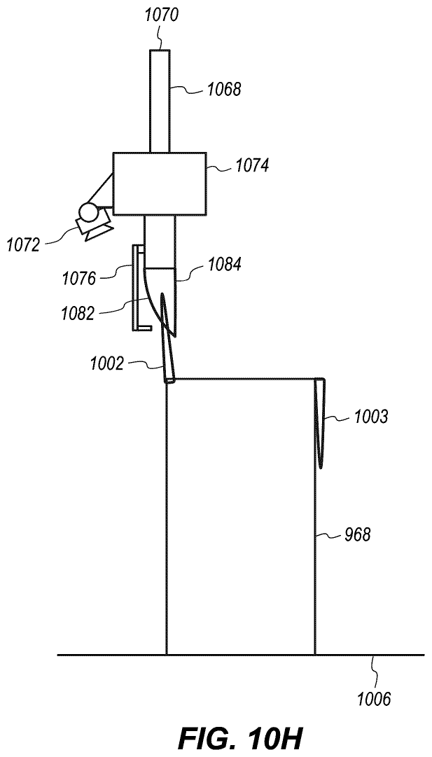

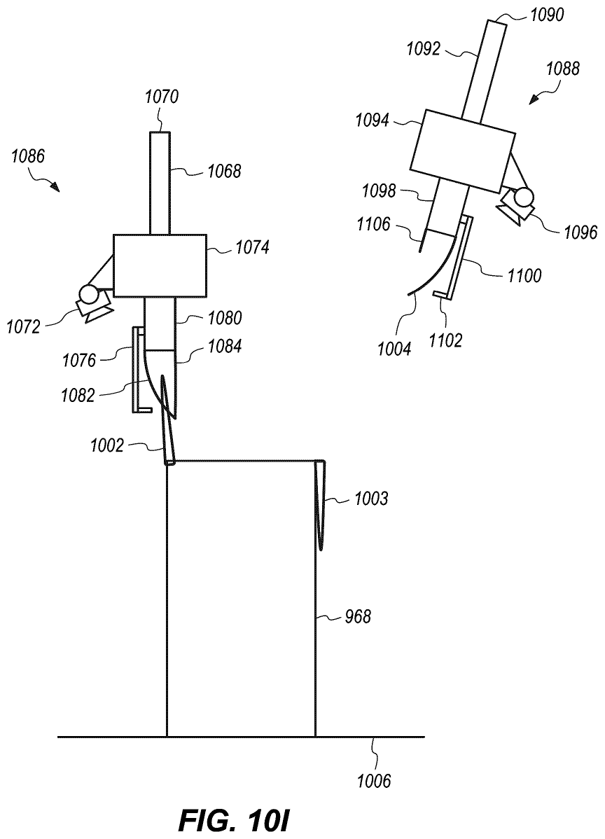

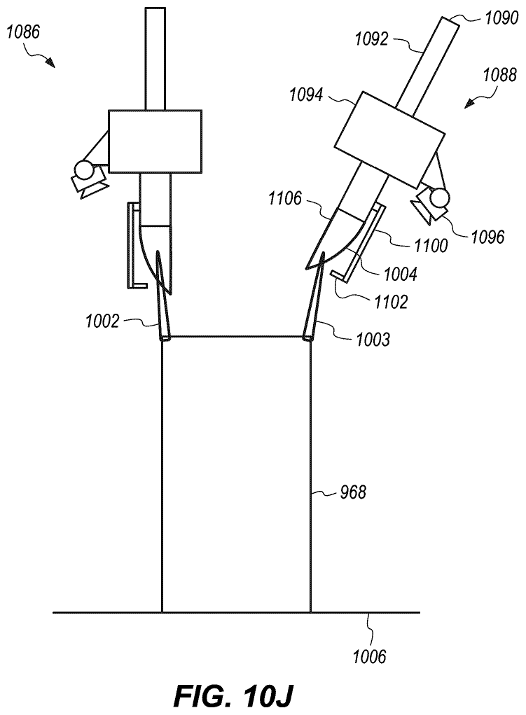

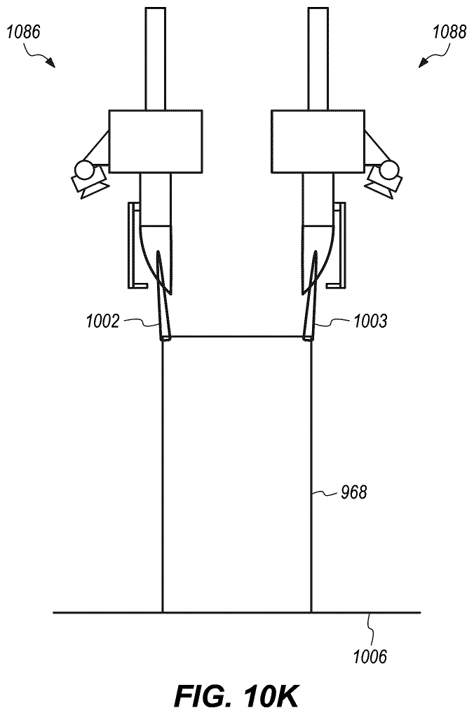

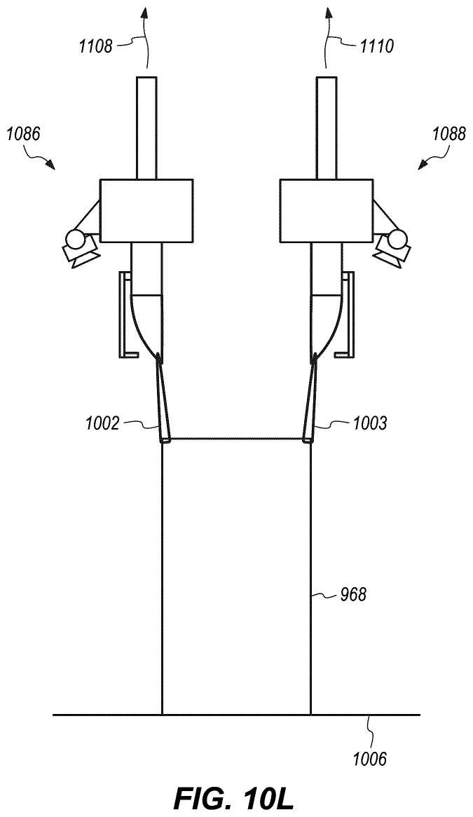

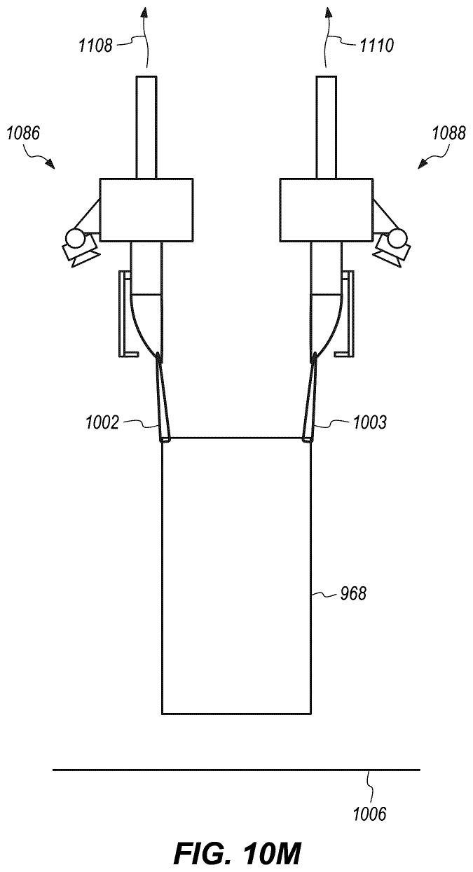

Referring to FIGS. 9A, 9B, and 10A, orthogonal views of a tote or output container (986) with handles (1002, 1003) are illustrated placed on a floor or other structure (1006) such as a rack or buffer structure. Referring to FIG. 10B, a computerized electromechanical or robotic manipulator (1068) system, the proximal end (1070) of which may be operatively coupled to another electromechanical system such as a robot arm (not shown; also operatively coupled to computing resource), may comprise an actuator module (1074) comprising one or more motors or actuators configured to controllably move or actuate one or more distal grasping members (1084, 1082), such as via lead screw, servo motor, stepper motor, and the like relative to the actuator module (1074) to controllably capture a structure such as a container handle (1002) as shown. One or more image capture devices (1072) may be positioned and oriented to assist with observing and automatically controlling such activity. Referring to FIGS. 10C and 10D, the manipulator (1068) may be automatically positioned and oriented to place a distal tip (1078) of a controllable air conduit (1076) adjacent to a targeted handle (1002) so that the air may rotate the handle upwards so that it is easily exposed to allow it to be captured by the intended distal grasping member (1082) as shown in FIGS. 10E and 10F, after which the other distal grasping member (1084) may be extended to capture the handle (1002), as shown in FIG. 10G, and pull the handle (1002) into tension and/or different orientation, as shown in FIG. 10H. The manipulator assembly (1086) may be matched with another similar manipulator assembly (1088; robotic manipulator 1092 with proximal end 1090 coupled to another controllable subsystem, not shown; actuator module 1094; image capture device 1096; air conduit 1100 with distal portion 1102; grasping members 1106, 1104) so that the other handle (1003) may be similarly grasped and the entire container or tote (968) controllably lifted away and/or reoriented, as shown in FIGS. 10I-10M.

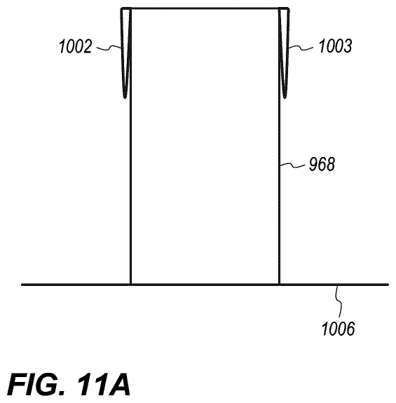

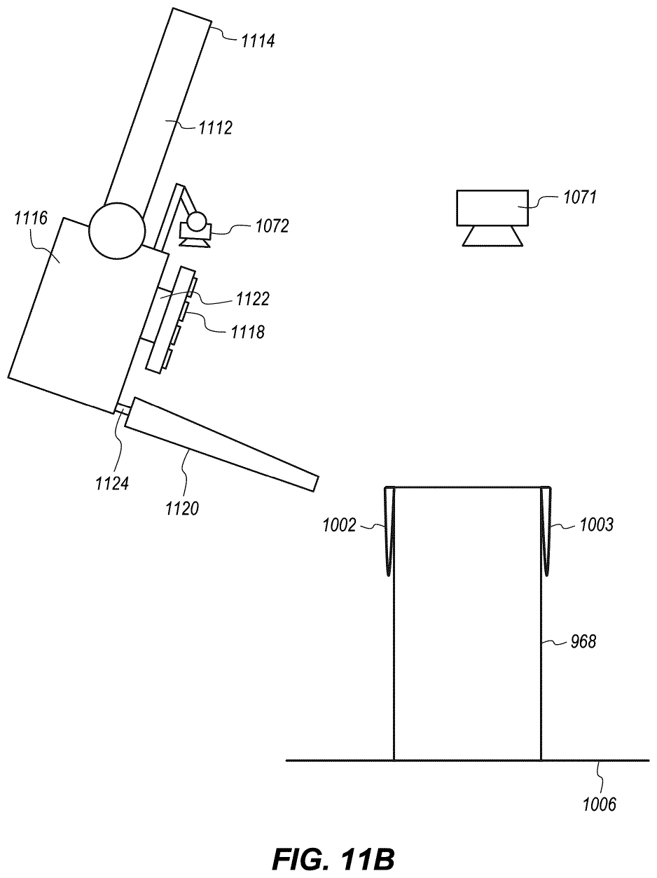

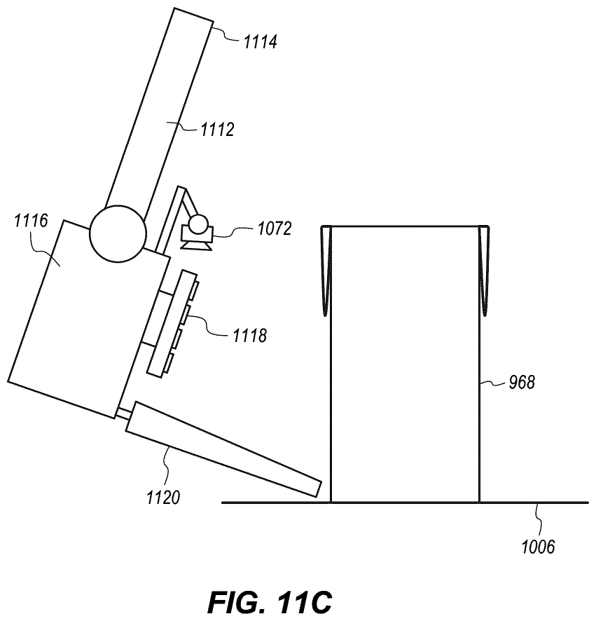

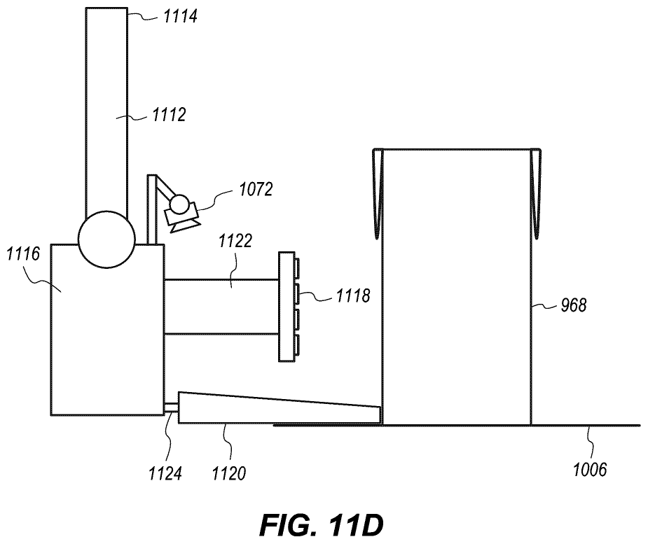

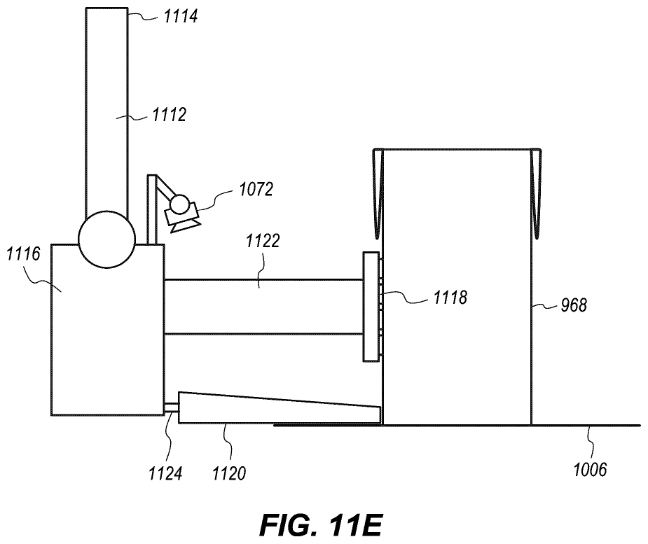

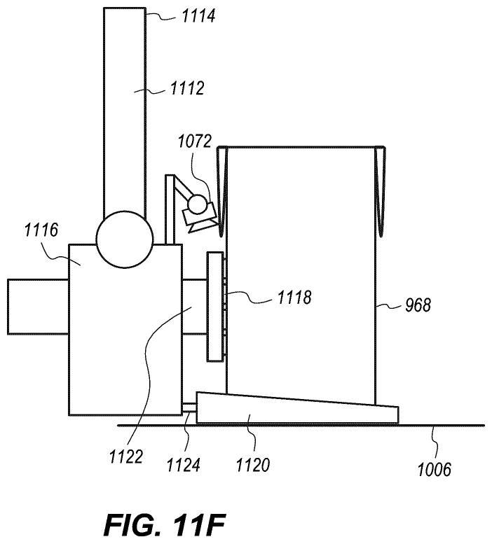

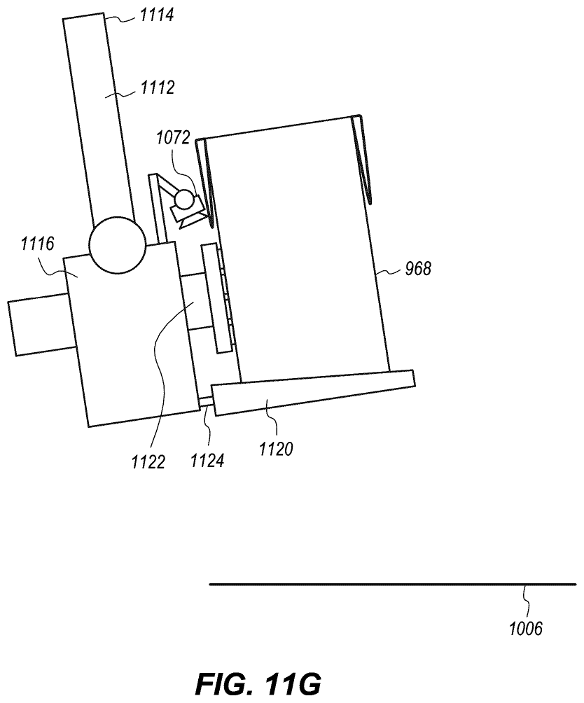

Referring to FIGS. 11A-11G, another embodiment of a robotic manipulator configuration is illustrated for removably coupling to and lifting away/repositioning/relocating an individual output container or tote such as that illustrated in FIG. 3. Referring to FIG. 11A, an individual output container or tote (968) is shown resting on a surface or structure such as a rack or floor (1006). Referring to FIG. 11B, a robotic manipulator (1112) is shown approaching (via coupling at its proximal end 1114 to another electromechanical subsystem such as a robotic arm; the manipulator 1112, image capture devices 1071, 1072, vacuum end effector 1118, and other components being operatively coupled to a computing resource) the container (968) and being operatively coupled to one or more image capture devices (1072), an actuator module (1116) which may comprise one or more electromechanical actuators, such as motors, lead screws, belts, gearsets, and the like, configured to controllably move an operatively coupled vacuum suction cup array end effector (1118) and operatively coupled lifting tray (1120). An image capture device (1071) may be operatively coupled and configured to capture operations such as by the robotic manipulator (1112) pertaining to the output container or tote (968). Suitable image capture devices include but are not limited to cameras, stereoscopic camera assemblies, depth cameras, and assemblies and pluralities thereof, and may be configured for operation with visible light or any other wavelength, such as infrared, each having a field of view which may be modified using lenses or other optical techniques. In one embodiment, each of the vacuum end effector array (1118) and lifting tray (1120) may be controllably inserted and retracted using a lead screw member (1122, 1124) powered by motors within the actuator module 1116). Referring to FIGS. 11C and 11D, the manipulator assembly may be positioned and oriented under vision-based (1072) control to be immediately adjacent to the targeted container (968), after which a combination of controlled insertion of the vacuum end effector array (1118) and lifting tray (1120), followed by vacuum coupling of the vacuum end effector array (1118) to the targeted container (968), as shown in FIG. 11E, and retraction of the vacuum end effector array (1118) relative to the lifting tray (1120), to pull the targeted container (968) securely onto the lifting tray (1120) for transport, as shown in FIGS. 11F and 11G.

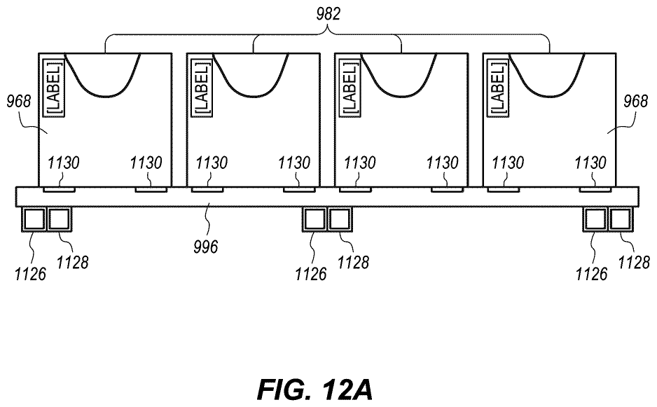

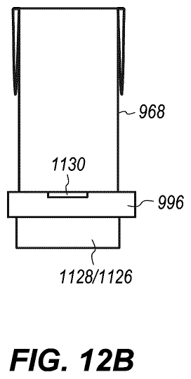

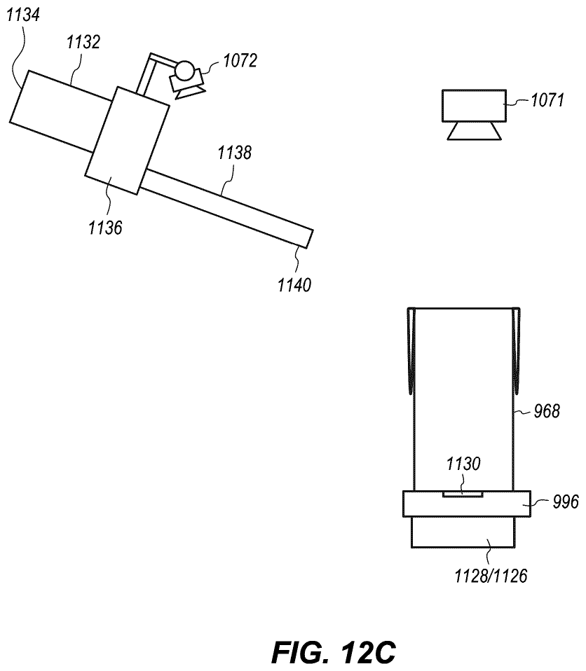

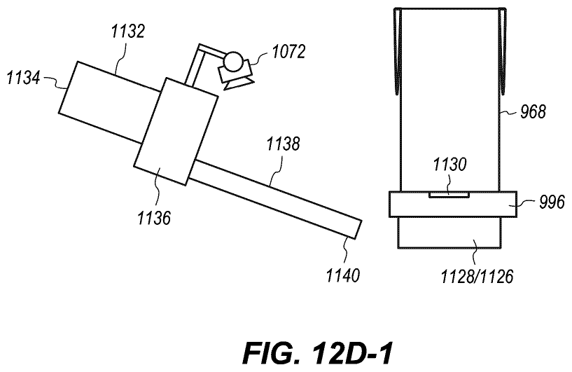

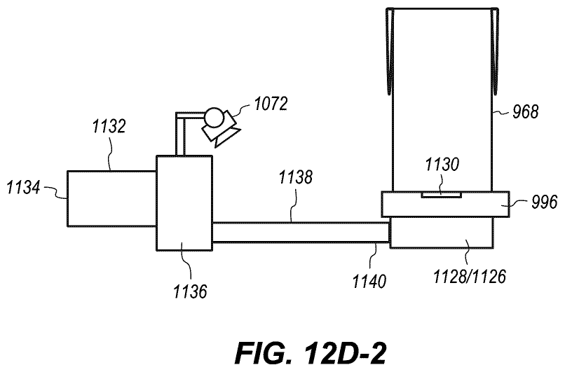

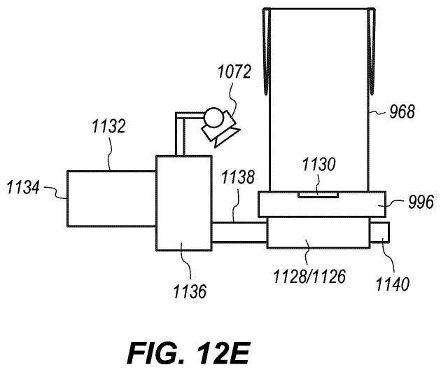

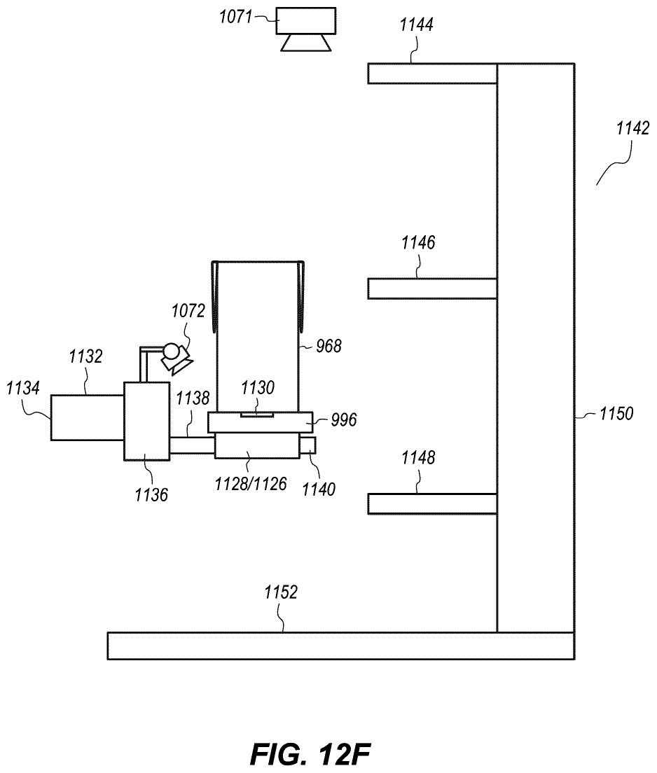

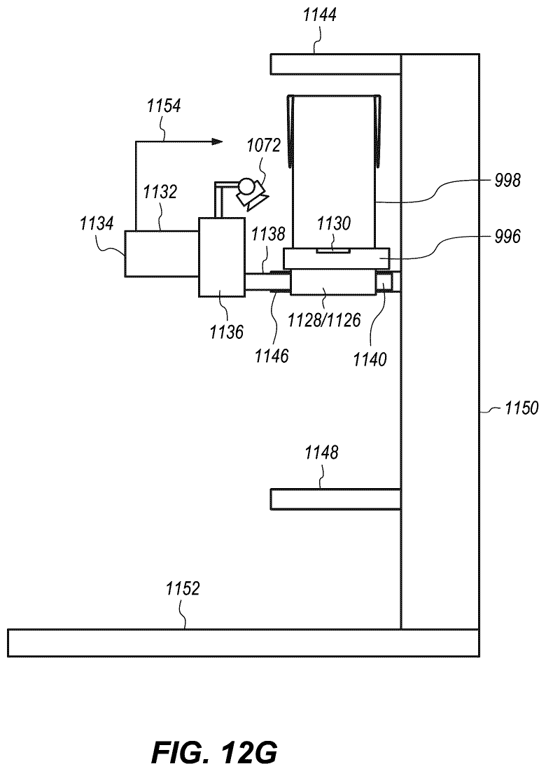

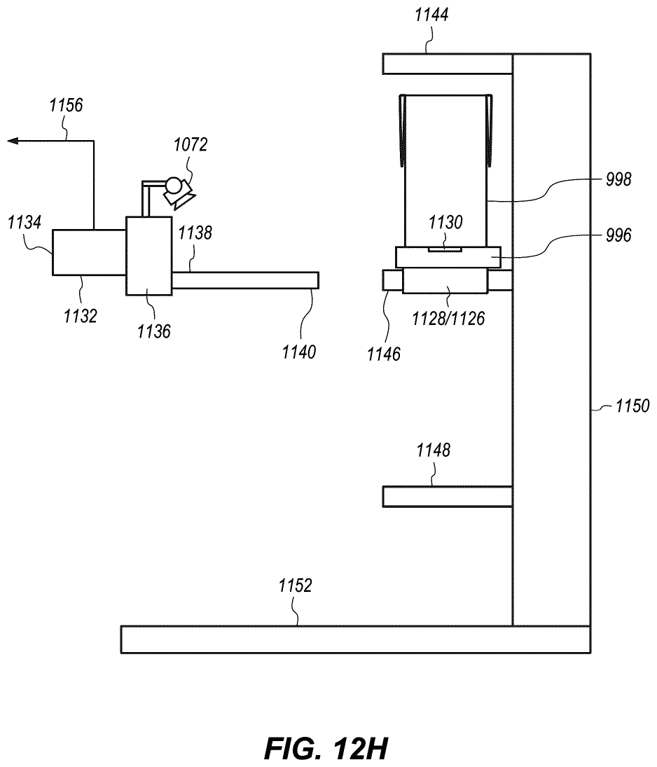

Referring to FIGS. 12A-12H, a structural rack (996) may be utilized to couple a plurality of output containers (982) together so that they may be transported to and from a sortation or other subsystem in a unified and efficient manner. Referring to FIG. 12A, each (968) of the plurality (982) may be removably coupled to the rack (996) using a plurality of permanent magnets or electromagnets or releasable latches (1130) configured to interface with various ferrous or mechanical features of the bottoms of the containers (986); these couplings may be configured to allow for easy and fast coupling, but also to prevent decoupling when a rack (996) is being moved or accelerated about during operation. The embodiment of FIG. 12A comprises pairs of mechanical coupling features, such as rectangular conduits (1126, 1128), which may be removably coupled to other rack structures, such as storage rack shelve structures, or protruding lifting members of a lifting manipulator, or both, as discussed below. FIG. 12B illustrates a side orthogonal view of a configuration such as that in FIG. 12A. Referring to FIG. 12C, a robotic manipulator (1132) may comprise a proximal end (1134) operatively coupled to another system such as a robotic arm, and may feature one or more operatively coupled image capture devices (1072, 1071), actuator module (1136; may contain motors, actuators, lead screws, and the like for operating nearby hardware such as a controllable protruding member 1138 having a distal portion 1140 mechanically configured for operative coupling with one or more aspects 1128/1126 of an associated rack structure 996). As shown in FIGS. 12C, 12D-1, and 12D-2, under preferably automatic vision-based control, the manipulator may be advanced toward the targeted rack (996); as shown in FIG. 12E, the distal portion (1140) may be inserted into a selected feature (1128/1126) of the rack for coupling, after which the selected rack (996) may lifted away, moved, reoriented, and advanced, for example, toward a storage or intermediate processing rack (1142) comprising a plurality of shelf structures (1144, 1146, 1148), a vertical support (1150), and a base support (1152), the shelves being configured also to be releasably coupled to one or more of the coupling features (1128, 1126) of the movable rack (996). As shown in FIGS. 12F and 12G, the movable rack (996) may be coupled to the storage rack shelf (1146), preferably via vision based automatic control (such as via one or more operatively coupled image capture devices 1072, 1071), and the manipulator may be retracted or withdrawn (1156) to do other work while the movable rack (996) remains temporarily coupled to the shelf (1146).

Referring to FIG. 13, in various scenarios, it may be challenging to fit a particular package (1160) into a given output or transportation container (968) without specific relative orientation of these structures. In other words, the single relatively large package or item (1160) shown in FIG. 13 may, indeed, fit within the targeted container (968), but only in a specific orientation relative to that container (968). Similarly, a group of three packages (1162, 1164, 1166) may only fit within the bounds of a targeted output container (968) when they are in specific positions and/or orientations relative to each other. The subject system may be configured to utilize vision and other tracking technologies to not only characterize the geometry of the selected packages and targeted output container, but also to optimize grasps, positioning, orientation (within the destination container, and also at intermediate locations during processing, such as in front of a barcode scanner or upon an intermediate buffer or table structure before further handling into the targeted output container), sequencing, acceleration, loading, and other factors to accomplish a desired result with a high rate of throughput speed. In one embodiment, operatively coupled image capturing/vision technologies may be utilized, along with a neural network trained in accordance with a supervised learning model, unsupervised learning model, and/or reward-based reinforcement learning model (each of which may be trained using actual image data, synthetic image date, or combinations of both) to understand the geometric bounds of various packages, fit prism geometries around them, identify labeling upon various sides of aspects of various packages, and analyze candidate grasp locations based at least in part upon factors such as: end effector type (such as single or plurality vacuum-suction-cup based end effector; or two-fingered grasper; or lifting tray+vacuum-suction-cup-array), determined free substantially-planar surface areas of a particular package, determined location of labeling information, determined mass of particular package, range of motion of associated robotic manipulator and/or related singularities, allowable global positioning envelope, allowable accelerations, allowable loading (for example, given meta data associated with a particular label upon a package; and/or based at least in part upon determined or estimated package mass, modulus, detection of loose objects within the package, and/or detection of sounds pertaining to the package, such as potentially fragile contents that make detectable noises when accelerated), and other factors.

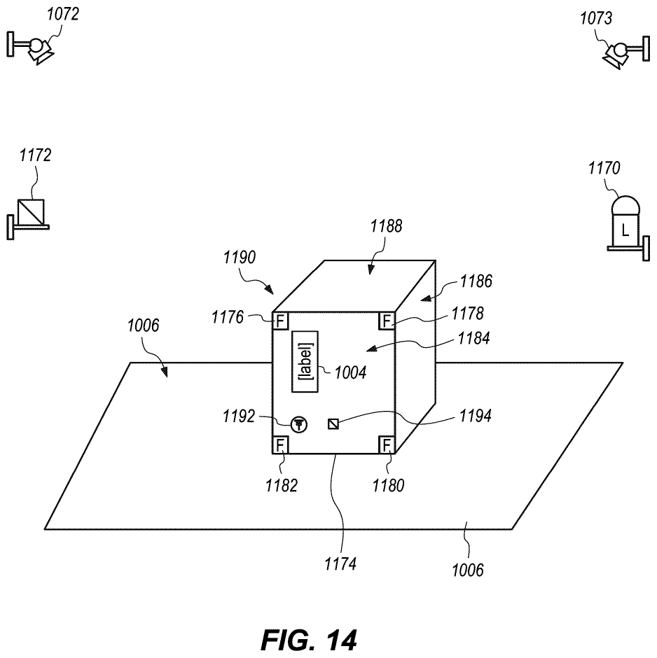

Referring to FIG. 14, a targeted package (1174) may comprise various features to expedite and enhance system tracking and processing, and these configurations and principles may be applied similarly to various containers as well, such as particular output containers (968). As shown in FIG. 14, a particular package (1174) may feature an external label (1004), which may feature textual and/or graphic material, and may be captured in image format and/or as a successful barcode, QR code, or other symbolic read. The package may also feature one or more fiducials (1176, 1178, 1180, 1182), such as marks, codes, patterns, or the like, which may be operatively coupled to meta data or information such as designated package side information (for example, they may identify the forward-presented side 1184 as one that is substantially planar, contains the label, and comprises a relatively stiff cardboard backing optimized for vacuum end-effector coupling, relative to other sides such as 1188, 1190, 1186 which may be sub-optimal for vacuum end-effector coupling and/or not contain label information). Such features may be configured to rapidly provide the electromechanical processing system with this type of information to assist with expedient processing and generally less de-novo analysis at one or more stages of processing. The package (1174) or container also may contain one or more geometric features configured to be easily and rapidly detected by not only an image capture device (1072, 1073, for example, which may be coupled to a portion of the electromechanical system, frame structure, aspect of the room structure such as ceiling or wall, or the like; suitable image capture devices may comprise simple cameras, IR or other spectrum sensors, depth or time-of-flight cameras such as those available from Intel under the tradename RealSense™, and the like) or scanner (such as a barcode scanner or image capture device configured to determine barcode information based upon captured image information), but also an operatively coupled LIDAR sensor (1170; also maybe coupled to system, frame, wall, ceiling, etc.; such as those available under the tradename Hokuyo™), and or electromagnetic tracking detector (1172; also maybe coupled to system, frame, wall, ceiling, etc.) which may be configured to determine position and orientation of a small coil box (1192; such as those manufactured by Northern Digital, Inc or Polhemus, Inc) which may be coupled to one predetermined aspect of the targeted package (1174) or container. Similarly, one or more small, relatively low-power wireless transmitters (1192) may be embedded or coupled to a given package (1174) or container to assist with identification and/or localization (such as via transceiver triangulation and/or nearfield identification or signal analysis/strength techniques) of particular packages and/or containers involved in a logistics process configuration. Each of these sensors and/or image capture devices may be operatively coupled to a computing resource to facilitate automatic identification and characterization, such as bounding box estimation, geometry estimation, mass estimation, stiffness estimation, reference to stored information (such as meta data previously associated with a given item identifier such as a barcode), and other operations.

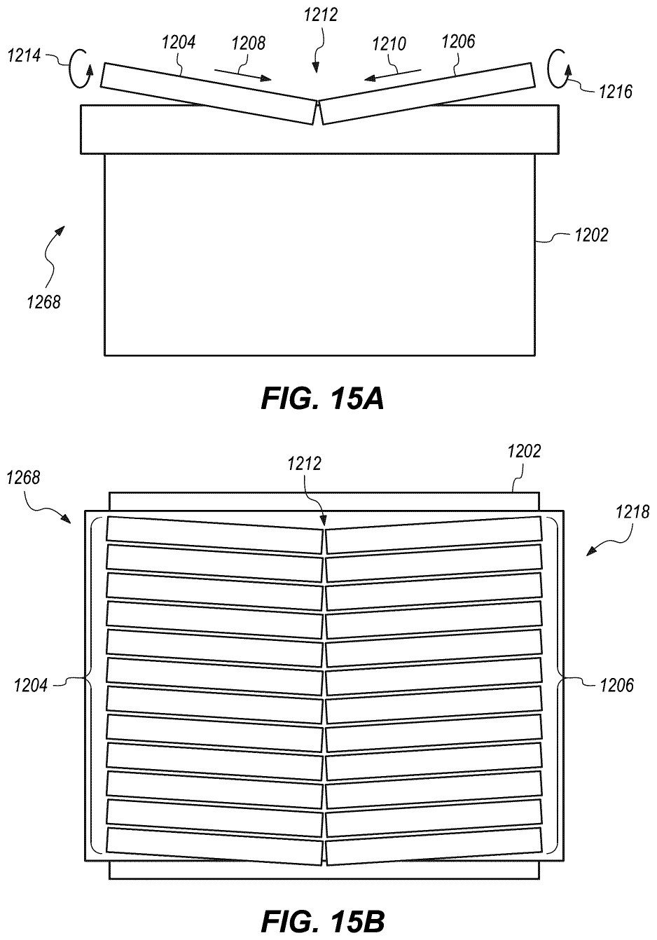

Referring to FIGS. 15A-15B, a central-gathering herringbone type of conveyance (1268) configuration is illustrated which may be utilized to electromechanically move and/or re-orient a given package that encounters such conveyance—to, for example, orient such package for optimal scanning and/or orient/vector such package toward a next step of processing en route to pack-out. Such operations may be conducted automatically utilizing operatively coupled computing resources and information from modules such as image capture devices. Referring to FIG. 15A and orthogonal/top view FIG. 15B, two assemblies (1204, 1206) of generally cylindrical and controllably rotatable members are angled up, for example at about 15 degrees of rotation, relative to a table or base structure (1202) so that a package will generally move (1208, 1210) toward a central position (1212) with vibration and movement of the members (1204, 1206). Such configurations may be utilized as input assemblies as they may be used to direct items or packages toward sortation, and termed “herringbone” arrangements (1268). In one embodiment, each assembly (1204, 1206) may be rotated independently together, so that a package may be advanced off of the conveyance (1268), or in opposing rotational (1214, 1216) directions, in which case a package at the center (1212) will be rotated relative to the table (1202). Such a subsystem may be configured to have various modes, such as one wherein after a package may be automatically moved toward the center (1212) and then rotated until it resides label-up for a label scan by a nearby intercoupled scanning or image capture device. Such system may also be configured to orient a package in a manner that is optimized for further processing. For example, a known heavier side of the package may be left facing downward as the package is transferred off of the conveyance to another subsystem; or a labelled side may be intentionally exposed to a scanner or image capture device at a known vector; or a substantially planar aspect suitable for vacuum end effector grasp may be exposed directly for quick interfacing with a nearby vacuum end effector grasper for subsequent processing. In various embodiments, it is desirable to maintain system level identification of a particular package once it has been identified. In other words, once a barcode, label, UPC, or other identifying information has been linked with a particular package, time may be saved and efficiency gained by not having to re-identify such package at subsequent steps-and thus the associated subsystems generally may be configured to retain package singulation where possible, as well as access to key labelling or identification information or continuous tracking such that further identification or de-novo analysis by subsequent subsystems is not required.

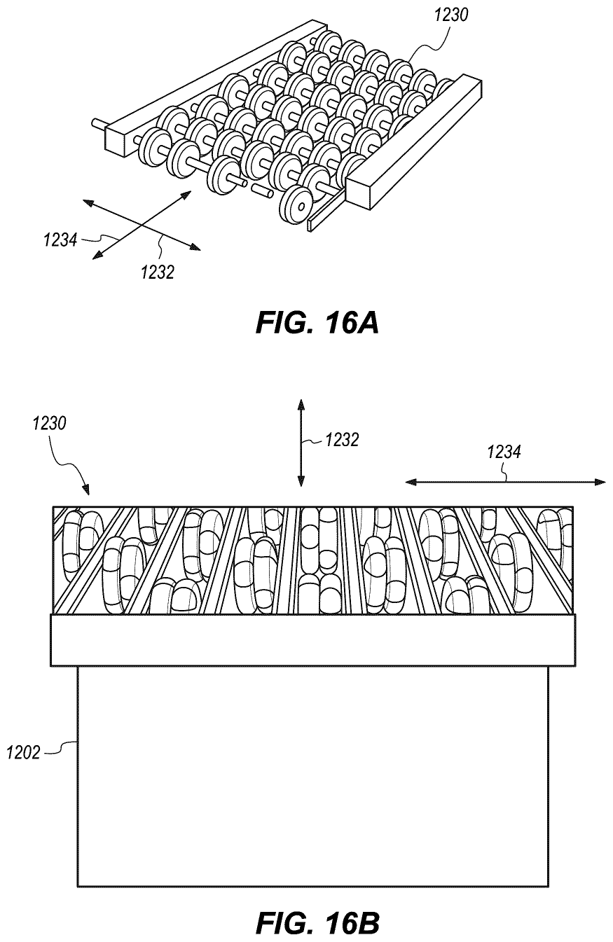

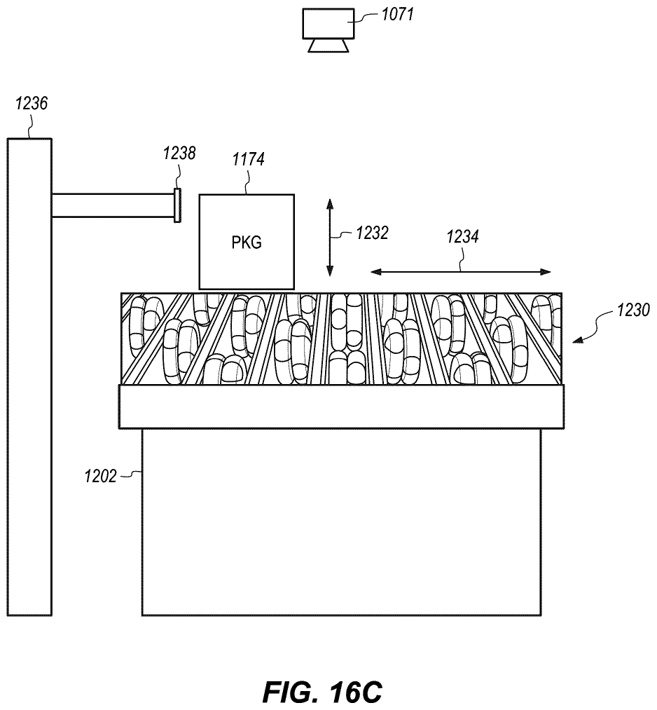

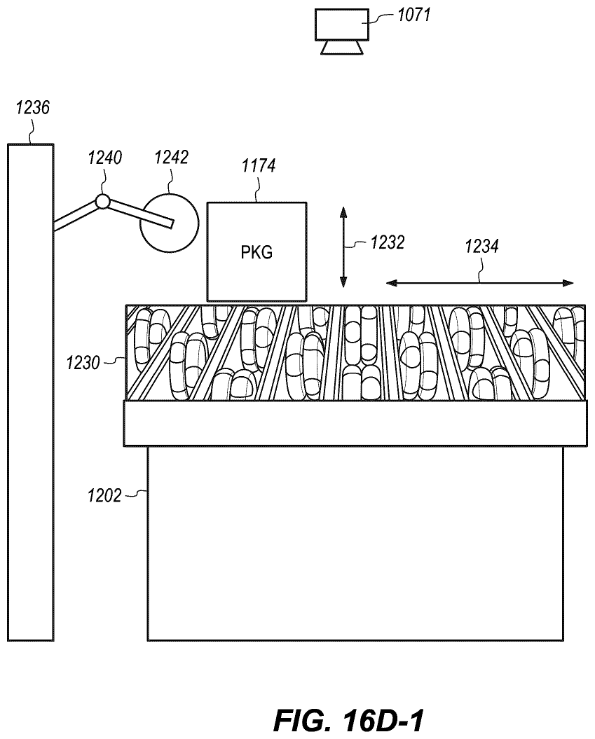

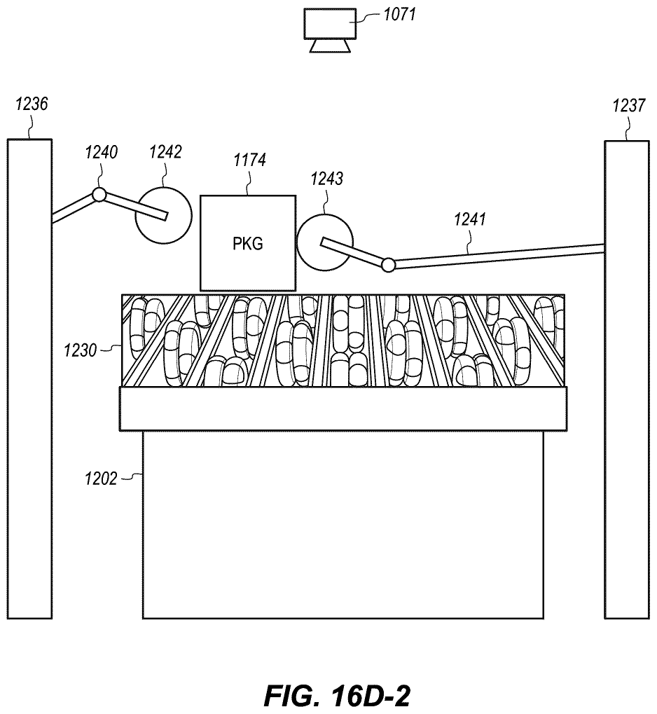

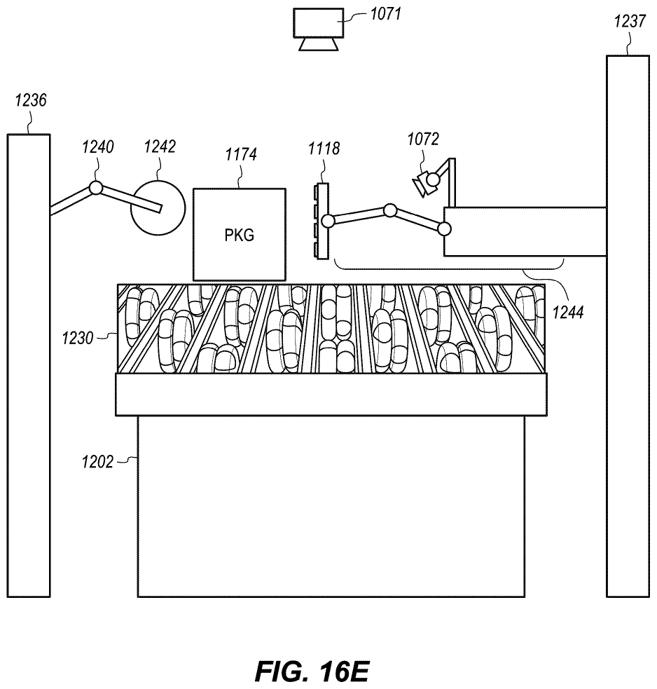

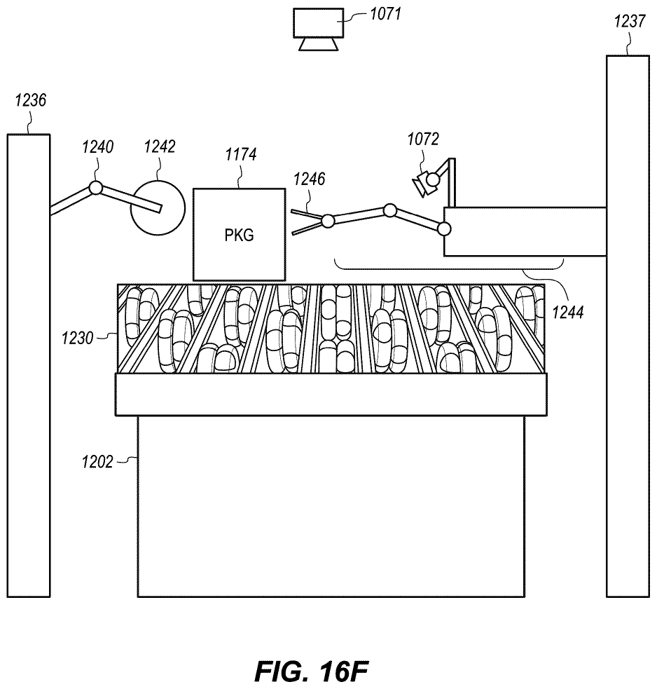

Referring to FIGS. 16A-16F, as noted above, multi-directional (1232, 1234) conveyance systems (1230) may be incorporated to divert, rotate, vector, and manipulate targeted packages with relatively high speed. Referring to FIG. 16B, a multi-directional (1232, 1234) conveyance system (1230) is mounted upon a table (1202) and may be used in various input, intermediate, and output configurations to rotate, orient, divert, eject, etc. packages. As noted in the incorporated reference, extrinsic features or structures may be utilized to assist with conveyor-based manipulation of a particular package (1174). For example, referring to FIG. 16C, a structural member (1236) may be coupled to a protruding structure (1238) configured and positioned to provide a vectored, positioned push resistance against a package (1174) which may be vectored toward it by a conveyor (1230); this may facilitate an intentional tipping or other mechanical manipulation of the targeted package (1174), which may be observed and/or controlled with assistance of one or more operatively coupled image capture devices (1071). Referring to FIG. 16D-1, an electromechanical or robotic arm (1240) may extend from the structural member (1236) and may have an intentionally atraumatic and/or high-adhesion or grip distal portion (1242) configured to mechanically interface with a package (1174) urged toward it by the conveyance (1230), which facilitates a significant panoply of mechanical manipulation and/or interaction (for example, the distal portion 1242 may be utilized along with the conveyance 1230 to quickly intercept, stop, tip, reorient, etc. the targeted package 1174). The distal portion may comprise a variety of geometries and/or surfaces, such as fingers, low-friction materials, and the like. The configuration may be observed and/or controlled with assistance of one or more operatively coupled image capture devices (1071). Referring to FIG. 16D-2, a second structural member (1237) may comprise a second robotic arm (1241) and engagement distal tip (1243) to facilitate significant mechanical manipulation of the targeted package along with the conveyor (1230) from positions across a conveyor table, for example. The configuration may be observed and/or controlled with assistance of one or more operatively coupled image capture devices (1071). In other embodiments, similar assemblies (1237, 1241, 1243) may be configured to encounter one or more packages in sequence down the length of a conveyor (1230), such that as a package (1174) is moving down the length of a conveyor, it can encounter one or more pairs, or generally a sequential plurality of such assemblies (1237, 1241, 1243) to sequentially adjust, re-vector, reorient, eject, hold, etc. the package as it moves sequentially along through processing. Indeed, referring to FIGS. 16E and 16F, one or more manipulation assemblies may comprise robotic manipulators (1244) with end effectors which may, for example, comprise vacuum-suction-cup arrays (1118) or grasper end effectors (1246), to provide different manipulation alternatives relative to the conveyor surface (1230).

To provide further manipulation precision, handling, and efficiency, referring to FIGS. 16G and 16H, a targeted package (1174) resides upon an electromechanically controllable conveyor (1248) which also may be operatively coupled with one or more wall structures (1250) configured to provide a known extrinsic loading surface—and also which may be live conveyors themselves (for example, single direction or multi-directional). Thus as shown in FIG. 16H, when the base conveyor (1248) urges the package (1174) against the wall structure (1250), the wall structure may assist in simply providing a known planar extrinsic loading surface to, for example, assist in orienting the package relative to the wall structure (1250), or may also be configured to advance/vector loading against the aspects of the package (1174) that engage the wall structure (1250). Additional use of extrinsic loading (or so-called “extrinisic dexterity” processing whereby elements extrinsic to an operable member such as a grasper) may be utilized throughout various aspects of the system configurations described herein, and are not limited to the use of a ramp or wall in the particular configuration of FIG. 16H. For example, in each use of a conveyance, grasper, coupler, or other active member wherein a particular package or item is targeted for repositioning, reorientation, and/or grasp/coupling, extrinsic loading from known members such as ramps, walls, cuboids, concave elements, convex elements, or other shapes may be utilized to assist in such operation, and these extrinsic loading members may be stationary relative to the package or grasper/coupler—or may be controllably active (i.e., controllably movable or controllably reorientable, such as in the case of a controlled pusher wall or ramp).

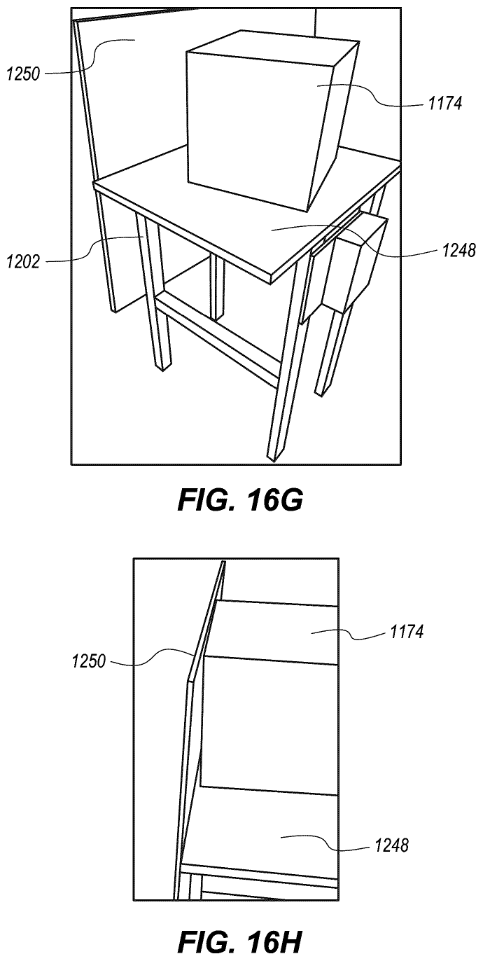

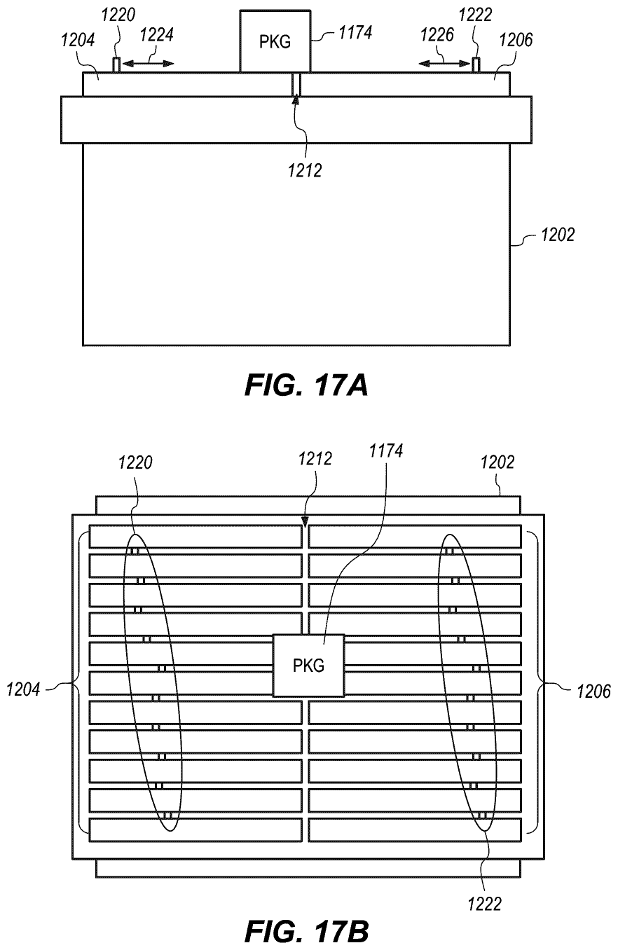

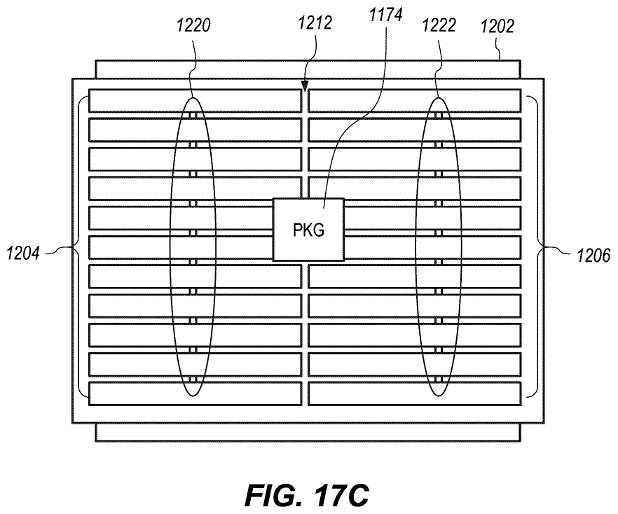

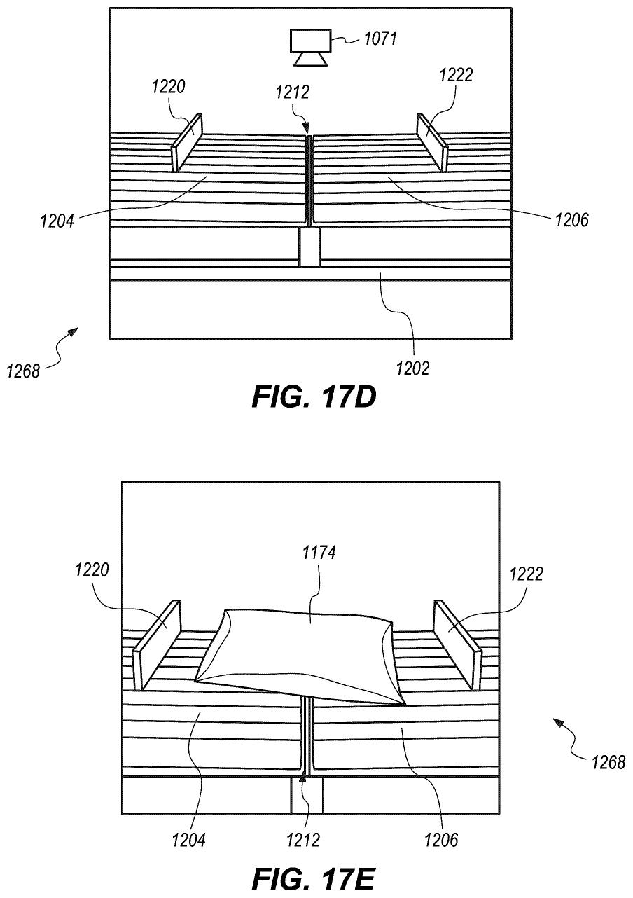

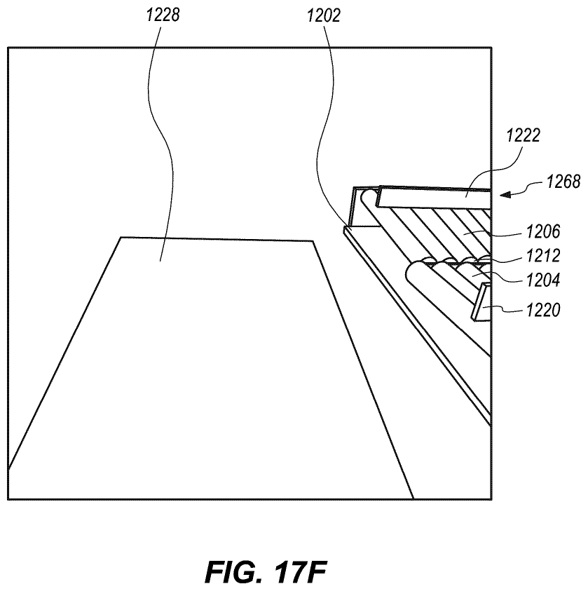

Referring to FIGS. 17A-17F, variations of herringbone style conveyance configurations, related to those described above, are shown wherein in addition to two intercoupled groups of controllably actuated/rotated cylindrical members (1204, 1206) are intercoupled to two sets of mechanical push features (1120, 1222) which may be configured to assist in gathering packages toward a given position on the conveyor, such as toward the center (1212), by being controllably movable (1224, 1226) in between the cylindrical members (1204, 1206) relative to the center (1212). Such configurations also may be utilized as input assembly configurations to direct packages or items into sortation. These features may be configured to act independently, as in the configuration of FIG. 17B, or together, as in the configurations of FIGS. 17C and 17D-17F. The configuration of FIGS. 17D-17F shows that the push features (1120, 1222) may be coupled above the conveyor surface to function as small movable walls to push/move a given package (1174), such as toward the center (1212) as shown in FIG. 17E, wherein the package may be moved forward, backward, etc.-and/or rotated/reoriented through opposing rotational motion of each opposing side of the herring-bone configuration (1204, 1206 rotating oppositely; in what may be called a “tank rotation” mode due to some similarities with the manner that a tank with tracks is steered or rotated); such configurations may be observed and/or controlled with assistance of one or more operatively coupled image capture devices (1071). Referring to FIG. 17F, the conveyance (1268) may be configured to eject the targeted package out onto another conveyor (1128), into an output container, etc.

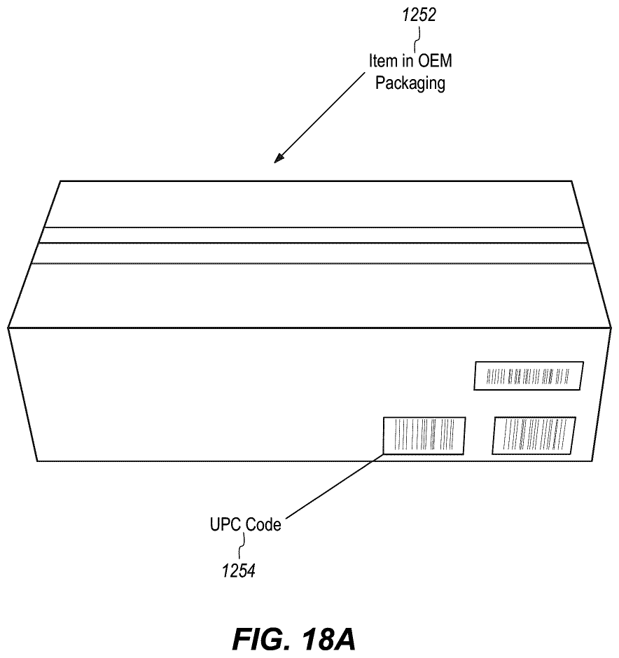

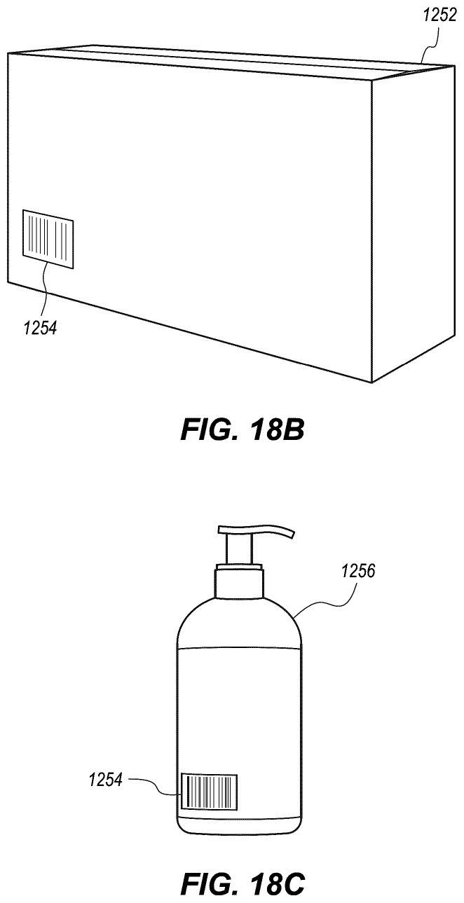

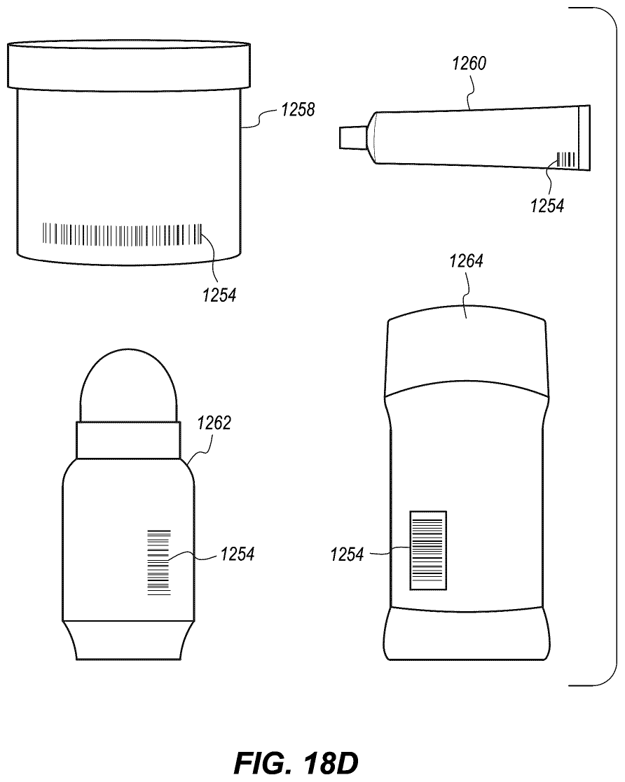

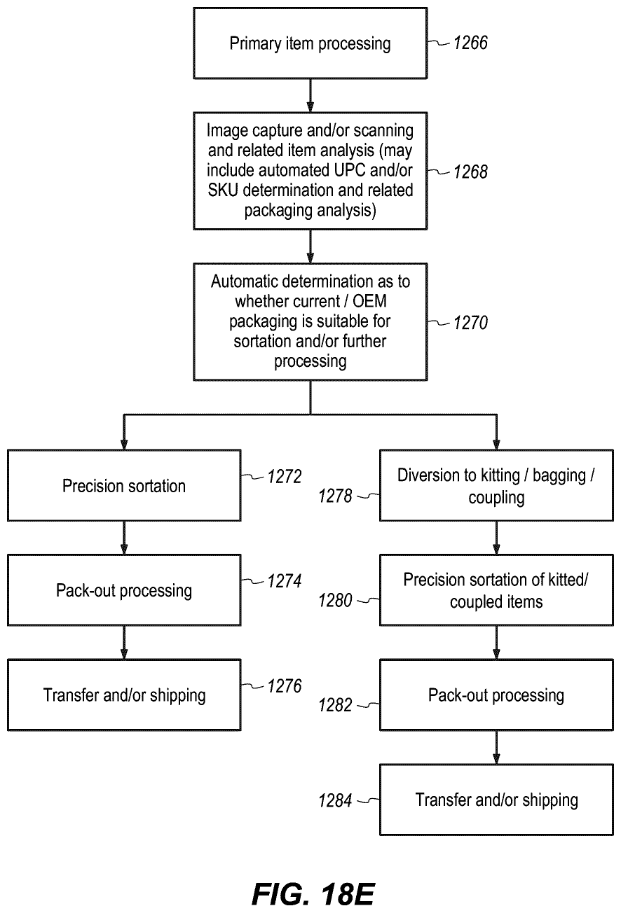

Referring to FIGS. 18A and 18B, where possible, it may be desirable to directly process, sort, and pack-out using OEM/SKU packaging (1252). In specific scenarios, this may be enhanced by the packaging itself containing identifying information (such as a stick-on label or other identifying information such as a UPC label 1254, SKU label, along with meta data which may allow the system to determine routing, shipping, and/or other variables based upon the UPC labeling; in other words, UPC code or SKU identification may not be enough to fully track and identify a given package or shipment because there may be many such packages with the same UPC or SKU labelling that day; in such situations the system may be configured to seek other meta data information to determine particular identification and routing, and may be configured to place an enhanced label upon the OEM packaging for additional use in processing). Further, certain OEM packaging may be unsuitable for logistics processing notwithstanding UPC code or other identification, and the system may be configured to automatically recognize, for example, that a lotion container (1256), or containers of other small cosmetic types of products (1258, 1260, 1262, 1264) should be kitted and bagged or boxed notwithstanding visible UPC identifiers (1254). Further, the system may be configured to automatically conduct basic analysis (such as image based, acceleration based, loading based) pertaining to the structure of such packages to determine that they should not be further processed in OEM packaging.

Thus referring to FIG. 18E, after primary item processing (1266), image capture and/or scanning and related item analysis (may include automated UPC and/or SKU determination and related packaging analysis) (1268). Automatic determination may be conducted as to whether current/OEM packaging is suitable for sortation and/or further processing (1270); if yes, precision sortation (1272), pack-out processing (1274), and transfer and/or shipping (1276) may follow; if not, diversion may be conducted for kitting/bagging/coupling (1278), followed by precision sortation (1280), pack-out processing (1282), and transfer and/or shipping (1284).

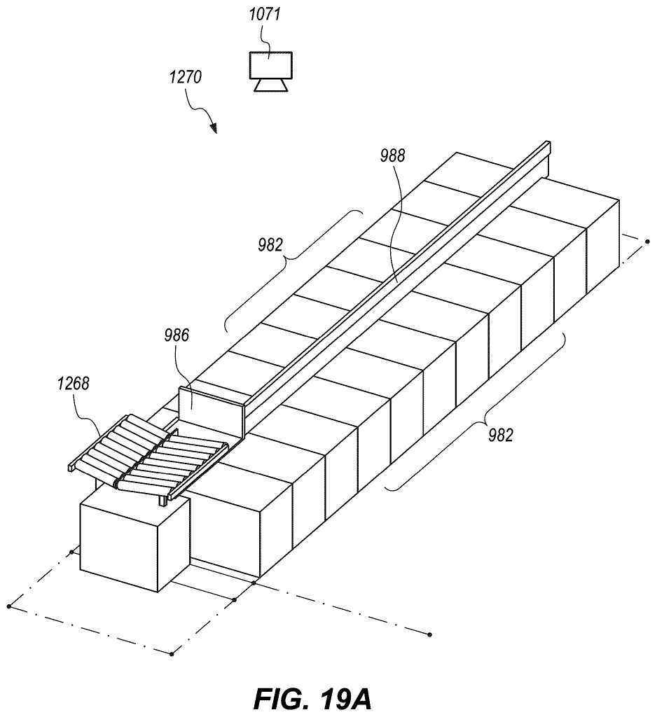

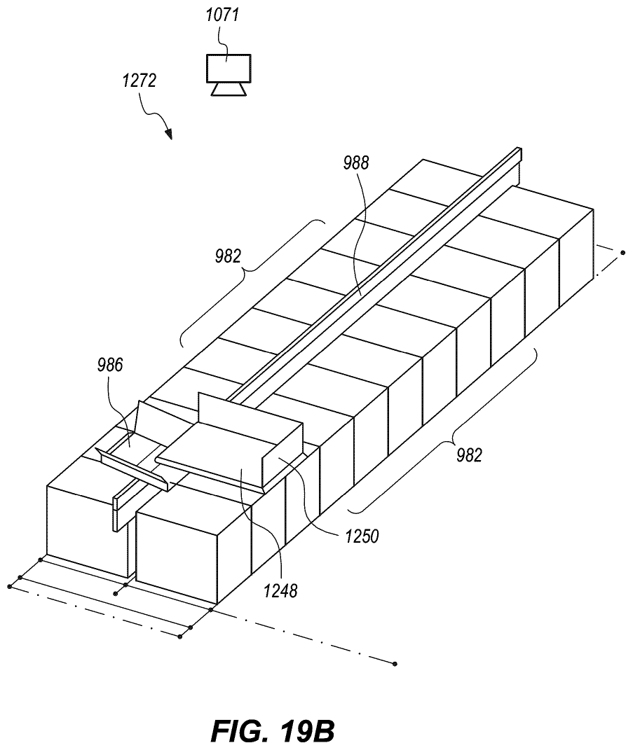

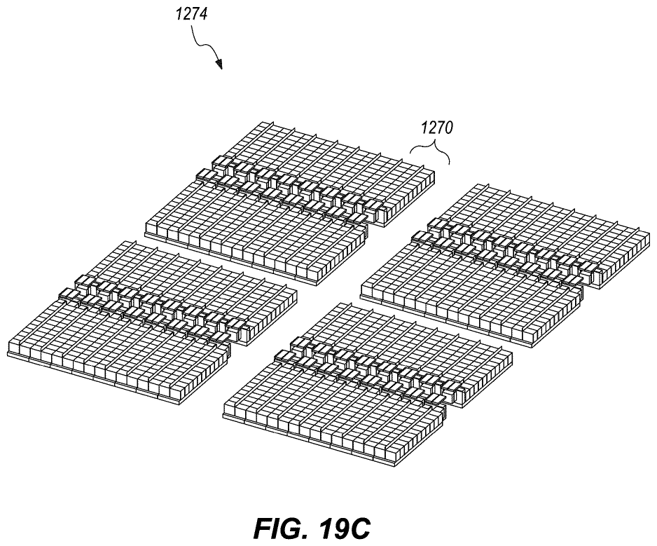

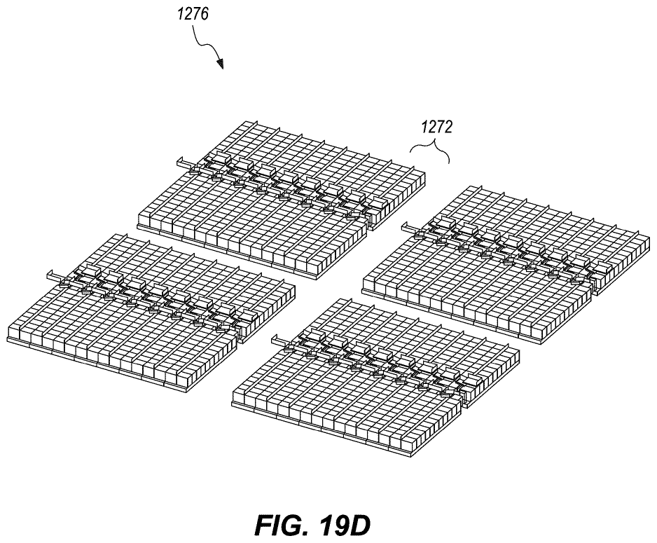

Referring to FIG. 19A, from an architectural and scaling perspective, a sorting unit (1270) comprising a herring-bone style conveyance (1268) may be configured to act as an input subsystem after primary item processing, and may be configured to controllably eject, such as with a preferred position and/or orientation, sequential packages onto a distribution module (986) such as a pan/tilt tray or small mobile conveyance, each of which may be coupled to a linear rail to provide access to each of an assembly of output containers (982). Referring ahead to FIG. 19C, many such units (1270) may be organized into a functional sortation assembly (1274) having many viable outputs. The configuration may be observed and/or controlled with assistance of one or more operatively coupled image capture devices (1071). Referring to FIG. 19B, a sorting unit (1272) is shown comprising a conveyor (1248; may be multi-directional) with wall structure (1250; may comprise a conveyor as noted above) which may be configured to act as an input subsystem or input assembly after primary item processing, and may be configured to controllably eject, such as with a preferred position and/or orientation, sequential packages onto a distribution module (986) such as a pan/tilt tray or small mobile conveyance, each of which may be coupled to a linear rail to provide access to each of an assembly of output containers (982). The configuration may be observed and/or controlled with assistance of one or more operatively coupled image capture devices (1071). Referring ahead to FIG. 19D, many such units (1272) may be organized into a functional sortation assembly (1276) having many viable outputs.

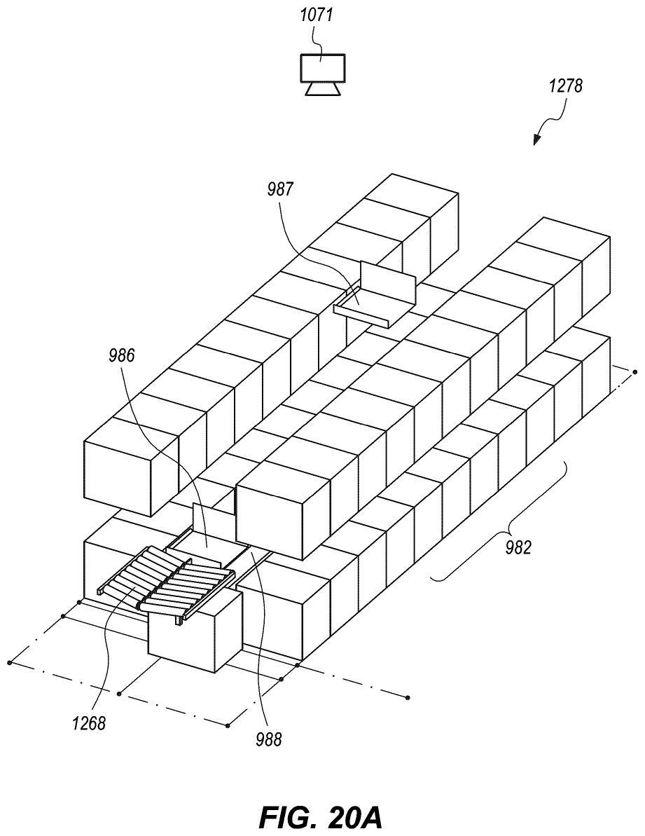

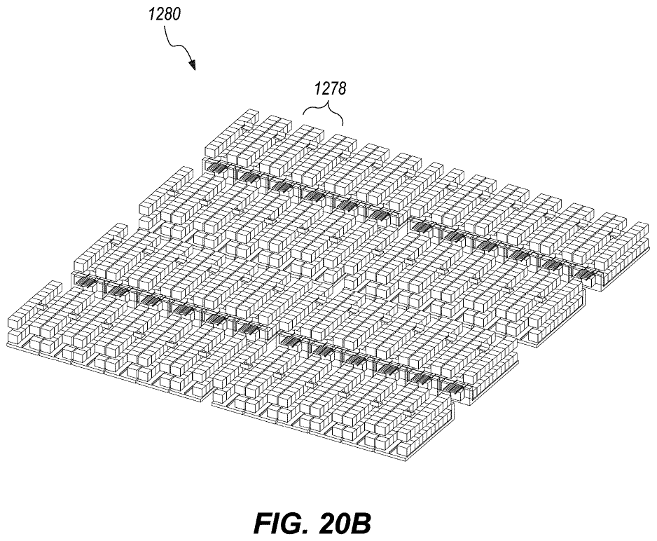

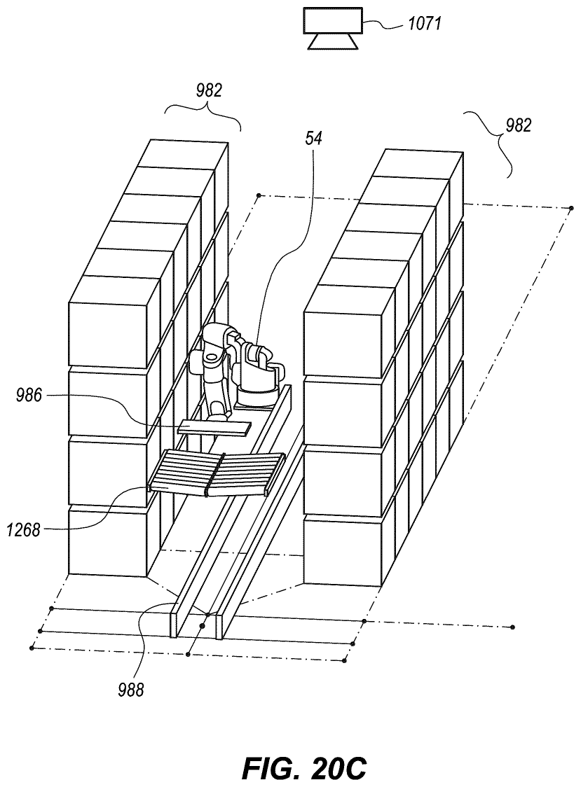

Referring to FIG. 20A, a sorting unit (1278) comprising a herring-bone style conveyance (1268) may be configured to act as an input subsystem after primary item processing, and may be configured to controllably eject, such as with a preferred position and/or orientation, sequential packages onto a plurality distribution modules (986, 987) such as a pan/tilt tray or small mobile conveyances, each of which may be coupled to a linear rail to provide access to each of a vertically stacked assembly of output containers (982). The configuration may be observed and/or controlled with assistance of one or more operatively coupled image capture devices (1071). Referring ahead to FIG. 20B, many such units (1278) may be organized into a functional sortation assembly (1280) having many viable outputs. Referring to FIG. 20C, a herring-bone type of conveyance (1268) may be configured to act as an input subsystem after primary item processing, and may be configured to controllably eject, such as with a preferred position and/or orientation, sequential packages onto a distribution modules (986) coupled to a robotic arm (54) mounted to a linear rail system (988) and configured to be able to controllably deposit packages into a stacked array of output containers (982). The configuration may be observed and/or controlled with assistance of one or more operatively coupled image capture devices (1071).

Referring to FIG. 21A, a robotic manipulator (1112) similar to that described above may be utilized to address a variety of package types. Packages known as “poly bags” or “mailers” (1284, 1290, 1292) present a unique challenge because they are somewhat rigid, somewhat flexible, relatively thin, and generally need to be somewhat geometrically organized relative to each other to efficiently fit within a desired output container (968), as shown, for example, in FIGS. 21D and 21E. Using a vacuum-based end effector (1118), such as in a configuration as shown in FIGS. 21B and 21C without a lifting tray, poly bags, mailers, sacks, and bags of various types may be controllably grasped, reoriented, repositioned, and placed efficiently in output containers as shown. Other scenarios wherein speed is of utmost importance, a similar system may be utilized to deliver such poly bags or mailers in an at least semi organized manner with the largest flattest side down toward the base of the output container (in other words, a disorganized pile of flats which at least has most planar flat surface in parallel fashion relative to each other within they output container).

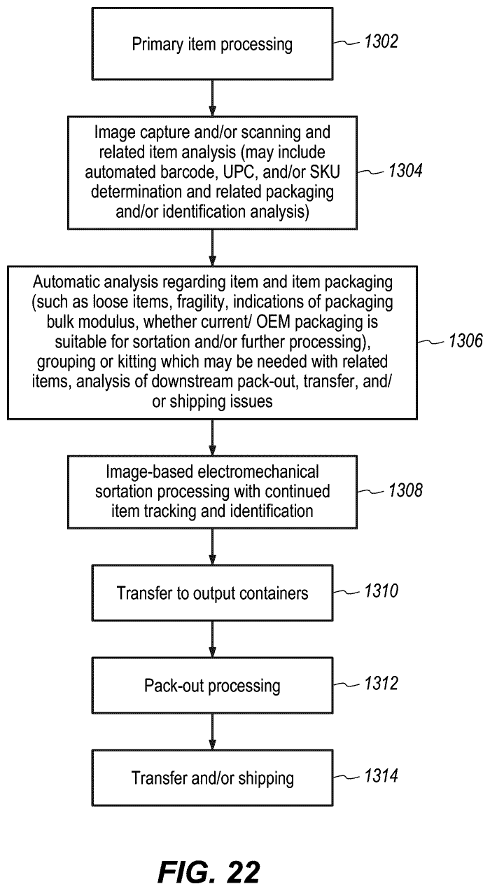

Referring to FIG. 21F, as noted above, the system may be configured to orient packages (1294) relative to each other within an output container (968), and also to provide a relative packaging schema optimized for input requirements, such as desired order of removal from the output container, predetermined, input, or determined fragility of packages, density or mass of packages, flexibility of packages, and the like. For example, depending upon the post-processing (such as during shipping or delivery), it may be desirable to optimize to be able to stack semi-rigid output containers up to three high within a truck without collapse, and this input may be modelled into the packing of the output containers (986). Thus referring to FIG. 22, after primary item processing (1302), image capture and/or scanning and related item analysis may be conducted (may include automated barcode, UPC, and/or SKU determination and related packaging and/or identification analysis) (1304). Automatic analysis may be conducted regarding item and item packaging (such as loose items, fragility, indications of packaging bulk modulus, whether current/OEM packaging is suitable for sortation and/or further processing), grouping or kitting which may be needed with related items, analysis of downstream pack-out, transfer, and/or shipping issues (1306). Image-based electromechanical sortation processing may be conducted with continued item tracking and identification (1308), followed by transfer to output containers (1310), pack-out processing (1312), and transfer and/or shipping (1314).

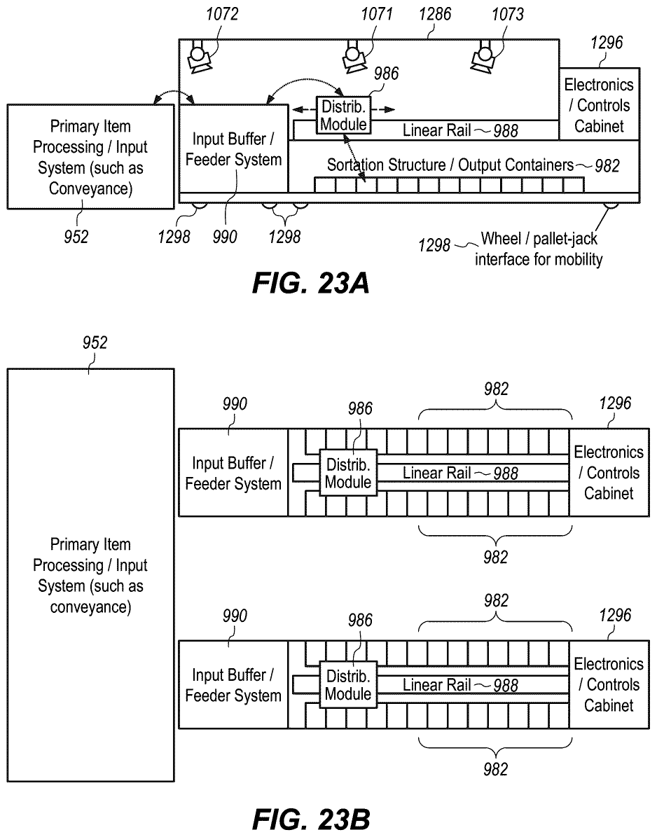

Referring to FIGS. 23A and 23B, a modular system configuration is shown comprising a frame assembly (1286) that couples one or more image capture devices (1071, 1072, 1073), a linear rail (986) configured to controllably move a distribution module (986) to access various coupled output containers (982) after receiving packages from an input buffer/feeder system (990), which is supplied by primary item processing (952; such as via conveyance). The frame (1286) assembly may comprise a plurality of wheels and/or pallet jack interfaces (1298) such that it may be moved throughout a warehouse floor, placed into storage, transported, easily scaled into a larger system, and the like. An electronics and controls cabinet (1296) may be located for convenient proximal access when in a larger assembly such as is shown in FIG. 23B, with wired and/or wireless coupling to all associated sensors, motors, and actuators. With a configuration such as that illustrated in FIG. 23A or 23B, and utilizing the various aspects of systems described above and in the incorporated reference, various types of packages may be brought into primary item processing in preparation for sortation, and they may be analyzed by computing resources operatively coupled to one or more image capture devices, which may be configured to not only identify, but also characterize packages as soon as possible in the processing, such that neural networks may be utilized to plot and execute singulation, precision sortation, positioning, transporting, and orientation within output containers, as well as the processing of completed output containers to pack out, as well as post-pack out processing, may be conducted quickly and efficiently using vision systems and operatively coupled computing resources configured to automatically process packages quickly and keep track of them during the process, preferably without undue de-novo or repeated analysis or processing along the way.

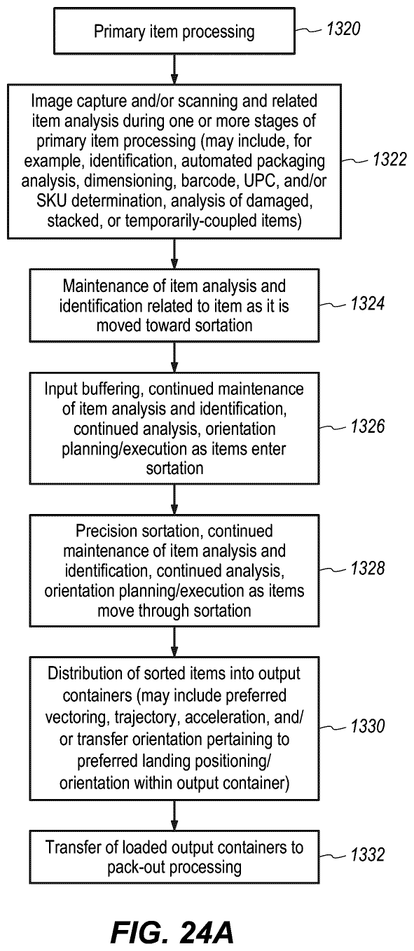

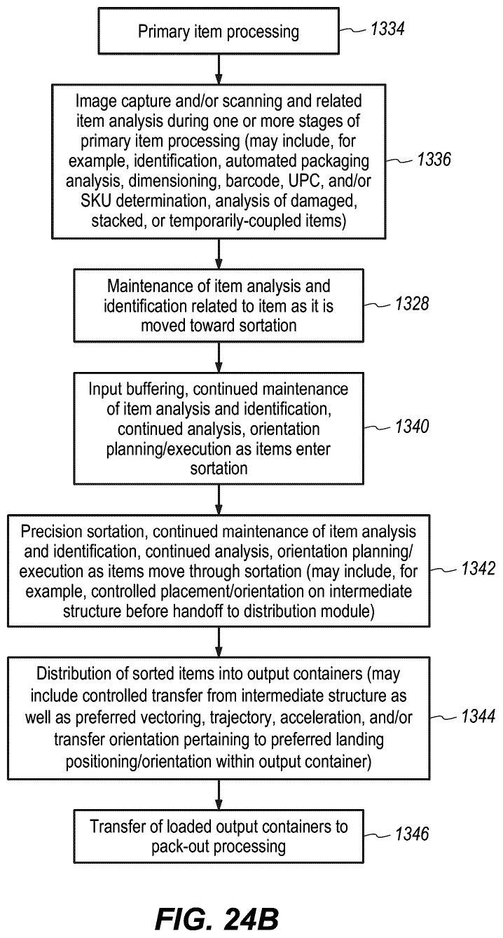

Referring to FIG. 24A, as noted above, in various embodiments it is desirable to continue to utilize identification and/or meta data information pertaining to particular packages or items as they are further processed. In other words, if a package is identified and characterized fairly early, or “upstream”, in the process, it is desirable to continue to be able to identify such package and utilize related meta data and characterization information downstream without the requirement of subsequent de-novo analysis; it may, indeed, be advantageous to continue to analyze a package as it moves “downstream” through a handling process, thereby gaining further information pertaining to the package itself and what has been done to it in terms of processing. Thus referring to FIG. 24A, a package may enter primary item processing (1320) and various events, processes, and subprocesses may be conducted. For example, image capture and/or scanning and related item analysis during one or more stages of primary item processing may be conducted, which may include, for example, identification, automated packaging analysis, dimensioning, barcode, UPC, and/or SKU determination, analysis of damaged, stacked, or temporarily-coupled items (1322). This information may be reported to connected computing systems, and following processing may be configured to retain or maintain the item analysis and identification capabilities pertaining to the particular package (1324). In other words, if a barcode label is successfully read pertaining to a particular package early in the primary item processing, the system may be configured to continue to orient the identified barcode label of such package in a manner such that it is exposed and vectored or directed toward a known position and/or orientation of an image capture device or scanner (i.e., not in a face down orientation wherein it may be difficult to re-identify such package). As items enter precision sortation, input buffering may be conducted (i.e., rate of throughput may be adjusted dynamic to downstream rate of processing in precision sortation to prevent over-feed, so-called “traffic jamming” of packages, and the like), and a continued priority may be maintained related to maintaining and improving item analysis and identification, as well as orientation planning and execution (1326). For example, orientation planning during early stages of primary item processing may be as simple as maintaining label visibility in something other than a face-down orientation; it may be as complex as maintaining a specific orientation of an item or package as it enters a specific chute, turn, conveyance, platform, or the like as the result of a known downstream manipulation singularity, pinch point, or scan or imaging tunnel. In other words, the system may be configured to not only maintain and improve identification and analysis of packages as they move through the process, but also to controllably and dynamically reposition and reorient them in accordance with known issues ahead for each package as it moves ahead through the processing (again, for example, the system may be configured to continue to observe identified packages as they move downstream with image capture and other devices, and if a particular undesirably does fall face-down onto a conveyance or other surface, the system may be configured to dynamically intervene, such as by grasping, pushing, flipping, diverting, or otherwise repositioning or reorienting such package until it can be readily identified again and/or is back in a preferred position and/or orientation given the known downstream processes and issues ahead. As items move through precision sortation, the system may be configured to continue to provide tracking, analysis, and identification information, as well as position and/or orientation optimization that is dynamic to the scenario for each package or item, in real-time or near real-time so as to keep the process moving expediently ahead (1328). With additional intervention and information, data from sensors such as one or more image capture devices (which may include color, monochrome, infrared, time-of-flight depth camera, and/or other types of image capture devices) and one or more compact LIDAR sensors may be utilized to continue to characterize packages. For example, in addition to so-called “sensor fusion” techniques as described above wherein data from two or more sensors with uncorrelated error configurations (such as two or more similar image capture device perspectives, or one image capture device rotated through two or more perspectives, or different types of sensors, etc.) may be utilized to produce a synergistic characterization of a targeted item, such data may be utilized to continue to characterize the mechanical or material properties of a given item or package. For example, a given image capture device and/or compact LIDAR sensor may capture information pertaining to a sequence of time during which a package has been loaded, such as by an intentional physical intervention (such as by an intentional contact by a configuration such as that described above in reference to FIG. 16C, 16D-1, 16-D2, 16E, or 16F). In other words, by intentionally physically addressing a given package with a known load at a known vector and observing behavior in detail with sensors such as image capture devices and/or LIDAR, the system may be configured to calculate and/or determine material or mechanical properties of such package. For example, the system may be configured to seek a substantially planar surface and apply a known perpendicular/principal style load, followed by a known load paradigm involving shear loading with a contact load and known contact coefficients of friction (static, kinetic) at the interventional device (such as element 1242 of FIG. 16F, for example); the results from such intervention may be utilized to determine and/or estimate valuable information such as bulk modulus of package surface or package generally, friction coefficients (i.e., is this a “slippery” vs “grippy” exterior surface on this package), mass, moment of inertia, package compliance (i.e., is the package firm or compliant to loading), whether loose items are detected inside of the package, etc. For example, a grasper type of tool, such as that shown (1246) in FIG. 16F, may be utilized to grasp, lift, and reposition in free space for brief period of time, a package such as that (1174) illustrated. Load sensing capabilities of the associated robotic arm holding the grasper (1241), such as those which may be based upon inverse kinematics, motor currents, piezoelectric sensors, strain gauges, and the like, may be utilized to estimate mass (i.e., in response to accelerations of the grasper 1241 holding the item), moment of inertia (i.e., measured as the grasped item is rotated/reoriented in space), overall package compliance (for example, in response to grasp or movement during grasp), as well as sounds, vibrations, or other responses indicative of loose items (for example, the grasper or intercoupled robot arm may be operatively coupled to one or more microphones or one or more inertial measurement units capable of detecting small sounds and/or accelerations which may be correlated with loose items or collisions within the package or item). Further, image capture devices of various types may be configured to use various irradiation wavelengths and technique to detect sheen, flatness, and other characteristics pertaining to materials, such as sheens of known plastics versus cardboards). Packages may also be loaded in mild bending or jetted with air or inert gas to confirm bending modulus or surface rigidity, for example, to confirm that a given package is a thin mailer or poly-bag. Similar analysis may be conducted throughout the various interlinked processes. Distribution of sorted items into output containers may, for example, include preferred vectoring, trajectory, acceleration, velocity, and/or transfer orientation pertaining to preferred landing positioning and/or orientation within a targeted output container (1330). For example, referring back to FIG. 13, it may be important to specifically position and orient one or more packages within a given structure, such as an output container or tote, or they may not fit as planned. The output containers may be subsequently transferred away for pack-out processing (1332).

Referring to FIG. 24B, a somewhat similar configuration to that of FIG. 24A is illustrated, with primary item processing (1334) which may include image capture and/or scanning and related item analysis during one or more stages of primary item processing (may include, for example, identification, automated packaging analysis, dimensioning, barcode, UPC, and/or SKU determination, analysis of damaged, stacked, or temporarily-coupled items) (1336). Again, maintenance of item analysis and identification related to item as it is moved toward sortation may be prioritized (1338), along with input buffering, continued maintenance of item analysis and identification, continued analysis, orientation planning/execution as items enter sortation (1340). Sortation may comprise a series and/or sequence of different subsystems, as described above. Precision sortation may be conducted with continued maintenance of item analysis and identification, continued analysis, orientation planning/execution as items move through sortation (may include, for example, controlled placement/orientation on intermediate structure before handoff to distribution module) (1342). Sorted items may be distributed into output containers (may include controlled transfer from intermediate structure as well as preferred vectoring, trajectory, acceleration, and/or transfer orientation pertaining to preferred landing positioning/orientation within output container) (1344), and loaded output containers may be transferred to pack-out processing (1346).

Referring to FIGS. 25A and 25B, as noted above, connected computing resources, such as local computing resources (such as local data center or network operating center resources 1352), remote computing resources (such as cloud computing resources available under tradenames such as Amazon Web Services ®, Microsoft Azure ®, or Google Cloud ®; 1350), individual computing resources (such as connected laptop computers, desktop computers, smartphones, tablet computers; 1354), and other connected systems (such as delivery or shipping trucks, mobile scanners, other computing or resource locations, weather information, disaster information, GPS information, mobile telecom information, traffic information, and air traffic control information pertaining to air-based logistics vehicles; 1348), each of which may be connected (1360, 1361) to the integrated sortation systems (1361, 1363) by wired (such as by terrestrial copper and/or optical fiber) and or wireless connectivity, such as via IEEE 802.11 wireless connectivity, proprietary wireless network, mobile telephony/smartphone wireless network, extra-terrestrial wireless connectivity (such as via systems available from StarLink® or proprietary satellite networks). FIG. 25A emphasizes that integrated computer vision, scanning, and tracking preferably may be ubiquitous throughout the various stages of processing (1364, 1366, 1368, 1370, 1372, 1374, 1376), and may be utilized not only for monitoring or quality control purposes (such as identifying a jam, damaged package, or the like), but also to responsive, dynamic control of the system to keep things moving rapidly and efficiently. FIG. 25B illustrates that various subsystems may be chained from or operatively coupled to other parent systems. For example, in the depicted embodiment, two (or more; second line depicted as elements 1367, 1369, 1371, 1373, 1375, 1377, 1363; with the integrated controls 1363, 1362 and computing 1348, 1350, 1352, 1354 all interconnected 1361 as shown) interconnected lines of sortation and processing may be dynamically linked to a given larger or preexisting primary item processing system to allow for flexibility and modularity, while all such subsystems may be centrally controlled and operated.

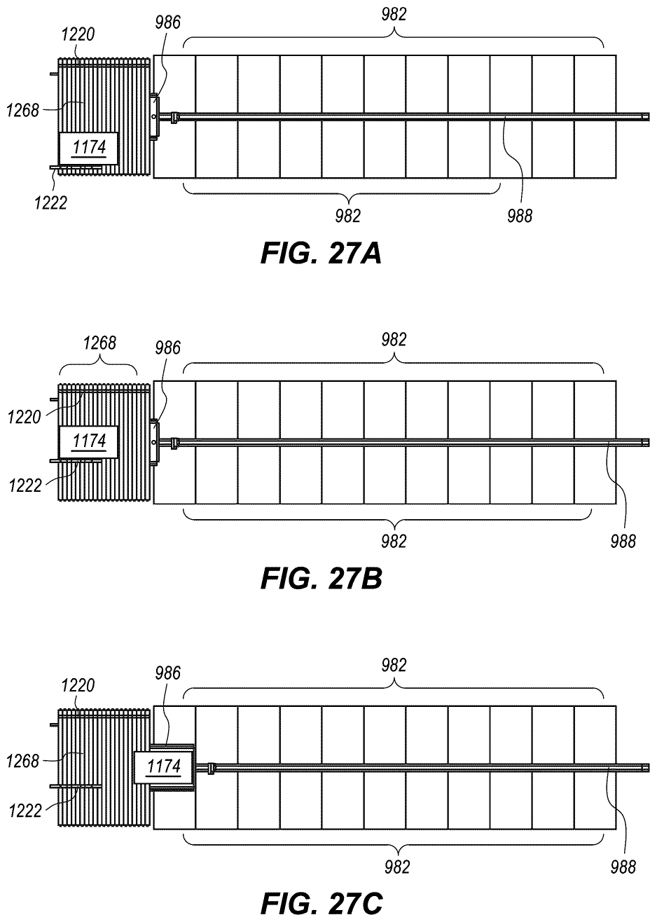

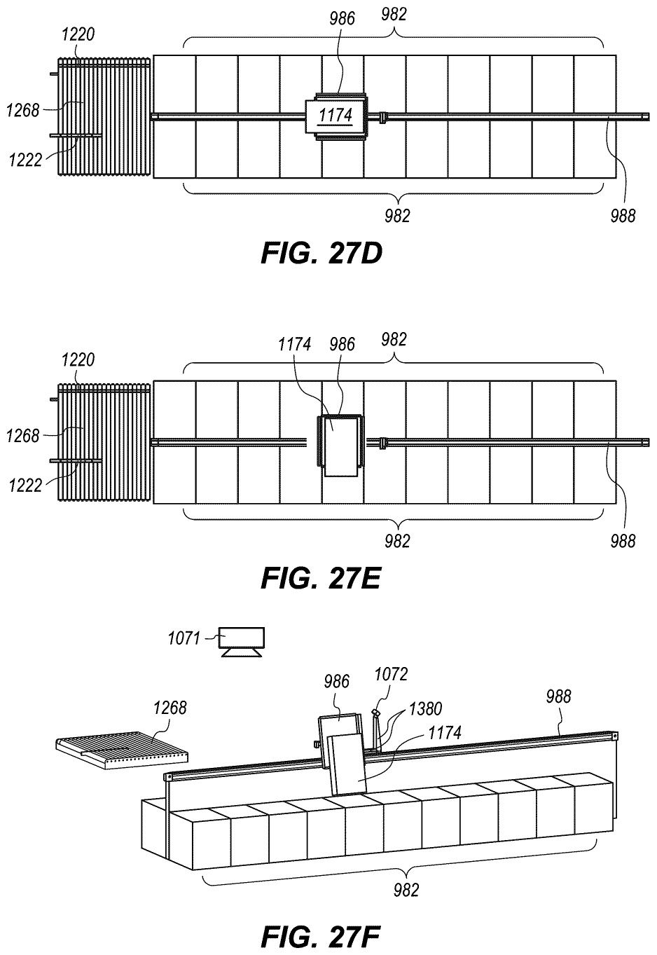

Referring to FIGS. 26A-26D, various aspects of a dual-motor pan-tilt distribution module (986), suitable for use in various above-described embodiments are illustrated. Referring to FIG. 26A, a frame assembly (1380) may be configured to constrain two motors (1384, 1386) relative to each other and to support a image capture device (1072) having a field of view or capture (1378) that is configured to at least capture the motion and activity of the distribution module (986). An input conveyance (1248) may be configured to deliver a package or item (1174) toward the distribution module (986) as shown in FIG. 24A, and to push it forward into the distribution module (986) as shown in FIGS. 26B and 26C. FIG. 26D illustrates an orthogonal view without the package for illustration of the distribution module (986); the frame assembly (1380) may be fixedly coupled to a movable portion of a linear rail (988) using a rail coupling member (1382). The pan motor (1386) may be configured to controllably rotate (1404) the distribution module (986) about the axis (1408) shown, while the tilt motor (1384) may be configured to controllably rotate (1402) the distribution module (986) about the axis (1406) as shown. These combined controlled rotations may be utilized to place a given package into an output container with specific vectoring, velocity, and orientation, as shown in FIG. 27F, for example.

Referring to FIGS. 27A-27F, an incoming package or item (1174) may enter a conveyance (1268) as shown, here a herring-bone style conveyance with controllably movable members (1220, 1222) for centering, as described above, for example, in reference to FIGS. 15A-15B and 17A-17F. FIG. 27B illustrates that the package (1174) has been centered using the movable members (1220, 1222), and in FIG. 27B, the conveyance 1268 then may be utilized to advance the package (1174) onto the distribution module (986) as shown. Referring to FIG. 27D, the package (1174) may be taken down toward an targeted output container (982) by the rail subsystem (988). When in a desired position along the rail (988), the distribution module (986) may be rotated as shown in FIG. 27E (using the pan motor 1386) to provide a preferred orientation for the package (1174), before the package is tilted (using the tilt motor 1384) into the targeted output container (982) with the preferred vectoring/orientation as planned, so that it will fit as desired. The configuration may be observed and/or controlled with assistance of one or more operatively coupled image capture devices (1071).

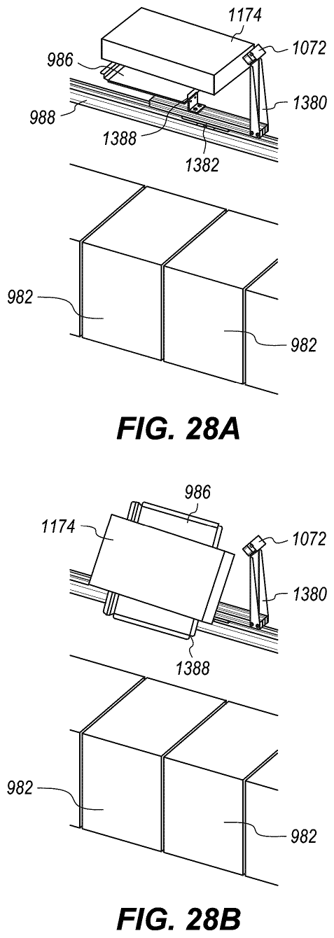

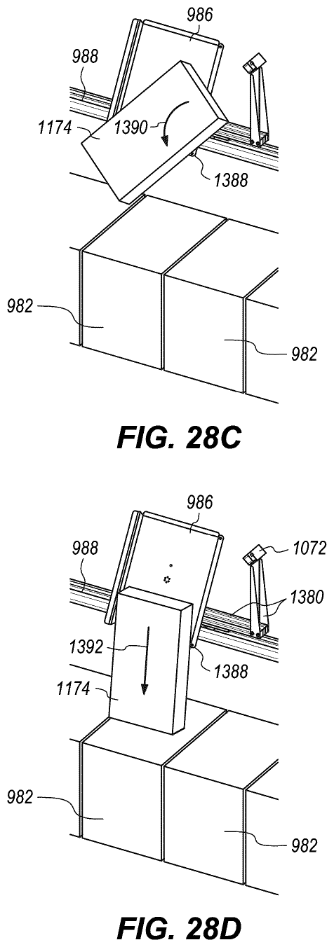

Referring to FIGS. 28A-28D, in another embodiment, it may be desirable to have one less motor, and to utilize the relative dynamics of the distribution module (986) and package (1174), as well as a protruding pivoting feature (1388) of the distribution module (986) which is specifically positioned and oriented to cause a rotation (1390) of the package (1174) as the package is falling down (1392) toward the targeted output container (982) after the tilt motor has been actuated, as shown in FIGS. 28C and 28D. In other words, with use of the protruding pivoting feature (1388) of the distribution module (986), the system may be able to avoid usage and/or integration of a separate motor for actuated pan, as in the embodiment of FIGS. 27A-27F.

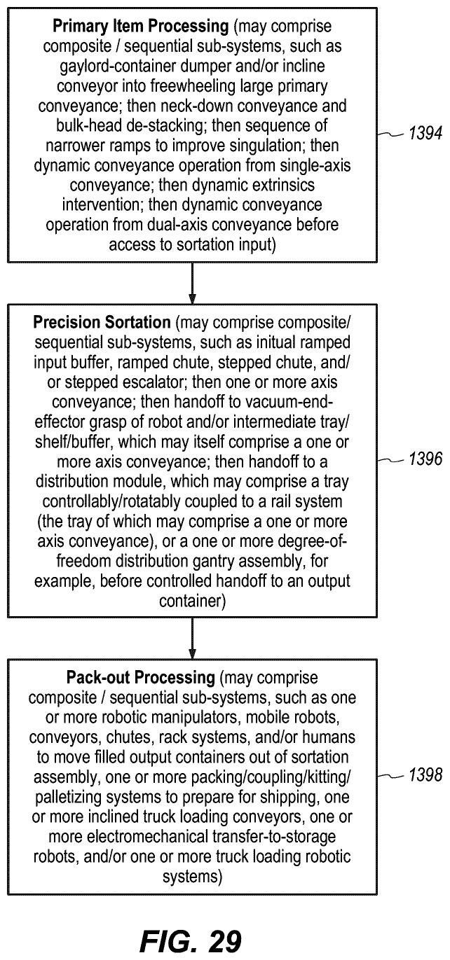

Referring back to FIGS. 25A and 25B and others, FIG. 29 again emphasizes sensor fusion, system integration, and efficiency in all stages of a package handling paradigm. Referring to FIG. 29, Primary item processing (1394) may comprise composite/sequential sub-systems and or aspects of input assembly, such as gaylord-container dumper and/or incline conveyor into freewheeling large primary conveyance; then neck-down conveyance and bulk-head de-stacking; then sequence of narrower ramps to improve singulation; then dynamic conveyance operation from single-axis conveyance; then dynamic extrinsics intervention; then dynamic conveyance operation from dual-axis conveyance before access to sortation input; all preferably including advanced levels of integration and cooperation. Precision sortation (1396) may comprise composite/sequential sub-systems, such as an initial ramped input buffer, ramped chute, stepped chute, and/or stepped escalator; then one or more axis conveyance; then handoff to vacuum-end-effector grasp of robot and/or intermediate tray/shelf/buffer, which may itself comprise a one or more axis conveyance; then handoff to a distribution module, which may comprise a tray controllably/rotatably coupled to a rail system (the tray of which may comprise a one or more axis conveyance), or a one or more degree-of-freedom distribution gantry assembly, for example, before controlled handoff to an output container; all preferably including advanced levels of integration and cooperation. Pack-out processing (1398) may comprise composite/sequential sub-systems, such as one or more robotic manipulators, mobile robots, conveyors, chutes, rack systems, and/or humans to move filled output containers out of sortation assembly, one or more packing/coupling/kitting/palletizing systems to prepare for shipping, one or more inclined truck loading conveyors, one or more electromechanical transfer-to-storage robots, and/or one or more truck loading robotic systems; all preferably including advanced levels of integration and cooperation.

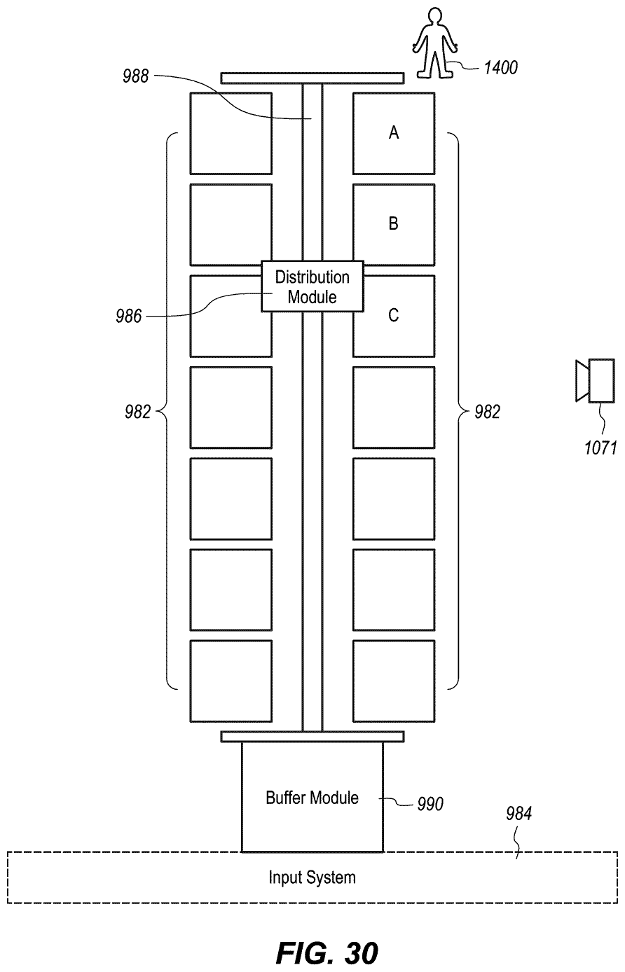

Referring to FIG. 30, of course human resources may be integrated into various aspects of the subject process and system configurations at many stages, and the systems preferably are configured to dynamically respond. For example, as shown in FIG. 30, a person (1400) located as shown may have limited feasible safe access to access output container “C”, or output containers “C”, “B”, and “A”, and as a result, may start by relocating container A; then container B, then container C (for example, in a simplistic scenario, all of the output containers 982 may be positioned together on a warehouse floor). The configuration may be observed and/or controlled with assistance of one or more operatively coupled image capture devices (1071). Indeed, the system preferably is configured using vision-based analysis, for example, to detect the person (1400) and the motion, repositioning, and reorientation of containers A, B, and C, and to continue processing otherwise as pertains the remainder of the output containers (982) shown, and/or to interrupt asking for a management response to confirm that activity should be continued during the activity of the person (1400) as pertains containers A, B, and C.

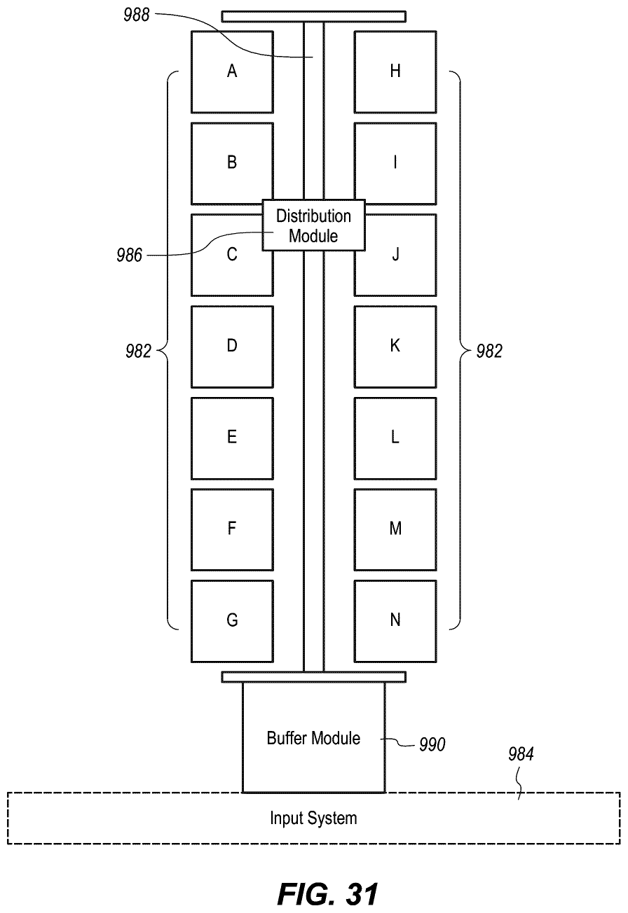

Referring to FIG. 31, and also back to the descriptions above related to FIGS. 4A-5B, and also FIGS. 6-12H, the system may be configured to cycle in and out various individual output containers, as well as groups thereof. In relatively straightforward scenarios, one or a group of output containers may receive one or more packages each, and then be exited toward pack-out in sequence (i.e., either individually, or as groups, as described above). In other scenarios, it may be desirable to coordinate the filling of various output bins in accordance with a variety of factors, such as breakability, ultimate endpoint destination, loading scenario within the truck (i.e., how many bins, totes, or other output containers high will the stacks in the trucks be at during truck transport), and/or unloading technique within the delivery truck at the ultimate endpoint destination (for example, in one scenario, the driver may be instructed to go sequentially through each bin on board the truck; after one bin is empty, then go to the adjacent bin; alternatively, the driver may be instructed to go sequentially layer by layer through the bins, so that he pulls the top item from the first bin; then the top item from the second bin; then the top item from the third bin, etcetera; then cycles back to get the second item from the first bin, second item from second bin, and so on; there are many such configurations wherein customization may be planned for at the sortation level). Thus referring to FIG. 31, the system preferably is configured to deposit items or packages into the various output containers (“A” through “N”) in accordance with the downstream plan. Such execution as the sortation/distribution module level may be best accomplished by moving various output containers in and out of immediate access to the distribution module during sortation using techniques such as those described above in reference to FIGS. 4A-5B, and also FIGS. 6-12H. In other words, it may be most efficient to sort in “batches” or “batch mode”, such that the distribution module (986) is commanded to distribute certain items to certain output containers (982), interrupted (preferably minimally or not at all with preferred coordinated motion planning) by switching in and out of certain output containers or groups thereof, for further sorting/batching, until certain output containers are ready for transfer out to pack-out as complete. System variations such as that depicted in FIG. 31 may be configured to sort packages or items within the targeted output containers (982) using a multi-pass sorting algorithm such as what is known as a “hash sort” configuration. In such configuration, output containers (982) may be assigned items by the order of the item in the sequence (e.g., all items that are to be first on the downstream delivery route go to bin A, all items that are to be second on the downstream delivery route go to bin B, etc.). Then after this subprocess, each full output container (982) may be moved away from the distribution module (986) and the items/packages therein unloaded, or “re-inducted”, into the primary sorters on the input side (984) in reverse order (e.g., the tote, bin, or other output container 982 assigned to the last items may inducted first in order, and so on). The items from the re-inducted output containers may then be re-sorted into delivery bins that are prepared for routing to final destinations (such as via delivery van or truck). This way the first item along the delivery route is on top of the container and the last item to deliver is at the bottom of the container. Such configurations may have optimized efficiency through the use of various above described techniques and configurations, all integrated using the most updated information pertaining to the various items/packages coming through the various subsystems. For example, at stages, positions, or orientations where image capture devices, scanners, LIDAR devices, and the like are present, the system may be configured to continually refine, preserve, and improve determinations regarding each subject package, its status, condition, etc. through the use of low-latency computerized neural networks trained (such as in supervised learning and/or unsupervised learning configurations) based upon real and/or simulated scenario data so that they are optimally responsive to a broad panoply of scenarios (i.e., we are able to greatly enhance the number of applied training cycles using simulated image and scenario information as compared with conventional labeled real data in a supervised learning configuration), and so that they are constantly improving, such as via reward-based reinforcement learning configurations, in view of the various packages, lighting, sensors, and system components present operationally. In various embodiments, with requisite knowledge of state information pertaining to key variables such as geometric ranges, distances, and sizes of certain known structures (such as general package sizes, parameters of the operational electromechanical systems and components such as conveyance features, robot arm dimensions and reach, etc.), reinforcement learning may be conducted not only in runtime to improve results in accordance to a designated reward paradigm, but may also be conducted in simulation, to utilize computing resources to generally enhance cycling of the reinforcement/reward paradigm for continually improved operational utility. As described above, the systems and subsystems may be configured to constantly observe, prune away problem packages or quality control issues, dynamically address problems and optimize processing, improve and optimize grasping, such as via the use of vacuum-based end effectors which may be configured to not only plan and execute grasps on substantially planar surfaces such as a box side, but also against irregular surfaces such as bags, mailers, and the like, such as via pulling one or more portions of a flexible surface such as that of a bag into an inner chamber of a vacuum end effector while also preventing over-protrusion with a permeable distal wall member configuration between the targeted package and inner chamber. We have also described and integrated various aspects of extrinsic dexterity configurations, wherein the system may be configured to utilize loading and contact pertaining to objects available during package handling which may assist in high-speed repositioning, reorientation, and the like, dynamic to what is observed with the various sensors and sensor fusion results, which may be utilized to not only observe positioning and orientation of packages, but also to fit volumes and 3-D prisms around targeted packages to dimension them, determine or estimate whether breakage or deformation has occurred, and estimate material properties, as described above. At a higher level, groups and/or networks of systems may be centrally controlled and operated with inputs from important sources such as weather analysis systems, trucking logistics systems, road quality systems, air traffic control systems, hurricane or other emergency warning systems, and the like—all of which can have dramatic impacts upon shipping and package handling demands and operation.

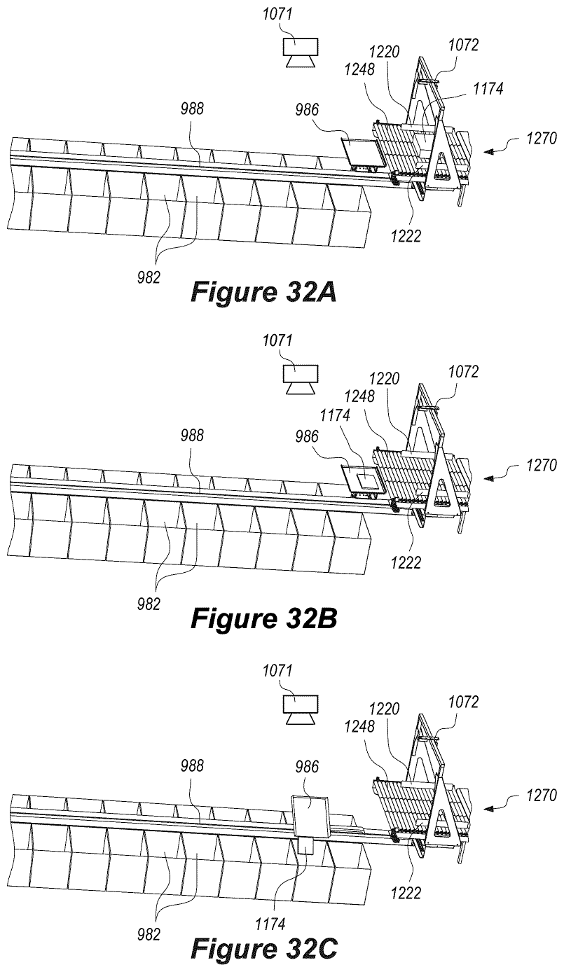

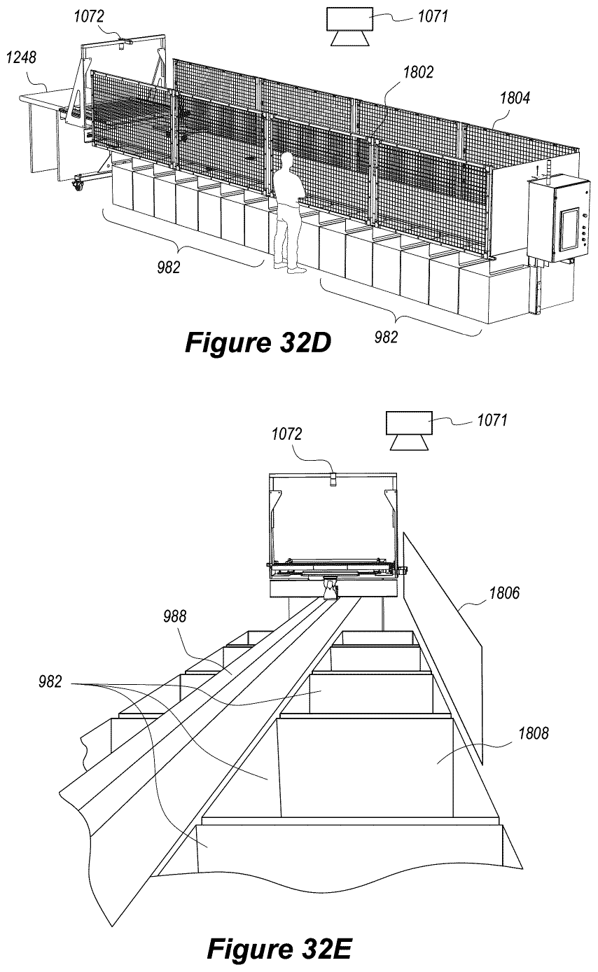

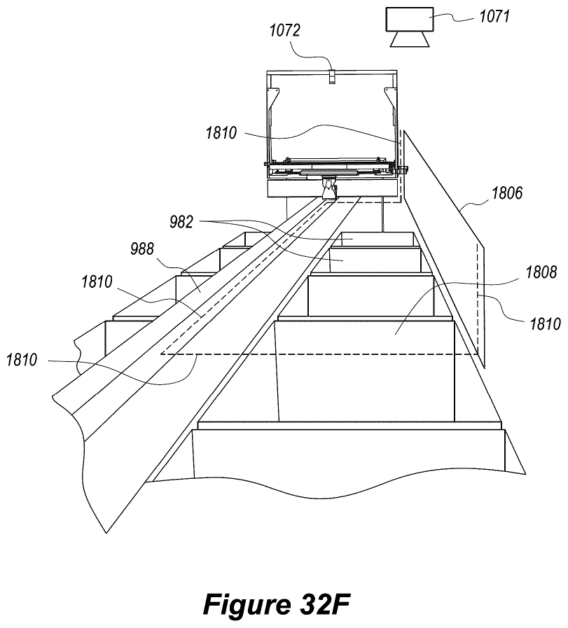

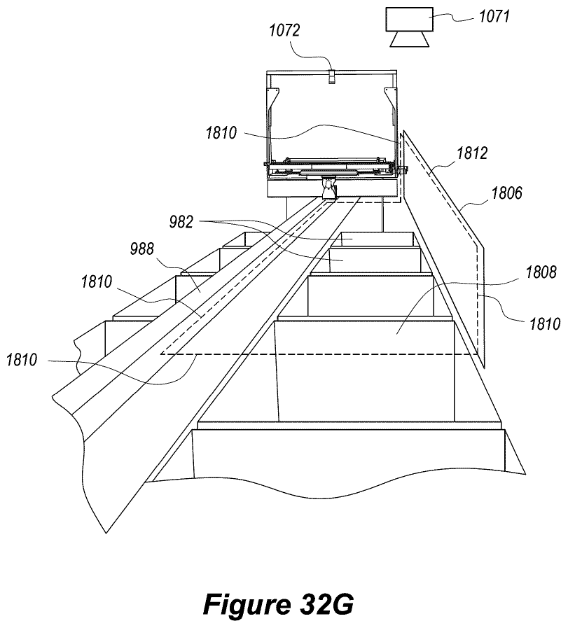

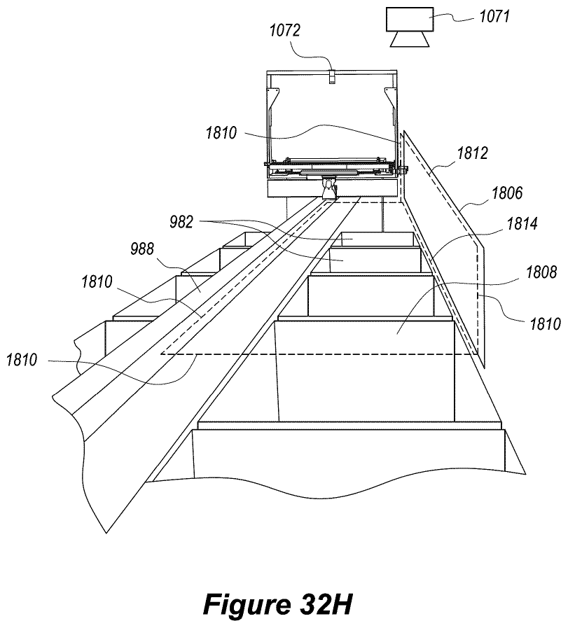

Referring to FIGS. 32A-32C, embodiments of sortation units (1270) similar to those discussed above in relation to FIGS. 19A, 26A, and 27A, for example, are illustrated. Referring to FIG. 32A, a package (1174) enters an input assembly or staging conveyance module (1248) wherein a pair of opposing controllably movable members (1220, 1222) may be utilized under image capture based control to move and orient the subject package (1174) for delivery onto the distribution module (986), after which, as shown in FIGS. 32B and 32C, the package (1174) and distribution module (986) may be controllably advanced toward a targeted output container (982) and deposited therein with controlled motion of the distribution module (986; such as via tilting and/or accelerations as noted above). The configurations may be observed and/or controlled with assistance of one or more operatively coupled image capture devices (1071, 1072).

Referring to FIG. 32D, a sortation unit configuration is illustrated which includes fixedly or removably coupled mechanical fence (1802, 1804) assemblies on either side of the unit to mechanically isolate nearby humans from moving parts therein, while still allowing these humans direct access to the output containers (982). As with other embodiments, such configuration may be observed and/or controlled with assistance of one or more operatively coupled image capture devices (1071, 1072).

Referring to FIG. 32E, another configuration for at least transiently or temporarily isolating human operators from moving parts such as the rail (988) subsystem during operation is shown featuring a so-called “electronic curtain” or “electronic fence” which may be configured to detect intrusion of one or more functional planes or other surfaces (1806, 1808) that are functionally formed by intrusion sensors such as radiation (such as visible light or other wavelength emitted from a radiation emittor) pathways with path completion sensors (i.e., may be configured to be integrated with central computing and configured to cause a flag to interrupt operation, for example, if so configured, when intrusion is detected by path interruption). In other words, these functional surfaces (1806, 1808) are not physical windows or barriers, but rather are surfaces operatively coupled to sensors configured to detect intrusion there-across. For example, if a nearby user places his hand across one of the depicted functional surfaces (1806, 1808), the system may be configured to immediately detect such intrusion, and to execute one or more commands, such as a command for the sortation assembly to immediately stop, slow down in function or joint velocity/velocities, and/or not exceed a certain predetermined applied load paradigm, for example. The boundaries of the electronic curtain or functional surfaces (1806, 1808) may be substantially invisible, or may be configured to provide nearby personnel that the electronic curtain has been activated. For example, referring to FIG. 32F, a linear electronic curtain position and/or status indicator (1810), such as a linear light emitting diode (“LED”) array, may indicate position and/or status of the electronic curtain (for example, on or flashing LEDs may be configured to indicate that the electronic curtain is active). FIGS. 32G and 32H illustrate configurations similar to that of FIG. 32F, but with additional curtain position and/or status indicator elements (1812, 1814) which may be useful in assisting nearby users in identifying the position and/or status of the electronic curtain system.

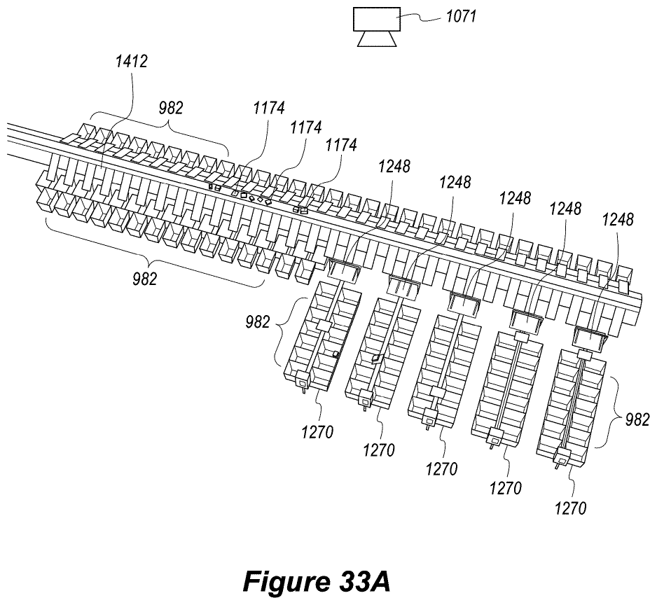

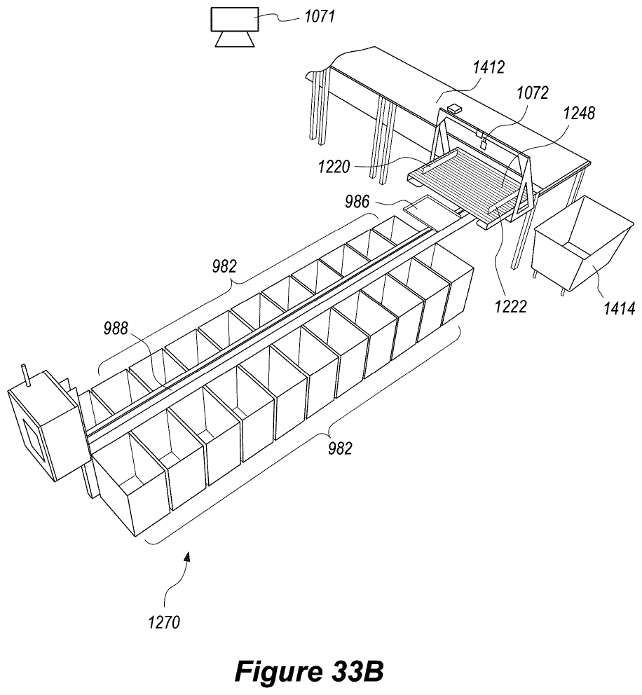

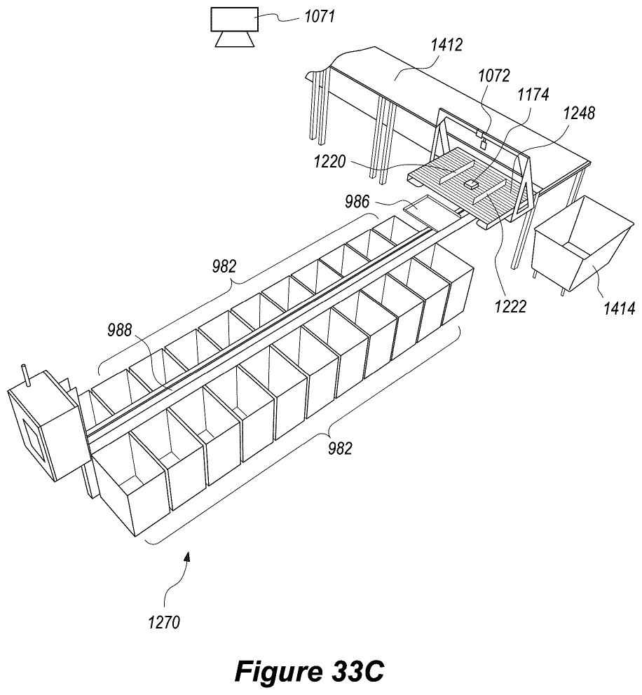

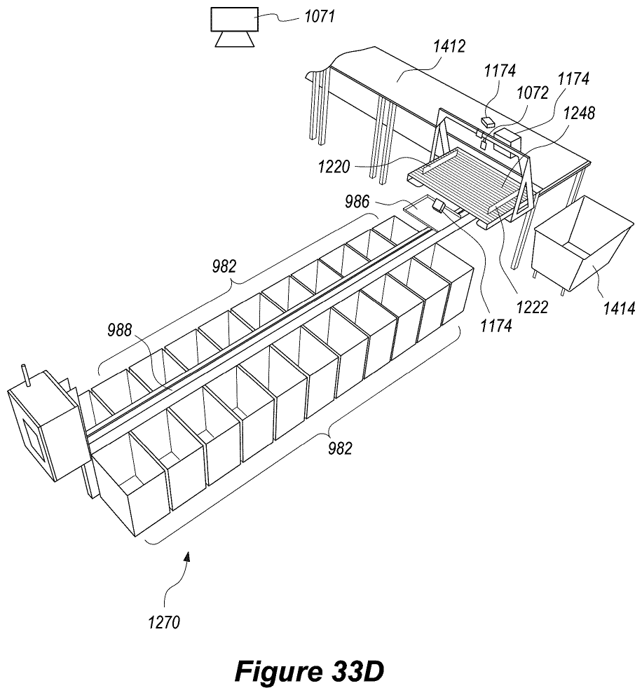

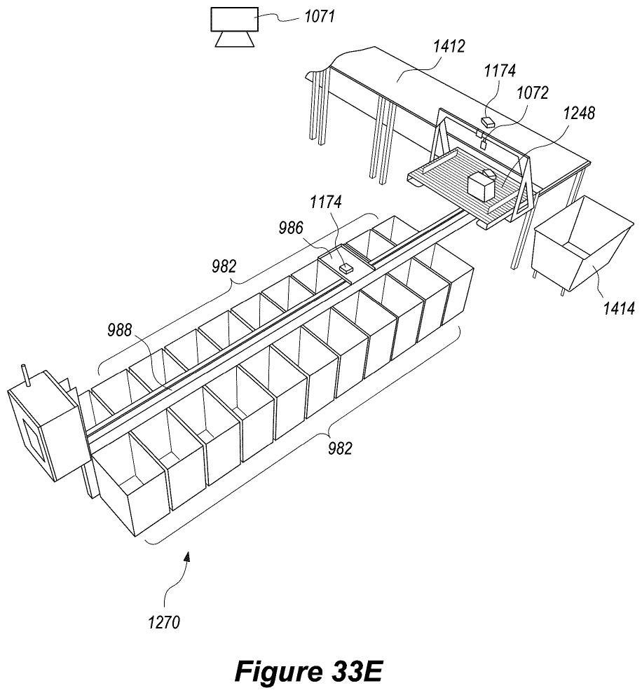

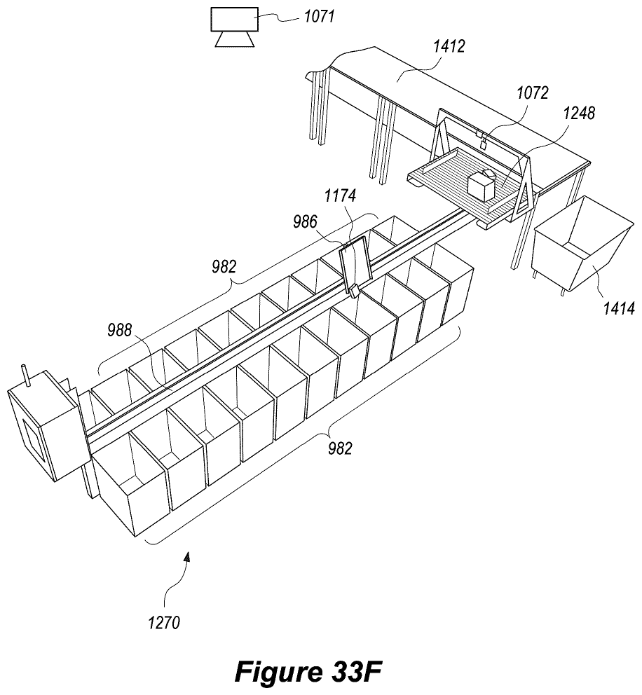

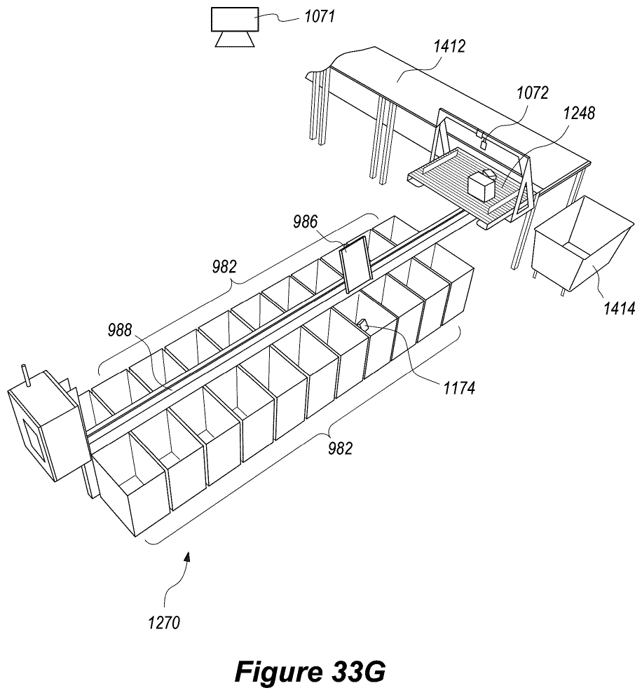

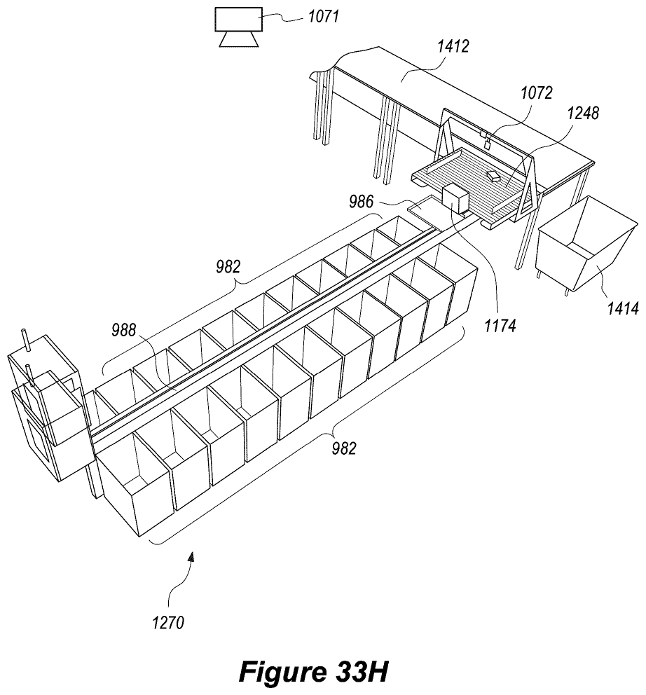

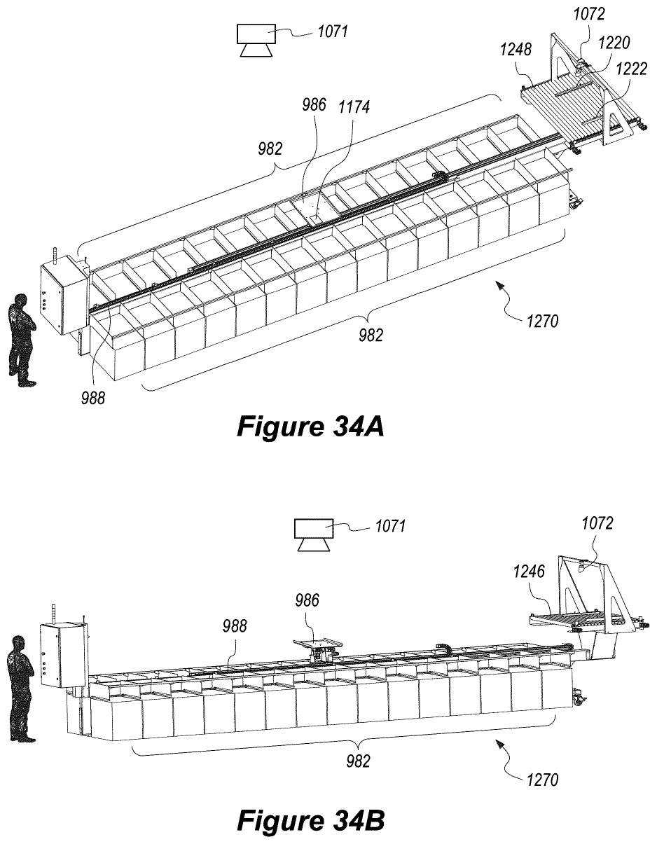

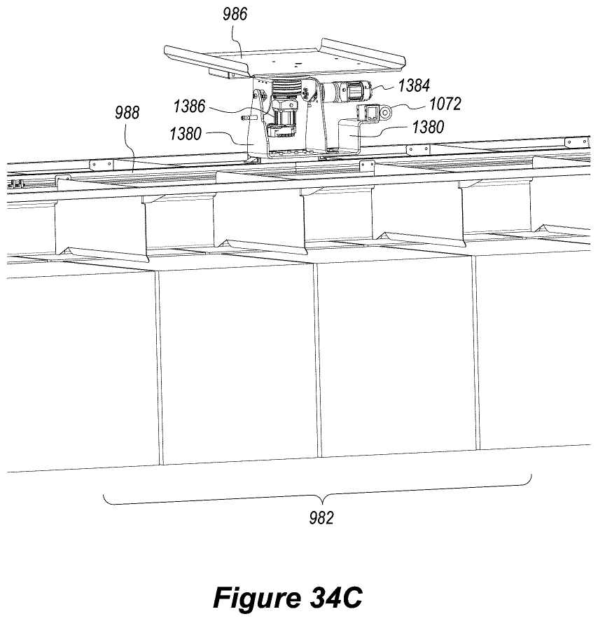

Referring to FIGS. 33A-33H and 34A-34C, similar sortation units (1270) may be utilized in various configurations to scale and adapt for various processing needs. These configuration may be observed and/or controlled with assistance of one or more operatively coupled image capture devices (1071, 1072; assemblies and/or integrations of image capture devices or imaging devices more generally may be term an image capture assembly or imaging assembly). For example, referring to FIG. 33A, a relatively large input conveyance (1412) may be utilized to rapidly feed not only a plurality of immediately adjacent output containers or output structures (982; the term output container and output structure are used synonymously herein) through multi-axis conveyance, ramps, pushers, and the like, but also to feed sortation units (1270) as shown, which may be utilized to sort to additional output container (982). FIGS. 33B-33H illustrate closer views of a particular sortation unit (1270) from a larger assembly such as that illustrated in FIG. 33A, wherein packages enter from the main input conveyance (1412), are controllably directed onto the staging conveyance module (1248; such as via multi-axis conveyance operation, ramps, pushers, and the like), repositioned and/or reoriented using the pair of opposing controllably movable members (1220, 1222), advanced onto the distribution module (986), controllably moved down the rail (988), and deposited into a selected output container (982). Packages at the end of the main conveyance (1412) that have not been already routed to a sortation unit (1270) may be controllably advanced into a so-called “jackpot” bin (1414), or a recirculation conveyance, chute, or other transport configuration, for cycling back into sortation. Each time a package (1174) is cleared from the staging conveyance module (1248) after repositioning and/or reorientation using controlled movement of the movable members (1220, 1222), these members (1220, 1222) may be returned to expanded-out positions, as shown, for example in FIGS. 33B and 33D, to receive the next sequential package from input.

FIGS. 34A-34C illustrate further orthogonal views of sortation unit variations (1270) wherein precision motion of a distribution module (986; again, may comprise a tray and/or small controllably actuatable conveyance, for example) may be utilized to controllably deposit a package (1174) into a desired output container (982) subject to observation by, for example, one or more image capture devices (1072). FIG. 34C illustrates roll (1386) and tilt (1384) actuation assemblies (may comprise, for example, motors, gearboxes, and encoders for closed-loop control of the distribution module 986 position/orientation along with controlled advancement provide by the electromechanical rail system 988).

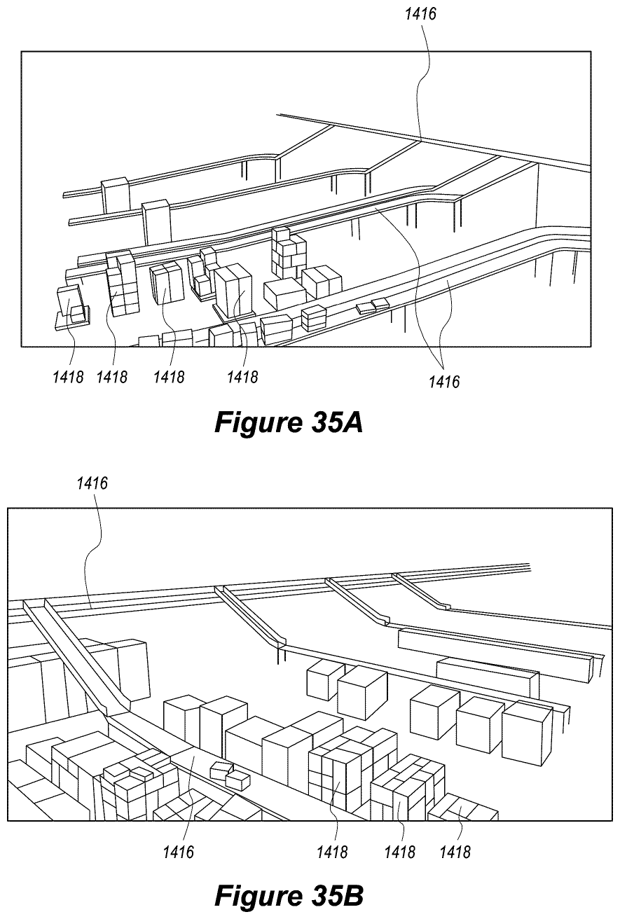

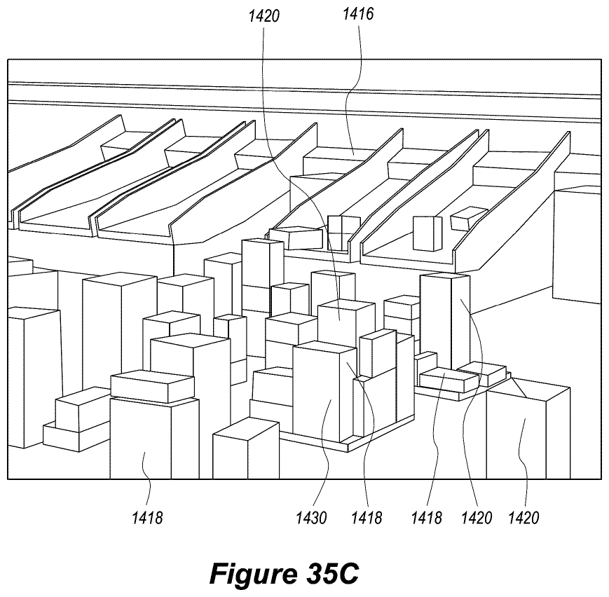

Referring to FIGS. 35A-35C, various logistics operation views are illustrated showing different types of conveyances (1416) ultimately leading to various partially and completely assembled pallet loads (1418) which may be loaded upon conventional wooden pallet frames (1424). Often these pallet loads (1418) are created manually and may have varying levels of instability, depending upon factors such as fit, mass, bulk modulus, loading precision, presence of retainer structure (such as a hoop-stress member or retainer member 1430, such as a manually or electromechanically applied cellophane wrap), height, presence of movable masses within other structures such as boxes, etc. Referring to FIG. 35C, to increase load height and add some stability for smaller packages, relatively large and tall so-called “chimney” boxes or structures (1420) may be utilized to retain an assembly of smaller packages.

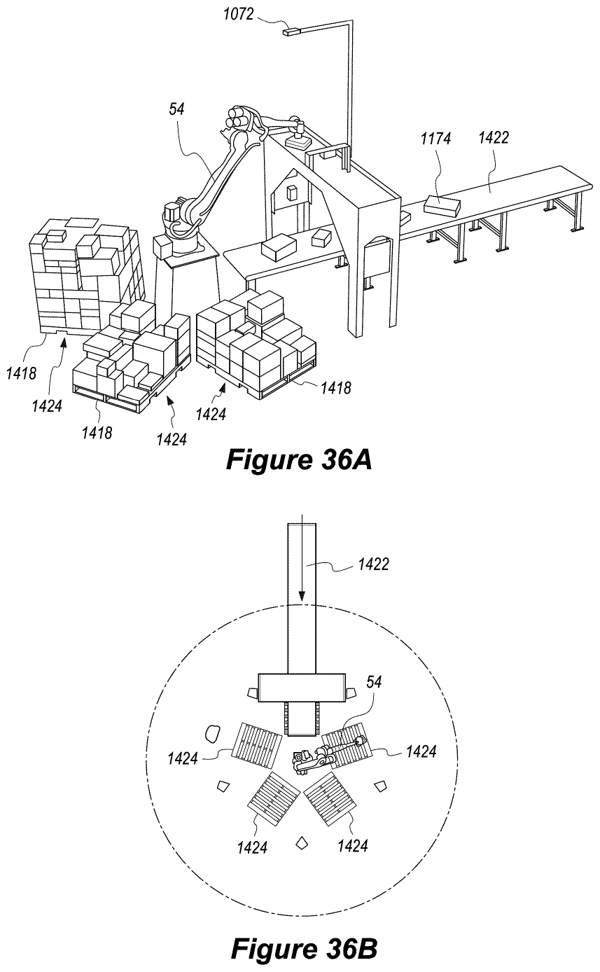

Referring to FIGS. 36A-36B, a controlled robotic arm (54) configuration such as those described above may be utilized to load packages (1174) upon pallet frames (1424) to create pallet loads (1418) with an enhanced degree of precision, since the robotic arm (54) may be configured, as described above, to operate with vision control enhancement to optimize positioning and orientation of each package. An input conveyance (1422) may be utilized to direct packages (1174) toward the robot and associated image capture device (1072) for sortation onto one of or plurality of pallet frames (1424) and/or pallet loads (1418) which may be assembled, for example, in a star-like pattern around the range of motion of the robotic arm (54) as shown.

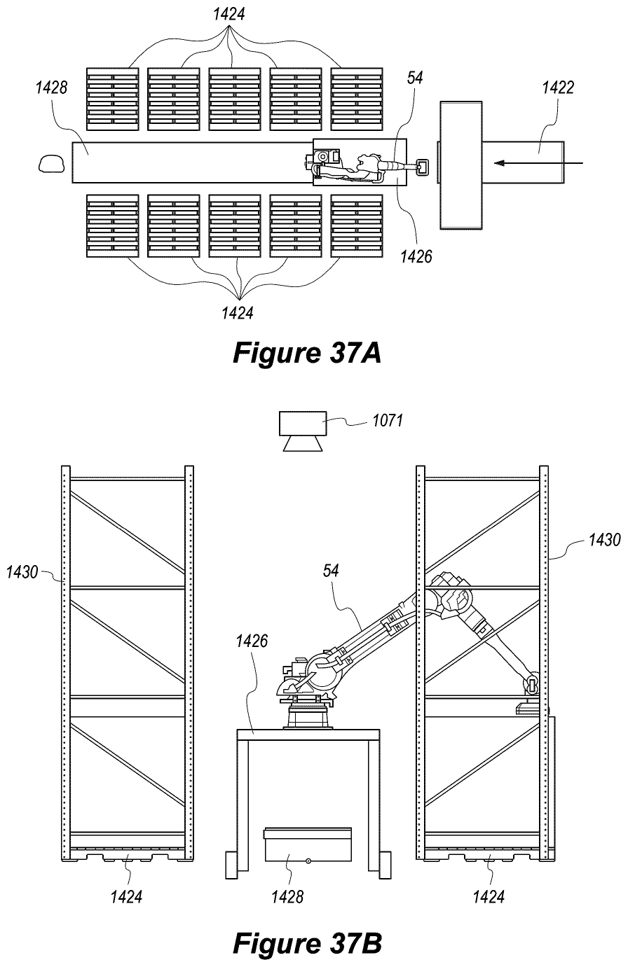

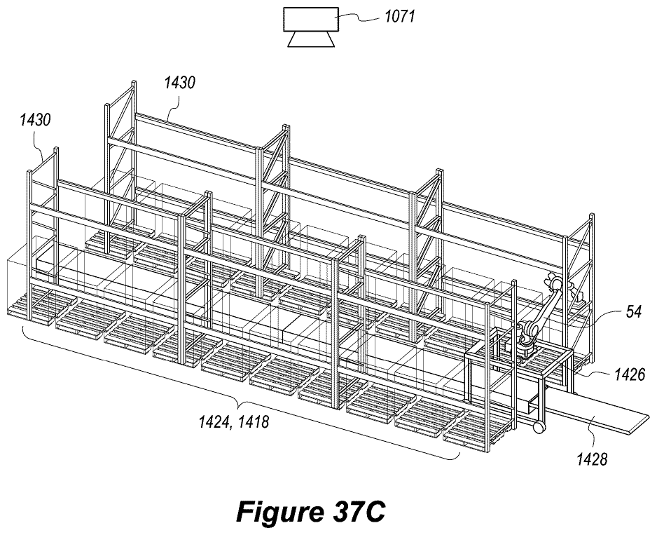

Referring to FIGS. 37A-37C, a controlled robotic arm (54) configuration such as those described above may be placed upon a movable cart (1426) system (which may be guided, for example, by an associated guide rail assembly 1428) and utilized to load packages (1174) upon pallet frames (1424) to create pallet loads (1418) which may be stabilized by a frame-like retaining assembly (1430) until loading has been completed of one or more given pallet loads such that they may be transported away. These configurations may be observed and/or controlled with assistance of one or more operatively coupled image capture devices (1071).

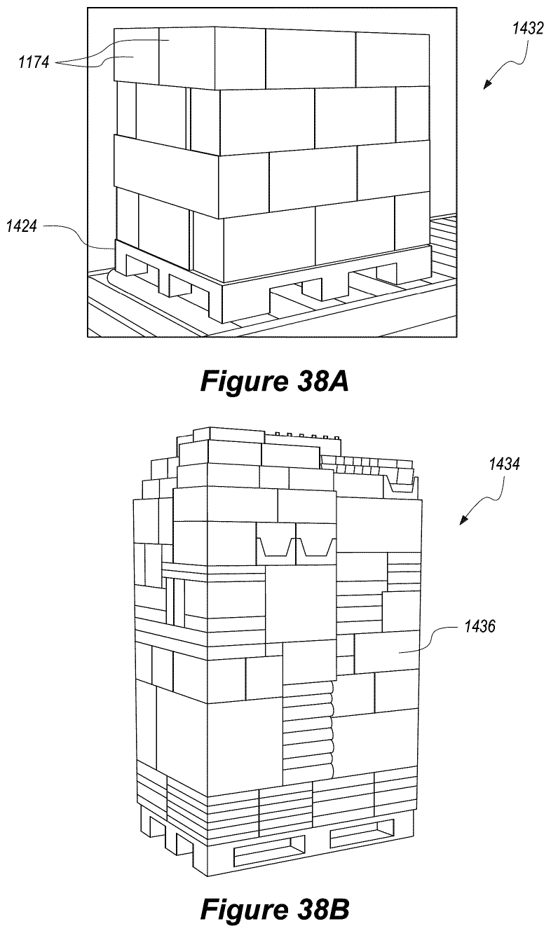

Referring to FIG. 38A, a pallet frame (1424) is illustrated with a relatively uniform load (1432) that has been assembled from relatively uniform packages (1174) as shown. Such an assembly may have relatively high stability due to the uniformity of the packages-but such uniformity often is not the norm, and many pallet loads look more like the irregular package load assembly (1434) in FIG. 38B, wherein a retainer such as a perimetrically applied cellophane wrap may be utilized to enhance stability of the load for transport, movement, and storage.

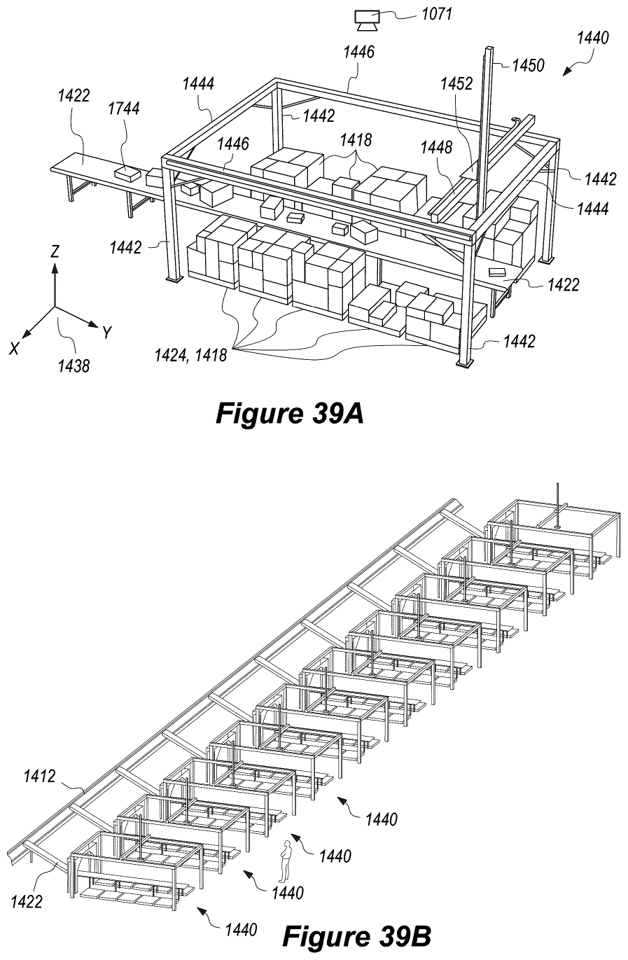

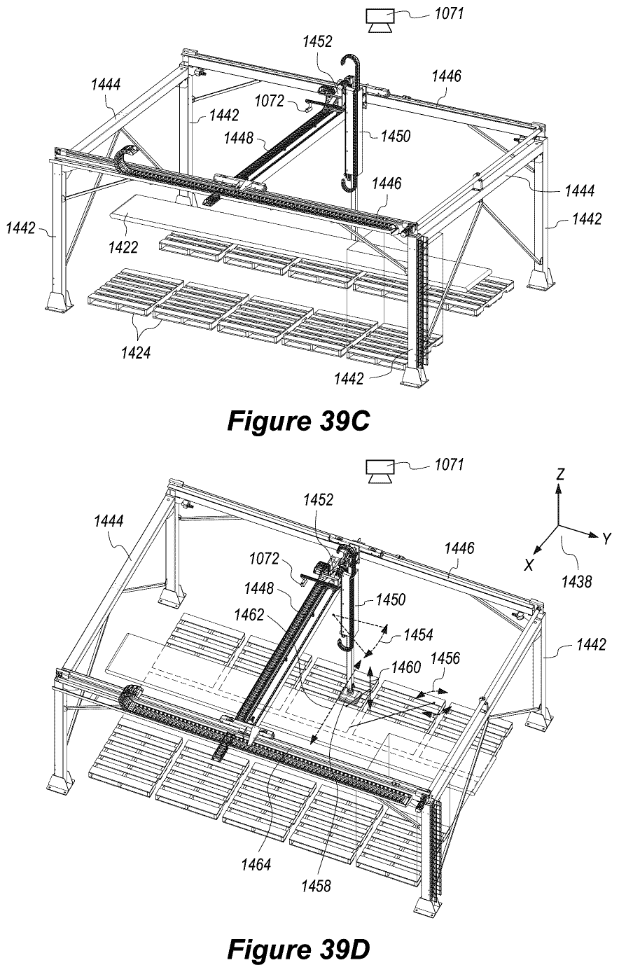

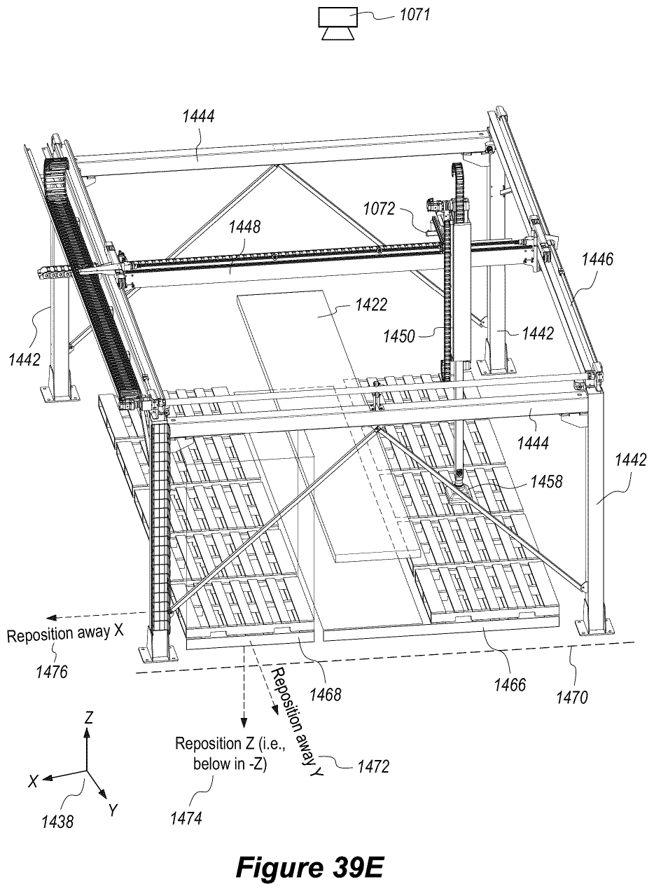

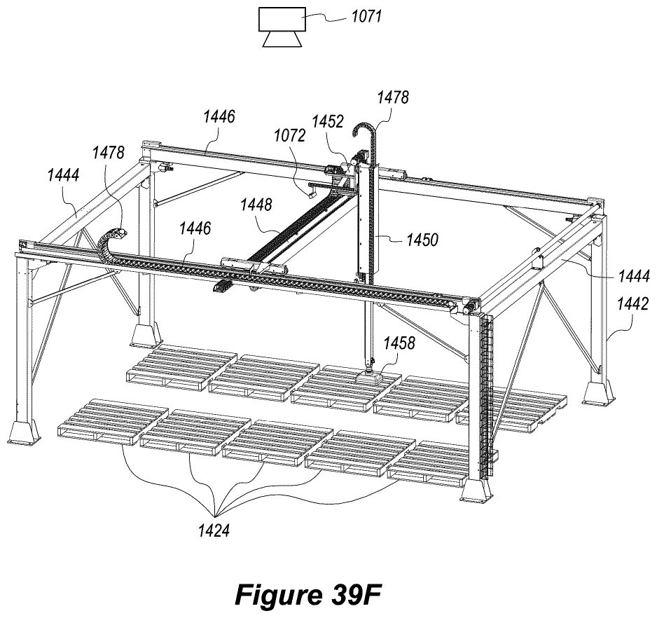

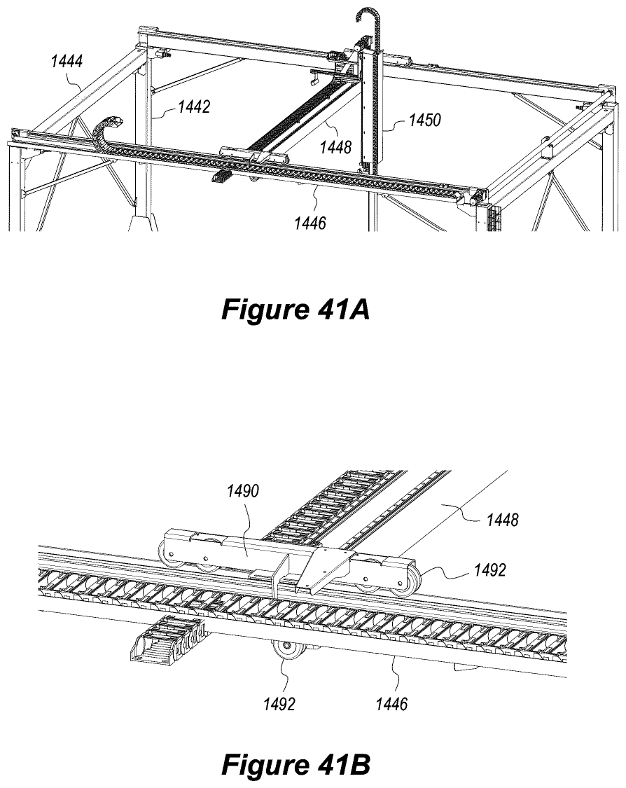

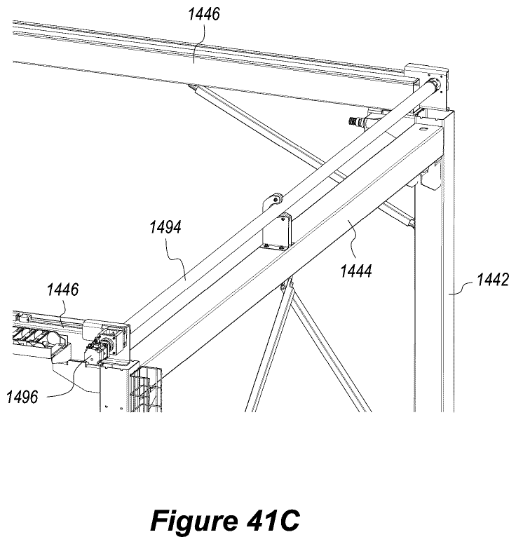

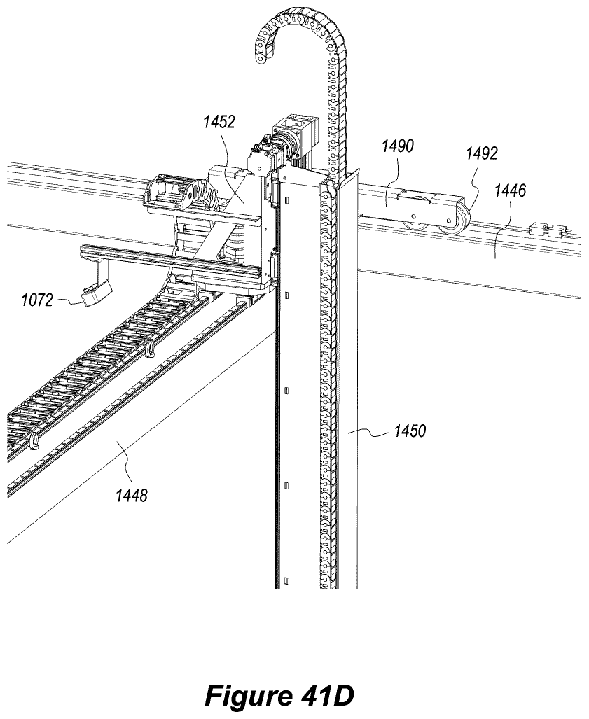

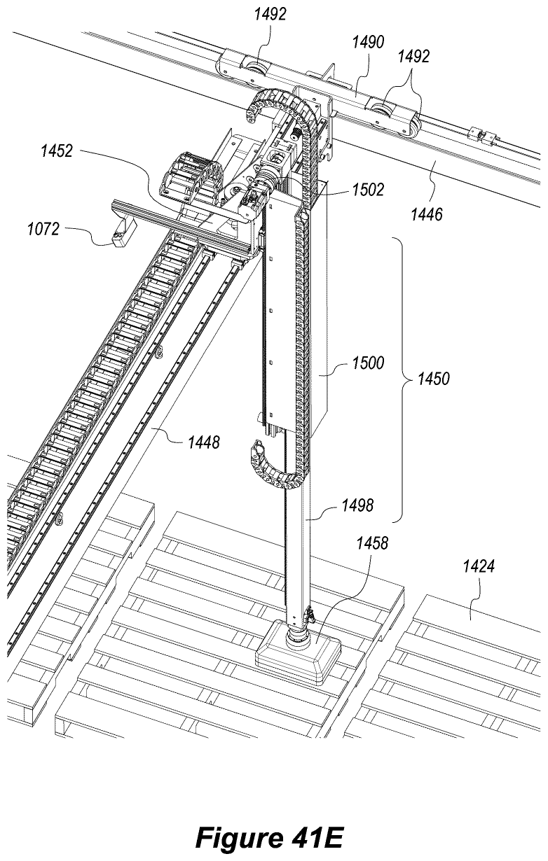

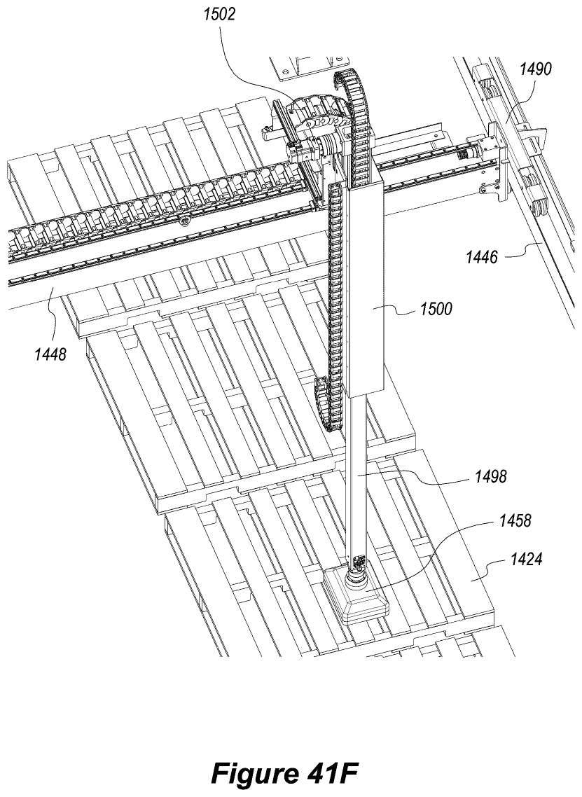

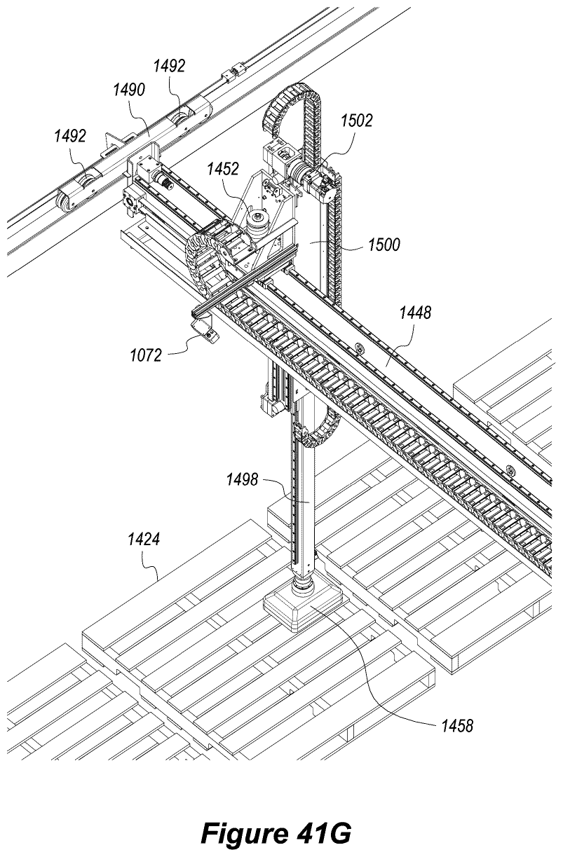

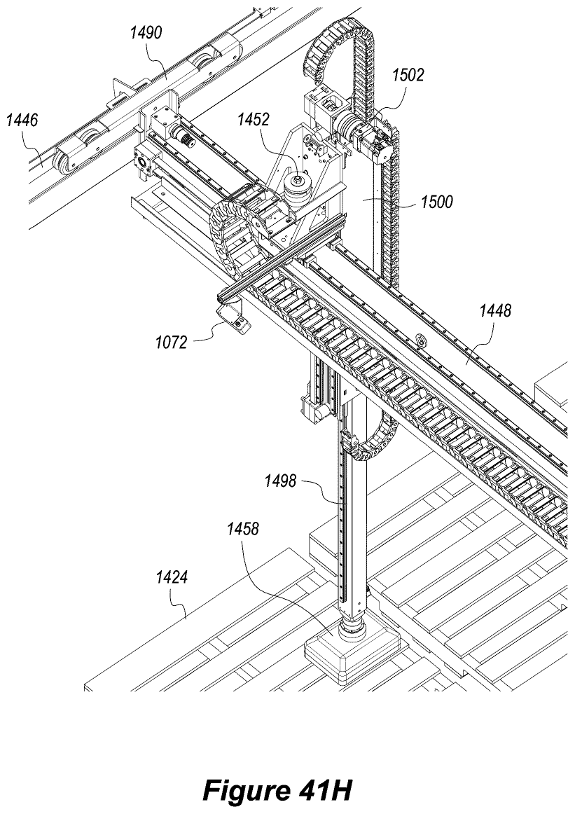

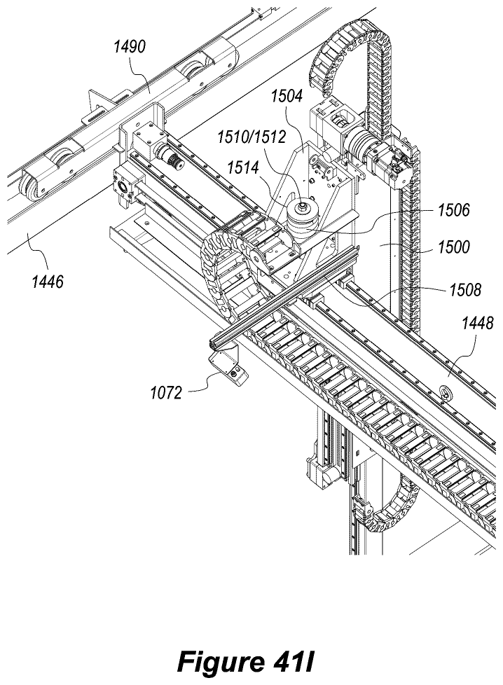

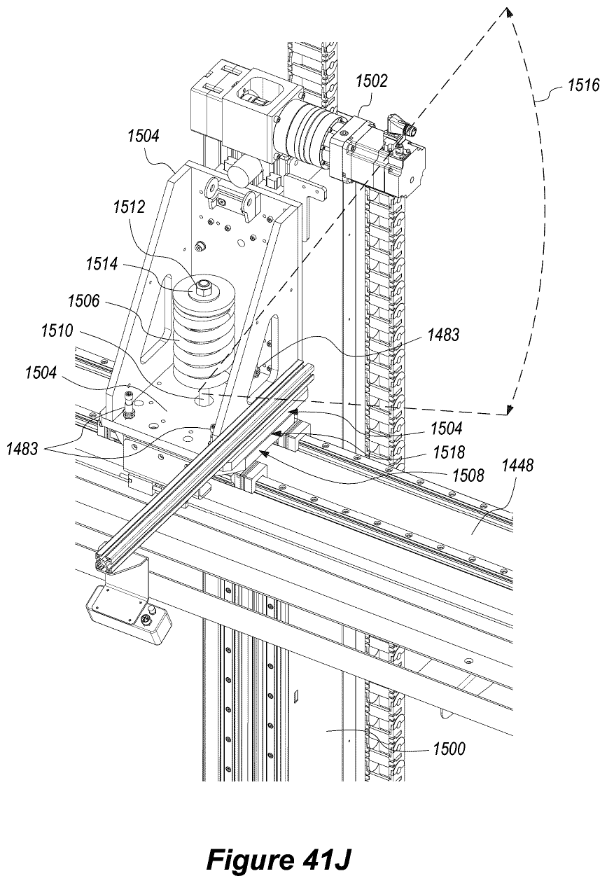

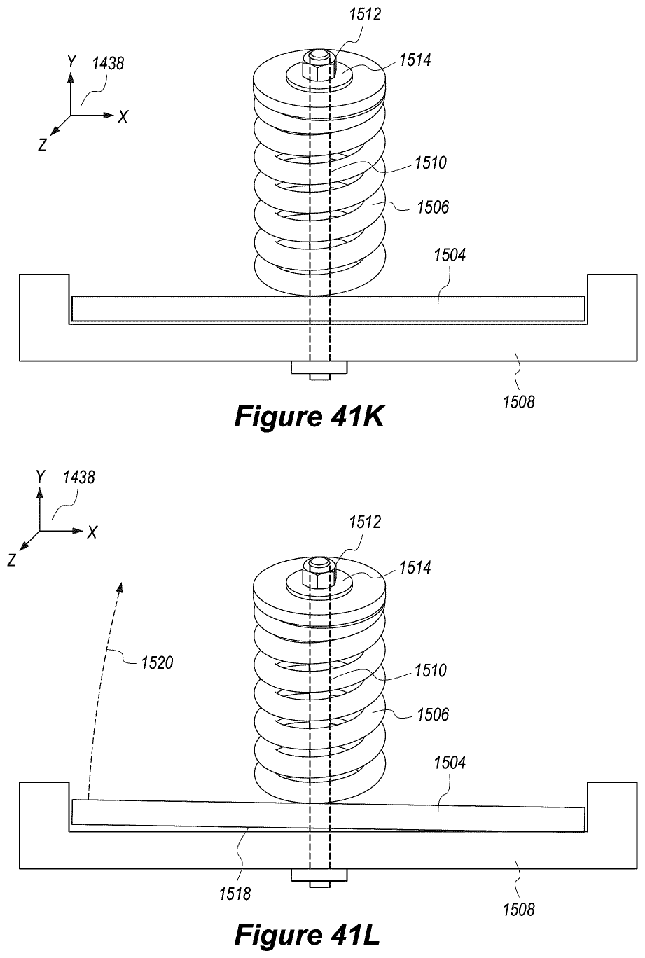

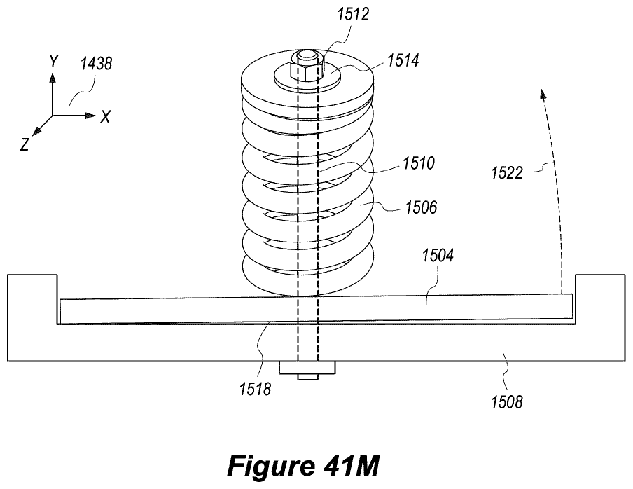

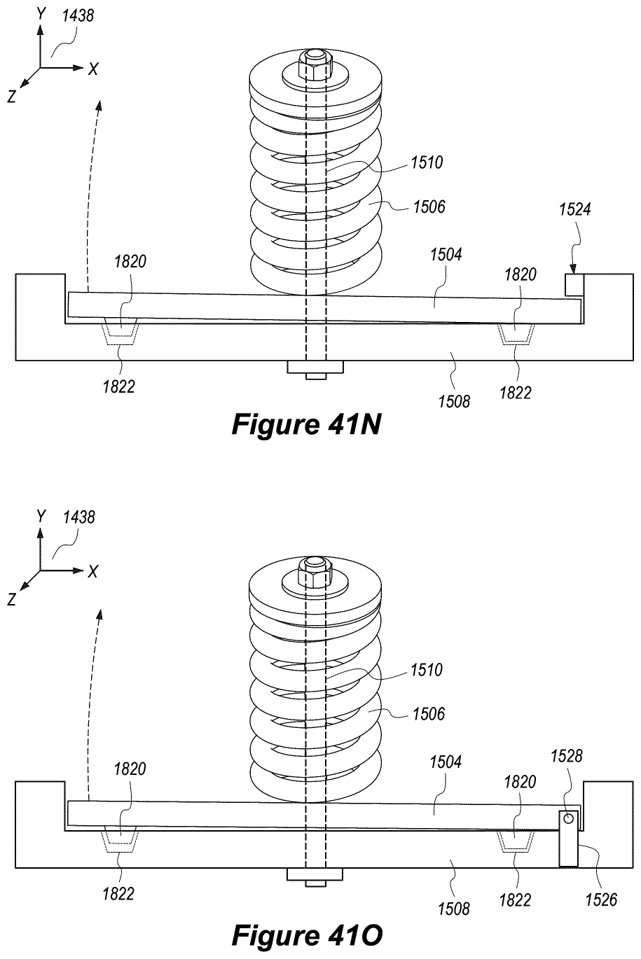

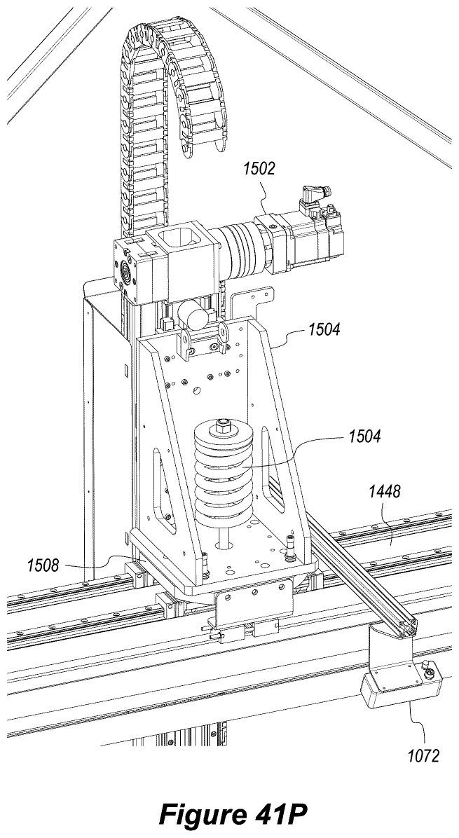

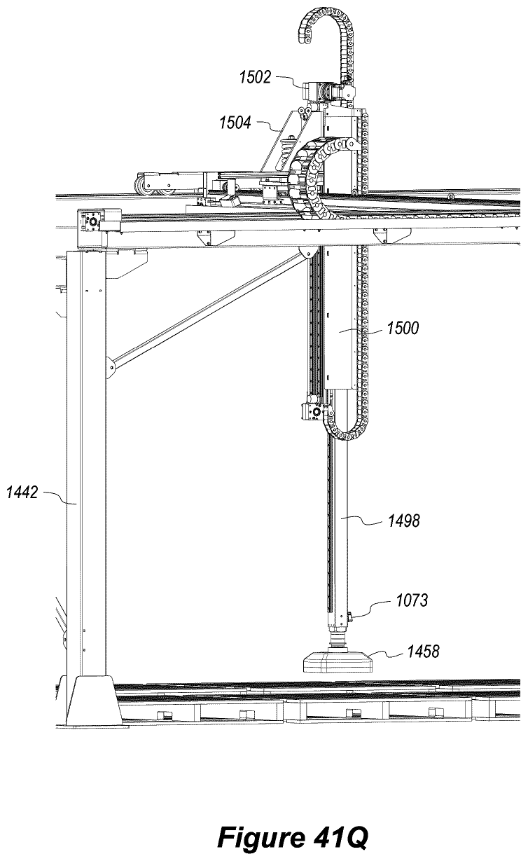

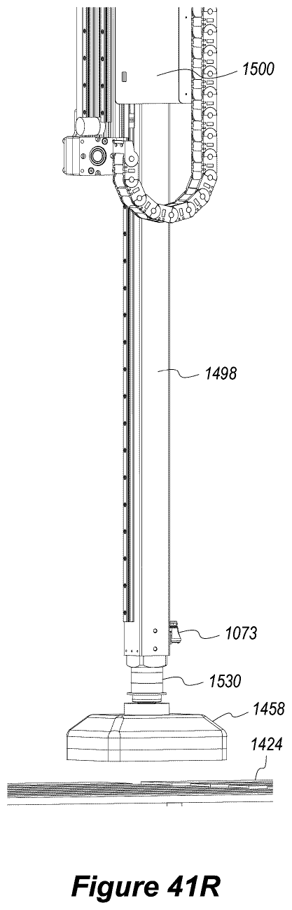

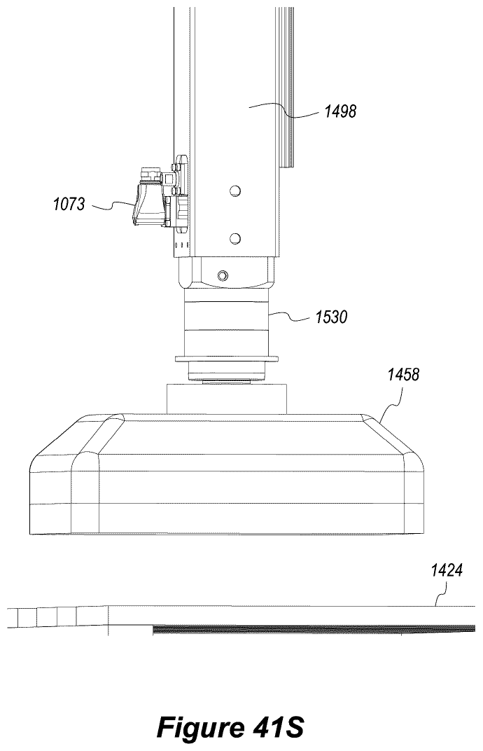

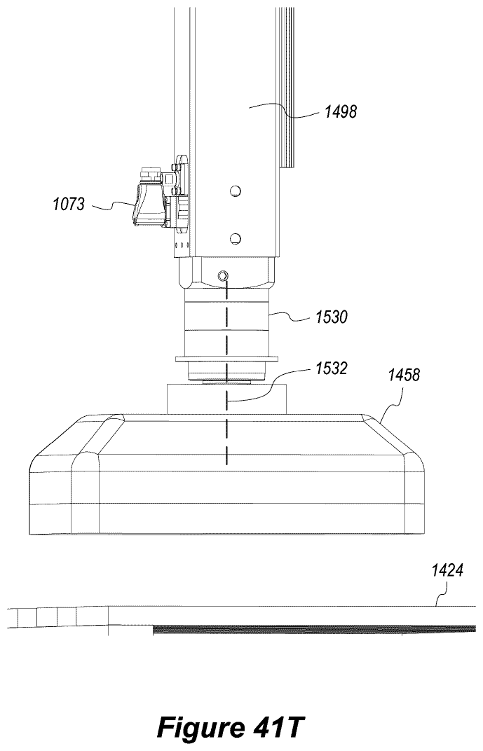

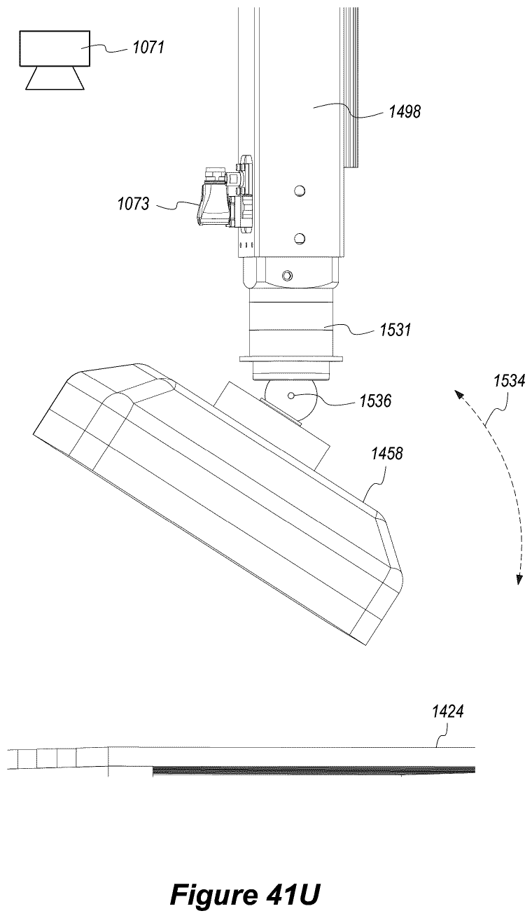

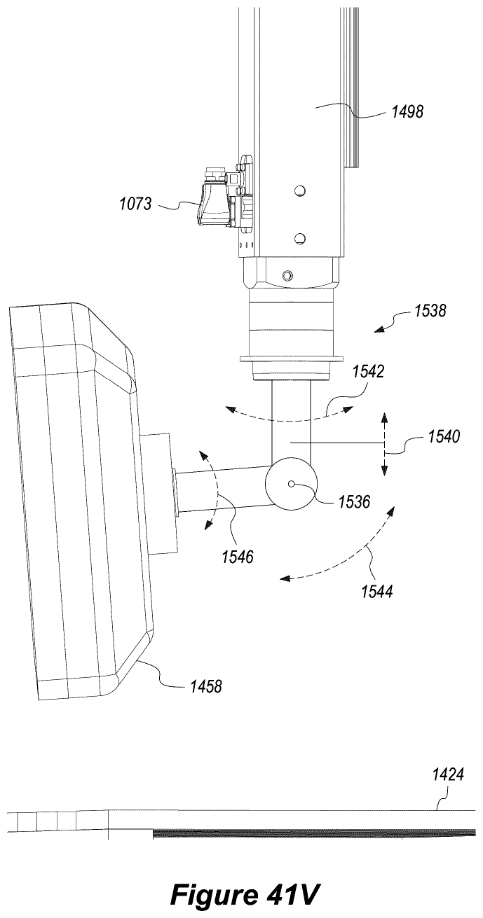

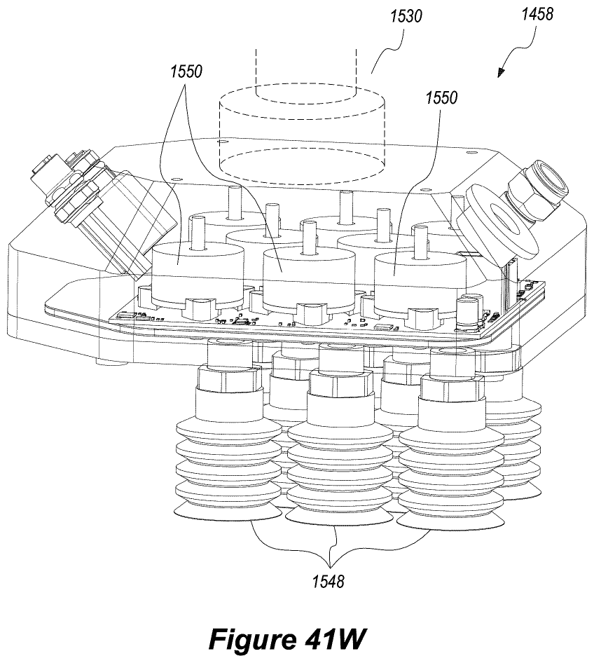

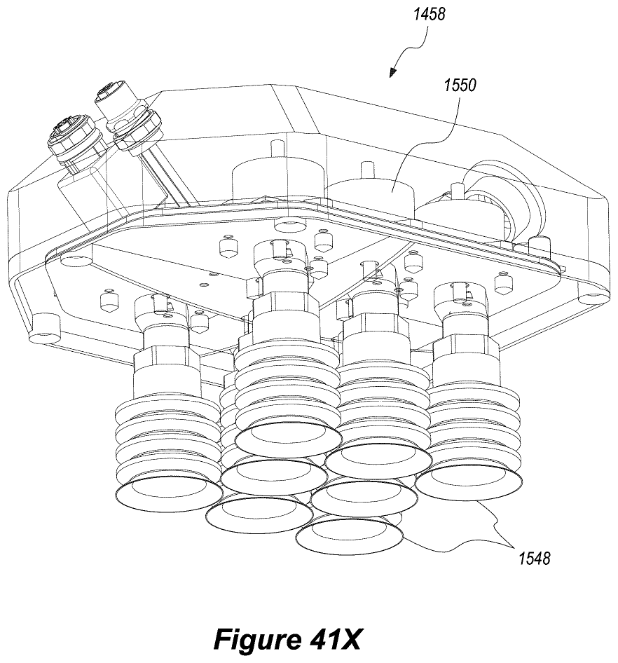

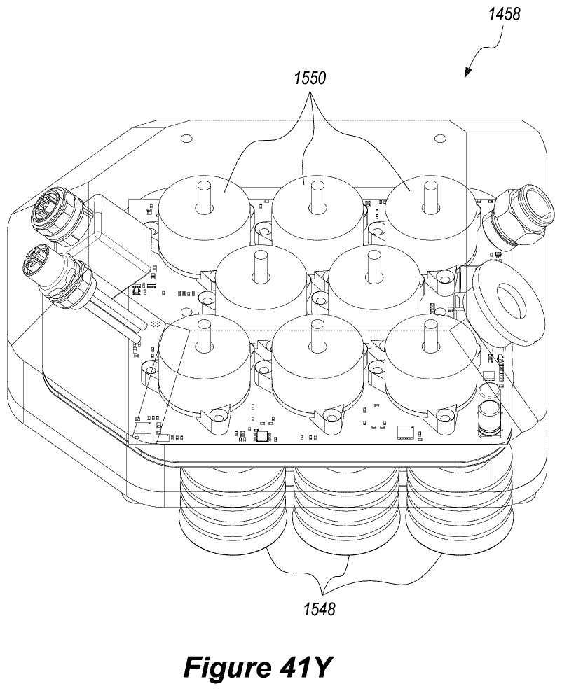

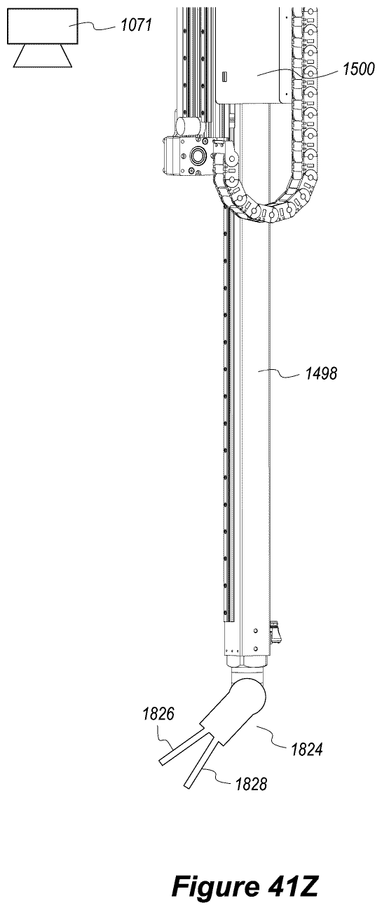

Referring to FIGS. 39A-43C, various aspects of pallet-related package processing configurations are illustrated. These configurations may be observed and/or controlled with assistance of one or more operatively coupled image capture devices (1071, 1072, 1073). Referring to FIG. 39A, a gantry sortation unit (1440) is illustrated comprising an assembly of four vertical support members (1442; also may be termed support column members 1442; may comprise high-strength materials such as steel), two end support members (1444; may comprise high-strength materials such as steel), two side support members (may comprise high-strength materials such as steel) fixedly coupled together (such as via bolts, welds, or other stable fasteners or fastening configuration). Movably coupled to the two side support members (1446) is a first horizontal member (1448), or mobile horizontal span member (1448; also may comprise high-strength materials such as steel) which itself is movably coupled to a mobile vertical grasping assembly (1450), or vertical structural assembly (1450; also may comprise high-strength materials such as steel). An input assembly or input conveyance (1422) is shown leading through the center of the gantry sortation unit (1440) with various packages (1744) being moved along toward and into the gantry sortation unit (1440). The frame assembly comprising the vertical support members (1442) and span members (1444, 1446) form a rectangular prismic working volume for the first horizontal member (1448) and intercoupled mobile vertical grasping assembly (1450) to operate, such that the distal grasping end effector (1458) is configured to reach not only the input assembly (1422) but also a plurality of output structures (1424, for example) which may be positioned about a perimeter within the frame assembly, while these output structures (1424, for example) remain accessible and movable away from the frame without further modification of the gantry sortation unit (1440). Referring to the sample global coordinate system shown (1438) for the room, as packages (1744) are moved along the +Y direction into the gantry sortation unit (1440), they may be observed and/or identified by various image capture devices and/or other sensor configuration (such as one or more LIDAR sensors) operatively couple to computing resources and configured to capture information pertaining to the conveyance (1422) and packages (1744). The mobile horizontal span member (1448) may be automatically, under vision-based control, be navigated in the +Y or −Y direction relative to the two side support members (1446) using an intercoupled drive assembly (such as 1496 in FIG. 41C; may comprise, for example, a motor, gearbox, and encoder for closed loop control as operatively coupled with computing resources; these may be operatively coupled across the span of the horizontal span member 1448 using a drive axle 1494 so that timing or drive belts on each side may advance the horizontal span member 1448 in equivalent manners in the +Y or −Y direction relative to the two side support members 1446). Referring, for example, to FIG. 39D, at the bottom of the mobile vertical assembly, a distal grasping end effector (1458), or distal coupling assembly (1458), is coupled thereto and configured to controllably grasp various packages under closed loop and visio-based control using a vacuum-based grasping interface as discussed below. The distal coupling assembly (1458) may be configured to controllably move up and down, such as in +Z and −Z directions relative to the conveyance (1462) (i.e., vertically-or away/toward the plane of the floor supporting the gantry assembly), packages (1174), and various pallets (1424)—such that the vacuum-based grasping under vision control may be utilized to pick up/grasp packages from one position and orientation (such as on the conveyance 1462), after which the combination of controlled movements from the mobile horizontal span (1448; i.e., for +Y or −Y movement), mobile vertical assembly (1450; i.e., for +Z or −Z movement), and +X or −X movement automatically commanded by the movable coupling of the mobile vertical assembly (1450) to the mobile horizontal span (1448) with another drive assembly (such as a motor, gearbox, and encoder operatively coupled with computing resources and drive belts to facilitate motion of the mobile vertical assembly (1450) relative to the mobile horizontal span (1448). In other words, the most distal coupling assembly (1458) may be controllably moved in X, Y, and Z to facilitate grasping, repositioning, and release of various packages (1174) to assemble pallet (1424) loads (1418) and generally move items around within the range of motion of the gantry assembly (1440). Indeed, referring to FIG. 39B, a plurality of gantry assemblies (1440) may be operated together, with common input coming from a central input conveyance (1412), for example, with various offshoot individual input conveyance configurations (1422). FIGS. 39C and 39D illustrate further views of embodiments of gantry assemblies (1440).

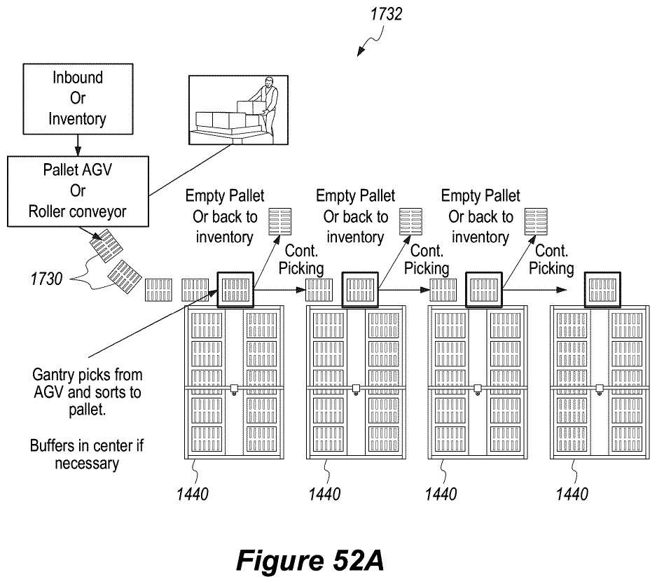

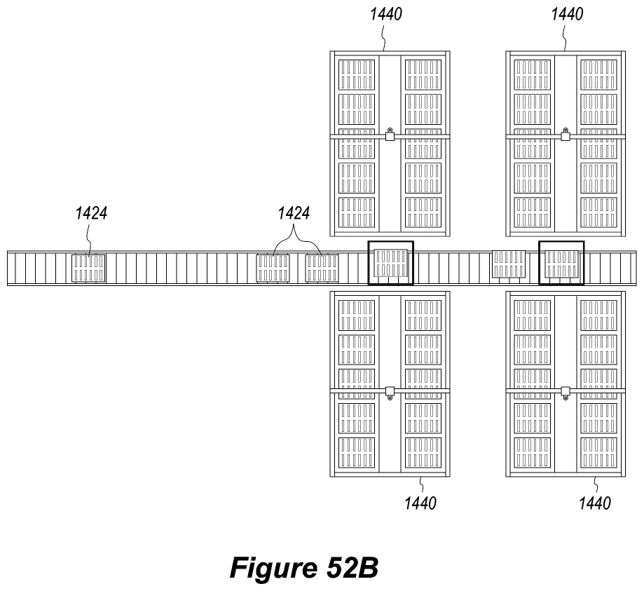

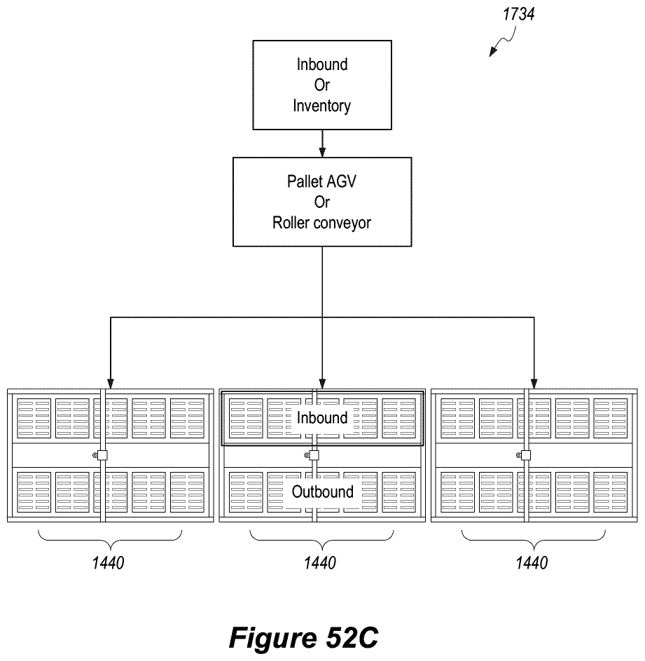

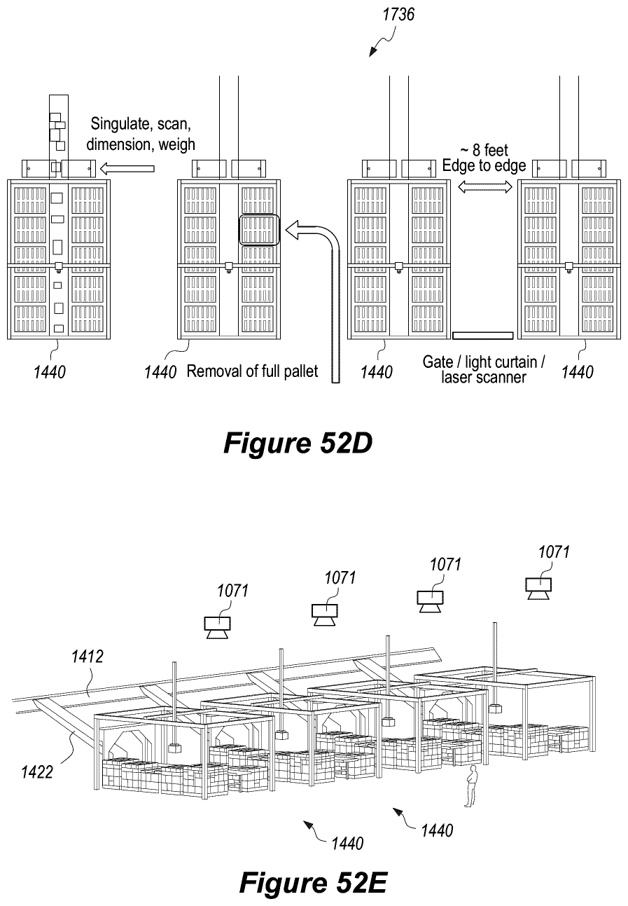

Referring to FIG. 39E, one or more regions or portions (1468) of the pallet support base (1466; may reside, for example on a warehouse floor 1470) may be configured to be movable relative to the remainder of the pallet support base (1466) such that one or more discrete pallets may be moved away during processing of the remainder of the nearby structures, such as by a movable panel or other structure on a rail, ramp, conveyance, or other routing configuration. For example, referring to FIG. 39E, the depicted movable portion (1468) may be moved, such as via forklift, electromechanical drive, or manual drive (such as via a rail system, lead screw, mobile robot, hydraulic system, operator person with pallet jack, or other configuration) away in an X direction (1476), Y direction (1472), or downward to a station below in the Z direction (1474) for further processing, such as for transport, or cellophane perimetric stability wrapping, etc. In other words, at one or more locations within the gantry sortation assembly (1440), subject to manual or automated controls, a pallet may be re-oriented, repositioned, repositioned and re-oriented, or moved entirely away from the assembly (1440) for further processing (such as wrapping, routing away to pack-out, storage, or further destination), such as in the embodiments described below in reference to FIGS. 52A-52E, 53A-53D, and 54D-54F.

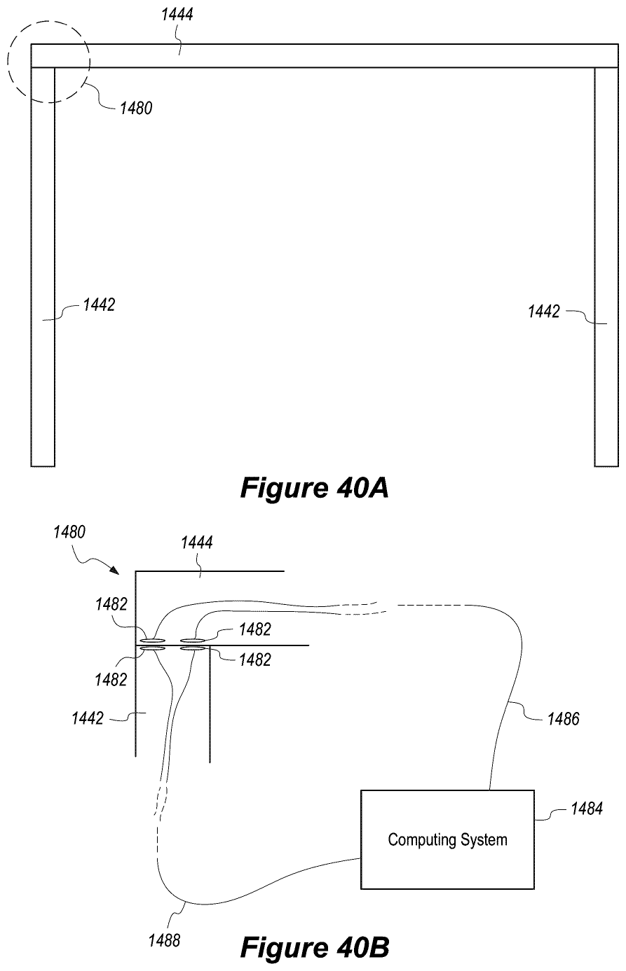

FIG. 39F illustrates a gantry sortation assembly (1440) with labelled “e-chain” cabling conduits (1478) which facilitate movable routing and management of cables (for example for controls, drive motors, image capture devices, computing, etc.) around the assembly (1440). Referring to FIGS. 40A and 40B (close-in view 1480), computing resources (1484) may be operatively coupled (such as by wired or wireless connectivity) to sensors (1482) and/or sensing leads (1486, 1488) such as capacitive, resistive, light-pathway based, strain gauge based, or other sensor configurations which may be configured to assist in detecting changes in the geometric relationship between two joined members, such as the vertical support members (1442) and end support members (1444). With such configuration, the computing resource may be configured to detect any motions, dislocations, movements, or the like which may be important for safe and effective operation of the overall system; if certain predetermined limits (for example, geometric gaps) are exceeded, and operator may be flagged through the intercouple computing systems and/or the system may be slowed or stopped.

Referring to FIGS. 41A and 41B, the movable horizontal span (1448) may be movably coupled to the side supports (1446) using cart assemblies (1490) comprising relatively low-friction wheels (1492) configured to allow for smooth motion of the movable horizontal span (1448) when commanded by the intercoupled driver assembly and drive belts (shown, for example, in FIG. 41C, as noted above in reference to the axle 1494 and driver assembly 1496).

FIGS. 41D and 41E illustrate various aspects of the breakaway configuration coupling assembly (1452) configured to couple the mobile vertical assembly to the mobile horizontal span (1448) while also providing for some intentional operational compliance, or “breakaway”, when loaded in specific ways past particular thresholds, as described below. The close-in partial assembly view of FIG. 41D also shows an image capture device (1072) which may be configured to gather image information pertaining to the conveyance, pallets, packages, and/or distal coupling assembly (1458) components below, for example; the image capture device (1072) preferable is operatively coupled to the intercoupled computing resources so that it may be utilized for vision based control, safety measures, package identification, and other purposes. Referring to FIGS. 41E, 41F, and 41G, a distal extension member (1498) of the mobile vertical assembly (1450; or vertical grasping assembly 1450) may be controllably movable relative to the proximal vertical member (1500) to provide at least one driven and controllable degree of freedom, as operated by a drive assembly (such as a motor, gearbox, and encoder assembly 1502 operatively coupled to computing resources) to produce controlled +Z and −Z motion relative to the mobile horizontal span (1448).

Referring to FIGS. 41H-41P, various aspects of a compliant coupling configuration between the proximal vertical member (1500) and mobile horizontal span (1448) are illustrated, with a coupling assembly (1452) comprising a coupling upper frame (1504) held in place against a coupling lower frame (1508) such that certain motion between thereto is allowed by a spring-loaded coupling with a spring member (1506) held in compression by a coupling axle (1510), coupling retainer (1514), and coupling fastener (1512; such as a threaded nut rotatably coupled to a threaded interface of the coupling axle, which may be a bolt). FIG. 41J illustrates a closer view, wherein depending upon the spring (1506) constant and tightness of compression of the spring (1506) as retained by the axle (1510), retainer (1514), and fastener (1512; fastener may be tightened or loosened to adjust breakaway performance), limited motion (1516), such as rotational motion, of the proximal vertical member (1500) may be allowed relative to the mobile horizontal span (1448) when the proximal vertical member (1500) is subjected to a load, such as when a portion of the vertical assembly 1450) collides with a package, pallet, operator, or other structure. In other words, a controlled breakaway compliance is provided, with predicable “snap back” into initial position/orientation with this compliant, spring-loaded coupling; this may be utilized to prevent damage to various structures or packages, and/or as a safety feature generally around other objects. In other words, the vertical grasping assembly (1450) may be operatively coupled to the first horizontal member (1448) with a breakaway configuration such that upon loading to a threshold loading configuration at a breakaway coupling, the vertical grasping assembly (1450) will move relative to the first horizontal member (1448) from an operating position and orientation to a relief position and orientation to relieve the threshold loading configuration, after which it will return to the operating position and orientation. The breakaway coupling may be configured to cause delivery of an electronic flag to an intercoupled computing system when caused to reach a relief position and orientation that is beyond a flag relief position and orientation, and the computing system may be configured to stop motion of the gantry sortation assembly when the electronic flag is received. As shown in FIG. 41J, one or more fasteners may be configured to also function as proximity and/or contact sensors (1483), so that they may be operatively coupled to a control system and provide signals pertaining to contact and/or structural continuity at the pertinent contact points (in other words, if one or more of the sensors 1483 detect a lack of contact or a proximity gap, this may be detected and flagged at the control system level to provide feedback to an operator, or to automatically execute one or more commands such as a system stop command, joint velocity slow-down command, for example). FIG. 41K illustrates a close-in view of pertinent structures with the spring-compliant interface between coupling upper frame (1504) portion and adjacent coupling lower frame (1508) portion. The shape of these structures also has an impact upon available relative motion or orientation under load. The configuration of FIG. 41L illustrates a mild relative rotation (1520) under load, which places the spring member (1506) in greater spring compression with greater rotation, thus resisting the rotation and promoting a return back to a configuration such as that shown in FIG. 41K. An opposite direction rotation (1522) from an oppositely applied load to the mobile vertical assembly (1450) is illustrated in FIG. 41M. Again, depending upon the mechanical interfacing between the two movably coupled surfaces (1504, 1508), motion may be constrained to specific rotations, movements, and the like. FIG. 41N illustrates a configuration with a feature (1524) configured to prevent nearby lifting of the upper member (1504) relative to the lower member (1508). FIG. 41O illustrates a configuration wherein a fastener (1526) with pivot axle member (1528) restriction motion to rotation about the pivot axle member (1528). The configurations of FIGS. 41N and 410 also comprise protruding physical features (1820) which may be configured to movably couple into matched physical void or concavity features (1822) to further restrict relative motion, such as rotational motion, between the upper member (1504) and lower member (1508), when engaged. FIG. 41P illustrates another assembly view to show the compliant interface structures.

Referring to FIGS. 41Q, 41R, 41S, and 41T, other views of the mobile vertical assembly (1450; 1500/1498) is illustrated with an image capture device (1073) configured to capture information pertaining to the nearby operation of the distal coupling assembly (1458); such image capture device (1073) being operatively coupled to computing resources to facilitate vision-based closed loop and automated control paradigms for the assembly. A Z-roll (for example, about a Z-axis 1532 as shown in FIG. 41T) controlled degree of freedom may be provided by having a Z-roll drive assembly (1530; for example, motor, gearbox, encoder; operatively coupled to computing resources for vision based and automatic control). Referring to FIG. 41U, a pitch or yaw (1534) electromechanical degree of freedom (for example, about a rotation joint 1536 as shown) may be added for greater control and manipulation using the distal coupling assembly (1458; also termed distal grasping end effector 1458). FIG. 41V illustrates a configuration with further degrees of freedom and further complexity, such that the distal coupling assembly (1458) may be controllably and electromechanically inserted/retracted (1540), rolled (1542), rotated about a joint (1536), and further rolled or rotated (1546) distally, for significant positioning and orientation sophistication of the distal coupling assembly (1458) relative to other objects, such as packages (1174) or loaded pallets.

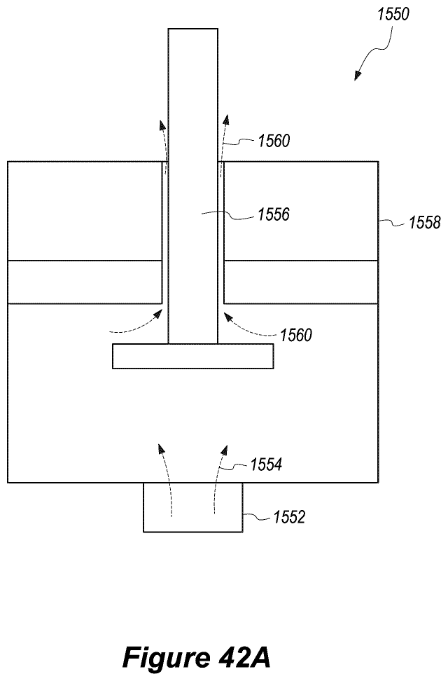

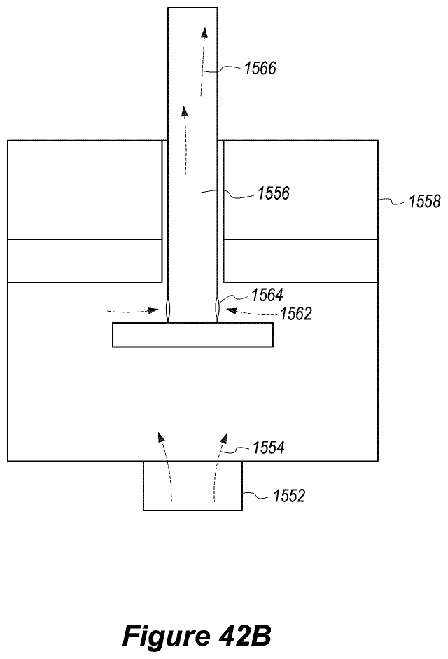

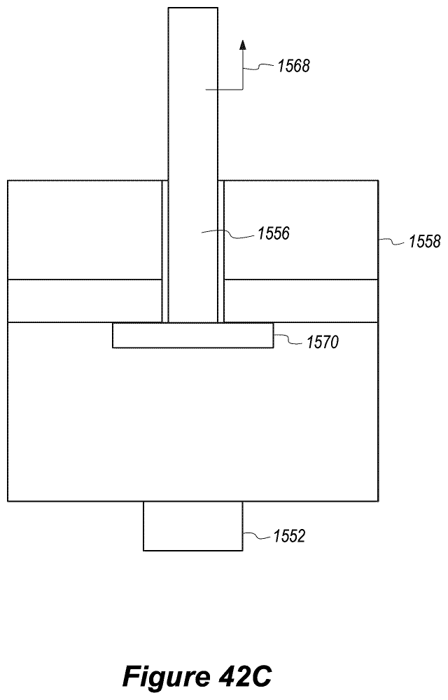

Referring to FIGS. 41W-41Z, various views of distal coupling assemblies are illustrated to show vacuum grasping interfaces (1548), which may be similar to those described above in reference to the illustrated robot arm (54) configurations for robotic sortation. Each vacuum grasping interface (1548) may be discretely controlled, such as via intercoupled computing resources, using individual valve assemblies (1550) unique to each of the vacuum grasping interfaces (1548). The depicted array of valve assemblies (1550) may be electronically coupled to each other and to a controller using conventional wiring, or a single printed circuit board which may be configured to not only mount/couple the assemblies (1550) together relative to each other, but also to electronically and controllably couple them as well in an efficient form. The coupled controller may be configured to not only control opening and closing of each assembly (1550), but also to detect leakage, timing/latency performance, and various other performance and/or function or malfunction related variables. FIG. 41Z illustrates a distal grasper (1824) configuration wherein two opposing grasper members (1826, 1828), which may, for example, comprised forked geometries configured to fit between gaps on associated conveyance or pallet structures, may be utilized to grasp various packages or items (1174) for sortation, reorientation, and/or repositioning relative to various processing and/or output containers or structures. The system may be configured such that end effector components such as those depicted in FIG. 41Z (1824; 1826, 1828) may be manually or automatically switched, such as by the robot itself using a tool holder subsystem, so that it may switch back and forth between end effector tooling deemed most effective (for example, grasper 1824 vs vacuum-based distal coupling assembly 1458 vs coupling assembly such as that described above in reference to FIGS. 11B-11G). Referring to FIG. 42A, with a valve member (1556) extended downward as shown, air, gas, or fluid may be moved up through (1554) and away from an intercoupled vacuum grasping interface coupling (1552), and past the open valve (1556) as it resides intercoupled with the valve housing (1558). FIG. 42B illustrates a variation wherein in an open valve (1556) position, air, gas, or fluid may move through apertures (1562) in the valve (1556) to provide for flow (1554) at the intercoupled vacuum grasping interface coupling (1552), as shown in FIG. 42B. Referring to FIG. 42C, with both configurations of FIGS. 42A and 42B, when the valve is controllably and electromechanically moved (1568; such as via a solenoid) into a closed position, flow at the intercoupled vacuum grasping interface coupling (1552) is stopped. Thus a distal grasping end effector may comprise a first suction cup assembly coupled to a controllably activated (such as via the valve configurations described above) vacuum load operatively coupled to the first computing system, the first suction cup assembly configured such that operating the distal grasping end effector to grasp a targeted item comprises engaging the targeted item and controllably activating the vacuum load. A system instantiation may be configured such that an intercoupled computing system is configured to operate a gantry sortation assembly (1440) to move a targeted item or package by planning and executing one or more motions from the first horizontal member (1448) relative to the frame assembly, from the vertical grasping assembly (1450) relative to the first horizontal member (1448), and/or from the distal grasping end effector (1458) relative to the vertical grasping assembly while also causing the distal grasping end effector to removably couple to the targeted item (such as via controlled vacuum engagement as described above). Again, the distal grasping end effector (1458) may comprise a first suction cup assembly coupled to a controllably activated vacuum load operatively coupled to an intercoupled computing system, the first suction cup assembly configured such that operating the distal grasping end effector (1458) to grasp and become removably coupled to a targeted item or package comprises engaging the targeted item and controllably activating the vacuum load.

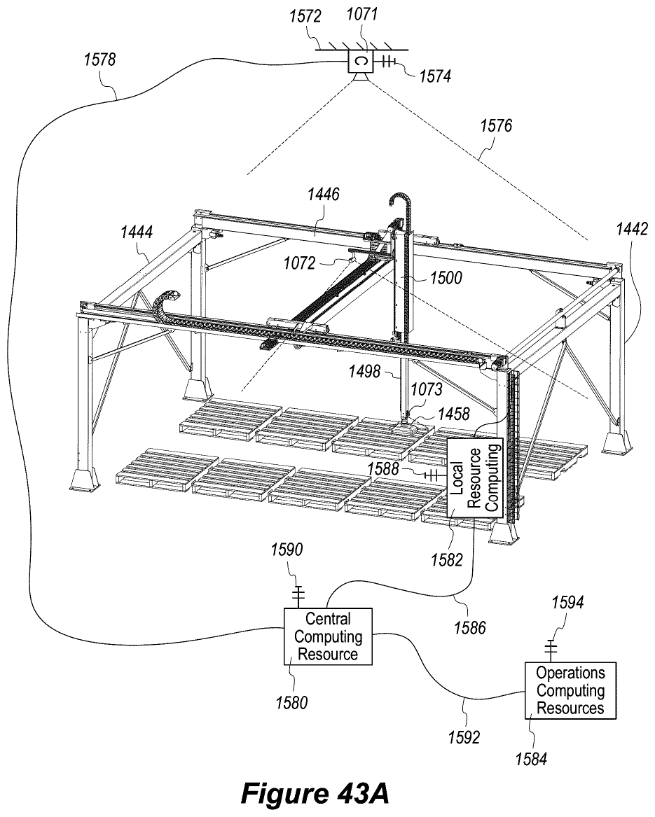

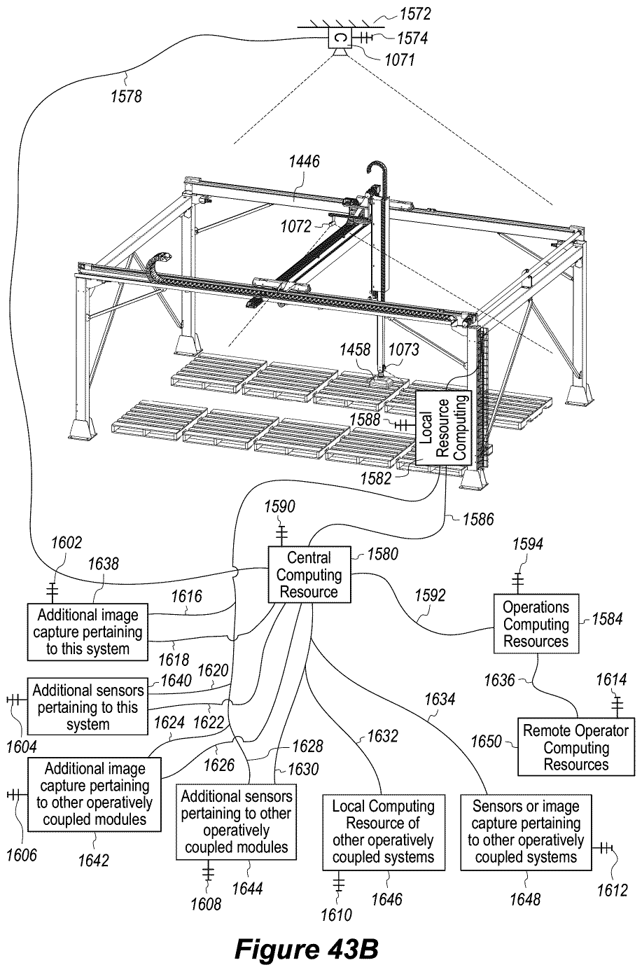

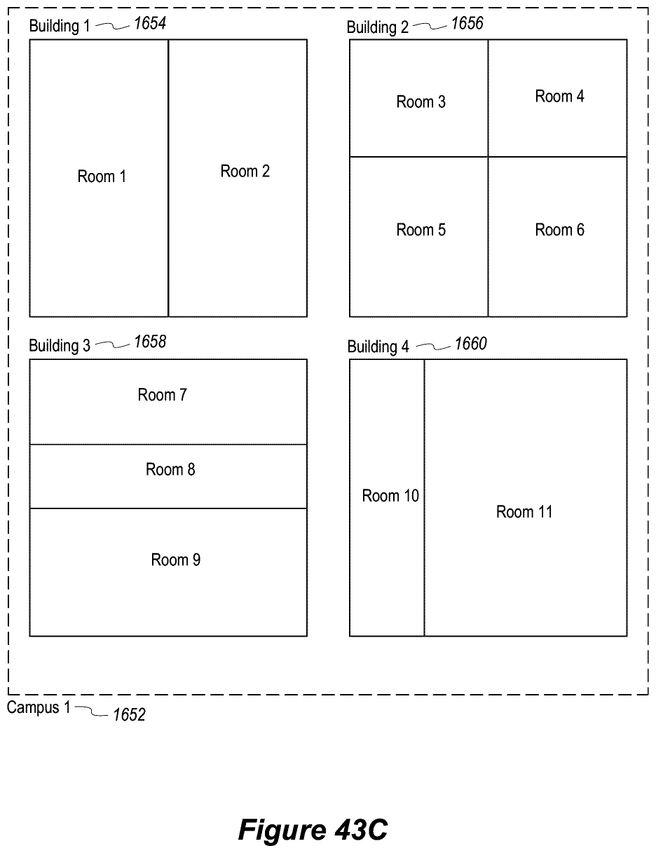

Referring to FIG. 43A, as noted above, generally every controllable element, actuator, sensor, or electronic device will be operatively coupled to computing resources, such as to local computing resources (1582), such as via wireless (1588; such as via IEEE 802.11, nearfield, Bluetooth™, or other wireless connectivity) or wired (1586, 1578, etc.; generally elements will be ubiquitously connected with wired connectivity through the assembly 1440, such as by CAT6 network cabling, ethernet connectivity, etc.). Local computing resources preferably are coupled (wirelessly 1590/1588 and/or via wire 1586) to central computing resources, which may be operatively coupled to various other resources as noted, such as image capture devices (1071; for example, may be coupled to the room 1572, as shown, or other structures; may be wired 1578 or wireless 1574 connectivity) and operator computing resources (1584; such as via wireless 1594 and/or wired 1592 connectivity), such as computers, smartphones, and network operating centers. Indeed, referring to FIG. 43B, preferably all pertinent additional resources (1638, 1640, 1642, 1644, 1646, 1648, 1650) in an operation are connected to computing resources via wired (1616, 1618, 1620, 1622, 1624, 1626, 1628, 1630, 1632, 1634, 1636) and/or wireless (1602, 1604, 1606, 1608, 1610, 1612, 1614) connectivity to promote low-latency control, execution, and safety with small-scale or larger scale operations, such as the one illustrated in FIG. 43C, wherein central computing resources and operator computing resources, for example, may be utilized to assist in operating a large-scale operation with multiple buildings (1654, 1656, 1658, 1660) and many different rooms, each of which may feature various sortation units or assemblies (for example, 1440) on a given campus (1652), or plurality thereof.

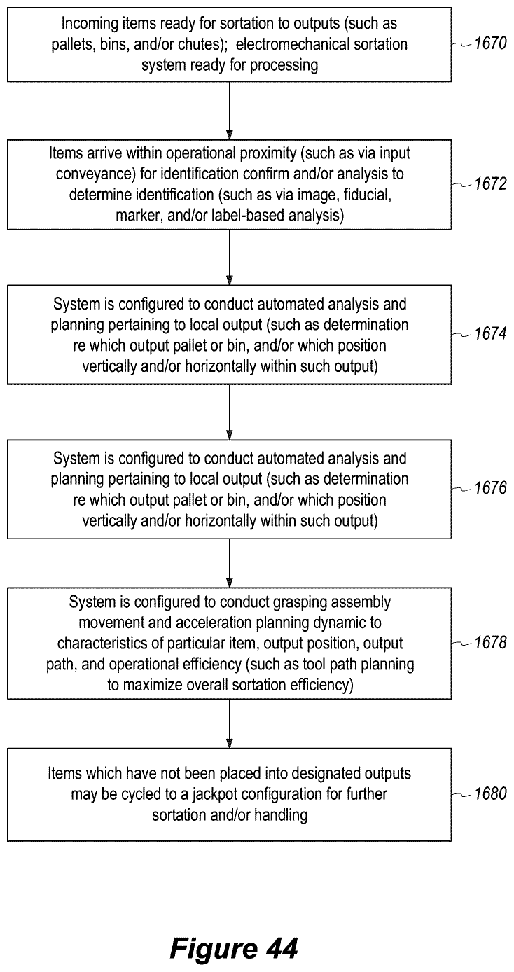

Referring to FIG. 44, in one embodiment, incoming items may be ready for sortation to outputs (such as pallets, bins, and/or chutes), and an electromechanical sortation system may be ready for processing (1670). Items may arrive within operational proximity (such as via input conveyance) for identification confirm and/or analysis to determine identification (such as via image, fiducial, marker, and/or label-based analysis) (1672). The system may be configured to conduct automated analysis and planning pertaining to local output (such as determination re which output pallet or bin, and/or which position vertically and/or horizontally within such output) (1674). The system may be configured to conduct automated analysis and planning pertaining to local output (such as determination re which output pallet or bin, and/or which position vertically and/or horizontally within such output) (1676). The system may be configured to conduct grasping assembly movement and acceleration planning dynamic to characteristics of particular item, output position, output path, and operational efficiency (such as tool path planning to maximize overall sortation efficiency) (1678). Items which have not been placed into designated outputs may be cycled to a jackpot configuration for further sortation and/or handling (1680).

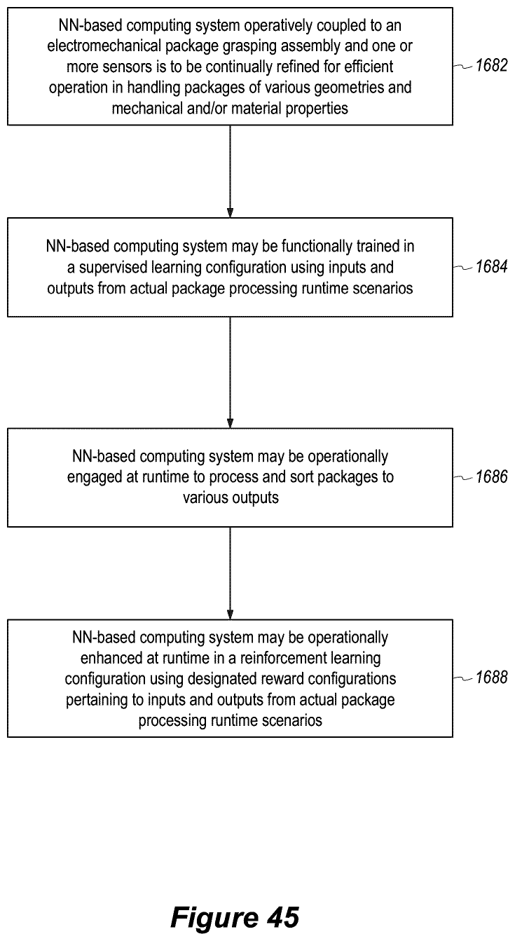

Referring to FIG. 45, a neural network (“NN”) based computing system may be operatively coupled to an electromechanical package grasping assembly and one or more sensors is to be continually refined for efficient operation in handling packages of various geometries and mechanical and/or material properties (1682). The NN-based computing system may be functionally trained in a supervised learning configuration using inputs and outputs from actual package processing runtime scenarios (1684). The NN-based computing system may be operationally engaged at runtime to process and sort packages to various outputs (1686). The NN-based computing system may be operationally enhanced at runtime in a reinforcement learning configuration using designated reward configurations pertaining to inputs and outputs from actual package processing runtime scenarios (1688). In various configurations, an intercoupled computing system may be configured to analyze candidate movements and select execution movements to move a targeted item or package based at least in part upon runtime use of a neural network operated by the computing system, the neural network trained using views developed from synthetic data comprising information related to three-dimensional models of one or more synthetic items in various positions and orientations relative to other structures. For example, in various arrangements, the computing system may be configured to operate the neural network in a convolutional sim-to-real configuration.

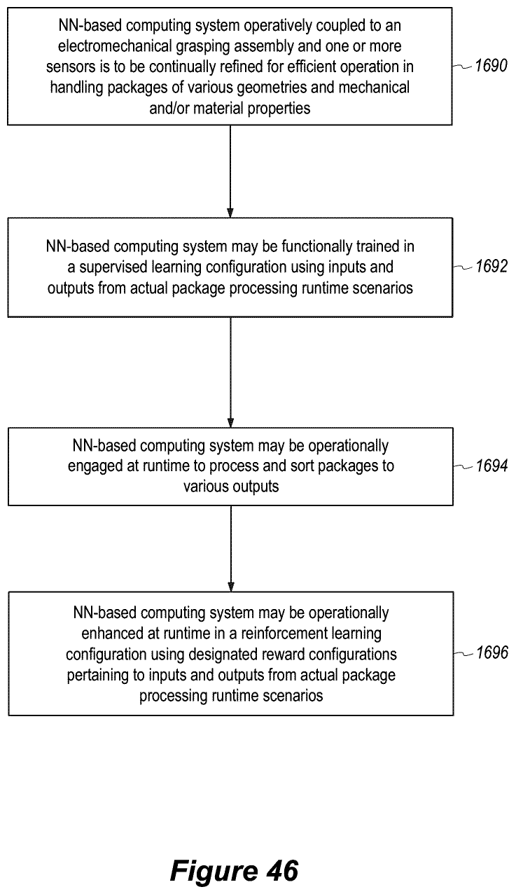

Referring to FIG. 46, an NN-based computing system may be operatively coupled to an electromechanical grasping assembly and one or more sensors is to be continually refined for efficient operation in handling packages of various geometries and mechanical and/or material properties (1690). The NN-based computing system may be functionally trained in a supervised learning configuration using inputs and outputs from actual package processing runtime scenarios (1692). The NN-based computing system may be operationally engaged at runtime to process and sort packages to various outputs (1694). The NN-based computing system may be operationally enhanced at runtime in a reinforcement learning configuration using designated reward configurations pertaining to inputs and outputs from actual package processing runtime scenarios (1696).

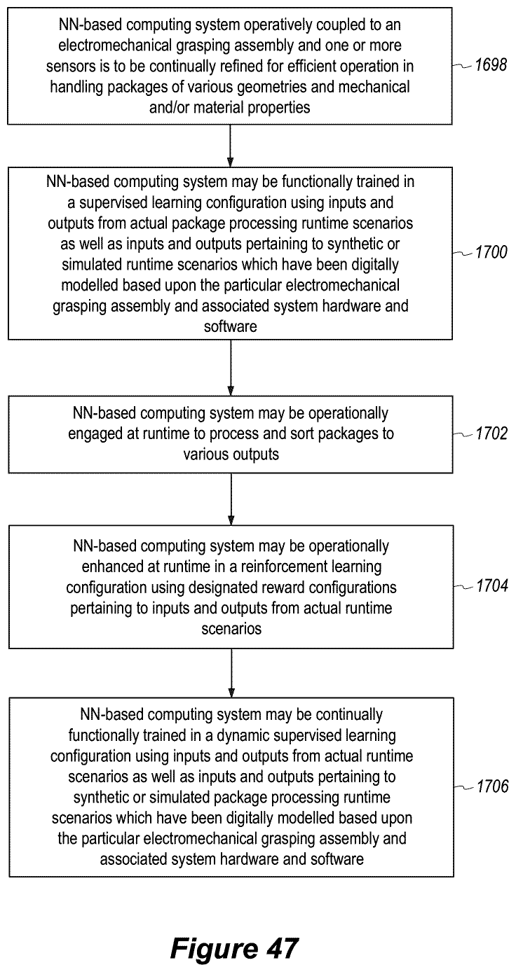

Referring to FIG. 47, an NN-based computing system may be operatively coupled to an electromechanical grasping assembly and one or more sensors is to be continually refined for efficient operation in handling packages of various geometries and mechanical and/or material properties (1698). The NN-based computing system may be functionally trained in a supervised learning configuration using inputs and outputs from actual package processing runtime scenarios as well as inputs and outputs pertaining to synthetic or simulated runtime scenarios which have been digitally modelled based upon the particular electromechanical grasping assembly and associated system hardware and software (1700). The NN-based computing system may be operationally engaged at runtime to process and sort packages to various outputs (1702). The NN-based computing system may be operationally enhanced at runtime in a reinforcement learning configuration using designated reward configurations pertaining to inputs and outputs from actual runtime scenarios (1704). The NN-based computing system may be continually functionally trained in a dynamic supervised learning configuration using inputs and outputs from actual runtime scenarios as well as inputs and outputs pertaining to synthetic or simulated package processing runtime scenarios which have been digitally modelled based upon the particular electromechanical grasping assembly and associated system hardware and software (1706).

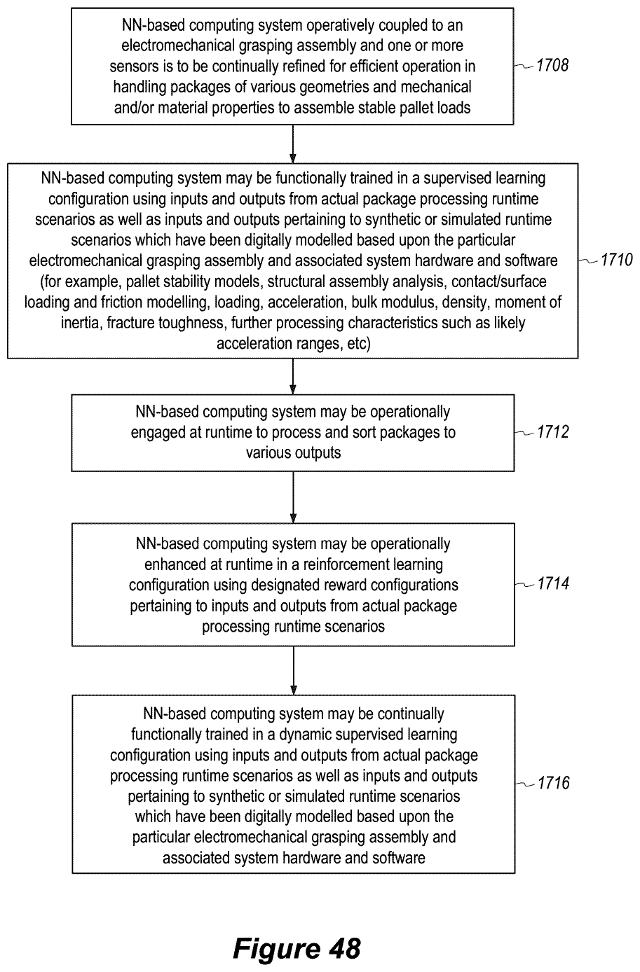

Referring to FIG. 48, an NN-based computing system operatively may be coupled to an electromechanical grasping assembly and one or more sensors is to be continually refined for efficient operation in handling packages of various geometries and mechanical and/or material properties to assemble stable pallet loads (1708). The NN-based computing system may be functionally trained in a supervised learning configuration using inputs and outputs from actual package processing runtime scenarios as well as inputs and outputs pertaining to synthetic or simulated runtime scenarios which have been digitally modelled based upon the particular electromechanical grasping assembly and associated system hardware and software (for example, pallet stability models, structural assembly analysis, contact/surface loading and friction modelling, loading, acceleration, bulk modulus, density, moment of inertia, fracture toughness, further processing characteristics such as likely acceleration ranges, etc.) (1710). The NN-based computing system may be operationally engaged at runtime to process and sort packages to various outputs (1712). The NN-based computing system may be operationally enhanced at runtime in a reinforcement learning configuration using designated reward configurations pertaining to inputs and outputs from actual package processing runtime scenarios (1714). The NN-based computing system may be continually functionally trained in a dynamic supervised learning configuration using inputs and outputs from actual package processing runtime scenarios as well as inputs and outputs pertaining to synthetic or simulated runtime scenarios which have been digitally modelled based upon the particular electromechanical grasping assembly and associated system hardware and software (1716). Generally with configurations such as those described above, a system may have an input assembly (such as an input conveyance 1422) directing items or packages toward a gantry sortation assembly (1440) such as is shown in FIG. 39A, with one or more imaging devices (1071 or additional; may be termed an imaging assembly) positioned and oriented to capture image information pertaining to the items (1744) output structures (1424), and sortation assembly components (1444, 1446, 1448, 1442, 1450, 1458) for desired output to the output structures (1424); a computing system (such as 1484, 1582, 1580, and/or 1584; such as discussed above in reference to FIG. 43A or 43B) operatively coupled (such as by wired or wireless communication) to the gantry sortation assembly and imaging assembly, may be configured to receive the image information from the imaging assembly and command movements of the gantry sortation assembly based at least in part upon the image information to move the packages or items as desired. In other words, the computing system may be configured to operate the gantry sortation assembly to move a targeted item from the input assembly based at least in part upon the image information, and release the targeted item into a targeted output structure with a position and orientation relative to the targeted output structure that is based at least in part upon the image information. For example, a first imaging assembly may comprise a first image capture device having a first field of view positioned and oriented to capture image information pertinent to the input assembly and a second image capture device having a second field of view positioned and oriented to capture image information pertinent to the gantry sortation assembly (1440); the fields of view of the image capture devices may be positioned and oriented to capture image information pertinent to a flow of an item or package from the first imaging assembly, to the gantry sortation assembly (1440), and to a targeted output structure such as a pallet (1424). At least one image capture device of the plurality of image capture devices may positioned and oriented to capture image information pertinent to an interior of a targeted output structure (for example, to see the interior or a bin, box, chute, or other output structure or output container), and the at least one image capture device may be configured to provide image information pertaining to interior portion factors such as: shape of interior of output structure, geometry of items within output structure, and fill level within output structure. The associated computing system may be configured to operate the gantry sortation assembly to place the targeted package or item into the targeted output structure with a position and orientation automatically selected to optimize geometric fit of the targeted item within the targeted output structure. In various configurations, an associated computing system may be configured to operate the gantry sortation assembly (1440) to sequence items into one of the plurality of output structures (such as 1424) based upon a pattern regarding a planned subsequent unloading of the plurality of output structures, such as a pattern that is determined automatically by the computing system based at least in part upon the image information from the first imaging assembly, and/or a pattern that determined at least in part based upon a predetermined patterning preference (for example, a customer or seller may have a prescribed pattern for loading output containers or output structures). The computing system also may be configured to operate the gantry sortation assembly (1440) to sequence items into one the plurality of output structures based upon a pattern regarding a known planned subsequent relative positioning of one or more of the plurality of output structures within a delivery vehicle (i.e., to assist delivery operator personnel with efficient output processing for deliveries). The computing system also may be configured to operate the gantry sortation assembly (1440) to sequence packages or items into one of a plurality of output structures based upon a known delivery route pertaining to a planned unloading of at least one of the plurality of output structures, further allowing for delivery efficiency. An associated computing system also may be configured to automatically controllably release a targeted item or package to a targeted output structure or container selected from the plurality of output structures based at least in part upon image information from the first image capture device which may be utilized by the first computing system to estimate a factor selected from the group consisting of: item geometry; item compliance; estimated item bounding box geometry; item relative mass (from an intercoupled scale or other mass estimator); relative rigidity of item material (for example, from image information pertaining to the item when loaded in various configurations, such as at the input assembly or with a grasp, or via use of intercoupled sensors such as accelerometers, gyros, inertial measurement units, and/or microphones); item mechanical stability (for example, from image information pertaining to the item when loaded in various configurations, such as at the input assembly or with a grasp; or via use of intercoupled sensors such as accelerometers, gyros, inertial measurement units, and/or microphones); and item moment of inertia (for example, from image information pertaining to the item when loaded in various configurations, such as at the input assembly or with a grasp, or via use of intercoupled sensors such as accelerometers, gyros, inertial measurement units, and/or microphones).

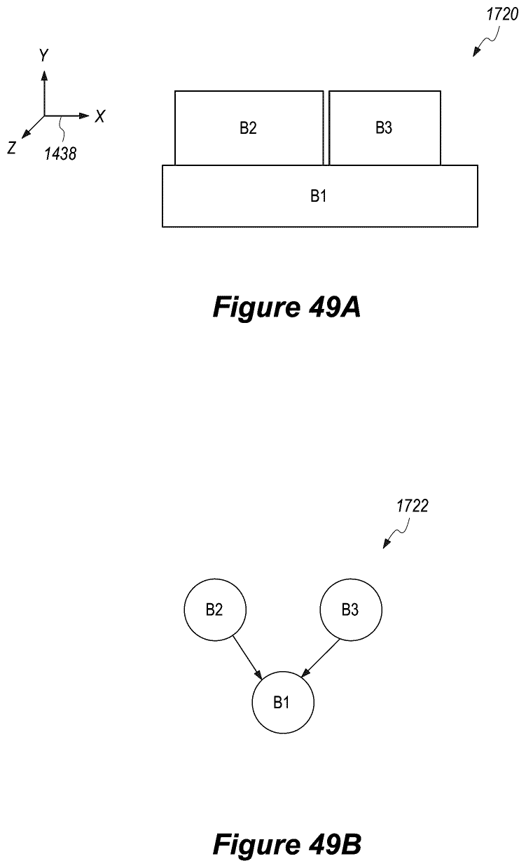

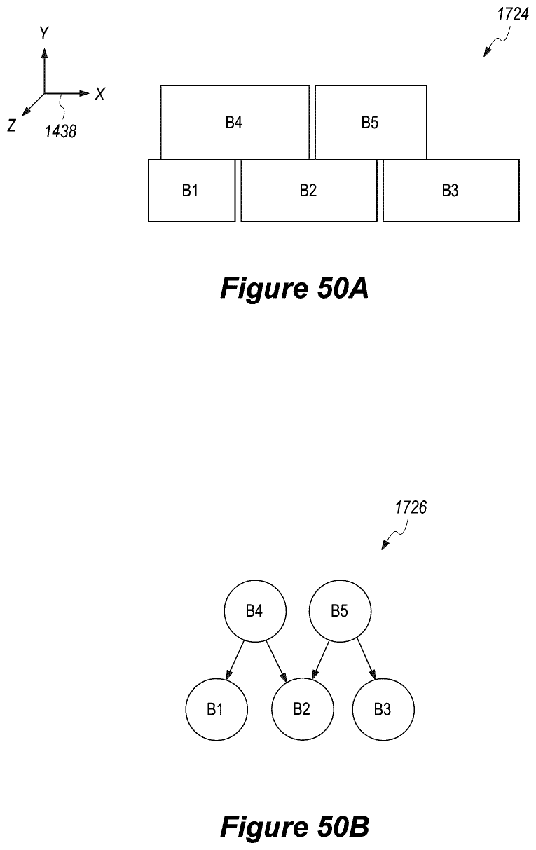

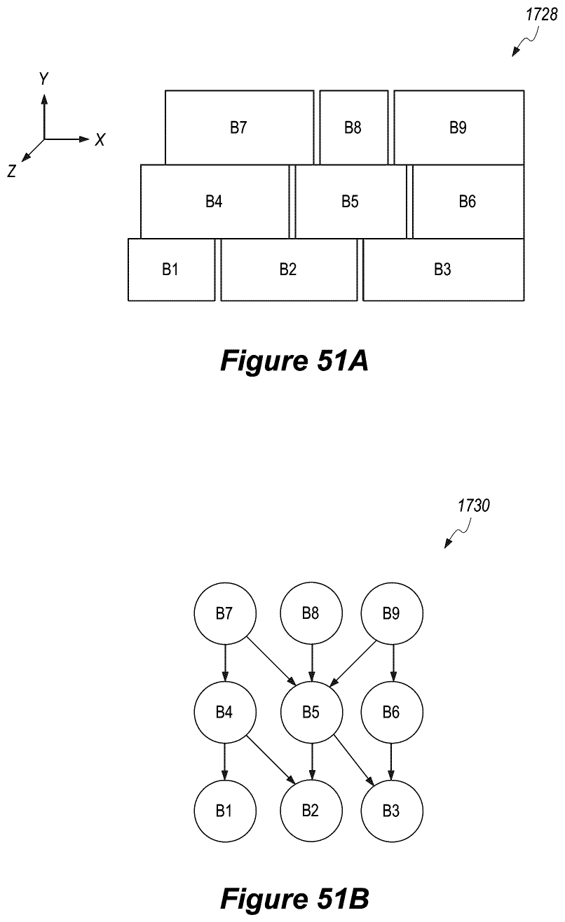

Referring to FIGS. 49A and 49B, in various embodiments the computing system, such as an NN-based computing system, may be configured to examine dependencies between various packages (such as the assembly illustrated, 1720) in terms of stability to each package (1722), so that pallet loading may be optimized for stability, amongst other rewarded outcomes. For example, referring to FIGS. 49A and 49B, the stability of items B2 and B3 depend upon the position and orientation of item B1, and the stability of the overall assembly of B1-B2-B3 depends upon the stability of all three together as an assembly. The NN-based computing system may be trained and configured to seek and reward greater stability of the overall assembly as well as individual items relative to other associated items. FIG. 50A/50B and 51A/51B illustrate more complex assemblies (1724 and 1728, respectively) and stability dependencies (1726 and 1730, respectively) which may be utilized in training and operation of the subject computing and operational systems. In various embodiments, user interfaces may be available to operators or users so that reward paradigms may be modified or tuned. For example, in various operational paradigms, both stack stability and assembly-of-stack-speed may be optimized/rewarded, or one more than the other—or a blend of various pluralities of reward factors of paradigms, including variations pertinent to time domain or sub-process issues (for example, stability may be more highly relatively rewarded at the top of a relatively high and fragile stack).

Referring to FIGS. 52A-52E, various operational scenarios are illustrated pertaining to the handling of packages, specifically related to sortation and transport utilizing pallet (1424) configurations. Referring to FIG. 52A, a configuration (1732) shows that inbound or inventory incoming packages or pallets may be moved using systems such as pallet jacks, fork lifts, conveyances, mobile robots, or so-called automated-guided-vehicles (“AGV”) in a substantially linear manner; such pallets (1424) may be navigated to one or more gantry sortation units (1440) for further processing of packages or items, such as picking from given incoming pallets and sortation to other pallets within the gantry sortation units (1440). A configuration such as that depicted in FIG. 52A may be utilized, for example, to direct pallets into an input side and have them picked by various gantry sortation units (1440) for routing to a relatively large number of output pallets, containers, destinations, or routes. Each of the gantry sortation units (1440) may be configured to have reach sufficient to retrieve or pick items individually from pallets that are navigated adjacently on the input side as shown.

Referring to FIGS. 52B and 52C, gantry sortation units (1440) may be positioned and oriented in various patterns around the incoming flow of pallets (1424) for optimized access and efficiency. For example, referring to FIG. 52B, a central or main input conveyance (346) may be utilized to feed a plurality of adjacently positioned gantry sortation units (1440) such that each of these units (1440) has sufficient reach to pick items directly from pallets (1424) coming through the central conveyance as shown. Referring to FIG. 52C, an operational configuration (1734) is shown wherein input configurations such as conveyors and/or mobile robots or AGV systems may be utilized to directly provide input packages or items into gantry sortation unit (1440) sortation circulation by feeding a deemed “input” or “inbound” side of each unit (1440), such that each gantry sortation unit (1440) may conduct further sortation therein and produce sorted pallets on a deemed “output” or “outbound” side of the assembly for further transport to pack-out, storage, delivery, or other processing.

Referring to FIGS. 52D and 52E, pluralities of gantry sortation units (1440) may be served by various operational patterns and conveyance input systems (1412, 1422). For example, referring to FIG. 52D, an assembly (1736) of a plurality of gantry sortation units (1440) may be configured to efficiently occupy a surface of a processing facility while also providing for room between each unit (such as about 8 feet in one embodiment) to facilitate removal and return of completed pallets after sortation, such as by hand truck, mobile robot, or AGV. One or more electronic or light curtains, such as those (1806, 1806; indicators 1810, 1812, 1814) described above in reference to FIGS. 32E-32H, or mechanical fences, such as those (1802, 1804) described above in reference to FIG. 32D, may be utilized to controllably isolate various portions of the assembly, and/or to notify the system and operators of the presence of personnel in various locations. As with each embodiment of FIGS. 52A-52E, various image capture devices (1072, 1072) may be operatively coupled to control elements and utilized to visualize not only individual elements such as packages, but also operation of various controllably movable elements, as well as personnel. With embodiments such as those illustrated in FIGS. 32A-32D, image capture (1072, 1071) information may be utilized to rate-limit the flow of items or packages. For example, an input assembly may be configured to be operated by the first computing system to control the supply of items based at least in part upon a number of the one or more items transiently coupled to input assembly; or an input assembly may be configured to be operated by the first computing system to control the supply of items based at least in part upon the image information pertaining to the one or more items at the input assembly. As noted above, an input assembly may comprise one or more mechanical singulation elements configured to mechanically process and direct the substantially singulated supply of items toward the gantry sortation assembly (for example: a ramp sequence; a vibratory actuator; a belt; a coordinated plurality of belts; a ball sorter conveyor; a step sequence; a chute with one or more 90-degree turns; a mechanical diverter; a vertical mechanical filter; and/or a horizontal mechanical filter may be utilized). An input assembly may be configured to be operated by the associated computing system to prune away certain items which do not become substantially singulated as a result of the mechanical process using a diversion element configured to selectably divert one or more targeted items.

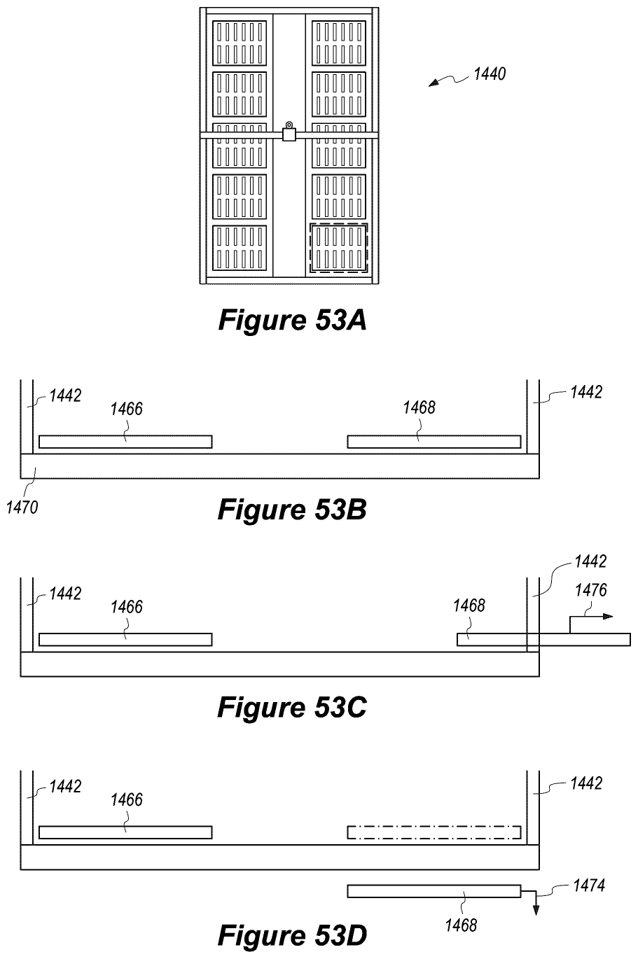

Referring to FIG. 53A, as noted above in reference to FIG. 39A, it may be useful for one or more portions of a gantry sortation unit (1440) support floor to be movable, such that one or more targeted pallets may be moved away from the gantry sortation unit (1440) for further processing while the remaining portions of the gantry sortation unit (1440) continue to operate.

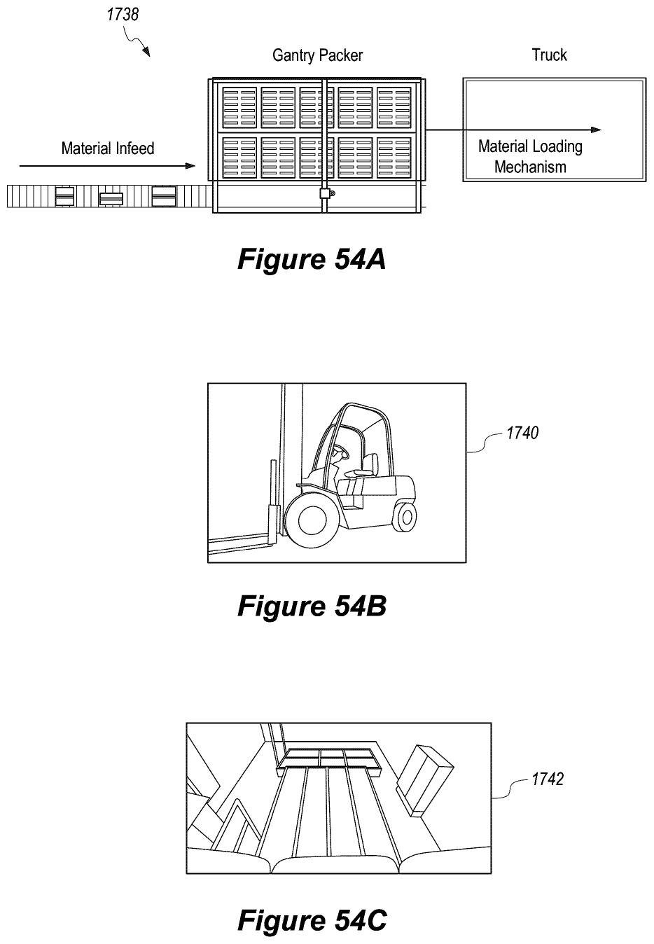

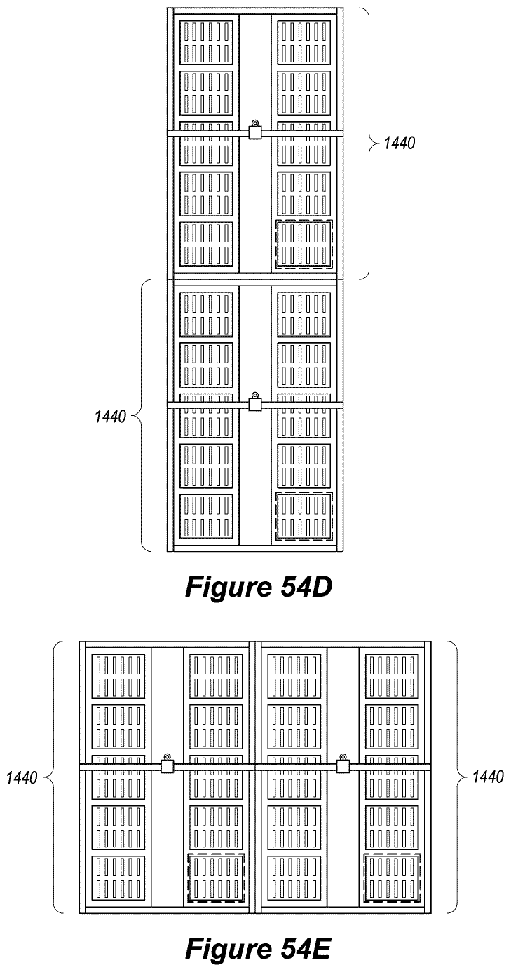

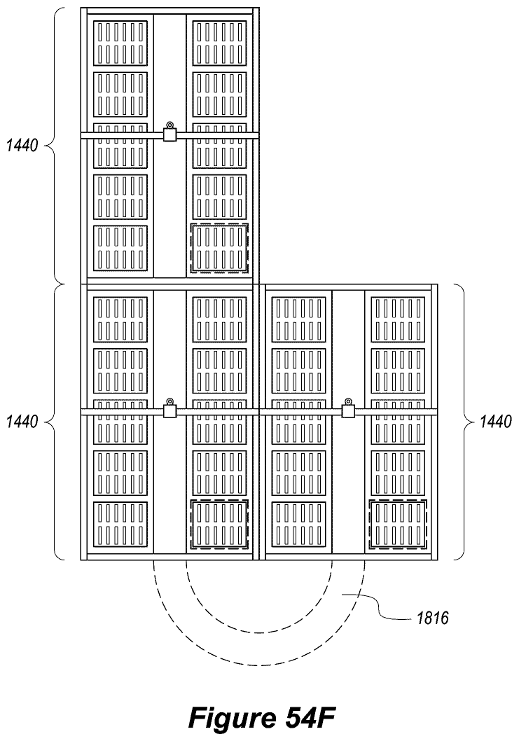

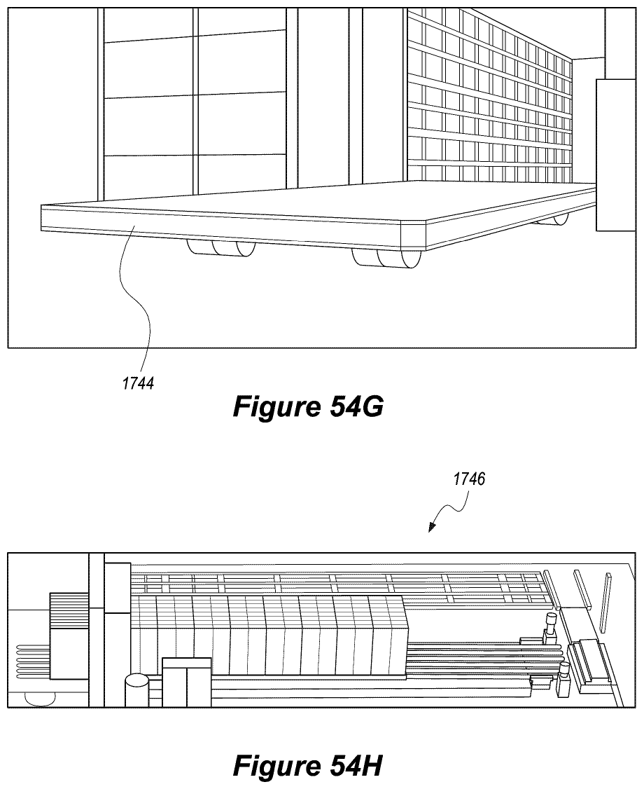

Referring to FIGS. 54A-54C, the high level flow (1738) of packages and pallets, through gantry sortation, and into an output flow, such as to a truck, often ends with loading of a truck or container (such as via a forklift 1740 or other mechanism), the interior of which (1742) may be difficult to access, even with a forklift (1740). Referring ahead to FIGS. 54G and 54H, in various embodiments, systems such as electromechanically assisted pallet movers (1744; some of which may be controllably holonomically mobilized relative to a floor) or truck loading systems (1746; some of which may be configured to slide a portion or entirety of a truck or container load into a truck at once) may be utilized or integrated. Referring to FIGS. 54D, 54E, and 54F, gantry sortation units (1440) may be assembled in serial, parallel, and/or intercoupled configurations to provide for a relatively large number of pallet, destination, or route location fulfillments simultaneously. Packages or items, or output containers or whole pallets, may be shared between sortation unit assemblies (1440) using various means such as robots with operational range of motion to reach across to each of two or more adjacent sortation unit assemblies (1440), conveyance systems (1816; for example, coupling a conveyance system internal to one assembly 1440 to a conveyance system internal to another assembly 1440 as shown) coupling adjacent sortation unit assemblies (1440), and/or mobile systems such as pallet jacks or autonomous mobile robotic systems to move packages between operably coupled sortation unit assemblies (1440).

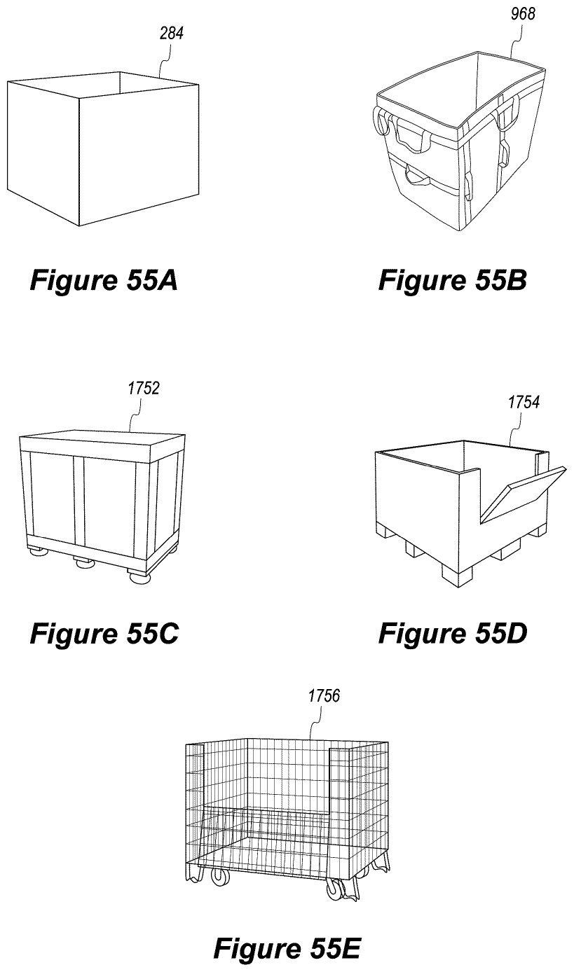

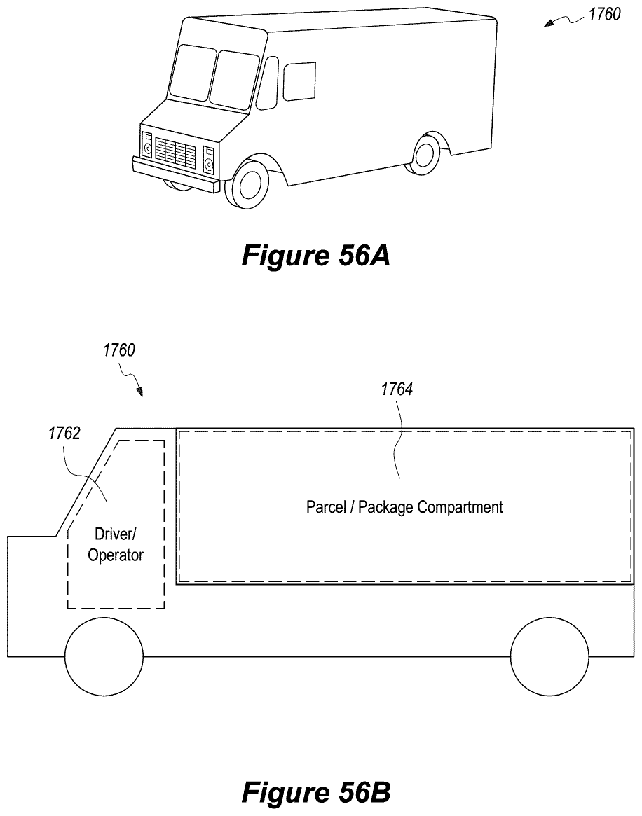

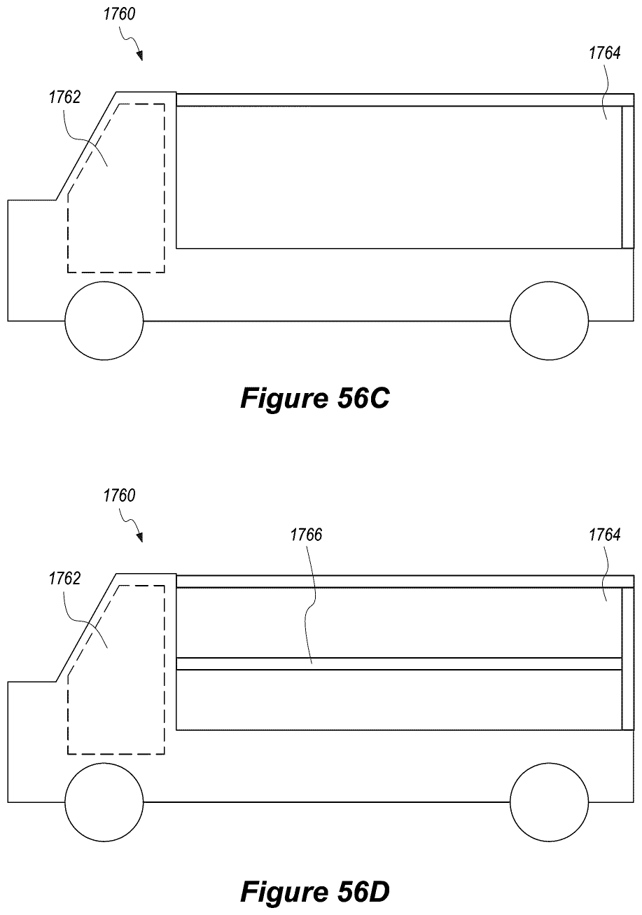

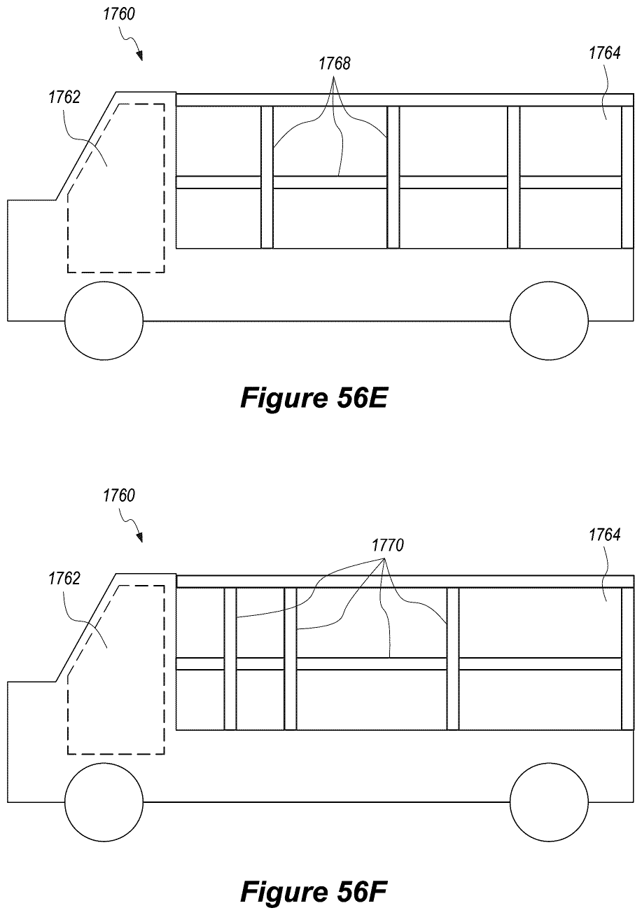

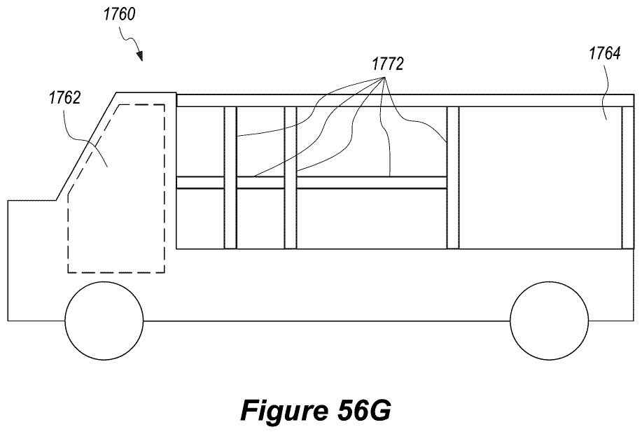

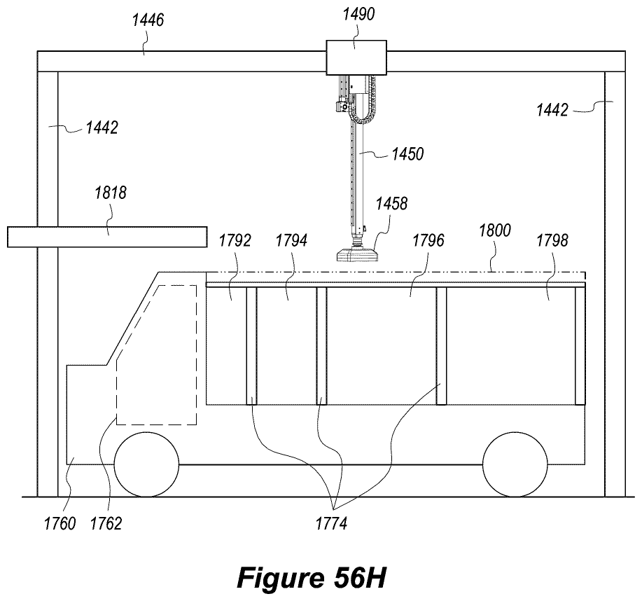

Referring to FIGS. 55A-55E and 56A-56G, different logistical challenges require different solutions for not only sortation, but also for transportation. FIGS. 55A-55E illustrate various container types which continue to be common in logistics (carboard gaylord style container 284; semi-rigid box type container 968; wooden containers 1752; plastic or polymeric containers 1754; metallic so-called “wiretainers” 1756). Such configurations often need to be not only addressed during sortation, but also during transport and trucking. Thus referring to FIGS. 56A-56G, trucks and trucking systems with various geometries (not only for driver compartment 1762, but also for package or container compartment 1764 and associated structural members 1766) may be utilized, and preferably the subject systems may be utilized to optimize loading and loading of such trucks, regardless of configuration. For example, a typical conventional delivery truck (1760) is illustrated in FIGS. 56A and 56B, with access through a roll-up door, or one or more swinging doors, typically in the rear of the vehicle (1760), to one or more typically large parcel/package compartments (1764); a driver/operator compartment (1762) typically is located in the front of the vehicle. Such a vehicle may be loaded manually, or with electromechanical assistance, such as via use of a manual or electromechanical conveyance system, one or more manual or electromechanical pallet jacks, or systems such as those referenced in discussion of FIGS. 54G and 54H. Referring to FIGS. 56C-56G, various side-loadable, or so-called “coffin” loadable configurations are illustrated, such that the vehicle (1760) may be loaded from each side to fill various volumes or spaces (1764) created by structural members (1766, 1768, 1770, 1772). The volumes or spaces (1764) may comprise empty volumes to be loaded from the side, or may be configured to have movable drawer type assemblies which may be slided outward from the truck (1760) so that they may be loaded from the top in a manner similar to that in which a human may load folded clothing into a typical dresser piece of furniture, before the drawer assemblies are moved back into position within the truck (1760) for driving/distribution activity. Loading of the spaces (1764), whether simple volumes or drawer type assemblies, may be conducted manually, or with electromechanical assistance, such as via use of a manual or electromechanical conveyance system, one or more manual or electromechanical pallet jacks, one or more mobile robotic systems, or systems such as those referenced in discussion of FIGS. 54G and 54H.

Referring to FIGS. 56H and 56I, in another embodiment, a delivery vehicle (1760) may have a roll-back or removable roof panel (1800) to facilitate top loading by aspects of a robotic configuration such as those described above (1450, 1490, 1446, 1442) wherein a conveyance system, such as an elevated conveyance (1818) may be configured to bring packages or items (1174) close to the top of the vehicle (1760) wherein they may be grasped by the end effector (1458) and placed into one of the volumes or cavities (1792, 1794, 1796, 1798) defined between the structural members (1774) of the vehicle. FIG. 561 illustrates further that the elevated input conveyance (1818) may have elements that are ramped to take packages (1174) from one level, such as a ground level or input feed or buffering level, up to a second level which is near or adjacent to the top of the delivery vehicle for top-loading, after which the delivery vehicle roof panel (1800) may be closed and the vehicle moved away for further activity, such as additional loading and/or routing for deliveries.

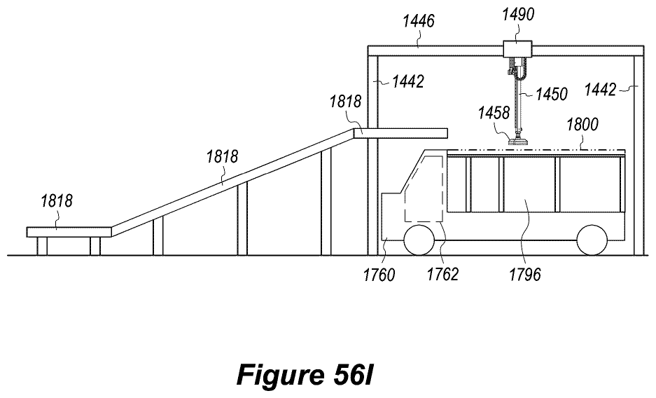

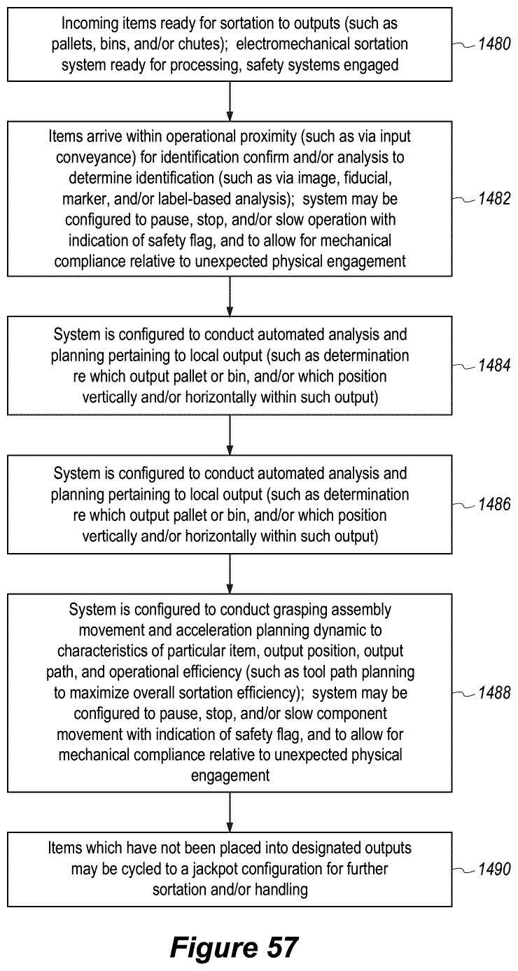

Referring to FIG. 57, in one embodiment, incoming items may be ready for sortation to outputs (such as pallets, bins, and/or chutes); electromechanical sortation system ready for processing, safety systems engaged (1780). Items may arrive within operational proximity (such as via input conveyance) for identification confirm and/or analysis to determine identification (such as via image, fiducial, marker, and/or label-based analysis); system may be configured to pause, stop, and/or slow operation with indication of safety flag, and to allow for mechanical compliance relative to unexpected physical engagement (1782). The system may be configured to conduct automated analysis and planning pertaining to local output (such as determination re which output pallet or bin, and/or which position vertically and/or horizontally within such output) (1784). The system may be configured to conduct automated analysis and planning pertaining to local output (such as determination re which output pallet or bin, and/or which position vertically and/or horizontally within such output) (1786). The system may be configured to conduct grasping assembly movement and acceleration planning dynamic to characteristics of particular item, output position, output path, and operational efficiency (such as tool path planning to maximize overall sortation efficiency); system may be configured to pause, stop, and/or slow component movement with indication of safety flag, and to allow for mechanical compliance relative to unexpected physical engagement (1788). Items which have not been placed into designated outputs may be cycled to a jackpot configuration for further sortation and/or handling (1790).

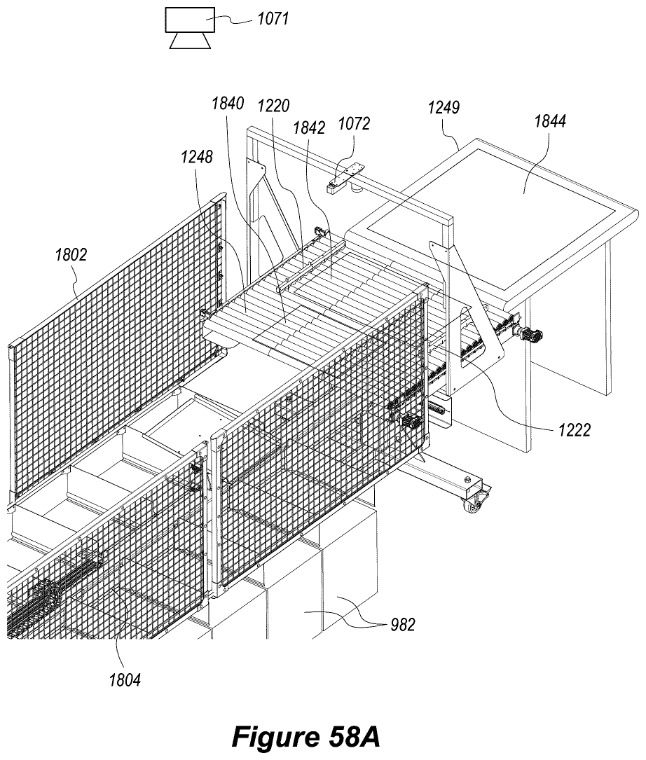

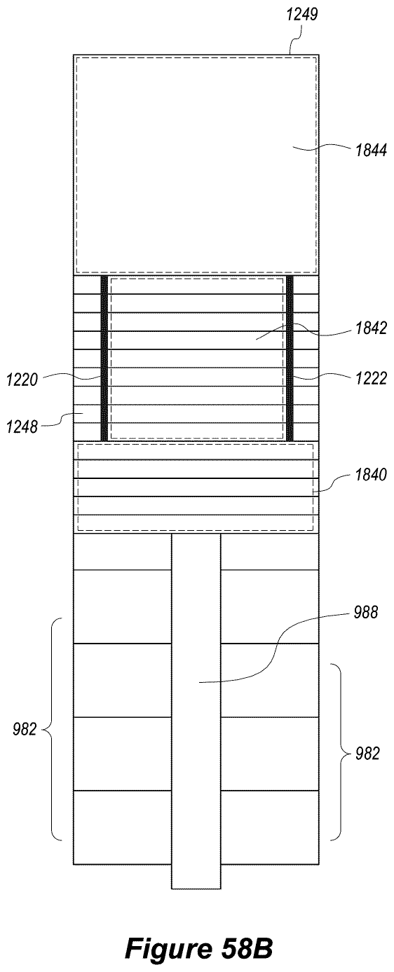

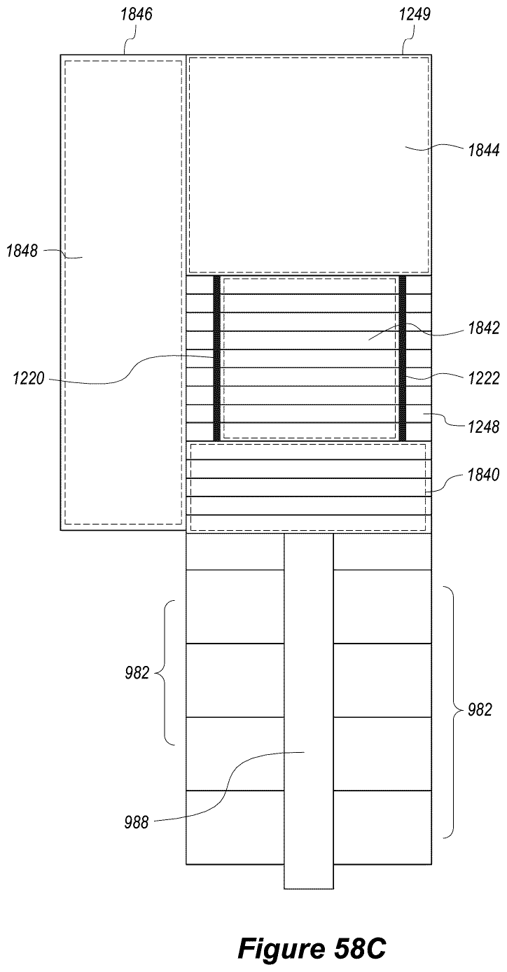

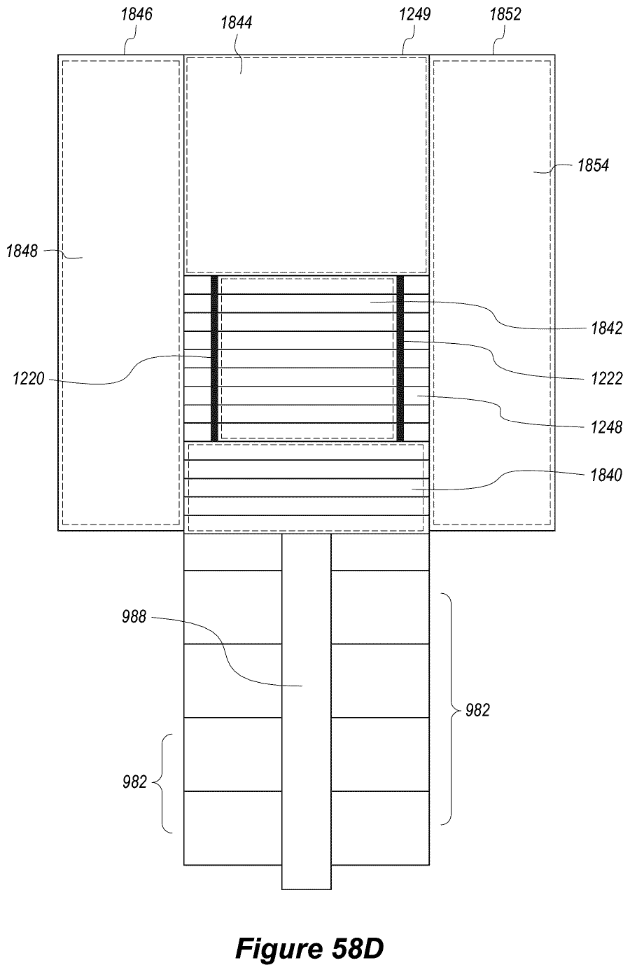

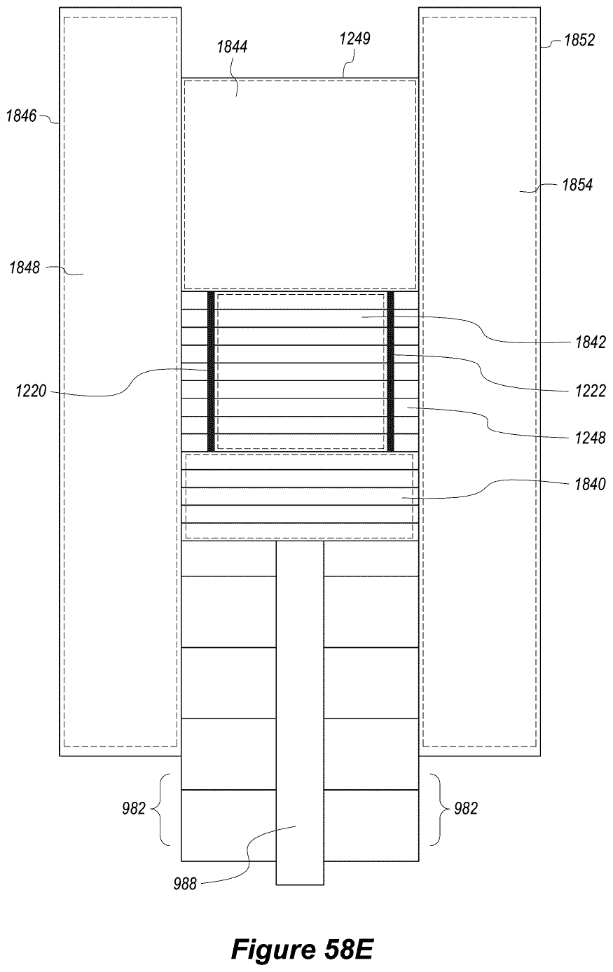

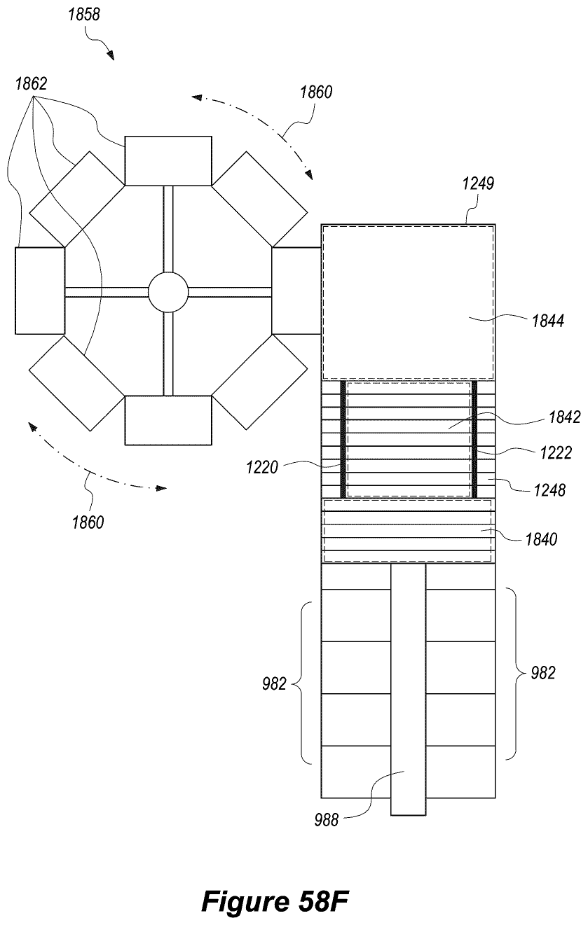

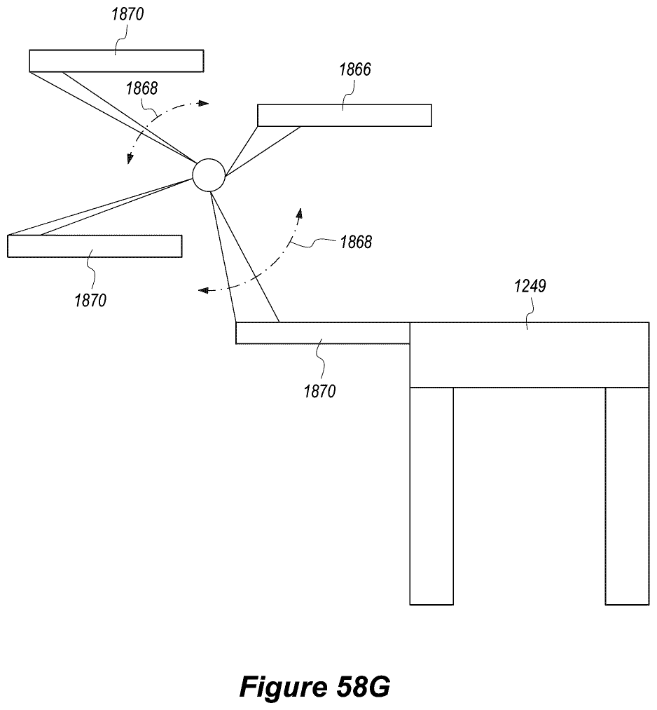

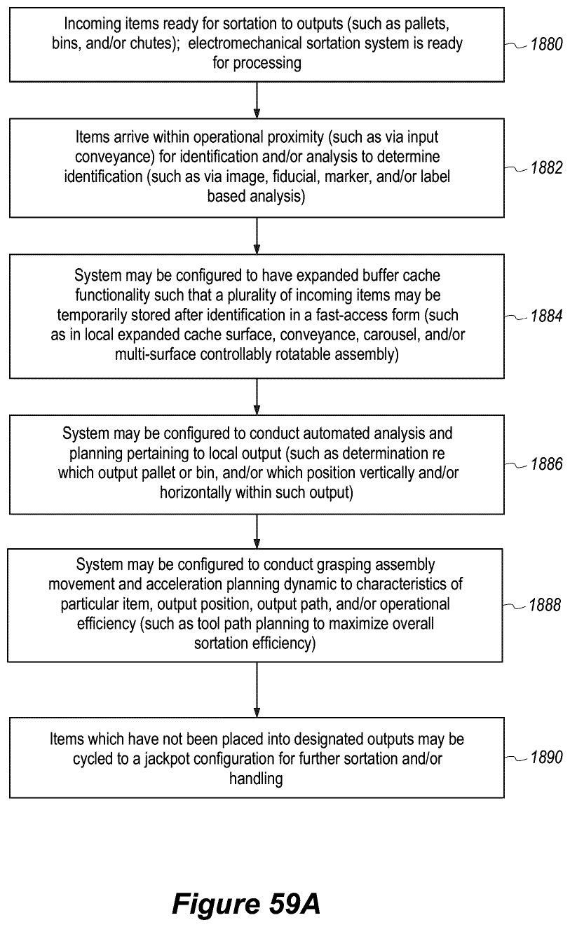

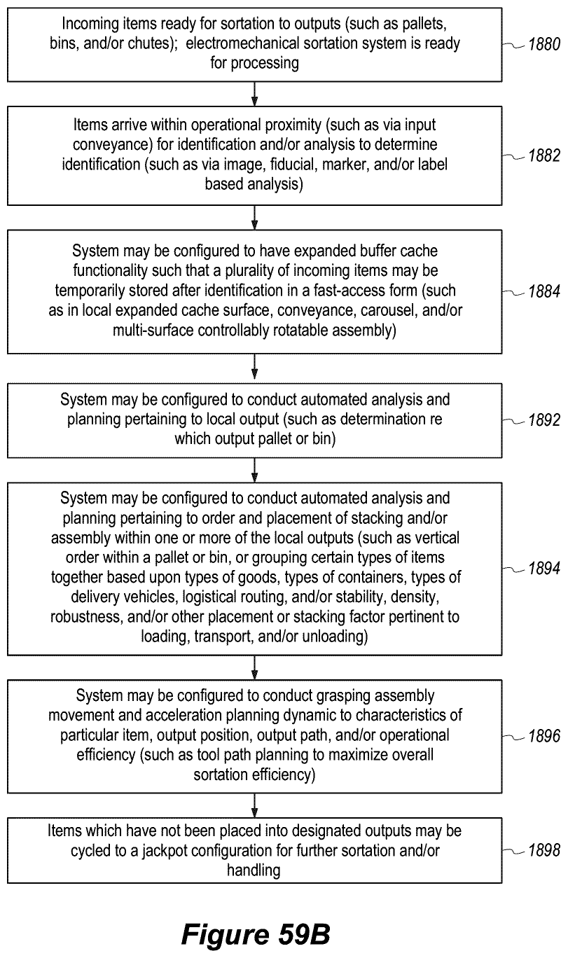

Referring to FIGS. 58A-58G and FIG. 59, utility of the surface area at the input portion of a sortation system such as those described herein (for example, gantry sortation units such as that illustrated in FIG. 39A, robotic arm/rail system sortation units such as that illustrated in FIG. 32C) may be maximized by increasing the functional “operational cache” of the available input surfaces so that a relatively large number of packages or items may be recalled and placed into sortation in a relatively short amount of time or operational steps. For example, it is possible that a small number of different types of packages need to be sorted from input to output containers or structures such as pallets. One may imagine a scenario wherein the universe of input headed toward a sortation system is either a red basketball in a cuboid cardboard box, or a yellow basketball in a cuboid cardboard box, each with distinct different labelling (i.e., red easily distinguishable by the system from yellow). With such a system, it may be the case that it doesn't matter to the associated business operation which color goes in which output container or structure (such as a pallet); in such case, there's literally no need for expanded operational cache at the input region, because every single incoming package may be immediately moved ahead toward an output container or structure. If it does matter which color is routed to which output container or structure (say all red balls are to go to Arkansas and all Yellow balls are to go to Los Angeles; or say that all red balls are to go to local high school A, while all yellow balls are to go to local elementary school B; or say that all red balls are to go to a local Target store, while all yellow balls are to go to a local Walmart store; or say that one delivery route or destination is to receive approximately equivalent numbers of yellow and red, while each other delivery route or destination is to receive a distinct color such as only yellow or only red; or say that twelve different pallet loads are each to receive a distinct number of specific colors due to specific ordering specifications), then it is useful to have at least some operational cache at the input region, such that certain identified colors may be temporarily stored in ready/quick access, so that they may be quickly recalled and placed into sortation in accordance with the sorting/routing plan for the output containers or structures. In other words, with greater operational cache at the input region, the sortation system may continue to move quickly through sortation while also efficiently providing for specific routing/sorting without as much sensitivity to the order of items coming from the conveyance or other input. In other words, if a particular output container needs three yellow basketballs and three red basketballs, but the input order from the conveyance ends up being 10 yellow and then 10 red, if the input configuration has the ability to route the first three yellows into sortation to the particular output container, cache the next seven, then route the first three reds into sortation to that same particular output container, it can keep moving and keep utilizing the operational cache to get the desired result (for example, after routing this first three yellows and three reds, it has seven yellows in cache, and seven reds coming through which may be cached also, or immediately routed for sortation, etc.; the system can keep moving efficiently and quickly to fulfill particular outputs, which may pertain to locations, delivery routes, delivery vehicles, distinct purchasors, etc.). With more operational cache, more sophisticated planning and execution is possible, and the system may also utilize neural network models for continued efficiency and speed gains, these models informed by supervised learning or synthetic learning, as well as reinforcement learning which may be informed by actual or synthetic scenarios.

Thus referring to FIGS. 58A and 58B, three regions (1844, 1842, 1840) of input region operational surface may be utilized as operational cache; the first (1844) may comprise a surface of an input conveyance system or table (1249) which may comprise a multi-axis conveyance (i.e., able to move items distinctly in X or Y orthogonal positions relative to the table, and also potentially reorient them rotationally); the second (1842) and third (1840) also may comprise portions of a multi-axis conveyance (i.e., able to move items distinctly in X or Y orthogonal positions relative to the table, and also potentially reorient them rotationally). Thus, operationally, when a given item that is temporarily stored in cache is needed front and center for sortation, it may be quickly diverted to such position and/or orientation to be moved ahead toward the output containers or structures. Referring to FIG. 58C, a configuration similar to that of FIG. 58B is illustrated, with the addition of a side table or conveyance (1846) providing an additional cache surface (1848) which may also comprise a multi-axis conveyance (i.e., able to move items distinctly in X or Y orthogonal positions relative to the table, and also potentially reorient them rotationally). Referring to FIG. 58D, a configuration similar to that of FIG. 58C is illustrated, with the addition of another side table or conveyance (1852) providing an additional cache surface (1854) which may also comprise a multi-axis conveyance (i.e., able to move items distinctly in X or Y orthogonal positions relative to the table, and also potentially reorient them rotationally). Referring to FIG. 58E, a configuration similar to that of FIG. 58D is illustrated with expanded surface area side cache tables or conveyances (1846, 1852) for expanded operational cache capability.

Referring to FIGS. 58F and 58G, in other embodiments, rotational assemblies (1858, 1866, respectively) may be utilized to rotationally (1860, 1868, respectively) and controllably present additional cache surfaces (1862—generally within the same plane as the input conveyance surfaces in FIG. 58F; 1870—generally in a ferris-wheel type of configuration wherein they may be rotated into a substantially coplanar functional availability with the adjacent input conveyance surface 1249 as shown in FIG. 58G) to the input region to functionally expand operational cache.

Thus referring to FIG. 59A, incoming items may be ready for sortation to outputs (such as pallets, bins, and/or chutes); electromechanical sortation system may be ready for processing (1880). Items may arrive within operational proximity (such as via input conveyance) for identification and/or analysis to determine identification (such as via image, fiducial, marker, and/or label based analysis) (1882). The system may be configured to have expanded buffer cache functionality such that a plurality of incoming items may be temporarily stored after identification in a fast-access form (such as in local expanded cache surface, conveyance, carousel, and/or multi-surface controllably rotatable assembly) (1884). The system may be configured to conduct automated analysis and planning pertaining to local output (such as determination re which output pallet or bin, and/or which position vertically and/or horizontally within such output) (1886). The system may be configured to conduct grasping assembly movement and acceleration planning dynamic to characteristics of particular item, output position, output path, and/or operational efficiency (such as tool path planning to maximize overall sortation efficiency) (1888). Items which have not been placed into designated outputs may be cycled to a jackpot configuration for further sortation and/or handling (1890).

Referring to FIG. 59B, another embodiment is illustrated wherein incoming items may be ready for sortation to outputs (such as pallets, bins, and/or chutes); electromechanical sortation system may be ready for processing (1880). Items may arrive within operational proximity (such as via input conveyance) for identification and/or analysis to determine identification (such as via image, fiducial, marker, and/or label based analysis) (1882). The system may be configured to have expanded buffer cache functionality such that a plurality of incoming items may be temporarily stored after identification in a fast-access form (such as in local expanded cache surface, conveyance, carousel, and/or multi-surface controllably rotatable assembly) (1884). The system may be configured to conduct automated analysis and planning pertaining to local output (such as determination re which output pallet or bin) (1892). The system may be configured to conduct automated analysis and planning pertaining to order and placement of stacking and/or assembly within one or more of the local outputs (such as vertical order within a pallet or bin, or grouping certain types of items together based upon types of goods, types of containers, types of delivery vehicles, logistical routing, and/or stability, density, robustness, and/or other placement or stacking factor pertinent to loading, transport, and/or unloading) (1894). The system may be configured to conduct grasping assembly movement and acceleration planning dynamic to characteristics of particular item, output position, output path, and/or operational efficiency (such as tool path planning to maximize overall sortation efficiency) (1896). Items which have not been placed into designated outputs may be cycled to a jackpot configuration for further sortation and/or handling (1898).

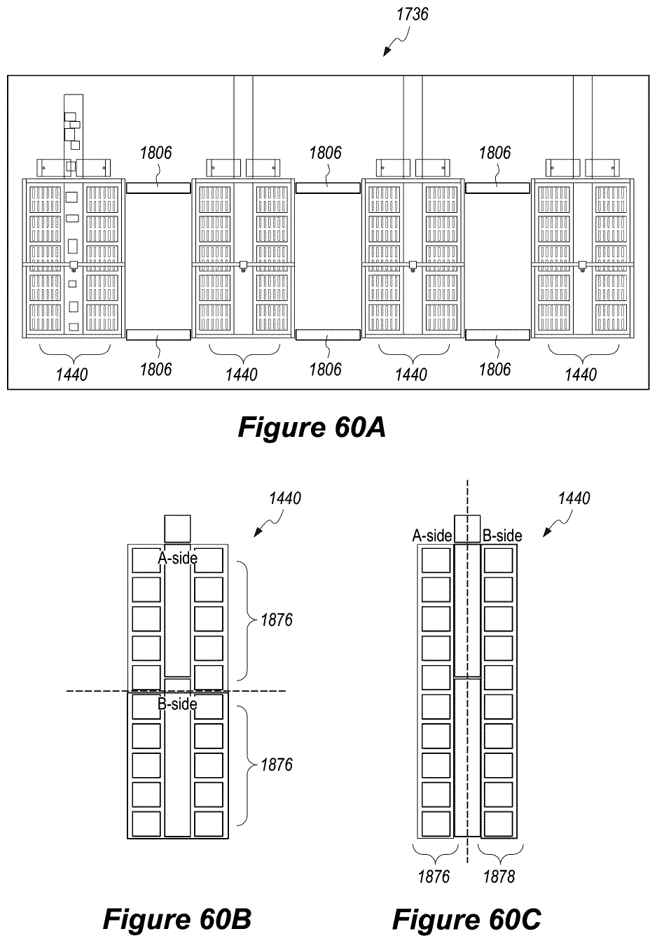

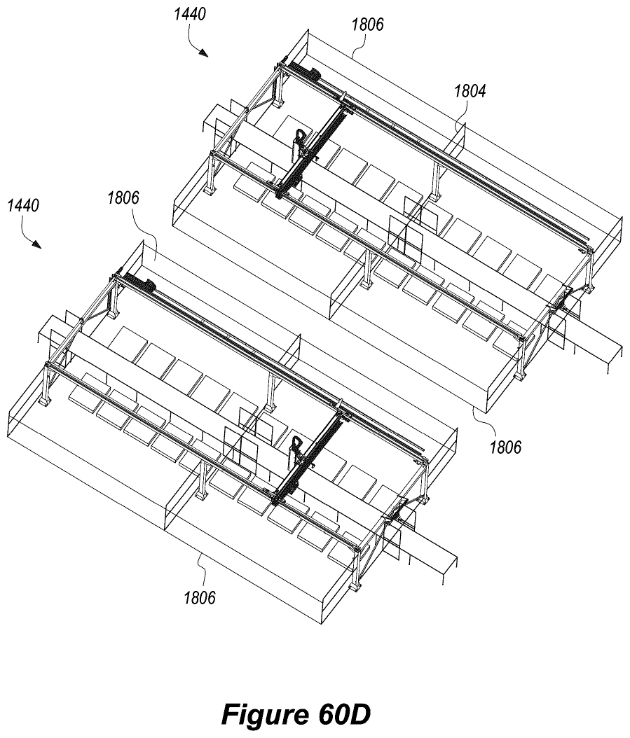

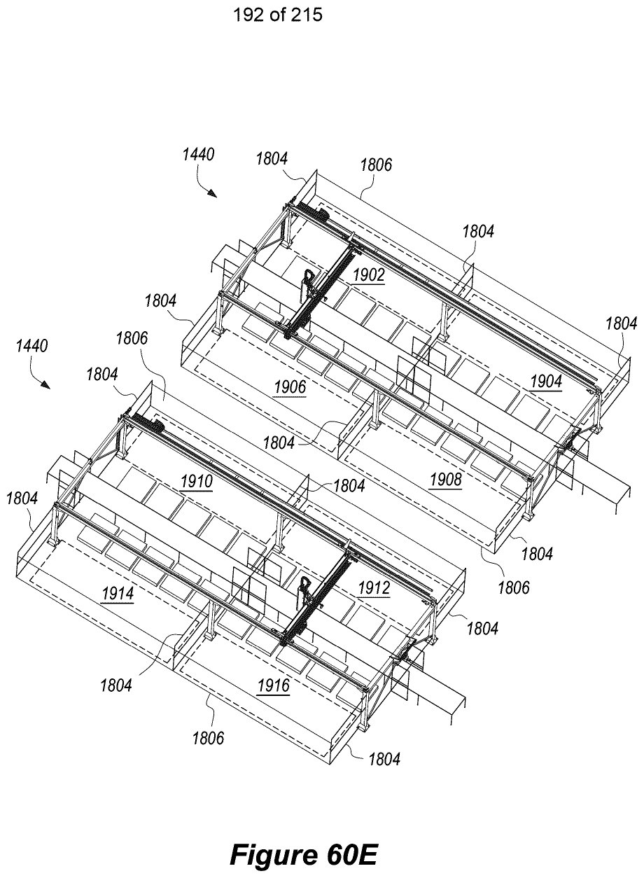

Referring to FIGS. 60A-60E, mechanical (1804) and electronic (1806) fence or isolation configurations may be utilized to isolate certain regions amongst operating sortation unit assemblies (1440), and/or to provide system level notification of intrusion into these regions. For example, referring to FIG. 60B, a given sortation unit assembly (1440) may be functionally divided into a first portion (1872) and a second portion (1874) using a fencing configuration (for example, mechanical 1804 or electronic 1806) so that one portion may be temporarily shut down while operations are continued in the other isolated portion. Similarly, a given sortation unit assembly (1440) may be functionally divided in half with one side (1876) separated from the other side (1878) using a fencing configuration (for example, mechanical 1804 or electronic 1806) so that so that one side may be temporarily shut down while operations are continued in the other isolated side. Referring to FIGS. 60D and 60E, configurations of adjacent sortation unit assemblies (1440) are shown utilizing both mechanical (1804) and electronic (1806) fencing configurations to provide eight or more (1902, 1904, 1906, 1908, 1910, 1912, 1914, 1916) work regions or areas which may be separately controlled in terms of access and notification.

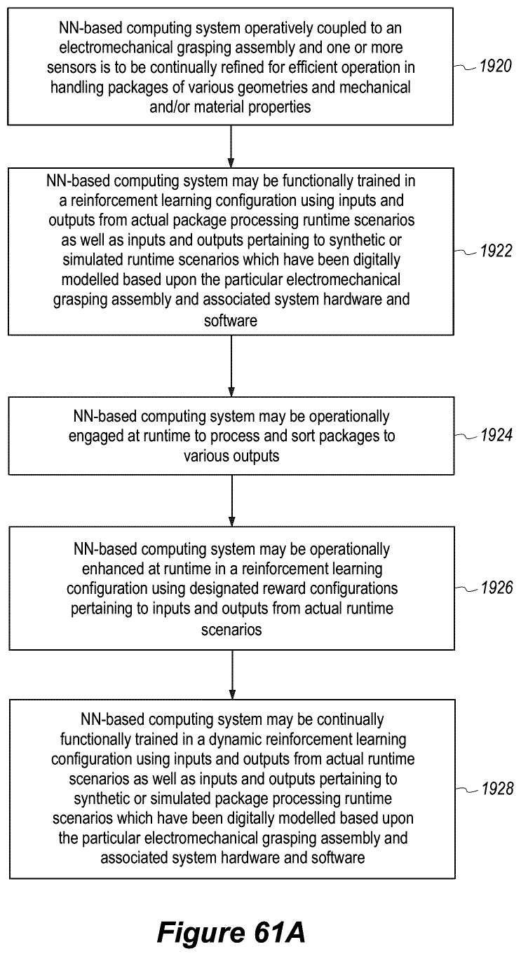

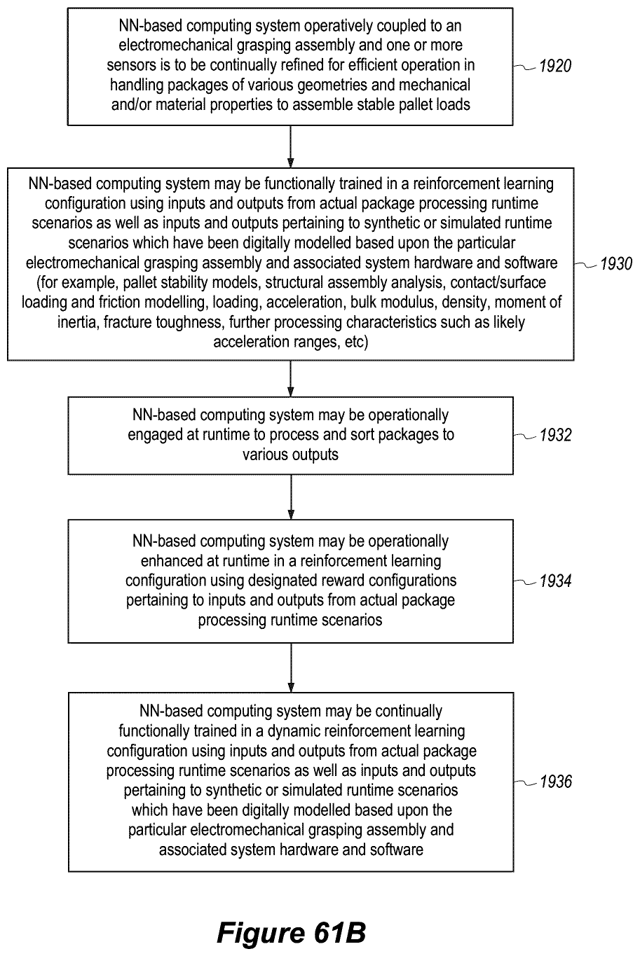

Referring to FIGS. 61A and 61B, as noted above, the subject neural network computing resources may be configured to benefit from simulation to assist with ultimate runtime exercise and operation, such as with a reward-based reinforcement learning configuration. Indeed, in various configurations, reinforcement learning may be conducted in simulation; such configuration may be assisted, at least in part, due to defined and constrained action space for the subject electromechanical systems and subsystems, the ability within the subject systems to simulate outcomes with a relatively high degree of reasonableness, and due to the notion that the subject reward functions may be made relatively clear (for example, reward to highest density of packing items into an output container in certain embodiments). Thus referring to FIG. 61A, a neural network (“NN”)-based computing system may be operatively coupled to an electromechanical grasping assembly and one or more sensors is to be continually refined for efficient operation in handling packages of various geometries and mechanical and/or material properties (1920). The NN-based computing system may be functionally trained in a reinforcement learning configuration using inputs and outputs from actual package processing runtime scenarios as well as inputs and outputs pertaining to synthetic or simulated runtime scenarios which have been digitally modelled based upon the particular electromechanical grasping assembly and associated system hardware and software (1922). The NN-based computing system may be operationally engaged at runtime to process and sort packages to various outputs (1924). The NN-based computing system may be operationally enhanced at runtime in a reinforcement learning configuration using designated reward configurations pertaining to inputs and outputs from actual runtime scenarios (1926). The NN-based computing system may be continually functionally trained in a dynamic reinforcement learning configuration using inputs and outputs from actual runtime scenarios as well as inputs and outputs pertaining to synthetic or simulated package processing runtime scenarios which have been digitally modelled based upon the particular electromechanical grasping assembly and associated system hardware and software (1928).

Referring to FIG. 61B, a NN-based computing system operatively coupled to an electromechanical grasping assembly and one or more sensors is to be continually refined for efficient operation in handling packages of various geometries and mechanical and/or material properties to assemble stable pallet loads (1920). The NN-based computing system may be functionally trained in a reinforcement learning configuration using inputs and outputs from actual package processing runtime scenarios as well as inputs and outputs pertaining to synthetic or simulated runtime scenarios which have been digitally modelled based upon the particular electromechanical grasping assembly and associated system hardware and software (for example, pallet stability models, structural assembly analysis, contact/surface loading and friction modelling, loading, acceleration, bulk modulus, density, moment of inertia, fracture toughness, further processing characteristics such as likely acceleration ranges, etc.) (1930). The NN-based computing system may be operationally engaged at runtime to process and sort packages to various outputs (1932). The NN-based computing system may be operationally enhanced at runtime in a reinforcement learning configuration using designated reward configurations pertaining to inputs and outputs from actual package processing runtime scenarios (1934). The NN-based computing system may be continually functionally trained in a dynamic reinforcement learning configuration using inputs and outputs from actual package processing runtime scenarios as well as inputs and outputs pertaining to synthetic or simulated runtime scenarios which have been digitally modelled based upon the particular electromechanical grasping assembly and associated system hardware and software (1936).

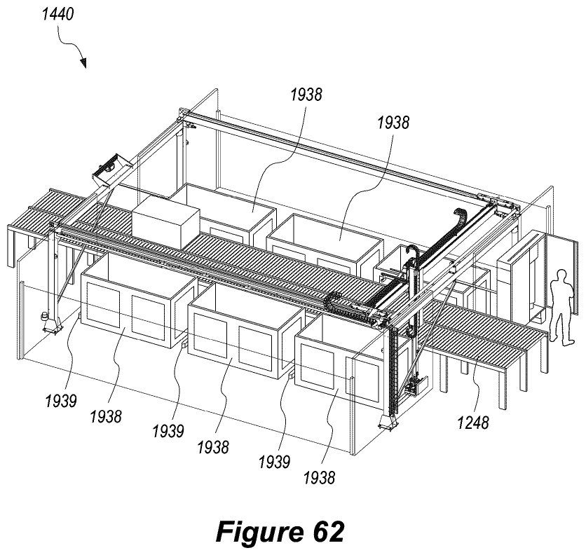

Referring to FIG. 62, a sortation unit assembly (1440) is shown sorting into relatively large output containers (1938) which may be configured to have mechanical features (1939; such as rigid rails and/or elongate sockets or interfaces) removably engageable by transportation equipment such as fork lifts, mobile robots, or pallet jacks to facilitate loading of such relatively large output containers (1938) directly into trucks or other vehicles, or storage locations.

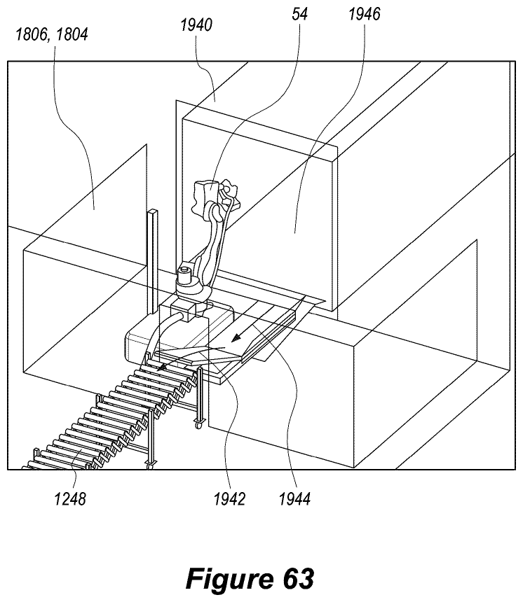

Referring to FIG. 63, a sortation robot (54) similar to those described above may be positioned adjacent a container structure (1940) such as a truck container or shipping container such that it may reach into the interior (1946) of the container structure (1940) to either load or unload packages or items from the container structure (1940). An isolation configuration (such as a mechanical or electronic fence; 1806, 1804) may be present to isolate the robot (54) or flag presence nearby. An input or output (depending upon loading or unloading activity) conveyance (1248) may be operatively coupled to the container structure (1940) using a ramped conveyance (1942) configured to provide a conveyance path (1944) for packages released by the robot (54) after successful grasping from within the interior (1946) of the container (1940) and release upon the ramped conveyance (1942; i.e., in the case of unloading; reverse for loading).

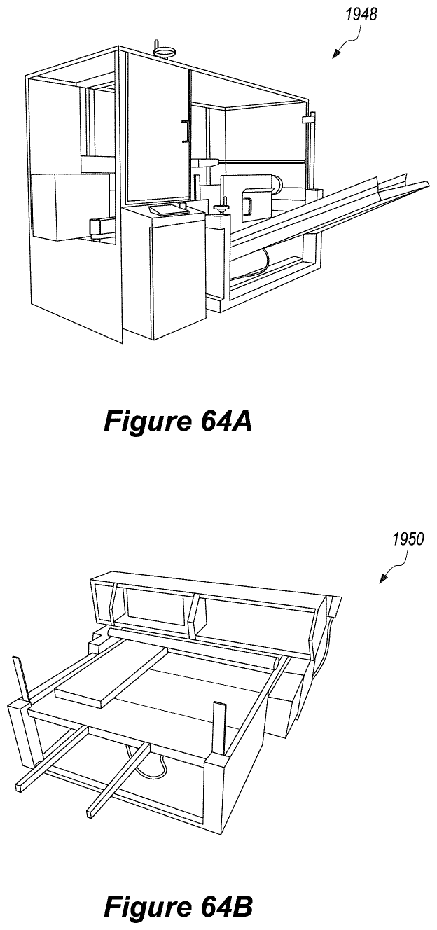

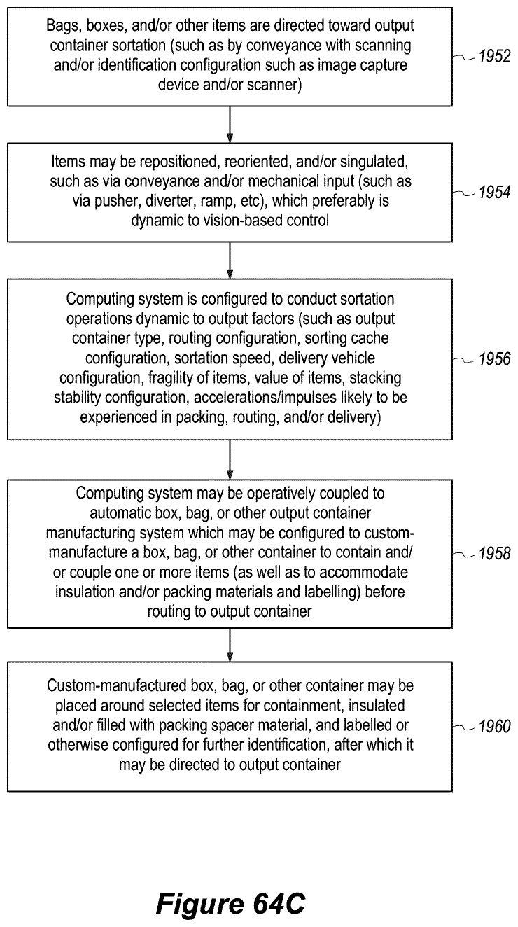

Referring to FIGS. 64A and 64B, two automatic and electromechanical boxing and/or bagging subsystems (1948, 1950) are shown which may be configured to create a box or bag configured to efficiently contain one or more given items. Systems such as these may be integrated to provide for efficient packing of items for distribution and shipping without undue additional empty volume in the pertinent box, bag, or other container. These systems may be configured to accommodate room for insulation and/or packing materials such as air cushions, blown-in recycled paper fiber, and other insulation and/or cushioning structures and/or materials.

Thus referring to FIG. 64C, bags, boxes, and/or other items may be directed toward output container sortation (such as by conveyance with scanning and/or identification configuration such as image capture device and/or scanner) (1952). Items may be repositioned, reoriented, and/or singulated, such as via conveyance and/or mechanical input (such as via pusher, diverter, ramp, etc.), which preferably is dynamic to vision-based control (1954). An operatively coupled computing system may be configured to conduct sortation operations dynamic to output factors (such as output container type, routing configuration, sorting cache configuration, sortation speed, delivery vehicle configuration, fragility of items, value of items, stacking stability configuration, accelerations/impulses likely to be experienced in packing, routing, and/or delivery) (1956). The computing system may be operatively coupled to automatic box, bag, or other output container manufacturing system which may be configured to custom-manufacture a box, bag, or other container to contain and/or couple one or more items (as well as to accommodate insulation and/or packing materials and labelling) before routing to output container (1958). A custom-manufactured box, bag, or other container may be placed around selected items for containment, insulated and/or filled with packing spacer material, and labelled or otherwise configured for further identification, after which it may be directed to output container (1960).

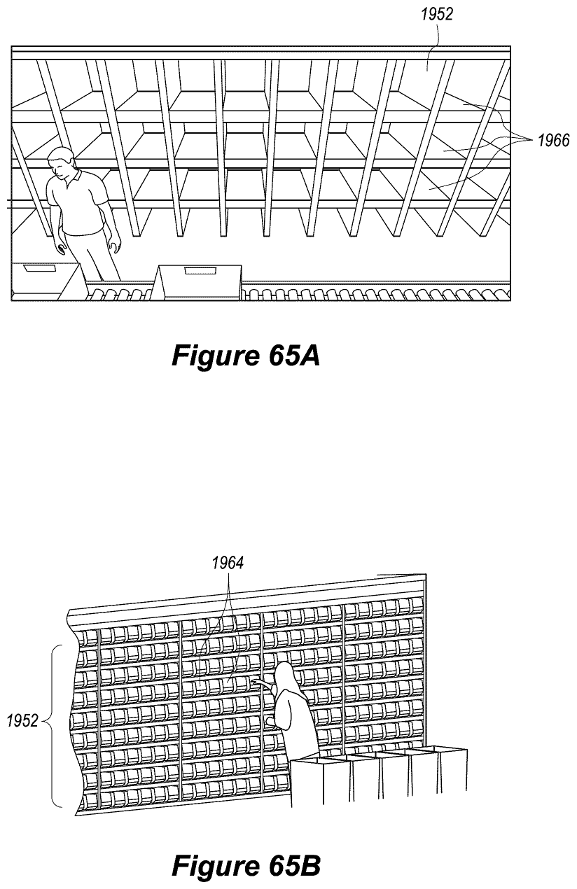

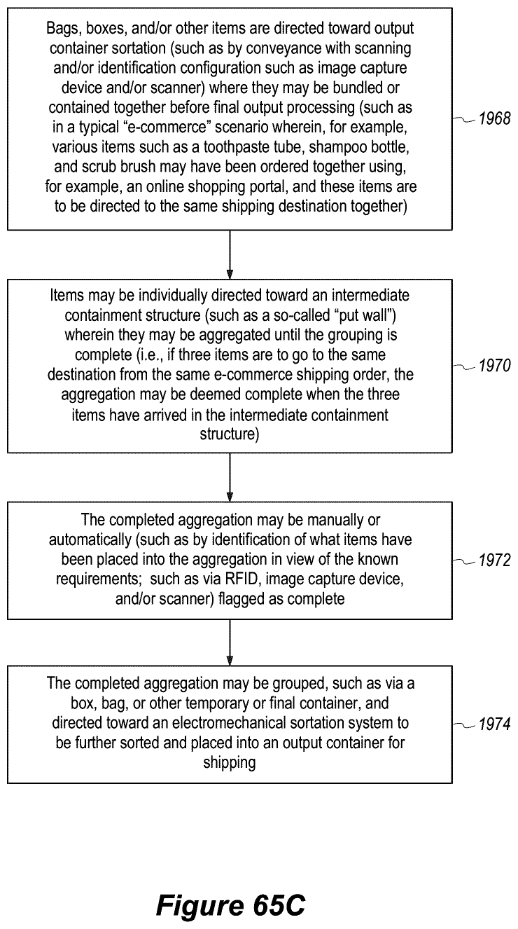

Referring to FIGS. 65A and 65B, certain fulfillment configurations may be processed using an intermediate containment structure such as a bin, shelf, box, or other structure (1964, 1966); an assembly of a plurality of these structures (1952) may be known as a “put-wall”, and may be effectively utilized in assembly of various items (such as in so-called “e-commerce” transaction fulfillment wherein various items often are aggregated together for shipping, such as a toothbrush and shampoo bottle) before passing a group further downstream toward pack-out and delivery. A put-wall may represent a simple structure, or may be integrated with one or more sensors (such as one or more image capture devices, scanners, and/or RFID readers) to detect presence of and identify various items within a particular location of the put-wall; similarly a put-wall may have controls integration to detect or determine (and also to signal or otherwise communicate to nearby personnel or operatively coupled computing resources) when an assembly is ready for transfer, or when it still requires one or more addition items for completion before transfer out.

Thus referring to FIG. 65C, bags, boxes, and/or other items are directed toward output container sortation (such as by conveyance with scanning and/or identification configuration such as image capture device and/or scanner) where they may be bundled or contained together before final output processing (such as in a typical “e-commerce” scenario wherein, for example, various items such as a toothpaste tube, shampoo bottle, and scrub brush may have been ordered together using, for example, an online shopping portal, and these items are to be directed to the same shipping destination together) (1968). The items may be individually directed toward an intermediate containment structure (such as a so-called “put wall”) wherein they may be aggregated until the grouping is complete (i.e., if three items are to go to the same destination from the same e-commerce shipping order, the aggregation may be deemed complete when the three items have arrived in the intermediate containment structure) (1970). The completed aggregation may be manually or automatically (such as by identification of what items have been placed into the aggregation in view of the known requirements; such as via RFID, image capture device, and/or scanner) flagged as complete (1972). The completed aggregation may be grouped, such as via a box, bag, or other temporary or final container, and directed toward an electromechanical sortation system to be further sorted and placed into an output container for shipping (1974).

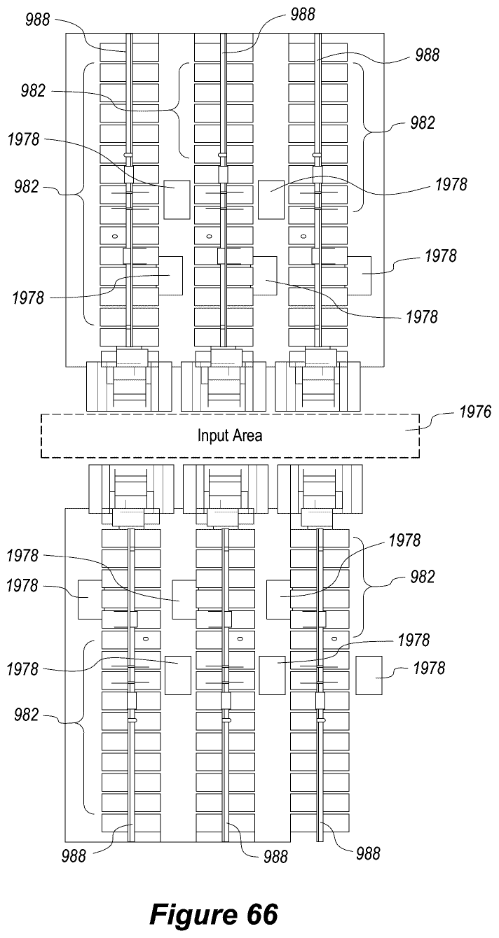

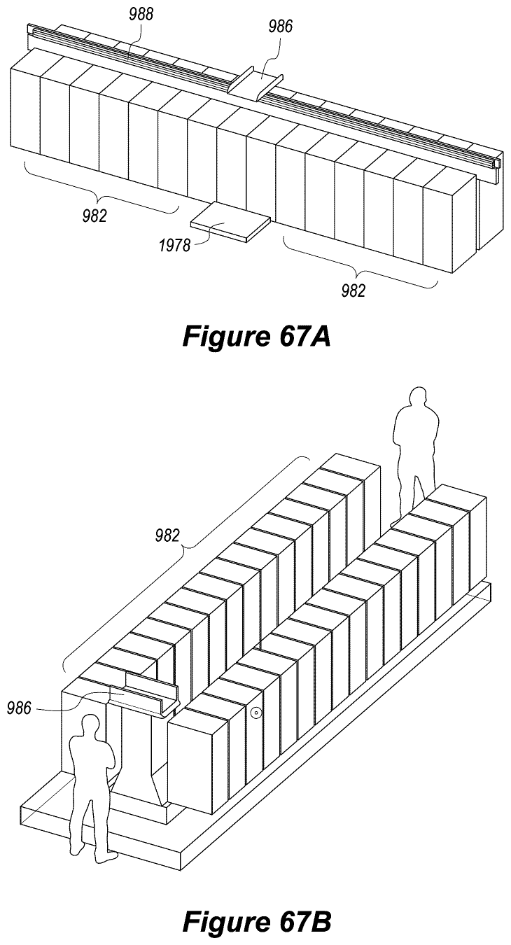

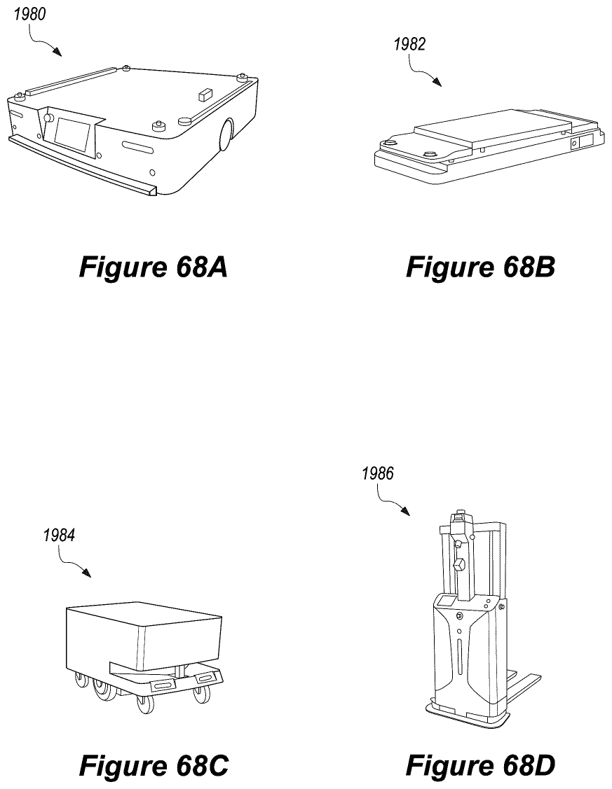

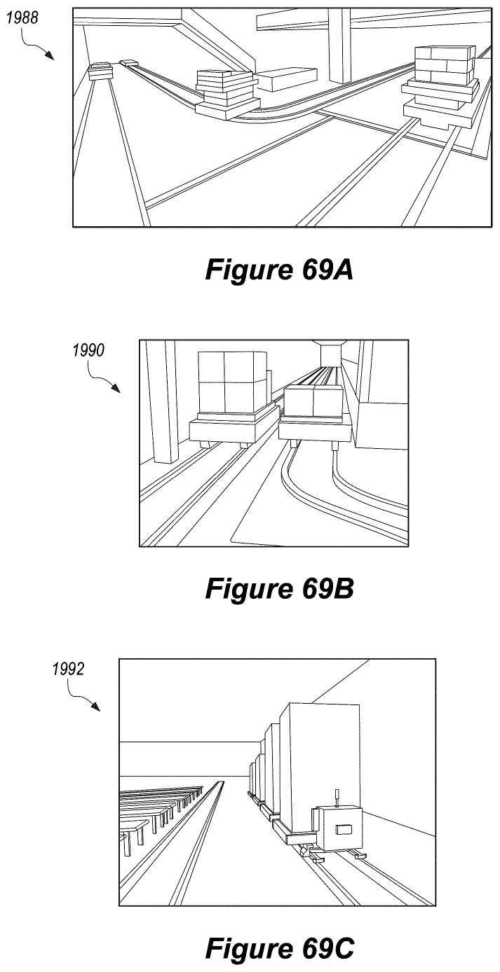

Referring to FIG. 66, various sortation systems, such as rail (988) based sortation systems such as those described above, may be positioned adjacent each other around a shared input area (1976) while automated electromechanical systems such as AMRs (automated mobile robots, such as those with mobile bases configured to navigate surfaces such as floors) or transportation robots (1978) may be utilized to continuously and efficiently retrieve completed output containers (982) and move them downstream in processing in an integrated manner. FIGS. 67A and 67B illustrate orthogonal views of similar systems, wherein tilt tray distribution subsystems (986) electromechanically coupled to rail transport modules (988) may be utilized to fill output containers (982) such that they may be moved away to pack-out by mobile robot systems/AMRs (1978) or other transportation systems automatically after completed output container (982) fulfillment. Referring to FIGS. 68A-68D, various electromechanical robotic/AMR systems (1980, 1982, 1984, 1986) are illustrated and are available from various manufacturers in configurations ready for various forms of automation. Referring to FIGS. 69A-69C, various rail systems (1988, 1990, 1992) may be utilized to automatically move various packages, items, and/or output containers through prescribed rail pathways.

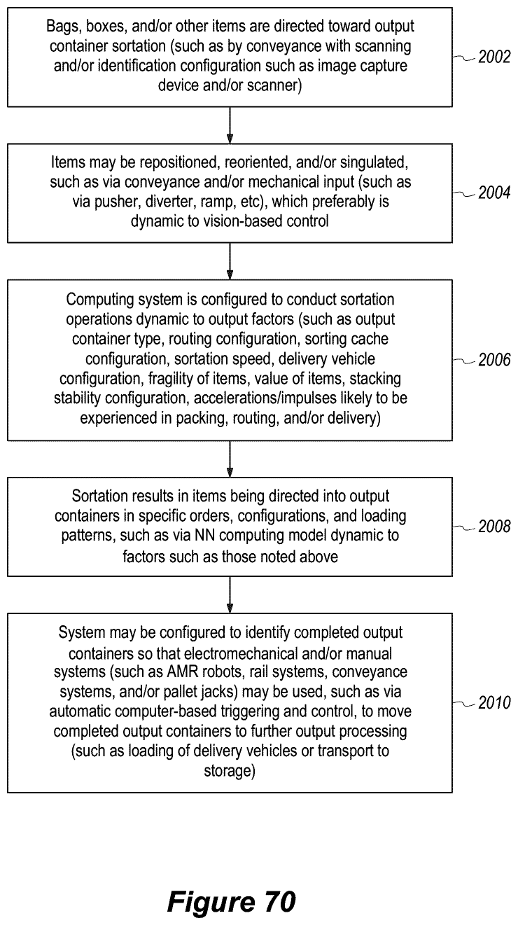

Thus referring to FIG. 70, bags, boxes, and/or other items may be directed toward output container sortation (such as by conveyance with scanning and/or identification configuration such as image capture device and/or scanner) (2002). The items may be repositioned, reoriented, and/or singulated, such as via conveyance and/or mechanical input (such as via pusher, diverter, ramp, etc.), which preferably is dynamic to vision-based control (2004). An operatively coupled computing system or resource may be configured to conduct sortation operations dynamic to output factors (such as output container type, routing configuration, sorting cache configuration, sortation speed, delivery vehicle configuration, fragility of items, value of items, stacking stability configuration, accelerations/impulses likely to be experienced in packing, routing, and/or delivery) (2006). Sortation may be configured to result in items being directed into output containers in specific orders, configurations, and loading patterns, such as via NN computing model dynamic to factors such as those noted above (2008). The system may be configured to identify completed output containers so that electromechanical and/or manual systems (such as AMR robots, rail systems, conveyance systems, and/or pallet jacks) may be used, such as via automatic computer-based triggering and control, to move completed output containers to further output processing (such as loading of delivery vehicles or transport to storage) (2010).

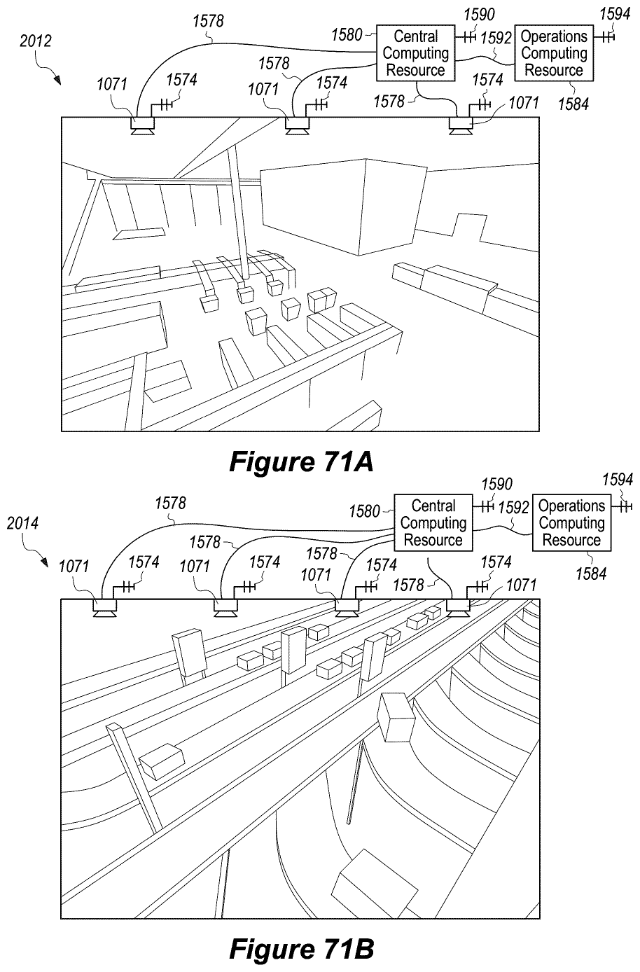

Referring to FIGS. 71A and 71B, in addition to the various sensors, trackers, scanners, and other subsystems at work in an integrated processing environment such as those (2012, 2014) illustrated, additional image capture devices (1071) may be operatively coupled (such as by wireless 1574, 1590, 1594 or wired 1578, 1592 connectivity) to intercoupled central computing resources (1580) and/or operations computing resources (1584) to assist in generally tracking activity within the field of view, or fields of view in the case of a plurality if image capture devices (1071) as shown. Distributed image capture devices (1071) may be configured to have different and overlapping or adjacent fields of view to assist in tracking a broad area from one or more vectors. Such a system may be utilized to assist in maintaining identification and/or tracking of the various packages or items within the field of view, and may be utilized as redundancy when a particular package has become lost or un-identified notwithstanding other local sensors. In other words, rather than sending a transiently unidentified package back to jackpot or start of processing, the identification may be re-determined using information from the entire superset of sensors (i.e., even if local scan tunnel or image capture device has lost or missed the scan or identification image capture, the additional systems above 1071 may have such information so that it can be utilized to re-identify and/or redundantly track a given item).

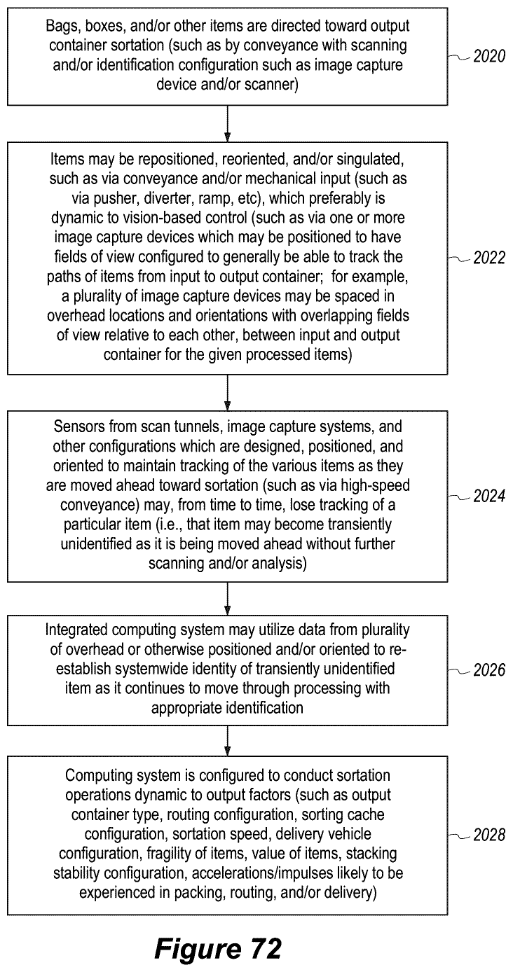

Thus referring to FIG. 72, bags, boxes, and/or other items are directed toward output container sortation (such as by conveyance with scanning and/or identification configuration such as image capture device and/or scanner) (2020). Items may be repositioned, reoriented, and/or singulated, such as via conveyance and/or mechanical input (such as via pusher, diverter, ramp, etc.), which preferably is dynamic to vision-based control (such as via one or more image capture devices which may be positioned to have fields of view configured to generally be able to track the paths of items from input to output container; for example, a plurality of image capture devices may be spaced in overhead locations and orientations with overlapping fields of view relative to each other, between input and output container for the given processed items) (2022). Sensors from scan tunnels, image capture systems, and other configurations which are designed, positioned, and oriented to maintain tracking of the various items as they are moved ahead toward sortation (such as via high-speed conveyance) may, from time to time, lose tracking of a particular item (i.e., that item may become transiently unidentified as it is being moved ahead without further scanning and/or analysis) (2024). Integrated computing resources may utilize data from plurality of overhead or otherwise positioned and/or oriented to re-establish systemwide identity of transiently unidentified item as it continues to move through processing with appropriate identification (2026). The integrated computing resources may be configured to conduct sortation operations dynamic to output factors (such as output container type, routing configuration, sorting cache configuration, sortation speed, delivery vehicle configuration, fragility of items, value of items, stacking stability configuration, accelerations/impulses likely to be experienced in packing, routing, and/or delivery) (2028).

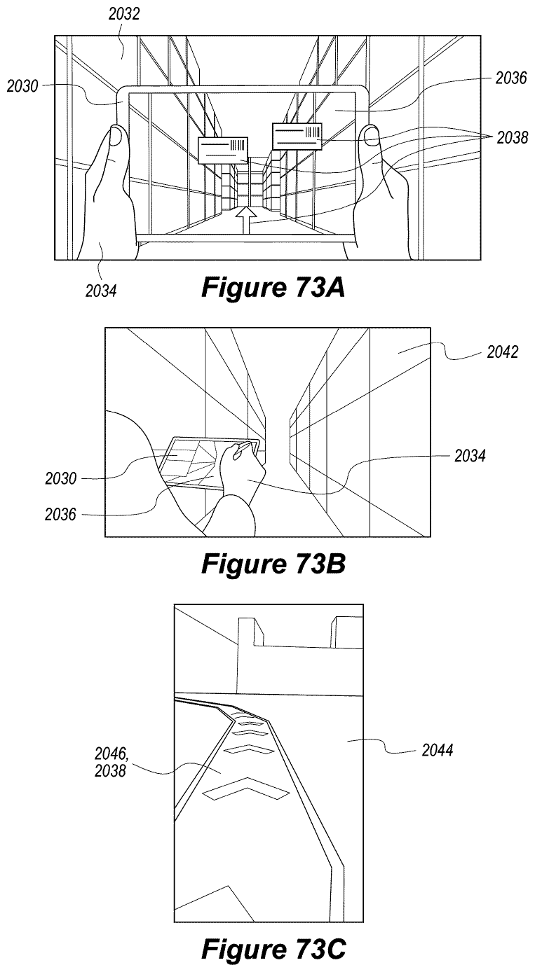

Referring to FIGS. 73A-73C, various so-called “augmented reality” configurations may be utilized to assist operators when working to identify, find, move, or otherwise process items within warehouses (2032), trucks (2042), driveways (2044), or other locations through the assistance of smartphones, tablets, wearable devices, or other portable computing devices (2030) with displays/user interfaces (2036) which may be configured to provide visualization of virtual (i.e., overlaid upon a view of actual reality) information (2038) such as visual (or audible in other configurations) signals, meta data, labels, indicators, instructions, arrows, pathway indicators (2046), mapping information, navigation information, or other information which may be helpful for the operator (2034).

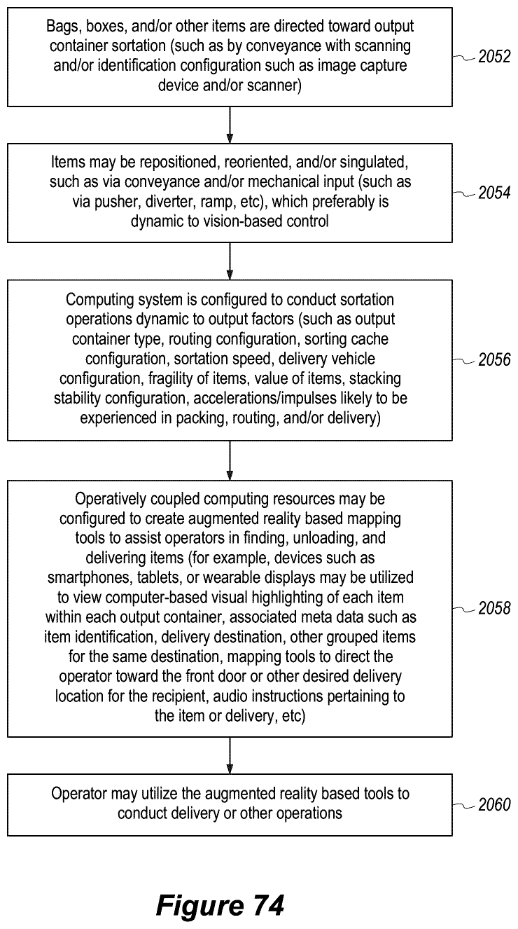

Thus referring to FIG. 74, bags, boxes, and/or other items are directed toward output container sortation (such as by conveyance with scanning and/or identification configuration such as image capture device and/or scanner) (2052). The items may be repositioned, reoriented, and/or singulated, such as via conveyance and/or mechanical input (such as via pusher, diverter, ramp, etc.), which preferably is dynamic to vision-based control (2054). Operatively coupled computing resources may be configured to conduct sortation operations dynamic to output factors (such as output container type, routing configuration, sorting cache configuration, sortation speed, delivery vehicle configuration, fragility of items, value of items, stacking stability configuration, accelerations/impulses likely to be experienced in packing, routing, and/or delivery) (2056). Operatively coupled computing resources may be configured to create augmented reality based mapping tools to assist operators in finding, unloading, and delivering items (for example, devices such as smartphones, tablets, or wearable displays may be utilized to view computer-based visual highlighting of each item within each output container, associated meta data such as item identification, delivery destination, other grouped items for the same destination, mapping tools to direct the operator toward the front door or other desired delivery location for the recipient, audio instructions pertaining to the item or delivery, etc.) (2058). An operator may utilize the augmented reality based tools to conduct delivery or other operations (2060).

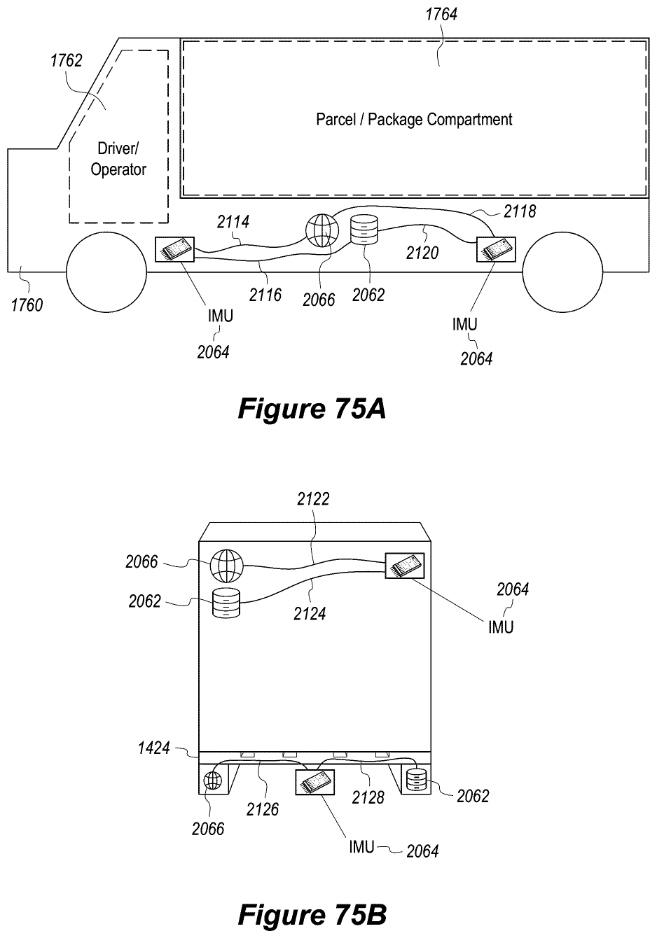

Referring to FIGS. 75A and 75B, accelerometers, gyros, and/or inertial measurement units (“IMU” 2064) may be coupled to various structures to determine and track accelerations, loading, and other factors pertinent to loading and delivery preparation (i.e., without breakage, with optimal packaging, etc.), as operatively coupled (2114, 2116, 2118, 2120, 2122, 2124, 2126, 2128; or wirelessly coupled such as via 802.11, Bluetooth, or similar configuration) with location tracking sensors (2066; such as GPS, cellphone triangulation, network ID, or other) and storage devices (2062; such as nonvolatile flash memory). In other words, referring back to FIG. 75A, accelerations, impulse loads, and other factors pertaining to delivery success may be tracked relative to location for given routes, trucks, truck suspension types, and other relevant factors-and these may be taken into account when an electromechanical sortation system is preparing output containers for transportation. For example, if a known route is to be pursued which is known, due to previous sensing, to have relatively large impulses and accelerations, more padding/insulation may be added to packing materials around a fragile item, and greater item stacking stability may be desired and executed, to promote successful delivery, and/or a vehicle with an air-suspension and smoother loading profile may be loaded for the particular mission, etc. FIG. 75B illustrate that the sensing capabilities may be integrated not only into vehicles as in FIG. 75A, but also into almost any other pertinent structure, such as an output container (982) box, or pallet (1424).

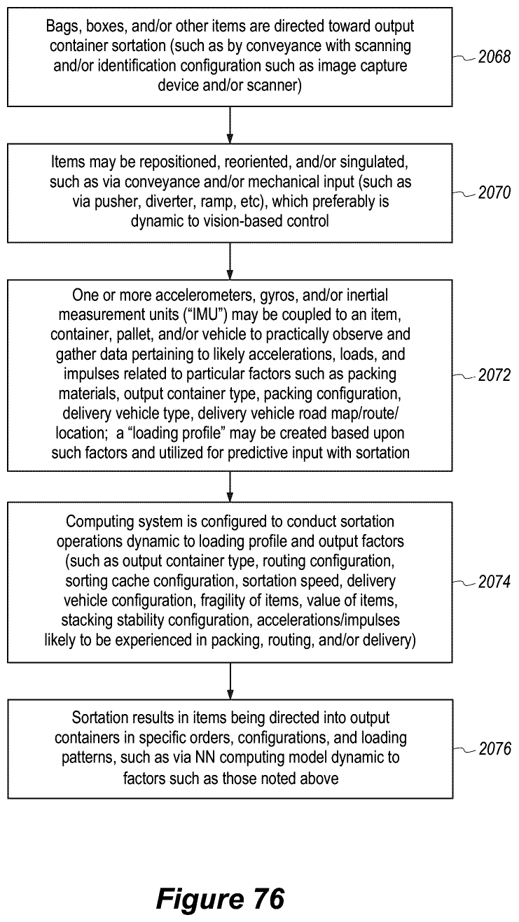

Thus referring to FIG. 76, bags, boxes, and/or other items are directed toward output container sortation (such as by conveyance with scanning and/or identification configuration such as image capture device and/or scanner) (2068). Items may be repositioned, reoriented, and/or singulated, such as via conveyance and/or mechanical input (such as via pusher, diverter, ramp, etc.), which preferably is dynamic to vision-based control (2070). One or more accelerometers, gyros, and/or inertial measurement units (“IMU”) may be coupled to an item, container, pallet, and/or vehicle to practically observe and gather data pertaining to likely accelerations, loads, and impulses related to particular factors such as packing materials, output container type, packing configuration, delivery vehicle type, delivery vehicle road map/route/location; a “loading profile” may be created based upon such factors and utilized for predictive input with sortation (2072). Operatively coupled computing resources may be configured to conduct sortation operations dynamic to loading profile and output factors (such as output container type, routing configuration, sorting cache configuration, sortation speed, delivery vehicle configuration, fragility of items, value of items, stacking stability configuration, accelerations/impulses likely to be experienced in packing, routing, and/or delivery) (2074). Sortation may result in items being directed into output containers in specific orders, configurations, and loading patterns, such as via NN computing model dynamic to factors such as those noted above (2076).

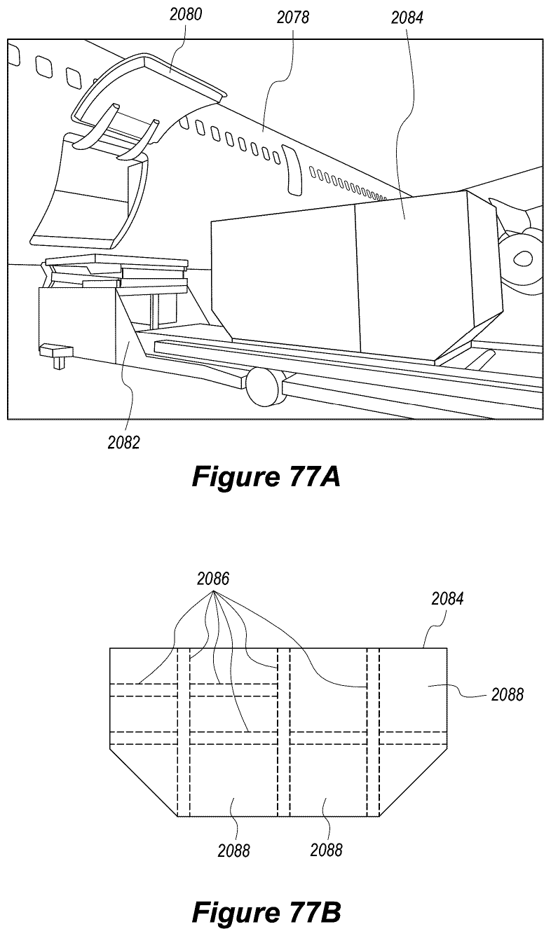

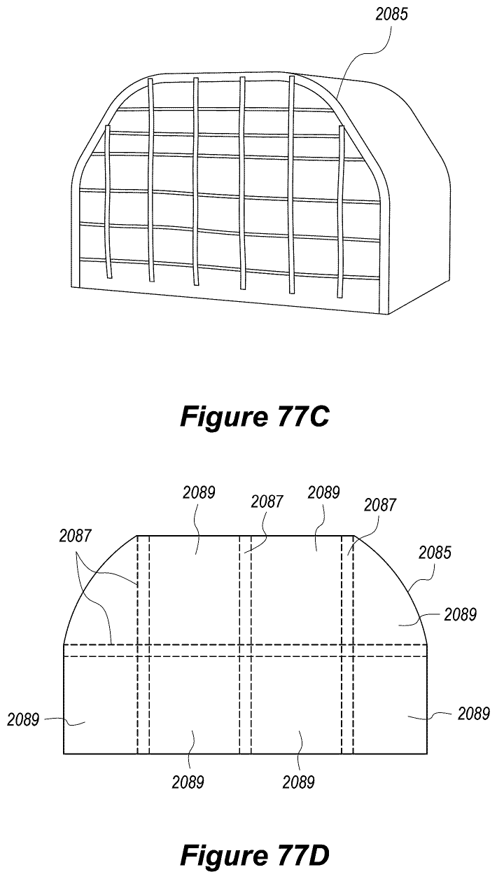

Referring to FIGS. 77A-77D, the above described configurations may be utilized for assisting with air cargo loading, unloading, and general logistics. Referring to FIG. 77A, an airplane (2078) cargo door (2080) may be utilized to accommodate one or more air cargo containers (2084) which may be transported by specialized vehicles (2082) and which may comprise peculiar shapes configured to maximize utilization of available fuselage volumes within the aircraft (2078). Such containers (2084) may have structural members and/or dividers (2086) which define usable volumes (2088) which may be loaded by sortation/processing systems such as those described above, which may be configured to electromechanically move packages, bags, or other items from various intermediate containers, output containers, and/or conveyance configurations directly into the usable volumes (2088), such as via electromechanical sortation and placement using telescoping and/or multi-degree-of-freedom robotic manipulation. FIGS. 77C and 77D illustrate aspects of a different air cargo container (2085) with different internal structures (2087) providing different usable volumes (2089) which may be loaded, or unloaded, as the case may desire, using vision-based electromechanical systems as described herein.

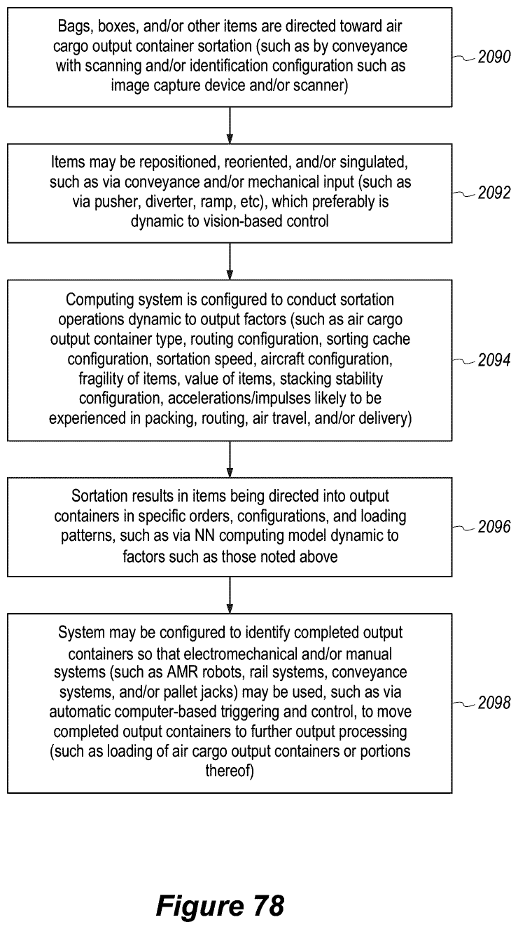

Referring to FIG. 78, bags, boxes, and/or other items are directed toward air cargo output container sortation (such as by conveyance with scanning and/or identification configuration such as image capture device and/or scanner) (2090). Items may be repositioned, reoriented, and/or singulated, such as via conveyance and/or mechanical input (such as via pusher, diverter, ramp, etc.), which preferably is dynamic to vision-based control (2092). Operatively coupled computing resources may be configured to conduct sortation operations dynamic to output factors (such as air cargo output container type, routing configuration, sorting cache configuration, sortation speed, aircraft configuration, fragility of items, value of items, stacking stability configuration, accelerations/impulses likely to be experienced in packing, routing, air travel, and/or delivery) (2094). Sortation may result in items being directed into output containers in specific orders, configurations, and loading patterns, such as via NN computing model dynamic to factors such as those noted above (2096). The integrated system may be configured to identify completed output containers so that electromechanical and/or manual systems (such as AMR robots, rail systems, conveyance systems, and/or pallet jacks) may be used, such as via automatic computer-based triggering and control, to move completed output containers to further output processing (such as loading of air cargo output containers or portions thereof) (2098).

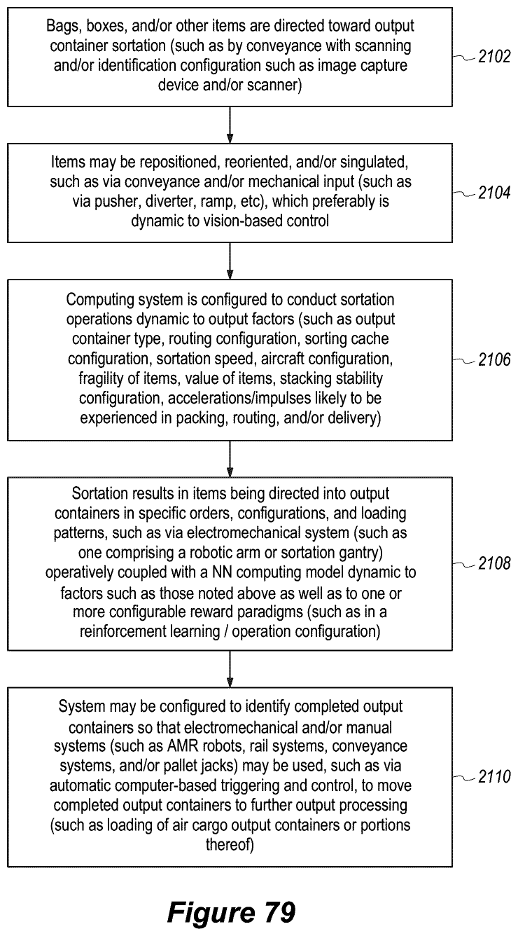

Referring to FIG. 79, in another embodiment, bags, boxes, and/or other items are directed toward output container sortation (such as by conveyance with scanning and/or identification configuration such as image capture device and/or scanner) (2101). Items may be repositioned, reoriented, and/or singulated, such as via conveyance and/or mechanical input (such as via pusher, diverter, ramp, etc.), which preferably is dynamic to vision-based control (2104). Operatively coupled computing resources may be configured to conduct sortation operations dynamic to output factors (such as output container type, routing configuration, sorting cache configuration, sortation speed, aircraft configuration, fragility of items, value of items, stacking stability configuration, accelerations/impulses likely to be experienced in packing, routing, and/or delivery) (2106). Sortation may result in items being directed into output containers in specific orders, configurations, and loading patterns, such as via electromechanical system (such as one comprising a robotic arm or sortation gantry) operatively coupled with a NN computing model dynamic to factors such as those noted above as well as to one or more configurable reward paradigms (such as in a reinforcement learning/operation configuration) (2108). The integrated system may be configured to identify completed output containers so that electromechanical and/or manual systems (such as AMR robots, rail systems, conveyance systems, and/or pallet jacks) may be used, such as via automatic computer-based triggering and control, to move completed output containers to further output processing (such as loading of air cargo output containers or portions thereof) (2110).

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1-52. (canceled)

53. A robotic package handling system, comprising:
an end effector assembly configured to transfer one or more packages from an input assembly to an output assembly, wherein the input assembly is configured to have a plurality of surfaces configured for transient storage of packages in an operational cache configuration;
a first imaging device positioned and oriented to capture image information pertaining to the one or more packages;
a first computing system operatively coupled to the end effector assembly and the first imaging device, and configured to receive the image information from the first imaging device and command movements of the end effector assembly based at least in part upon the image information;
wherein the input assembly is operatively coupled to the first computing system and configured to be operated by the first computing system based at least in part upon the image information to mechanically process a plurality of incoming packages to provide a supply of packages to be transferred to the input assembly; and
wherein the first computing system is configured to operate the end effector assembly to move a targeted package of the one or more packages from the input assembly based at least in part upon the image information, and release the targeted package to be at least transiently coupled with the output assembly with a position and orientation based at least in part upon the image information.

54. The system of claim 53, wherein the operational cache configuration is electromechanically movable to provide additional transient storage surfaces.

55. The system of claim 53, wherein the end effector assembly comprises a first suction cup assembly coupled to a controllably activated vacuum load operatively coupled to the first computing system, the first suction cup assembly configured such that operating the end effector assembly to move a targeted package comprises engaging the targeted package and controllably activating the vacuum load.

56. The system of claim 55, wherein the end effector assembly is coupled to a robotic arm.

57. The system of claim 56, wherein the robotic arm is configured to controllably removably couple to the targeted package from one of the plurality of surfaces of the input assembly, and to controllably place and removably couple from the targeted package to be at least transiently coupled with the output assembly.

58. The system of claim 53, wherein the first imaging device comprises a camera.

59. The system of claim 53, wherein the first imaging device comprises a stereoscopic camera assembly.

60. The system of claim 53, wherein the first imaging device comprises a depth camera.

61. The system of claim 53, wherein the input assembly is configured to be operated by the first computing system to control the supply of packages based at least in part upon a number of the one or more packages transiently coupled to output assembly.

62. The system of claim 53, wherein the input assembly is configured to be operated by the first computing system to control the supply of packages based at least in part upon the image information pertaining to the one or more packages at the input assembly.

63. The system of claim 53, further comprising a second image capture device operatively coupled to the first computing system and configured to capture information pertaining to the one or more packages on the input assembly.

64. The system of claim 53, further comprising a second image capture device operatively coupled to the first computing system and configured to capture information pertaining to the one or more packages on the output assembly.

65. The system of claim 53, wherein the first image capture device is positioned and oriented to capture information pertaining to packages being moved from the input assembly to the output assembly.

66. The system of claim 53, wherein the input assembly comprises an electromechanical conveyance.

67. The system of claim 15, wherein at least a portion of the conveyance comprises a multi-axis electromechanical conveyance.

68. The system of claim 53, wherein the output assembly is configured to controllably release the targeted package to an output container.

69. The system of claim 68, wherein the output container is selected from the group consisting of: a bin, a sack, a tote, a gaylord container, a chute, a conveyance.

70. The system of claim 53, wherein the first computing system is operatively coupled to the output assembly.

71. The system of claim 70, wherein the output assembly is configured to controllably release the targeted package to a distribution module, the distribution module being operatively coupled to the first computing system and configured to controllably release the targeted package to an output container.

72. The system of claim 68, wherein the output container is selected from the group consisting of: a bin, a sack, a tote, a gaylord container, a chute, a conveyance.

73. The system of claim 71, wherein the distribution module comprises a tray or bin movably coupled to a transport assembly coupled between the distribution module and the output assembly.

74. The system of claim 73, wherein the distribution module is movably coupled to the transport assembly using a pan-tilt actuation assembly operatively coupled to the first computing system.

75. The system of claim 73, wherein the transport assembly comprises an elevated gantry assembly configured to have physical access to an array of available output containers.

76. The system of claim 73, wherein the transport assembly comprises a rail assembly configured to have physical access to an array of available output containers.

77. The system of claim 75, wherein a plurality of output containers comprising the array of available output containers may be coupled together as an assembly to be transferred away from the output assembly together.

78. The system of claim 75, wherein a plurality of output containers comprising the array of available output containers may be removably coupled together as an assembly to be transferred away from the output assembly together.

79. The system of claim 71, wherein the distribution module is configured to be able to controllably release the targeted package to a targeted output container selected from an array of available output containers.

80. The system of claim 79, wherein the first computing system is configured to operate the distribution module to sequence packages into one a plurality of targeted output containers selected from the array of available output containers based upon a multi-pass sorting algorithm.

81. The system of claim 80, wherein the multi-pass sorting algorithm comprises a hash-sort configuration selected to facilitate efficient sequenced unloading of the plurality of targeted output containers.

82. The system of claim 79, wherein the first computing system is configured to automatically controllably release the targeted package to a targeted output container selected from an array of available output containers based at least in part upon image information from the first image capture device.

83. The system of claim 82, wherein the first computing system is configured to automatically controllably release the targeted package to a targeted output container selected from an array of available output containers based at least in part upon image information from the first image capture device which may be utilized by the first computing system to estimate a factor selected from the group consisting of: package geometry; package compliance; estimated package bounding box geometry; package relative mass; relative rigidity of package material; package mechanical stability; and package moment of inertia.

84. The system of claim 79, further comprising a second image capture device fixedly coupled to the distribution module and configured to provide image information pertaining to movement of packages between the distribution module and the array of available output containers.

85. The system of claim 84, wherein the second image capture device is further configured to provide image information pertaining to interior portions defined within output containers comprising the array of available output containers.

86. The system of claim 85, wherein the second image capture device is configured to provide image information pertaining to interior portion factors selected from the group consisting of: shape of interiors of output containers, geometry of items within output containers, and fill level within output containers.

87. The system of claim 86, wherein the first computing system is configured to operate the distribution module to place the targeted package into the targeted output container with a position and orientation automatically selected to optimize geometric fit of the targeted package within the targeted output container.

88. The system of claim 79, wherein the first computing system is configured to operate the distribution module to sequence packages into one a plurality of targeted output containers selected from the array of available output containers based upon a known pattern regarding a planned unloading of the plurality of targeted output containers.

89. The system of claim 79, wherein the first computing system is configured to operate the distribution module to sequence packages into one a plurality of targeted output containers selected from the array of available output containers based upon a known pattern regarding a planned relative positioning of the plurality of targeted output containers within a delivery vehicle.

90. The system of claim 79, wherein the first computing system is configured to operate the distribution module to sequence packages into one a plurality of targeted output containers selected from the array of available output containers based upon a known delivery route pertaining to a planned unloading of the plurality of targeted output containers.

91. The system of claim 53, wherein the input assembly comprises a herringbone conveyance operatively coupled to the first computing system and configured to automatically position the one or more packages in a central position within reach of the end effector assembly.

92. The system of claim 91, wherein the first computing system is configured to operate the herringbone conveyance based at least in part upon the image information from the first image capture device.

93. The system of claim 53, wherein the input assembly comprises an input conveyance and a plurality of movable members configured to extend above the input conveyance, the plurality of movable members and input conveyance being operatively coupled to the first computing system and configured to automatically reposition the one or more packages when on the input conveyance.

94. The system of claim 93, wherein the first computing system is configured to operate the plurality of movable members and input conveyance based at least in part upon the image information from the first image capture device.

95. The system of claim 53, wherein the first image capture device is configured to capture image information pertaining to the one or more packages as they are positioned upon the input assembly.

96. The system of claim 95, wherein the first computing system is configured to establish an identity for each of the one or more packages based at least in part upon the image information captured from the input assembly.

97. The system of claim 96, wherein the first computing system is configured to utilize the established identity in releasing the targeted package to the output assembly.

98. The system of claim 97, wherein the first computing system is configured to utilize the established identity in releasing the targeted package to the output assembly based at least in part upon characteristics of the targeted package which may be associated with the established identity.

99. The system of claim 96, wherein the first computing system may be configured to associated other predetermined information pertaining to the one or more packages from another operatively coupled computing system based at least in part upon the image information captured from the input assembly.

100. The system of claim 53, wherein the input assembly comprises a primary item processing/input system.

101-200. (canceled)
